(19) United States
(12) Patent Application Publication
(10) Pub. No.: US 2024/0362994 A1
(43) Pub. Date: Oct. 31, 2024

(54) GLOBAL TRACKING DEVICE SYSTEMS

(71) Applicant: PB, Inc,, Renton, WA (US)

(72) Inventors: Daniel J Daoura, RENTON, WA (US); Pawel Kazimierowicz, Krakow (PL); Kal Karel Lambert, Hammond, OR (US); Radoslaw Sajdak, Krakow (PL); Damian Smela, Krakow (PL); Marina Marques, Renton, WA (US); Nicholas Gutraich, Renton, WA (US)

(21) Appl. No.: 18/242,482

(22) Filed: Sep. 5, 2023

Related U.S. Application Data
(63) Continuation-in-part of application No. 17/228,403, filed on Apr. 12, 2021, now Pat. No. 11,792,605.
Application No. 17/228,403 is a continuation-in-part of application No. 16/747,458, filed on Jan. 20, 2020, now Pat. No. 10,979,862.
Application No. 16/747,458 is a continuation-in-part of application No. 14/301,236, filed on Jun. 10, 2014, now Pat. No. 10,580,281.
Application No. 17/228,403 is a continuation-in-part of application No. 16/207,192, filed on Dec. 3, 2018, now Pat. No. 11,145,183.
Application No. 16/207,192 is a continuation-in-part of application No. 15/853,917, filed on Dec. 25, 2017, now Pat. No. 10,424,189.
Application No. 15/853,917 is a continuation of application No. 14/301,250, filed on Jun. 10, 2014, now Pat. No. 9,892,626.
(63) Continuation-in-part of application No. 17/699,112, filed on Mar. 19, 2022, now Pat. No. 11,799,573.
Application No. 17/699,112 is a continuation-in-part of application No. 17/069,686, filed on Oct. 13, 2020, now Pat. No. 11,403,924.
Application No. 17/069,686 is a continuation of application No. 15/959,250, filed on Apr. 22, 2018, now Pat. No. 10,937,286.
Application No. 15/959,250 is a continuation-in-part of application No. 15/863,731, filed on Jan. 5, 2018, now Pat. No. 10,063,331.
Application No. 15/863,731 is a continuation of application No. 15/681,806, filed on Aug. 21, 2017, now Pat. No. 9,900,119.
Application No. 15/681,806 is a continuation of application No. 14/967,339, filed on Dec. 13, 2015, now Pat. No. 9,774,410.
(60) Provisional application No. 62/260,313, filed on Nov. 26, 2015.
(60) Provisional application No. 62/256,955, filed on Nov. 18, 2015.
(60) Provisional application No. 63/536,430, filed on Sep. 3, 2023.
(60) Provisional application No. 63/528,056, filed on Jul. 20, 2023.

(51) Int. Cl. G08B 25/10; G08B 25/08; G08C 17/02

(52) U.S. Cl. CPC G08B 25/10; G08B 25/08; G08C 17/02; G08C 2201/20; G08C 2201/91

(57) ABSTRACT

Using synergic AI in multi-layered radio networks, a global location service based on remote learning has been realized by a system for coupling the BTx devices of the IOT to the IP Packet Data network that powers the Internet. In a first embodiment, a smart device is configured as a radio proximity-actuated “community nodal device” by an “App” that operates as part of the system. The community nodal device is given instructions to function as a “soft switch” to automatically “upswitch” local area Bluetooth®, Wi-Fi®, or 6LoWPAN “messages” (and radio contact logs received from endpoint nodes that represent IOT radio signal topology) to a cloud-based server, where the messages are interpreted for the benefit of a particular user or a community of users, and commands may be transmitted for execution to a remote device or a network of endpoint nodes. The commands may be user-specific if a message contains or pertains to a user identifier, but also may be community-specific, based on the generic character and content of a message, the pattern of messages, the tempo of messaging, or a community identifier in the fields of the message. The AI or machine learning resource exports a predictive algorithm to the end nodes in a process termed here “distributed AI platform”, integration with the end node's dataset and user profile. The end nodes then provide feedback to the cloud host that scores the algorithmic performance based on realworld location-based services and outcomes over a 2 week or 2 month timeline. A poly-radio satellite transceiver, with multiple form factors for plug-in BTx/Wi-Fi installation, powered by PoE or battery, is introduced to support the new infrastructure, which challenges the value proposition of Email, SMS, WhatsApp, LinkedIn, WeChat, AppleTalk, and other network instruments, in scaling user adoption.

### CROSS REFERENCE TO RELATED APPLICATIONS

This Patent Application U.S. patent Ser. No. 18/242,482 is a Continuation-in-Part of U.S. patent application Ser. No. 17/228,403, titled “Tracking Device Systems”, filed 12 Apr. 2021, now U.S. Pat. No. 11,792,605, which is a Continuation-in-Part of U.S. patent application Ser. No. 16/747,458, filed 20 Jan. 2020, titled “Tracking Device System”, now U.S. Pat. No. 10,979,862, which is a Continuation-in-Part of U.S. patent application Ser. No. 14/301,236, filed 10 Jun. 2014, titled “Tracking Device System”, now U.S. Pat. No. 10,580,281.

This Patent Application U.S. patent Ser. No. 18/242,482 is a Continuation-in-Part of U.S. patent application Ser. No. 17/228,403, filed 12 Apr. 2021, titled Tracking Device Systems, filed 12 Apr. 2021, now U.S. Pat. No. 11,792,605, which is a Continuation-in-Part of U.S. patent application Ser. No. 16/207,192, filed 3 Dec. 2018, titled “TRACKING DEVICE PROGRAMS, SYSTEMS AND METHODS”, now U.S. Pat. No. 11,145,183, which is a Continuation-in-Part of U.S. patent application Ser. No. 15/853,917, filed 25 Dec. 2017, titled “Tracking device programs, systems and methods”, now U.S. Pat. No. 10,424,189, which is a Continuation of U.S. patent application Ser. No. 14/301,250, filed 10 Jun. 2014, titled “Tracking Device Program”, now U.S. Pat. No. 9,892,626.

This Patent Application U.S. patent Ser. No. 18/242,482 is a Continuation-in-Part of U.S. patent application Ser. No. 17/699,112, filed 19 Mar. 2022, titled “Radiobeacon Data Sharing by Forwarding Low Energy Transmissions to a Cloud Host”, which is a Continuation-in-Part of U.S. patent application Ser. No. 17/069,686, filed 13 Oct. 2020, which is a Continuation of U.S. patent application Ser. No. 15/959,250 filed 22 Apr. 2018, now U.S. Pat. No. 10,937,286, which is a Continuation-in-Part of U.S. patent application Ser. No. 15/863,731 filed 5 Jan. 2018, now U.S. Patent Ser. No. 10,063,331, which is a Continuation of U.S. patent application Ser. No. 15/681,806, filed 21 Aug. 2017, now U.S. Pat. No. 9,900,119, which is a Continuation of U.S. patent application Ser. No. 14/967,339, filed 13 Dec. 2015, now U.S. Pat. No. 9,774,410, which claims the benefit of priority under 35 U.S.C. § 119(e) from U.S. Provisional Patent Appl. No. 62/260,313, filed 26 Nov. 2015 and from U.S. Provisional Patent Appl. No. 62/256,955 filed 18 Nov. 2015. This Patent Application U.S. patent Ser. No. 18/242,482 also claims the benefit of priority under 35 U.S.C. § 119(e) from U.S. Provisional Patent Application No. 63/536,430, titled “Global Tracking Device Systems”, filed 3 Sep. 2023 and U.S. Provisional Patent Appl. No. 63/528,056, titled “Global Bootswap Adaptor for FHSS radiotags”, filed 20 Jul. 2023. All said cross-referenced patent documents are incorporated herein in full by reference for all that they teach.

### TECHNICAL FIELD

This disclosure pertains generally to the field of solutions utilizing radio devices, crowdsourcing and artificial intelligence to provide a platform and network for location-based services.

### BACKGROUND

“Radiotags” were developed initially as cookie-sized “radiobeacons” that broadcast a script intended to advertise services to customers via a potential customer's smartphone. An ecosystem arose in which radiotags provided location-specific sensor information that could trigger remote action (U.S. Pat. No. 9,392,404 et seq). As IP Packet Data addressing became standardized for Internet services, radiotag broadcasts came to rely on smartphone intermediaries to exchange information and commands with the developing cloud infrastructure.

Recent improvements in analog and digital hardware suggest that new opportunities exist for a generation of smart radiotags that participate in the IoT for collecting location-based “information” and receive AI-taught instructions by which edge computing of global lost-and-found services, and location-based services more generally, can be realized.

### SUMMARY

Embodiments of the “tracking devices and systems” (also termed “radiotag systems”) of the invention are configurable to help track or find lost items, assets, pets, children and so forth. The terms “tracking device” and “radiotag” may be used interchangeably to indicate a wireless Bluetooth® radio device (optionally with dual, tri-, or quad-radio capacity, more generally poly-radio capacity) that is attachable to an asset, person or pet in need of location and tracking services, and include systems for sensor data collection. The terms may be applied to devices that advertise by transmitting data, devices that are transceivers, and devices that conserve energy by switching between advertising, listening only, and interactive modes. Currently, there are about 50 Billion radiotags on the planet, and the device population is growing exponentially.

Bluetooth® radio devices are generally configured as a radio and modem on a single chip, with a firmware stack, but may include hybrid systems having dual radio capability, such as adding a 6LoWPAN radioset and Wi-Fi radioset together on a chip, as are termed here XWB devices. The radio devices may also include a Cellular radioset and modem in which the Cellular modem receives at least some energy management services from the Bluetooth radio modem, as responsive to ambient Bluetooth radio signal topology and are termed here XCB devices. Cellular radiosets and modems must include a SIM module to be connectable to a Cellular network.

Not just Cellular, satellite transceiver radio and modem chips may be included in the poly-radio devices described here, all of which include Bluetooth radiosets. Advantageously, satellite radio and fully powered Wi-Fi radio systems may exchange information between ground stations or between access points without the of the Cellular networks. Bluetooth radio is limited to a short range, as is both a feature and a failure. The feature is that Bluetooth radio is specifically ‘proximity radio’, which inherently indicates that all radio data exchanged by Bluetooth radio is local, as has profound implications for systems that supply location-based services, particularly when the data exchanged is the radio contact data itself.

These radiotag systems are globally deployable, and are comprehensive solutions for location services, including the capacity to locate, monitor and track missing pets, people, luggage, inventory, tools and other assets, generally termed “items of interest”. The radiotags may be attached to the items of interest or may be embedded in them.

In some embodiments, tracking devices incorporate various sensors and control mechanisms that make the tracking devices a versatile multi-function device which can remotely control other devices such as smartphones, garage doors, coffee pots, computer networks, and so forth. The devices are instrumental in shaping and creating a market for the “Internet of Things” (IoT) by allowing a user or network of users to seamlessly share sensor data-providing a global, regional, local and intimate picture of environmental conditions such as temperature, movement, sounds, trends, social interactions in a selected locale. The sensor data may yield information as a collaborative picture from a population of devices as may be useful in teaching artificial intelligence (AI) resources so that reliable prediction by hindsight during training can be the foundation of expert prediction of future events, outcomes and conditions. Generally, sensor data can be analyzed as above or below a programmable threshold or fit to a chronological trendline that breaks a programmable threshold, for example.

The tracking device typically has a speaker (broadly including buzzers), a light emitting diode, and a direct or indirect user interface. A control apparatus is associated with the tracking device. The control apparatus may command the tracking device to emit an alert, including a buzz or flashing light, for example. If a tracked item is inside a drawer or under a pillow, the person searching for the item will hear the buzzer or see the flashing light. The control apparatus may also set its own alerts to be triggered based upon the distance (also termed a “radio leash”) between the tracking device and the control apparatus. Alerts can be based upon pairing the location of the tracking device to the alert (also termed a “geofence”) so that alerts are only provided at predetermined locales and/or predetermined times in defined locations. Alert and notification logical relationships, as supported by “information”, are termed “conditional rules”, each rule having an informational trigger condition and an engineered result that may be local or remote.

Various embodiments of the tracking devices conserve power and space and are typically battery operated. The electronics of the tracking device may be carried in a small housing on a crescent-shaped printed circuit board that partially encircles a battery, for example. Encircling the battery with the printed circuit board reduces the thickness of the tracking device. Top and bottom covers enclose the printed circuit board and the battery. Optionally, one cover has an opening to access the battery. In some embodiments the battery may be wirelessly recharged with inductive or solar powered chargers.

The electronics include a Bluetooth Low Energy transmitter (BTx) and modem that has enough computing power to control at least itself and to transmit at least one signal. More typically the device is a transceiver. A ceramic radio antenna further conserves space. The device may include sensors. In some embodiments the sensors include a multi-axis sensor such as a nine-axis motion sensor, a heading sensor with magnetic compass and multiaxis gyroscope, an altimeter, a temperature sensor, and other sensors selected for particular applications. Embodiments may omit GNSS sensing circuitry and rely on the GNSS circuitry in network-accessible or companion devices or on a satellite network to reduce power demand on the battery, for instance. Location services may also be accessible via AGPS and POLTE, for example. Frequently cited here as “companion devices” are the ubiquitous smartphones carried by more than 3 Billion people; these devices may be referred to here generically, including “smart devices” generally, as a “control apparatus”.

In a first embodiment, the control apparatus is a smartphone or other smart device with internal Bluetooth® radioset combined with a SIM card and cellular radio. Other network embodiments for the tracking devices in a local network use a “hub” that communicates with local tracking devices and relays their sensor outputs to a cloud/internet site. Multiple hubs can form a wider area network that allows the hubs to communicate with each other and triangulate the approximate position of each tracking device using BTx or UWB radio signals, for example. In a still wider area network, tracking devices anywhere in the world can be monitored by position, time of day, motion and any other characteristic or parameter sensed by a tracking device, including radio signal topologies. Tracking devices may communicate with each other in mesh networks using a frame (sometimes termed a “packet”) signal structure licensed by the BT Special Interest Group (BT SIG, Kirkland WA) as well as communicate with wired and wireless devices capable of interacting with the World Wide Web.

The tracking devices are assigned to an owner-user who may grant privileges to others for using personal control apparatus for accessing the device. The owner-user may also have shared privileges with tracking devices of other users. Objects lost anywhere in the world may be located by using position data provided by other control devices (sometimes termed “bystander devices”) that carry a control program and are registered to a cloud/Internet site or sites operated to maintain user profiles, contact information, and radio unit identifier (RUI) data associated with tracking devices. Tracking devices may also be public devices that function as radio landmarks for direction finding or as guides to hotspots.

The embodiments described here generally provide a computer program (sometimes termed an “App”) that is installed on a control apparatus. The computer program enables the control apparatus to detect tracking devices within range of the control apparatus and optionally to report radio contacts to an administrative cloud/Internet site or sites or trigger other APIs based on sensor data input with the signals, for example. The program may include instructions for pairing with and acquiring control of tracking devices, as known in the art. Under defined conditions, unless another control apparatus already controls the device, the control apparatus may release one or more selected tracking devices from its control. The control program also may allow the user to keep private the information and any private radio unit identifiers of the tracking device. In a preferred embodiment, once set to private, only the control apparatus or other designated apparatuses or individuals will have access to personally identifiable data from the tracking device.

The control program allows the user or the user's substitute to set or select at least one alert. The control device or the tracking device or both may generate the alerts as programmed. In order to trigger the alert on a control device or some other remote device, the tracking device broadcasts a radio signal via the Bluetooth transceiver. The signal strength of the beacon signal received by the control apparatus is representative of the distance or range between the control apparatus and the tracking apparatus. The signal strength is considered a “condition” for a distance alert. If a control apparatus suddenly receives a signal of a controlled (“owned”) tracking device, the control apparatus may indicate the device has returned to a location proximate the control apparatus. Likewise, failure to detect a radio signal of a controlled tracking device indicates the device is outside the range of the control apparatus. Using this logic, various conditions for “LEFT BEHIND” and “LOST” alerts are described below. Alerts may include notifications to the owner-user. The notifications may be pre-programmed by the owner-user or may be established by a system administrator.

The control apparatus or the tracking device or both may monitor other conditions. Each other condition and combinations of two or more conditions may be paired or otherwise associated with each other to provide multiple conditions for triggering an alert. In addition to the range signal itself, the tracking device may carry one or more sensors and each sensor may output one or more digital signals (“information”) representative of other conditions monitored by the sensors such that the sensor data is transmitted with the radio signals(s). Other conditions include and are not limited to motion of the sensor in any direction or in a particular direction, including accelerometric data, temperature, a signal representative of the status of the charge of the battery, and so forth. Signals representative of time (such as for logged data), the geographic location of the tracking device or both, motion and other physical, biological or chemical conditions being monitored by sensors are transmitted. Radio traffic is also information and as such, the radio receiver itself is a sensor.

The signal may include an identification datum unique to each tracking device. All data is transmitted as a bitstream containing bits in fields or frames having a defined format that generally conforms to BT SIG standards. The program displays both the range and battery status information. As explained above, the location of the tracking device may be detected by other control devices, which may assist the owner in locating a lost tracking device. Accordingly, the control apparatus, if associated with a network of other control apparatuses, may acquire information about the location of a tracking device remote from the other networked control apparatus collectively. As we invented it, this collective capacity is termed “crowdsourcing” of lost-and-found services. The control program provides a feature for selecting a map displaying the remote location of each tracking device controlled by a control apparatus.

In other embodiments the control program allows the control system to remotely control operation of the tracking device or allow the tracking device to remotely control the control apparatus, or both. The control program enables the control apparatus to activate an audible or visual alarm or both by selecting a corresponding alarm button shown on a display of the control program. The control program allows the control apparatus to allow one of more of its operations to be controlled by the tracking device. The control program permits the user to set a multi-function button on the tracking device to operate a camera, an email, or a text messaging system of the control apparatus, for example. In addition, the multi-function button may be programmed with the control program to activate an audible alarm on the control apparatus. Pressing the multi-function button may cause a smartphone to emit a distinctive sound so that it is readily located when misplaced.

In yet other instances, the control program may be configured to allow the user to define groups of items (each having a tracking device) and to find or track those items as a group. In selected instances, the control program may be configured to track items leaving a geofenced area with other users. And in some instances the message traffic may be repurposed for orientation purposes.

Where poly-radiosets are provided, new emergent functions are achieved. XCB radiotags (with Cellular radiosets) are autonomous, and can CALL HOME when lost to notify the owner that the device is lost and to provide a current location. XWB radiotags (with Wi-Fi and optionally satellite radiosets) have the capacity to communicate directly with the cloud host in IP Packet Data formatted signals, to amplify their signals on the Wi-Fi modems of Access Points, and also to enter into meta-mesh networks with like radiotags and with BTx radiotags in general. These are P2P PAN devices that have an IP Address.

Devices with 6LoWPAN radiosets are programmable in IP Packet Data signal formats and include IPv6 identifiers. These are P2P PAN devices that have an IP Address. Because this capacity is achieved without the need for a SIM module, their introduction into the IoT is deeply disruptive of established information markets.

Other embodiments described here provide programming that is installable on a cloud host. The cloud host is a server or servers having an IP address and is accessible via a packet data environment. The cloud host includes programs and databases designed to implement lost-and-found location and tracking services. The cloud host may also have resources for AI, for development and release of learning modules that detect patterns in the local radio signal topology, and can be used to throttle the energy consumption of Cellular networks, for example, as is an important societal consideration.

### BRIEF DESCRIPTION OF THE DRAWINGS

The teachings of the inventive art disclosed here are more readily understood by considering the drawings in conjunction with the written description including the claims, in which:

FIG. 1A is a perspective view of the top of a first tracking device.

FIG. 1B is a reverse perspective view of the tracking device shown in FIG. 1A.

FIG. 1C is an exploded top-to-bottom perspective view of an assembly for a tracking device showing covers on opposite sides of a printed circuit board (PCB), a battery above to an opening in the PCB and a battery connector on one of the covers.

FIG. 1D is a reverse exploded perspective view of the tracking device shown in FIG. 1C.

FIG. 2A is block diagram of elements on the PCB.

FIG. 2B is a partial schematic of an alternative charging system.

FIG. 3 is a view of a basic tracking system.

FIG. 4 is a view of a single hub (hive) tracking system.

FIG. 5 is a view of a wide area location system for finding lost tracking devices or monitoring multiple sensors in tracked devices.

FIG. 6 is a view of screenshot 101 with “Login” of a control program.

FIG. 7 is a view of screenshot 102 with “Hive Grouping” of a control program.

FIG. 8 is a view of screenshot 103 with “Alerts and Radio Proximity” of a control program.

FIG. 9 is a view of screenshot 104 with “Tracking Device Profiles” of a control program.

FIG. 10 is a view of screenshot 105 with “Alert Setup and Remote Control” of a control program.

FIG. 11 is a view of screenshot 106 “Map View” of a control program.

FIG. 12 illustrates a control device set up to track multiple items that make up a user-defined group 1203.

FIG. 13 is a view of a screenshot 1300 of a control program, the screen having user interactive controls for finding and tracking groups of items.

FIG. 14 illustrates a group 1400 of BTx radiotags that report via a dedicated connection to a BTx radio of a smartphone 70.

FIG. 15 illustrates a group of BTx radiotags 1500 that in addition to connecting to the BTx radio of a smartphone, also are capable of forming a mesh network 1500a with each other.

FIG. 16 shows the BTx mesh network 1600a as an independent network.

FIG. 17A shows BTx device 1701 in a hub or star radio network 1700.

FIG. 17B shows a true peer-to-peer mesh network 1710.

FIG. 18 is a view of a BTx tracking device 1800 with an alternate form factor.

FIG. 19A is a view of a BTx radiotag 1900 with a thin credit card-like body.

FIG. 19B e 32) is a view of a radiotag 1950 with collar or wrist strap.

FIGS. 20A and 20B form a two-panel view of a block diagram of a general method of deploying and using an exemplary system of the invention.

FIGS. 21A, 21B and 21C show three layers of radio interconnects that have been evolving into a larger network.

FIG. 22 is a view of a pyramidal scheme of human radio networks. Not shown is the large data capacity of terrestrial and seafloor cables and other telecomm services such as fiber optics.

FIGS. 23A and 23B form a two-panel view illustrating the density of the BTx in what can be termed the Internet of Things (IoT).

FIG. 24 reinforces the point that in the prior art, links in the upper layers have limited proprietary connectability.

FIG. 25 diagrams the structure of a BTx transmission 2500 as specified by the BT Special Interest Group.

FIGS. 26A, 26B, 26C and 26D are sample packet structures that relate to the BTx advertising and link layers.

FIG. 27A, 27B, 27C, 27D, 27E are views of proprietary BTx advertising packets with data payloads, illustrating how fragmented this layer is by proprietary innovations.

FIG. 28 is a view of a first structure of a proprietary inquiry response packet from year 2014. The first two bytes of an 8 byte MAC Address are pre-empted as a manufacturer's identifier that is invariant from unit to unit.

FIG. 29 is a view of a second structure of a proprietary inquiry response packet from year 2023.

FIG. 30 describes the sophisticated power control engineered in BTx devices.

FIG. 31 establishes the basic Wi-Fi and/or Cellular radio linkage characteristic of handsets.

FIG. 32 is a view of a tracking device with onboarding capacity for OTA and data logging.

FIG. 33 is a first schematic of a flow chart for onboarding via OTA using a VPN with cloud assistant.

FIG. 34 is a schematic of a flow chart for onboarding using a WebApp configured for user hands-free updating via OTA.

FIG. 35A is a flow chart for a method of onboarding using a WebApp and FIG. 35B tabulates a use case with multiple operating systems.

FIG. 36 shows a screenshot of a tracking device setup and activation with successful implementation of local mapping display.

FIG. 37 shows a decomposition of a connection request packet to generate a radio contact payload 3765.

FIG. 38 is another view of signal decomposition as a part of a radio topology monitoring system.

FIG. 39 is a view of an IP packet data message containing radio contact information 3950.

FIG. 40 shows a concatenated structure 4001 useful in transmitting radio contact log information.

FIG. 41 is a view of a relational database for managing sequential snapshots of radio contacts.

FIG. 42 is a view of a rolling memory stack containing radio contact records.

FIG. 43 is a flow chart showing a method for controlling a community of devices by their BTx radio topology.

FIG. 44 is flow chart for finding lost tracking devices using cloud shortcutting.

FIG. 45 shows a hybrid XCB radiotag with BTx and Cellular radio with SIM and BTx radio environment-control of Cellular and MPU power consumption.

FIG. 46 shows a hybrid XWB radiotag with BTx and Wi-Fi radios, Satellite radio, RAM data logger and radio environment-control of power consumption.

FIG. 47 is an overview of a global system that includes a community of users, and is intended to show the basic concepts of “cloud shortcutting” for finding lost tracking devices.

FIG. 48A is an overview of a poly-radio network that provides multiple paths from the IoT to the cloud layer through the DMZ layer.

FIG. 48B is a view of a cybernetic network process of continuous learning and updating of the IoT network.

FIGS. 49A, 49B, 49C and 49D are CAD views of a tri-radio device with optional satellite transceiver for cloud shortcutting and crowdsourcing of location-based services in a global lost-and-found network.

FIG. 49E is a view of a cybernetic system that bypasses the DMZ layer and provides new infrastructure as a platform and network for delivering location-based services.

FIG. 50 introduces a Novel device that bypasses the DMZ layer and converts LAN modems worldwide into agents of a global lost-and-found system on an open-access global area network (GAN).

### GLOSSARY AND NOTATION

Although the Detailed Description contains specific details for the purposes of illustration, the following glossary is set forth as an aid in explaining the invention as claimed.

Certain terms are used throughout the following description to refer to particular features, steps or components, and are used as terms of disclosure and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. All words and phrases used herein generally take their meaning as consistent with usage as would be apparent to one skilled in the relevant arts. The following definitions supplement those set forth elsewhere in this specification.

“Bluetooth® Radio” (BTx) Communication devices and systems”—refer to radio technology licensed by the Bluetooth Special Interest Group (BT SIG) that uses the ISM band and divides transmitted data into bluetoothed packets, transmitting each packet on one of 79 designated Bluetooth channels for BTx Classic and 40 designated channels for BTLE (BTx Low Energy). BTx Classic defines channel bandwidth as 1 MHz. BTLE uses 2 MHz channel spacing. Within a channel, data is transmitted using Gaussian frequency shift keying (GFSK). While both the FCC and ETSI classify Bluetooth technology as a frequency-hopping, spread spectrum (FHSS) scheme, Bluetooth Low Energy is classified as a system using digital modulation techniques or a direct-sequence spread spectrum (DSSS). The idealized bit rate is up to 2 Mbps for BTx, about 1.5 Mbps for BTLE, and the maximum transmit power is 10 mW (100 mW in Bluetooth 5). In actual use, transmission is limited by payload size, although the maximum transmission unit (MTU) has been increased from about 27 bytes to about 250 bytes, with the capacity to do multiple slots and continuous streaming. However, transmission is inherently limited by packet back-and-forth protocols between a center device and a peripheral device, and rules about packet intervals. Recent introduction of quadrature modulation limits compatibility of legacy devices with newer hardware link layers, so this modulation is not widespread.

Per-packet overhead remains the same (i.e., 14 bytes). However, this overhead is now associated with payloads of up to 251 bytes instead of 27 bytes. MTU is “maximum transmission unit”, as needed for firmware updates, for example. Link Layer (LL): LL interfaces with the Physical Layer (PHY) and provides the higher levels an abstraction and a way to interact with the radio. This layer handles the transfer of L2CAP packets while ensuring guaranteed delivery and integrity of data. The PHY portion consists of the RF signal modulation, analog and digital baseband portion that use digital signal processor (DSP) and communication algorithm processing, including channel codes. It is common that these PHY portions are integrated with the medium access control (MAC) layer in system-on-a-chip (SoC) implementations. A major goal of all BTLE protocols is reduced power consumption for greater portability of deployments. The smartphone BTx and BTLE radios can consume up to 10% of a battery charge per hour, depending on the signal density in the local BTx environment and usage such as for cardiac monitoring. In contrast, ISA100.11a BTLE deployments (as are configured for IoT applications and industrial sensor automation) are designed to be battery-only and to literally run for years without intervention. More technical details, as would be known to those skilled in the art, are published in BT SIG and device manufacturer descriptions and may also be accessed at (1) en.wikipedia.org/wiki/Bluetooth, (2) en.wikipedia.org/wiki/Bluetooth_Low_Energy #Radio_interface, (3) en.wikipedia.org/wiki/Direct-sequence_spread_spectrum, (4) en.wikipedia.org/wiki/Frequency-hopping_spread_spectrum, and, (5) en.wikipedia.org/wiki/Bluetooth_Low_Energy #:˜:text=The %20new %20packet %20form at %20of, 31%20 bytes %20in %20Bluetooth %204, for example.

Bluetooth packets are not directly compatible with the IP Packet Data Protocol of the World Wide Web. In addition to services, characteristics, and descriptors defined by UUIDs, transmission payloads may also contain public and private addresses and URLs. The addresses may be MAC Addresses, or may be rotated, hashed or otherwise encrypted to require a public or private key to decrypt. Transmission protocols are changing to adapt to increased emphasis on user control of privacy.

BTx 5+ has introduced three new PHY protocols. BTLE 5 2M PHY doubles the bandwidth (to 2 MHz per channel) with a modified symbol profile. Earlier released Bluetooth 2 EDR doubled the data rate by employing a π/4-DQPSK or 8-DPSK phase modulation, but BTLE 5 2M PHY uses standard GFSK. Every transmission starts on the 1M PHY leaving it to the application to initiate a switch to the 2M PHY. Both sender and receiver will switch to the 2M PHY for extended transmissions. This is designed to facilitate firmware updates where the application can switch back to a traditional 1M PHY in case of errors. “Coded PHY” protocols also have been introduced for improved resolution at greater ranges. The “LE Coded” transmissions have not only changed the error correction scheme but use a fundamentally new packet format. Each “LE Coded” burst consists of three blocks. A new header block is followed by a payload of 2 to 256 bytes as a single burst. In contrast, BT 4 was limited to about 27 bytes of effective information per packet, a critical change. Older data signal architectures are termed “uncoded” in BT 5 and reverse compatibility is retained for now.

“Direct Sequence Spread Spectrum” (DSSS) is a type of spread spectrum technology in which the transmitted signal is spread across multiple frequency bands.

“Frequency Hop Spread Spectrum” (FHSS) is distinguished from DSSS in that the data transmission is encoded and decoded using a specific pattern called hopset, as shared by a Frequency Hop Sequence (FHS) packet. In DSSS, the data transmission is encoded and decoded using a pseudo-random binary sequence or chip code.

While in this discussion, Bluetooth® as a trademark is avoided in the Claims, any reference to FHSS or DSSS is intended to indicate, sensu lato, either one of BTx or BTLE, and either one of FHSS or DSSS modulation, and also any bluetoothed signals of a quadrature modulation type, as is found in some “bluetoothed” applications, as shall be generally termed “BTx radio systems and devices”. In other words, the moniker BTx shall be read broadly to include flavors of Bluetooth, including classic, BTx classic, BTx4, BTLE, BTx5+, BTx quadrature modulation, and other BTx radio protocols as introduced by BT SIG (Kirkland, WA).

“Peer-to-Peer” (P2P) relates to a kind if networking by which computers can share information and resources directly without relying on a dedicated central server. In peer-to-peer computing, every client can be a server so that roles of server and client are interchangeable.

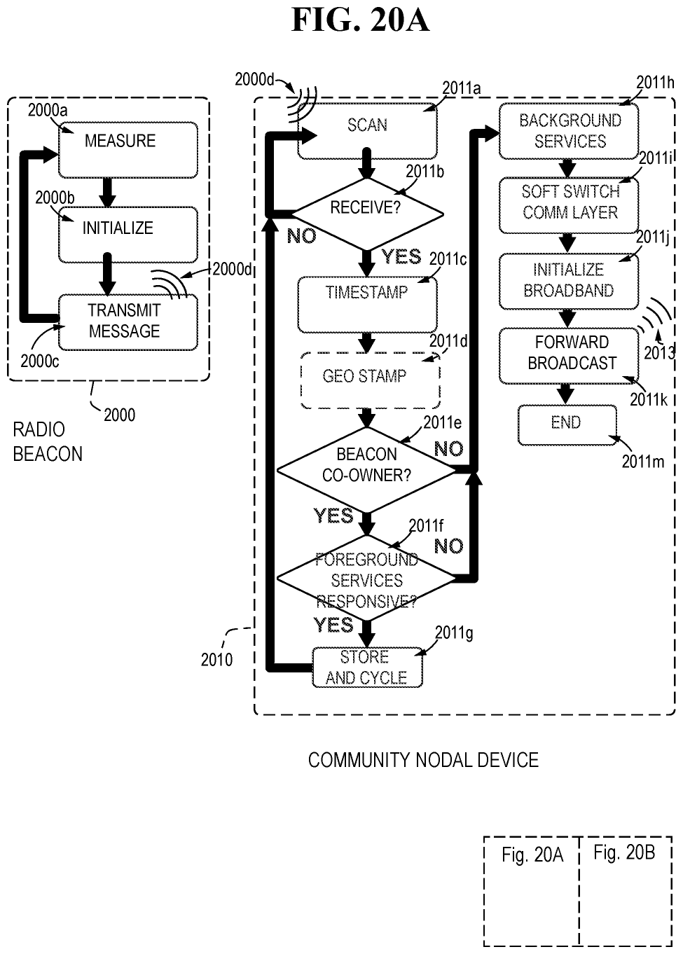

“Internet of Things” (IoT), relates to a network of devices with communications interconnections with the Internet, i.e., having capacity to read and/or write messages in the Internet Protocol (IP) Packet Data language. (However, as used here, the term is more specifically directed to layer 2202 (FIG. 22) in which “smart” wired and wireless nodes are embedded in or associated with the everyday items of living). Our particular interest in the IoT is in the envelope or “radio topology” of radio signals associated with the 2202 layer and the layer above it, the signal confluence zone 2210. These layers have higher predictive value for location than signals of higher layers, and are thus of particular interest for delivery of location-based services. As used here, “Radio topology” is a sensor field metric, not a network interconnect diagram.

“Smart devices” are most commonly illustrated here as smartphones (also termed “control devices” for this disclosure). These devices contain a package of computing features that include at least one display and/or user interface, a microcontroller, processor or GPU, supporting logic and memory circuitry, and at least one radio set. More typically the devices have four or more radio sets and several antennae, including cellular (LTE and/or GSM), Wi-Fi, Bluetooth (2.4 GHz or dual band), NFC, UWB, and FM. Also sometimes encountered are 802.15.4 radios for WPAN (such as the Zigbee, WirelessHART, MiWi, 6LoWPAN, Thread, Matter and SNAP specifications).

“Artificial Intelligence” relates to a process by which a training set is introduced to a computer designed with a learning function or “neural network”. The learning function is configured so that the training set enables the computer to predict proper responses to new queries, as is termed a “learning model”. More formally, AI is an iterative process where a computing machine running an algorithmic model learns heuristically from experience (i.e., from historical data) during the model training phase; then the trained AI models predict the output of real-world data presented as a query for various tasks such as classification, regression, and clustering. Multiple processors or threads may use the neural networks in multiple parallel pathways to solve problems more quickly.

“Computer” means a virtual or physical computing machine that accepts information in digital or similar form and manipulates it for a specific result based on a sequence of instructions. “Computing machine” is used in a broad sense, and may include logic circuitry having a processor, programmable memory or firmware, random access memory, and generally one or more ports to I/O devices such as a graphical user interface, a pointer or mouse, a keypad, a sensor, imaging circuitry, a radio or wired communications link, and so forth. One or more processors may be integrated into the display, sensor and communications modules of an apparatus, and may communicate with other microprocessors or with a network via wireless or wired connections. Processors are generally supported by non-volatile and dynamic memory, a timing clock or clocks, and digital input and outputs as well as one or more communications protocols. Computers are frequently formed into networks, and networks of computers may be referred to here by the term “computing machine.” In one instance, informal internet networks known in the art as “cloud computing” may e be functionally equivalent computing machines, for example. Computers are also devices in an IoT world, and the firmware and software behind the machine end of the system are all interconnected at the network level, generally with some user interface, but under ideal conditions, are automated to be simple and fast to complete tasks.

A “server” refers to a software engine or a computing machine on which that software engine runs, and provides a service or services to a client software program running on the same computer or on other computers distributed over a network. A client software program typically provides a user interface and performs some or all of the processing on data or files received from the server, but the server typically maintains the data and files and processes the data requests. A “client-server model” divides processing between clients and servers, and refers to an architecture of the system that can be co-localized on a single computing machine or can be distributed throughout a network or a cloud.

“Processor” refers to a digital device that accepts information in digital form and manipulates it for a specific result based on a sequence of programmed instructions. Processors are used as parts of digital circuits generally including a clock, random access memory and non-volatile memory (containing programming instructions), and may interface with other digital devices or with analog devices through I/O ports, for example.

In this work “central processing unit” (CPU), microprocessor unit (MCU) and microcontroller unit (MCU) refer to processors having various degrees of sophistication and cost.

A “bootloader” is a program or firmware utility in ROM that allows other programs to be loaded through a convenient interface such as a comm port. The bootloader will initialize a system on start and provides any startup data and state configuration to an application or to operating system.

“Record making”-refers to creating, entering and logging or storing a record of at least one datum and an associated timestamp in a memory module of a radioset. Record making also refers to a process of making radio contact records. Records of a received radio contact may include an identifier associated with the transmitter, a user identifier and permissions, a cellular telephone number, or an IMSI for example. Records may also include a UUID as used in BTx signals to denote services or mixed identifications. Records may also include a geostamp or other contextual information indicative of location, and radio signal strength of a received signal. Records in storage are generally retrievable, such as by accessing or searching a table or a database, or other computer-enabled data retrieval systems known in the art. Records may also be uploaded to a higher layer in a network, such as to a server or other cloud-based service and may be retrievable on request. In a preferred embodiment, record making is performed by a device capable of auto-provisioning location-based services, which comprises a first memory containing a Bluetooth radio contact log, the log having log entries that are timely records of intercepted Bluetooth radio signals, wherein each intercepted signal is represented as at least a bitstring captured from the signal in a corresponding log entry.

“Satellite Internet Constellation”—refers to a system or systems of Low Earth Orbit (LEO) communications satellites, beginning with Iridium and Globalstar, and resumed by Starlink, OneWeb, Amazon, Samsung, Boeing, ToTum, Roscosmos (Russia), formerly Hongwan (China), Space Pioneer (China), and more to follow, that link ground-based Internet portals and optionally may collect and process electronic signals. Given the low signal latency and the vulnerabilities of seafloor telenet cables, the number of LEO satellites in orbit is rapidly saturating the available space. Encryption services are ballooning as a result. Home satellite internet providers include ViaSat, Echostar, HughesNet and Starlink. OneWeb offers several hundred low-earth orbit (LEO) satellites.

“Internet Service Provider” (ISP) is a referent notation for the domain providing basic IP configuration services to users, i.e. servers for Domain Name System (DNS) and Dynamic Host Configuration Protocol (DHCP).

“Virtual Private Network” (VPN) is a secure overlay network on a common public infrastructure that allows a provider to maintain its own addressing and routing between its sites and to remote users.

### DETAILED DESCRIPTION

While exemplary embodiments have been illustrated and described, it will be appreciated that various changes can be made therein without departing from the spirit and scope of the invention.

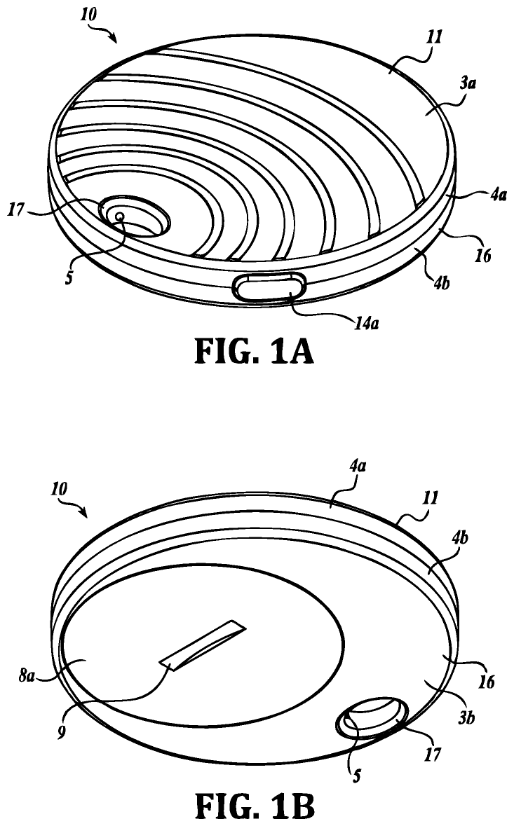

One embodiment of a tracking device 10 is shown in FIGS. 1A, 1B. The tracking device 10 is an assembly having outside covers 11, 16. The covers are made of glass filled acrylonitrile butadiene styrene (ABS) thermoplastic which is light in weight, can be injection molded and is resistant to impact, heat, water, acids, alkalis, alcohols and oils. The covers 11, 16 have circular-shaped bodies 3a, 3b, each with an annular wall 4a, 4b. The covers also form a through-hole 17 for receiving a cord or chain to attach the tracking device to an item, a pet or the clothing of a person.

Turning to FIGS. 1C, 1D, the covers 11, 16 enclose a printed circuit board (PCB) 12 and a battery 15. The PCB 12 has a crescent-shaped body with an outer edge 2a having a radius of curvature slightly smaller than the radius of curvature of the covers 11, 16 and an inner edge 2b with a smaller radius of curvature. Two circular arcs of different diameters thus define the crescent shape of the PCB 12. The PCB 12 has an opening 13a for receiving a circular battery 15.

The diameter of the battery 15 is smaller than the diameter of opening 13a in the PCB 12. The battery 15 has one terminal on its surface and another terminal on its edge.

The edge of the battery engages a conductive edge connector 18 on the inner edge 2b of the PCB 12. Another conductor has a spring-biased body 19 that extends from the PCB 12 toward the middle of an surface of the battery 15. The battery 15 is held in the opening 13a, 13b between the two covers 11, 16 and against the conductive edge connector 18 on the inner edge 2b of the PCB 12. Cover 11 has a ripple wave design on its surface.

Cover 16 has an opening 13b sufficient to receive the battery 15. A threaded battery cover 8a, a matching threaded annular wall 8b and an O-ring 7 secures battery 15 in the openings 13a, 13b. A detent 9 in the surface of the battery cover 8a receives an opening tool, such a screwdriver or the edge of a coin (not shown). Inserting the tool in the detent and rotating the cover 8a opens the cover to access the battery. In an alternate embodiment as shown in FIG. 1E, the slot 9 is replaced by two spaced-apart holes 110, 111. A key 115 has two prongs 112, 113 that fit into the spaced-apart holes and allow a user to apply torque to the cover 8a to open it and remove the battery 15.

The tracking device is assembled by inserting a PCB 12 with component circuitry on the inside surface of cover 16. The other cover 11 is placed on top of cover 16 to define a cavity that holds the battery 15 and the PCB 12. The two covers are ultrasonically sealed to resist water or other materials from entering the device 10. A battery is inserted through opening 13b in cover 16 and the battery cover 8a engages the O-ring 7 and the threaded wall 8b. Cover 8a rotates in opposite directions to close or open. By encircling the battery with the PCB 12, the PCB does not increase the thickness of the assembly that is determined only by the covers 11, 16 and the thickness of the battery 16. Some embodiments are 5 mm thin and 40 mm in diameter. Unlike other devices that use batteries, the PCB does not contribute to the thickness of the device 10 because the battery 15 does not rest on the PCB 12 but is partially encircled by the opening 13c in the PCB 12.

A multi-function button 14a extends from an opening defined by half-oval walls 14b, 14c in the sidewall of the junction of the annular walls 4a, and 4b. In one embodiment there is a single multi-function rubber button 14a that extends from the edge of the device. Button 14a is held in place by wall edges 14b, 14c that overlap surface 14d to hold the rubber button 14a inside the covers 11,16. The rubber button is aligned with a mechanical button 14e that is attached to the PCB 12 and coupled to core device 21. The covers 11, 16 and the PCB 12 have aligned openings 17a, 17b, 17c that create an external key ring hole 17 for holding a key ring, a carrying chain or cord. As will be explained below, the component circuitry has a speaker for sounding one or more alarms. The edge of the covers defines a key ring hole 17 that has one or more small holes that may be sealed. In those embodiments a removable rubber plug 5 is inserted into the hole to prevent moisture and water from entering the cavity holding the component circuitry 20. As an alternative, a larger rubber plug could fill the entire keyhole opening 17 or at least cover the annular inner surface of the keyhole.

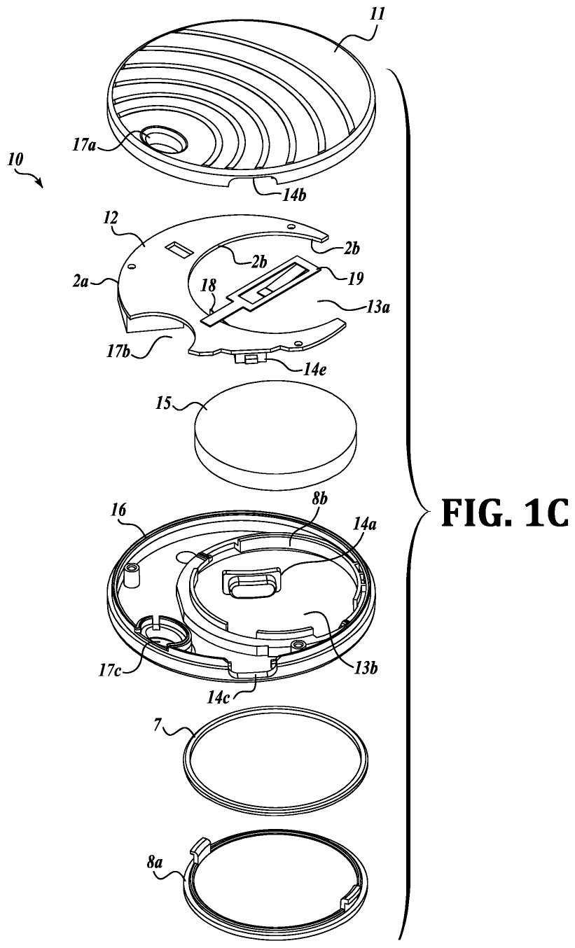

FIG. 2A shows the component circuitry 20 of the PCB 12, including a Bluetooth low energy (BTLE) core device 21. The core device 21 includes a transceiver for sending and receiving information signals and control signals. The core device also includes a microprocessor, read only memory and random access memory sufficient to enable the core device 21 control the other components on the PCB 12. In a further embodiment, a permanent or removable memory device is added to the device. The memory may be added through another side hole similar to the side hole formed by walls 14b, 14c that hold the rubber button 14d in place. The memory device could be inserted or removed through the second sidewall hole and a rubber stopper, similar to rubber button 14a, would seal the opening second sidewall hole. The memory device may hold information sensed by the sensors.

Core device 21 is typically an SoC. The core device 21 is assigned a unique radio unit identification code known to the user and the core device may broadcast the code at periodic intervals, although with newer advertising protocols, other radio unit identifiers are being used. The maximum range of the core device 21 is approximately 300 feet.

Broadcasts are made using a ceramic antenna 22. The ceramic antenna saves space. A typical ceramic antenna may take up only 20% of the space occupied by a trace antenna, thereby contributing to the overall small size of tracking device 10.

The core device 21 controls a speaker 23 and a light emitting diode (LED) 24.

The speaker 23 and the LED 24 provide alarms for the tracking device 10. The cover 11 is thin enough to allow light to pass through. In alternate embodiments, a clear or highly translucent window is provided in the cover 11 above the LED 24.

The core device 21 is connected to one or more sensors 25, 26 or any number of sensors 27. The sensors in some embodiments sense physical parameters experienced by the tracking device 20, including and not limited to displacement, motion, acceleration, electromagnetic radiation, radioactivity, temperature, sound, pressure and other physical parameters. In some embodiments, a sensor 25 is a combined 9-axis motion sensor and temperature sensor. The sensor 25 has an accelerometer, gyroscope, and magnetometer for each axis. The information output by the 9-axis sensor enables the receiver to track the position of the tracking device from one location to another location. The motion of the tracking device can be monitored continuously as long as a receiver is close enough to record the motion output information of the 9-axis sensor 25. As an alternative, the information may be stored in the memory.

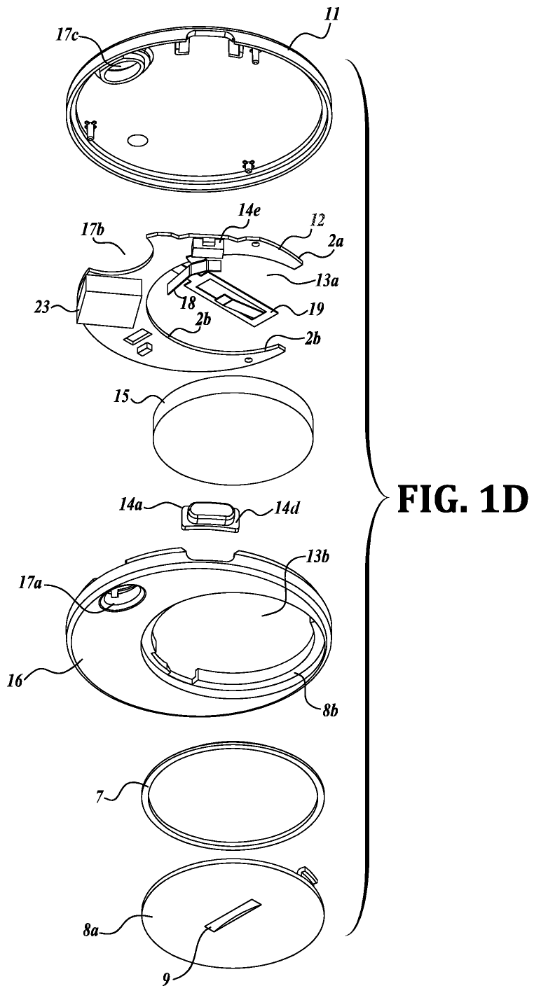

A multi-function button 14a is operable to perform one of more functions described in more detail below. The single button 14a on the tracking device 10 and one or more control programs resident on a control apparatus 70 (see FIG. 3) operate together to set one or more alarms, pair triggers and remotely control operations of the control apparatus 70. Those skilled in the art understand that a control apparatus may be any electronic device with processor, memory and communication ability including and not limited to a smartphone, a smartwatch, a desktop computer, a laptop or notebook computer, a tablet computer, a personal digital assistant, or any equivalent device that can store and hold programs and data, execute programs, receive and/or transmit information and commands via wired or wireless channels of communication.

Some embodiments of the invention are equipped with rechargeable batteries that may be recharged via a wireless or wired recharging apparatus or a solar recharging apparatus. Wireless chargers, also known as induction chargers, typically place one coil in a charging device or pad that is connected to an AC power source and another (receiver) coil inside the device with a rechargeable battery. As shown in FIG. 2A, a transmitter module 28a has a transmitter coil 28b that produces a time-varying electromagnetic field that is coupled to a receiver coil 29b of a receiver module 29a on the PCB 12. The receiver module 29a also includes circuitry to convert AC voltage and current to DC voltage and current. The core device 21 controls operations of the receiver module 29a and turns it on and off to recharge the battery 15 as needed. Transmitter and receiver modules are available from a number of integrated device manufacturers.

Other embodiments of the invention may have wired rechargers. These are well known devices and may be incorporated into tracking devices 10 by providing a suitable port (not shown) to receive power from an external power source. However, such external ports provide openings in the covers 11, 16 where water or other fluids may gain entry to the cavity holding the PCB 12 and its component circuitry 20.

Still other embodiments may have solar recharging systems such as shown in FIG. 2B. One such solar recharging system 120 has one or more solar cells 125, 126 located on respective covers 11, 16 and connected to a battery regulator circuit 128 and rechargeable battery 115. Core device 21 is connected to the regulator circuit 128 and battery 115. The core device 21 uses the solar current to know whether the tracking device is in available light or not. In that way, the solar cells provide a dual role by acting as light sensors. This allows further flexibility by pairing any other sensed parameter to the presence or absence of light. The amount of current generated by the solar cells 125, 126 indicates the intensity of light received by the tracking device 10.

Other embodiments of the tracking device have circuitry for harvesting RF power to charge the battery 115. At hindawi.com/journals/apec/2010/591640/there is described an RF harvester having a GMS antenna, one or more resonant circuits, boosters, peak detectors and an adder. The circuitry contains passive components and is designed to have tuned circuits at known frequencies of cell phone towers (960 MHz) and Bluetooth devices (2.4 GHz). The boosters are Villard voltage multipliers. Reported test results show the RF harvester located within 500 meters of a cell tower was capable of generating 158 nW and successfully operated a calculator and a light emitting diode.

Turning to FIG. 3, an embodiment of a first system 30 is shown. The system includes tracking devices TD₁ 31, TD₂ 32, . . . TD_{N} 33. Each tracking device 10 is paired with a control apparatus 70 which may be a computer, a tablet, a smartphone or a smartwatch, for example. As shown here, the control apparatus is smartphone 70. The nomenclature TD1 is shorthand for a radio unit identifier that can be a “nickname” but is associated with a radio bitstring that is globally unique. The control apparatus 70 has a transceiver for establishing a wireless connection to the cloud/internet 35. In this patent a symbolic cloud and the reference number 35 are metaphors for the internet itself, for local area networks, for wide area networks and for individual sites on the internet where users may store and retrieve programs and data. Control apparatus 70 may create one or more alerts based upon the relative location between the control apparatus 70 and tracking devices 31-33 and information detected by the sensors 27 in the devices. The system 30 may be used to find a lost item attached to a tracking device 10, set an alert for when an object, pet or person bearing a tracking device 10 moves into or out of one or more predetermined ranges, and pair alerts with locations or motions of the tracking device 10. The owner-user may share with others information transmitted by the tracking devices 31-33 and control of devices 31-33.

Accordingly, another user with a control apparatus 38 may use the same tracking devices 31-33 to establish alerts on the control apparatus 38 that are different from those of the alerts created by control apparatus 70.

Remote controls for television sets are frequently lost. The system 30 solves the problem of finding a lost remote control or other item 34. A tracking device 31 is attached to a remote control or item 34. Any suitable means for attaching is acceptable including hook-and-loop fasteners or adhesives that attach to the item 34 and the tracking device 31. Other attachment means include a chain or cord for attaching the item 34 via a key ring hole. The control apparatus 70 has a program 100 that provides a control menu associated with the tracking device 31. The tracking device 31 has a speaker 23 and an LED 24 that operate upon commands received from the control apparatus 37. The control apparatus 70 sends a suitable signal to the core device 21 to cause the speaker 23 to generate a distinctive sound, such as a buzz or ring, and to operate the LED 24 in a flashing mode, or both, in order to locate the item 34.

The system 30 may also monitor when an object, pet or person enters or leaves a predetermined range with respect to the control apparatus 37. For example, another tracking device 32 has a cord or chain 36 connecting to an object, a collar of a pet, to an article of a person's clothing, surrounding a wrist of a small child or an Alzheimer's patient. The control apparatus 70 sets one or more alerts depending upon the distance between the control apparatus 70 and the tracking device 32. If a parent were shopping with a small child, the parent may program the control apparatus 70 to issue one or more alerts depending upon the distance between the child wearing tracking device 32 and parent carrying the control apparatus 70. If the child and parent became separated by a first predetermined distance, such as 10-15 feet, the control apparatus would emit a first alert, such as one of the many sounds or vibration patterns that are included on a smartphone. If the separation becomes larger, such as 30-50 feet, a second alert would occur with a different sound and/or vibration. A third alert could be provided when the tracking device 32 lost radio contact with the control apparatus 70.

The system 30 may remind a user to take along key personal items before leaving a predetermined location. Tracking devices 33 could be attached to a key ring, a laptop or tablet computer, a briefcase, a purse, a wallet, luggage, a backpack or other personal items. A user may carry the tracked items during travel from one place to another. If the user departs a location and forgets the tracked item, an alert would sound on the control apparatus 70 to advise the user he or she forgot the tracked item. Such alerts may be paired to specific locations to that they are only triggered when and where the user wants.

The core device 21 of each tracking device 31 has a clock. The beacon signal and any signal from a sensor may include the time the signal is sent. The clock also may be used to extend the life of the battery 15. The control apparatus 70 may set the tracking device to a power savings mode where its broadcast signal is only active for a short period of time compared to the intervals between activation. The core device also tracks time and any alert may be paired to one or more chosen times or day, week, month or year.

The system 30 may also alert user when an item has returned. For example, assume the tracking device 32 is attached to an automobile operated by another member of the user's household. When the driver of that automobile returns home, the tracking device will trigger an alert in the control apparatus 70 to alert the user that the automobile bearing the tracking device 32 has returned within range of the control apparatus 37.

The tracking devices 33 may have their alerts paired to one or more locations.

For example, if a user places tracking device 32 on a briefcase or backpack, the user has little need to be warned of leaving the vicinity of the briefcase or backpack when the user is at home or at work. Those locations may be excluded from alerts and all other locations could be active. This embodiment would be especially for commuters who take a train or bus. The alarm could sound if the commuter moves more than 10 feet from the tracking device on the briefcase or backpack.

Among the numerous options available to the user is the option to have one or more alerts activated on the control device 70, the tracking device 32 or both. Recall that some embodiments include a 9-axis motion and temperature sensor 25. Sensor readings are transmitted by core device 21 and received and recorded by the control apparatuses 70, 38 and any other control apparatus with permission to control the tracking device 31. So long as the tracking device 31 is within range of at least one control apparatus, the GNSS location of the apparatus and the motion of the tracking device 31 can be viewed on line in real time or at a later time by other users, such as 38.

In one embodiment a tracking device 31 is fixed to a snowboard and the snowboarder carries a control apparatus 70 that continuously receives the motion data from tracking device 31.

All travel of the snowboard, including vertical travel up ramps and acrobatic flips and turns of the snowboarder will be sensed by the 9-axis sensor and sent to the first control apparatus 70. That apparatus can be set to record the information received from the tracking device 31 or to continuously transmit the information to the cloud/internet 35.

Another feature of each tracking device is the ability of the owner of the device to share device information or control or both with others. For example, a remote user with control apparatus 38 and with shared privileges may access the cloud/internet 35 and use the recorded motion information to drive a display showing an icon moving in accordance with the same motion as the tracking device 31. In some embodiments the shared users are designated as “friends” of one or more tracking devices that are generally under the control of the owner of the tracking device. As will be explained later, an owner may voluntarily transfer control of a tracking device to another authorized user or simply relinquish control of a tracking device to any other authorized user who is or passes within range of the relinquished tracking device. An authorized user is, at a minimum, a user who has a control apparatus with a copy of an operating program for controlling tracking devices. In other embodiments authorized users are registered with a central user site that may be accessed through the Internet.

Embodiments with the 9-axis motion sensor may be used to pair location, time, direction, and position, velocity and acceleration in each of three axes of motion. For example, a user could set an alert to show whether the speed of a tracking device 31 exceeded a threshold of 10 miles per hour in the time between 10 AM to 11 AM on Aug. 4, 2014, when the temperature was between 75-85° F. while traveling north within the city limits of Seattle, Wash. As such, motion, time, heading and location may all be paired together or in any combination of one or more types of sensed information to set an alert.

The pairing of tracking device 31 with a smartphone having GNSS has endless possibilities. Motion data can be configured to user-defined alerts that include activating the speaker and LED 24. For instance, if a user was jogging and his speed dropped below a threshold, the speaker 23 on the tracking device 10 would buzz. In another embodiment the tracking device 10 monitors temperature outdoors, and buzz from speaker 23 could warn the user when the temperature dropped below a level that would harm outdoor plants. In some embodiments the 9-axis sensor enables the system 30 to control functions of the control apparatus 70. A control program 100 installed on the control apparatus 70 records motion of the tracking device 31 and associates the recorded motion with a function of the control apparatus 70. With the control program 100 open, control apparatus 70 records a motion or set of motions of the tracking device 32. The user then associates the recorded motion or set of motions with a function provided on the control apparatus. Such functions include triggering an alert on the control apparatus 70 when the tracking device 32 moves in any direction, taking a picture with the control apparatus 70 in response to a first predetermined motion or first combination of motions of the tracking device 32, placing a phone call from the control apparatus (smartphone) 70 in response to another motion or another combination of motions of the tracking device 32, sending an email or text message from the control apparatus 70 in response to a third motion or third combination of motions of the tracking device 32. For example, the sensor 25 could be attached to a door or a window and any movement of the door or window would set off an audible or visual alarm on the control apparatus 37. A combination of motions such as shaking the tracking device 32 up and down could command the control apparatus 70 to take a picture. Moving the tracking device 32 left and right could command the control device 70 to send a message (email or text) to one or more addressees with a predetermined announcement, such as a reminder to take medication. A user may map out specific locations, click the button and the tracking device 32 will save the place of interest. For example, a surveyor could walk a specific path, and mark specific points of interest such as corners of a road, or edges of a hill. The geographic properties of each point of interest would be saved and mapped out. Thus, the tracking device 10 has uses in the fields of gardening, home security, child monitoring, health/fitness, sports applications, navigation, commercial and industrial monitoring and safety appliances.

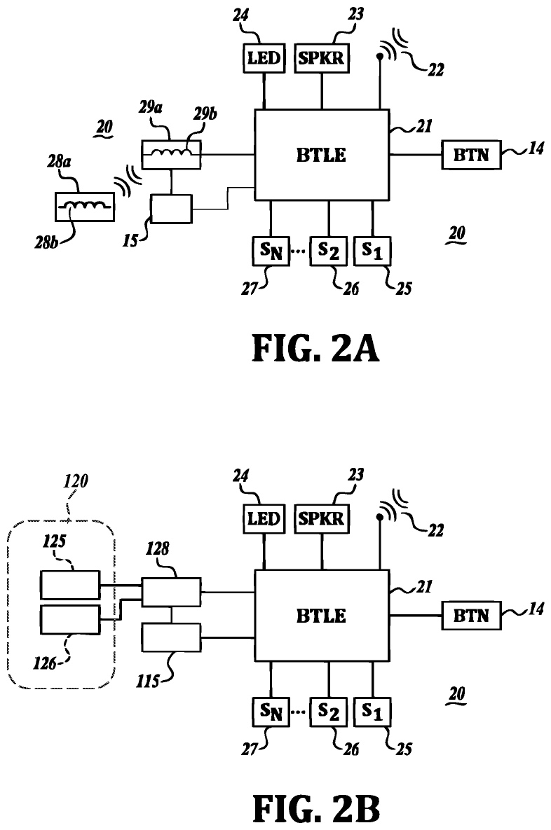

Turning to FIG. 4, a first network 40 has tracking devices TD1-TDN, 31-33 that are in wireless communication with a hub 41. The hub 41 may be connected to a gateway system 47 that in turn is connected to the cloud/internet 35. In some embodiments of the first network 40, the hub 41 is directly connected to communicate with the cloud/internet 35. The hub 41 listens for signals from the tracking devices 31-33. The hub has Bluetooth or other wireless communication apparatus and can sense the range of each tracking device within its effective field. Upon receiving signals from one or more tracking devices, the hub relays information associated with the tracking devices to the cloud/internet site 35. Likewise, the hub 41 may send control information received from the cloud/internet site 35 to each or all the tracking devices 31-33.

Each tracking device 31-33 and the cloud/internet 35 associated with the devices has an owner and may have one or more shared users. As used in this patent, the term “owner” applies to a user of a tracking device 10 who has primary control over the tracking device 10 and the cloud/internet 35 associated with the tracking device. The embodiment envisions local, regional, national and international networks 43-44 within the scope of cloud/internet 35. It also envisions registered owner-users of tracking devices and others register users with one or more dedicated cloud/internet sites 35 for collecting information about tracking devices 10. An owner-user may grant one or more privileges to others, known as “friends”, allowing the other users some or all access or control of the owner's tracking devices and owner's account on the cloud/internet site 35.

For example, one owner-user may give a friend a privilege to view all data on the cloud/internet site 35 or view data only associated with one or more tracking devices chosen by the owner-user for sharing. Even when the owner permits other users to see the data, some data may be marked “private” and excluded from the view of the shared user. An owner may also permit other users to control one, more, or all functions of individual tracking devices of the owner. A user-owner may also allow device data to be posted publicly, so that any user can view the data.

The friend feature solves a potential problem of locating lost tracking devices. If a friend finds a lost item of the owner, the friend may discretely notify the owner that the friend has found the lost tracking device (and the item attached to the device) by calling the owner or sending the owner an email or text message that the friend found the tracking device at a particular location and time. The email could include a map with a pin showing the location.

In an alternative friend-based scenario, assume a user of control apparatus 42 who was granted privileges for the lost device 32 by its owner detects the lost device. The owner sees on the database that the user of control apparatus 42 is close to the lost device 32 and also has privileges for the lost device 32. The owner may contact the user of control apparatus 42 via telephone or email and ask the user to find the lost device 32 by initiating a buzzer sound or light alert on the device 32.

Shared use has a number of advantages. For example, assume the owner of the device 31 is away from home and receives a call from a member of his family asking for help finding a lost remote control attached to tracking device 31. The owner could log into the cloud/internet and send a suitable command to the tracking device 31 to operate its speaker 23 and LED 24. If the owner had shared control of the tracking device with other family members, then the shared user could send the command to generate an alarm without contacting the owner.

The embodiment of first network 40 helps integrate multiple tracking devices 31-33 and Bluetooth devices. A control apparatus 70 (FIG. 3, e.g. smartphone) does not have to control the tracking devices. Instead, all tracking devices 10 for an owner are registered in the hub 41 where each can be securely accessed from a smartphone or other control apparatus anywhere in the world. The registered tracking devices can be used for home security, automation, or playing games with friends across the world.

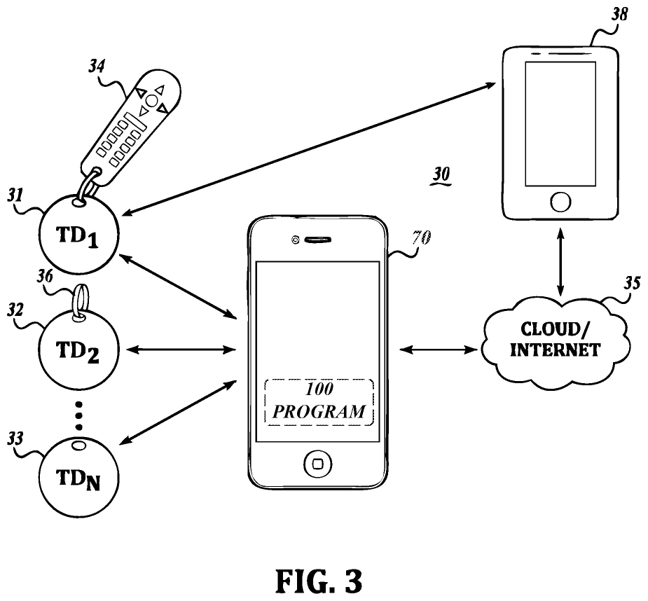

A next network embodiment 50 is shown in FIG. 5. An owner of multiple tracking devices 31, 32, 33 operates a networked control apparatus 70 such as a smartphone that has two-way communication via cloud/internet 35 with the tracking devices 31, 32, 33. A server 58 is also in two-way communication with the cloud/internet 35. The server 58 includes one or more databases 60 that keep records on owners, users, user profiles, sensor information, and location of each tracking device. For user of the network 50, the database 60 would show the devices owned by the user or those devices for which the user had granted or received one or more privileges or are marked for public access, the radio unit identity 61 of each device that is owned or subject to a privilege granted or received, the information 62, 63, 64, 65 reported by each sensor of each device, including and not limited to the time the information was received and the location of the control apparatus that receives the information. At any time the owner (via smartphone 70) of the tracking devices 31-33 may view the historic information on the location and sensors of each tracking device of the owner, including the last known location of the tracking device and when the last known location was recorded in the database 60.

The owner's control apparatus 70 may be beyond the range of the transceivers in core devices 21 of the tracking devices. A number of other control devices 71-74 (FIG. 5) may be within range of one or more of the transceivers 21 in the tracking devices. Each tracking device uses its core device transceiver 21 to broadcast a periodic beacon signal with information including the identity of the tracking device and information from the sensors 25-27 of the respective tracking devices. The identity information can include a bitstring in the advertising payload. Each control apparatus 71-74 receives the beacon broadcast 68 and relays the information in the broadcast in a transmission to a designated host on the cloud/internet 35, including the GNSS location of the control apparatus. The control apparatuses 71-74 do not need permission from the owner of the tracking devices to receive and forward the identity and sensor information. As long as the control program 100 for tracking devices is running, each control apparatus will receive the beacon signal from the tracking devices. No permission is required to receive the beacon signal. The control apparatus may add a location and/or a time stamp, and other information, to a “record” of the transmission from the tracking device before forwarding the record to the cloud host. The retransmission of beacon information by the control apparatuses 71-74 imposes no hardship on them because each one likely transmits its own beacon signal to a cellular phone network or a local or wide area network.

The third network embodiment 50 may be used to locate misplaced items that are beyond the range of a control apparatus. An owner may access the database 60 and mark one or more of the owned devices as “lost.” Assume that device 32 is owned by the operator of control apparatus 70 and is attached to a tablet computer (not shown).

Assume another user carries control apparatus 73 and has no shared privileges for tracking device 32. Nevertheless, when control apparatus 73 passes within range of the beacon signal 67 from tracking device 32, the identity of the lost device 32 and its approximate GNSS location will be relayed via control apparatus 73 to the cloud/internet 35 and recorded on the database 60. That allows the owner to know the general location of the lost device 32. The approximate location can be displayed on a suitable application such as Google Maps, or MapQuest to provide the owner with local streets or landmarks where he may physically search for the lost device.

Details of radio unit identifier and community identifier concepts are described in a co-owned patent family titled, Radiobeacon Data Sharing by Forwarding Low Energy Transmissions to a Cloud Host, including representative U.S. Pat. No. 9,774,410 et seq. Also relevant are a co-owned patent family titled “Tracking Device System” and “Tracking Device Systems”. Both families of patents and their respective patent applications are incorporated by reference in full for all that they teach.

The waypoint database has numerous uses. Tracking devices 33 may be distributed over a large geographic area where each tracking device is in communication with a hub or a mobile smart device. The tracking devices may be located at one or more known locations or the hubs may provide GNSS data. The sensors on the tracking devices could report their temperatures, air pressure, humidity, and other environmental characteristics via the hubs or smartphones to provide data for a database 60 of the variable environmental characteristics of the geographic area.

There are a virtually unlimited number of sensors that can be used to provide trigger signals and a similar unlimited range of responses or alerts that may be given in response to the trigger signals. Each tracking device has a button 14a and may have one or more sensors 25-27. The button and each sensor may generate a trigger signal.

Trigger signals may be combined in any number of combinations and/or sequences of trigger signals to generate particular trigger signals depending upon the occurrence of predetermined combinations and/or sequences of trigger signals. The tracking devices and control apparatuses may also generate one or more responses or alerts upon receipt of trigger signals and combinations thereof.

While not a limiting list, the sensor data may be sensor output selected from location sensor output, geofence sensor output, radiotag leash sensor output, radio proximity sensor output, temperature sensor output, humidity sensor output, windspeed sensor output, barometric pressure sensor output, soil moisture sensor output, Hall effect sensor output, photoelectric sensor output, Bluetooth radio contact sensor output, blacklist sensor output, whitelist sensor output, Bluetooth signal density sensor output, Wi-Fi radio contact sensor output, electromagnetic radiation sensor output, received radio signal power sensor output, transmitted radio signal power sensor output, 6LoWPAN radio contact sensor output, movement sensor output, displacement sensor output, heading sensor output, accelerometer sensor output, gyroscopic sensor output, compass sensor output, vibration sensor output, altimetry sensor output, radioactivity sensor output, pressure sensor output, switch continuity sensor output, audio sensor output, battery charge sensor output, memory capacity sensor output, RAM activity sensor output, chemical sensor output, gas sensor output, physiological function sensor output, friend sensor output, time interval or clock value sensor output, wherein all sensor output is collectively “sensor data” or “information” as defined herein.

Button 14a may be pressed one or more times to generate one or more button trigger signals. Two or more sequential pressings of the button 14a are an alternate trigger signal. The button switch may be held down to generate a long duration trigger signal or promptly released to generate a short trigger signal. A combination of long and short duration signals may also be used as a trigger signal.

For embodiments having a 9-axis sensor or heading sensor, any motion or combination and/or sequence of specific types of motion may be used to generate trigger signals. For example, when a tracking device 31 is used to secure a door or a window, any motion of the sensor may be a trigger signal. In other embodiments, specific user-defined spatial displacements are received and stored in the control apparatus as trigger signals for a response. For example, moving a tracking device left to right, shaking the tracking device up and down, moving the tracking device to define a letters, such as the letter “L”, or moving the tracking device to define a shape such as a circle or square, are but a few custom motions. The shapes and letters could be paired with a click of the button 14a to indicate the start of a motion and second click when the custom motion is completed. The control apparatus would remember the click to start and stop and the motion between clicks.

Range is another trigger for the tracking devices. On the control apparatus the user may define one or more ranges for generating responses including alerts. One potential use is keeping a parent advised of the relative location of a child while shopping in a store. Different responses or alerts could be given at different ranges as the distance between the child and the parent varies. In the system of FIGS. 3, 4 and 5, a trigger may be tripped when a tracking device leaves or enters radio proximity of a parent device.

Location is still another trigger. In some embodiments, the tracking device may carry its own GNSS device and broadcast its latitude and longitude coordinates. In other embodiments, the tracking device may rely upon the GNSS coordinates of any control apparatus that participates in systems such as shown in FIGS. 4, 5 and is within range of any tracking device. In still other embodiments, the location of one control apparatus 70 may be paired with the range of one tracking device. For example, in the basic system shown in FIG. 4 control apparatus 70 provides the location of the control apparatus using its GNSS function and pairs that location with the range between the control apparatus 70 and the tracking device 31. A user can have an alert triggered when the distance between the control apparatus 70 and the tracking device 31 exceeds a predetermined distance selected by the operator of the control apparatus 70. A user can also set an alert that is only active at a “home” location to remind the user to take a laptop to which the tracking device 31 is fixed when the user leaves home. However, if the location were different from the “home” location, no alert would be given.

Time is another trigger signal. As explained above, time of day may be combined with other trigger signals to enable or disable one or more alerts, such as enabling a motion alert during the night but disabling the alert during the day. Date may also be used as a trigger condition.

Other trigger signals and their combinations and/or sequences are possible with added sensors. The tracking devices of the embodiments of the invention may use any of a vast number of sensors including and not limited to sensors for motion, distance, velocity and acceleration, temperature, pressure, magnetic fields, gravity, humidity, moisture, vibration, pressure, light, electrical fields, ionizing and non-ionizing radiation, cosmic rays, and other physical aspects of the external environment; analytes for chemical or biological substances including and not limited to sensors for detecting toxic compositions such as carbon monoxide, carbon dioxide, methane, and other hazardous or poisonous components. The tracking devices may be worn as badges by personnel to detect ambient analytes and physical parameters. The data collected by the tracking device may be sent to the data collection center 58 where others can analyze it and provide responses or alerts to the personnel wearing the tracking devices.

The control apparatus has a program (for example an “application”) that allows the user to create custom trigger signals including combinations and/or sequences of individual trigger signals. The control apparatus, the tracking device or both may generate one or more responses to a trigger signal or a combination of trigger signals.

The tracking device, the control apparatus or both may give responses or alerts.

Thus with more generality, the control apparatus is enabled to create conditional rules, each conditional rule comprising two parts in “IF/THEN” logic order, in which beacon signal information can be assessed in an “IF” process and assigned a truth value, and according to the truth value, a command associated as the “THEN” part of the conditional rule can be executed. In some instances, a simple sensor output broadcast from the radio tracking device will trigger execution of some control apparatus function. In other instances, the control apparatus or an associated cloud host and network may cause a remote device to execute a function. In yet other instances, the control apparatus may compare one sensor output with another sensor output and cause a function to be executed if the comparison meets or deviates from a specified value. The sensor outputs need not be parametric. A non-parametric sensor such as a button press (“switch input”) may also be evaluated as part of rules-based conditional execution of functions. And in some instances, other information, such as date, time, location, and so forth, may be factored into the conditional rule. That other information may be found in the control apparatus or in a host system (such as a “cloud host”) in operative communication with the control apparatus. The functions triggerable when a conditional rule is satisfied, broadly, include alerts, notifications, and command execution of functions by any of a control apparatus, a remote device, or in some instances, execution of a function by the tracking device, such as actuation of an alarm display by the tracking device. In another example, when the conditions of a conditional rule are met by information contained in a radiobeacon broadcast, then a friend's control apparatus may execute a display notification or sound an alarm, for example. Thus the examples provided here are for illustration, but do not limit the possibilities achievable by the capacity to write customized conditional rules having a trigger condition (IF) and an executable (THEN) that some component of the system will execute when the trigger condition is recognized in a radio transmission.

The foregoing embodiments of tracking devices provide audible and visual alerts, but could also vibrate the tracking device upon receipt of a command or trigger signal. In the embodiments described above the tracking devices and the control apparatus may establish a remote-control system between themselves to cause one of the system components to execute a function upon receipt of a predetermined command or trigger signal from the other component. For example, a custom motion trigger signal of the tracking device may remotely control the control apparatus to take a picture, send a message via email of SMS, make a phone call to a predetermined party, and combinations thereof such as take and send a picture to a predetermined party or group of predetermined recipients.

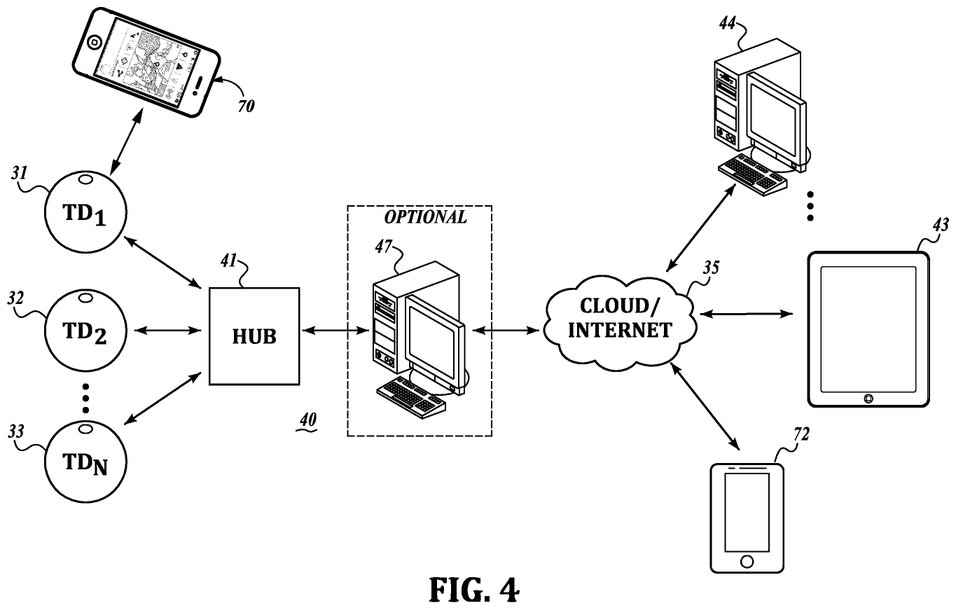

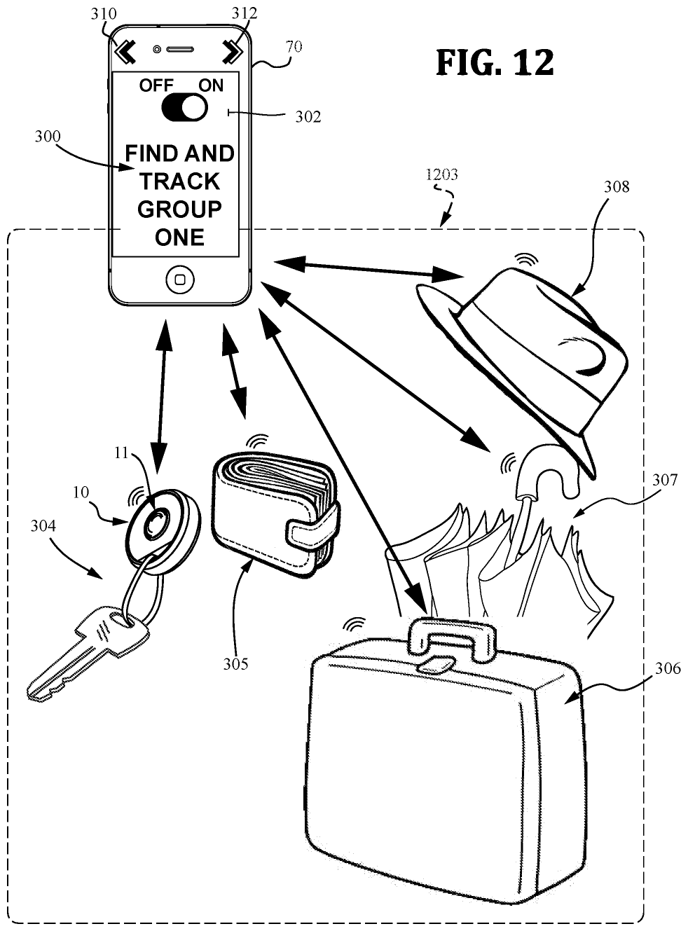

A first control program 100 (FIG. 3) is shown by means of screenshots 101 to 106 in FIGS. 6-16. Turning to FIG. 6, screenshot 101 shows a login screen for the control program. The login screen has a legend “Login” in banner 110. Below the banner are two rows 111, 112 for a user's email address or user name and password, respectively. In row 113, the user may sign in via the indicated website pebblebee.com or, in the alternative, login through Facebook using the button on row 114. This discussion also applies to a variant control program 300 depicted in FIG. 14.

Rows 115 and 116 allow the user to set up an account or recover a forgotten password.

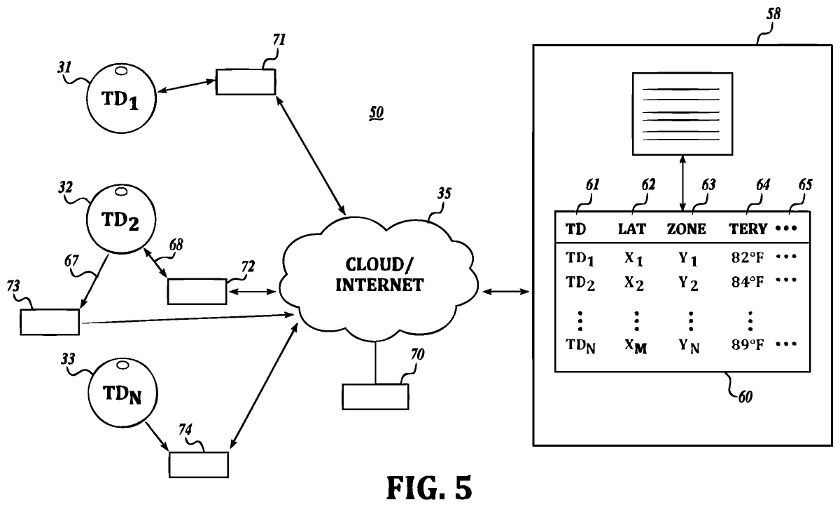

Turning to FIG. 7, and screenshot 102, the user is presented with an image of a hive 122 of tracking devices. A hive is a group of tracking devices owned or controlled by a user of the program. In the top banner 120, there are control buttons 124, 126, and 200, respectively, for enabling the control apparatus to receive and send Bluetooth transmissions, release one or more of the tracking devices from the hive, and set general settings for the tracking devices. Banner 130 defines columns for active devices 131, their range 132, and status 134. For example, tracking device TD1 has a range indicated by three squares and a status showing a can 135. The can 135 indicates that the device is under control but may be released if so desired. In the next row, another tracking device TD2 is closer as shown by the four status squares, and it is also under control as shown by the can 135.

In the hive, there are several more devices, which are located far away. See the Far Away banner 138. Far away devices include a device identified as My Wallet 139, and another device identified as cat 141. Note that My Wallet has a Y-shaped symbol 136 to indicate that the tracking device on the wallet is shared with another user. Near the bottom of the screenshot, a banner 140 shows Friends. A friend is any other user who has some control over one or more of the tracking devices. The symbol 142 indicates a button that may be pressed to add additional friends. To the left of the symbol 142 are shown existing friends.

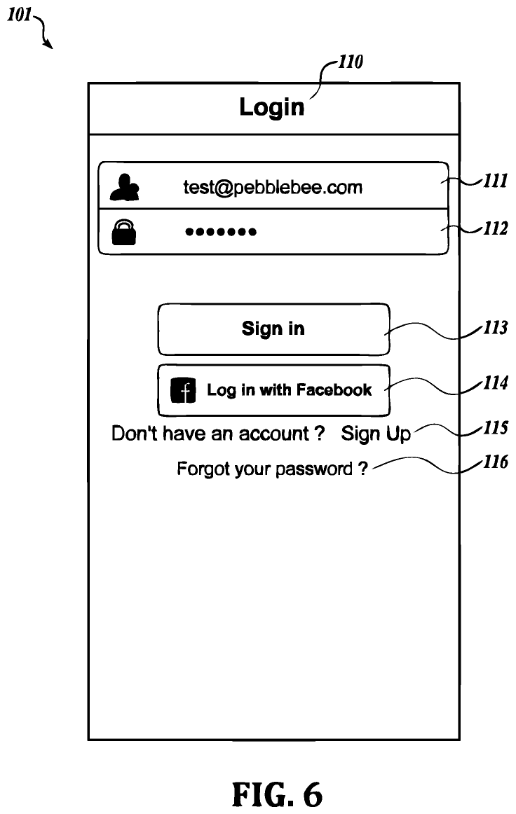

Turning next to FIG. 8, screenshot 103 shows a particular control screen for the tracking device TD1. Clicking or typing on one of the tracking devices shown in screenshot 102 accesses screenshot 103. Top banner 150 has a number of status symbols. Symbol 104 identifies the screen as relating to tracking device TD1. A user returns to the prior screen 102 by pressing the hive symbol 152. Symbol 156 shows the percentage charge of the battery, symbol 157 is the release symbol, and symbol 200 is for general settings.

Below banner 150 are a set of symbols for immediate alerts, paired alerts, and locations for the tracking device. Symbol 160 when touched will immediately sound the audible alarm through the loudspeaker of tracking device TD1. Symbol 162, a light bulb, when touched will cause the tracking device LED to emit periodic light by blinking its LED. If the tracking device is equipped with a vibrator, another symbol would be provided to indicate the vibrator. Symbol 190 allows the user to set up alerts, which include a combination of conditions as will be explained later. Symbol 164 is a mapping signal, which allows the user to acquire and display a map of the current location of the tracking device TD1.

Symbol 166 corresponds to the top cover 11 of the tracking device. The concentric arcs radiating from the bottom of the circular cover represent the relative range between the control apparatus and the tracking device. On the display, the arcs within the circular image 166 will bear different colors and will gradually fill in from bottom to top as the control apparatus comes in closer proximity to the tracking device.

Below the range circle 166, the user has a number of options. The user may select symbol 168 in order to share the device with another user. By selecting symbol 170 the user may designate TD1 as lost. Selecting symbol 172 marks TD1 as private and only the user may see the data generated from TD1 as well as the location of TD1.

Symbol 174 allows the user to release all control of the tracking device TD1. At that point, the tracking device TD1 may be claimed and controlled by any other authorized user. The bottom banner 176 indicates other users with whom the current user has shared TD1.

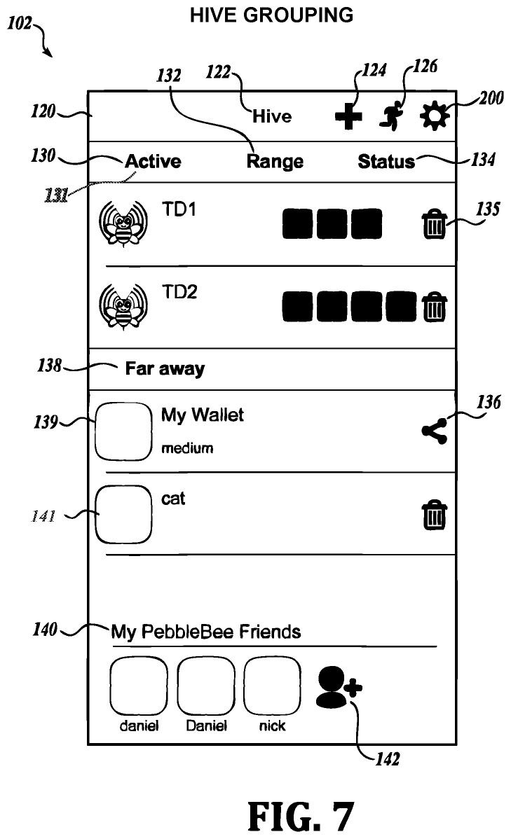

FIG. 9 shows a screenshot 104, which displays the general settings for tracking device TD1. By clicking on symbol 200 on screenshot 103, the user is taken to screenshot 104 where the user may enter particular information about the tracking device. For purposes of illustration, the user may enter a picture 182 of the tracking device or the item or person tracked. In this case, the tracking device is a computer tablet. In the entry 184, the user gave the name “My Tablet” to the tracked item. In box 186, the user may describe the item or person attached to TD1 and pressing bar 188 saves or the Save button on the top banner saves all settings. Pressing the Back button returns the user to screenshot 103. Pressing the Edit Button allows the user to make changes in the settings on screen 104.

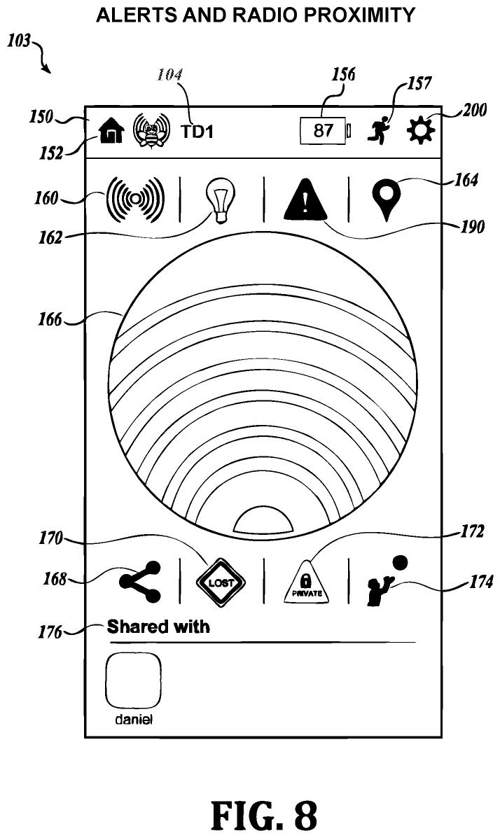

Screenshot 105 shown in FIG. 10 controls the Alert Settings for the tracking device 31 and the control apparatus 70 for example. Shown are screenshots from control apparatus 70. Pressing triangular symbol 190 in screenshot 103 of FIG. 8 takes the user to screenshot 105 of FIG. 10. In screenshot 105, the user has a number of options for setting alerts. The user may select alert settings 192 for the kind of alert (audio, light, vibration) and may also pair the alert with other conditions. Screenshot 105 is also used to establish remote control between the apparatus and TD1. As explained above, the tracking device may control the control apparatus 70 and vice versa. If desired, the user may have an alert show up on a control apparatus 70 such as the user's smartphone. In addition, the user may operate a loudspeaker on the tracking device. The user may also ask for an alert when the battery is low. Other alerts may be set for distance. For example, in the Distance alerts 194, the user has the option to set alerts for when the device leaves the hive (i.e., the range of the control apparatus), when it is nearing the edge of the hive, when it is out of the hive, and when it returns to the hive. Controls for the multi-function button 195 allow the user to find the control apparatus 70 or set the multi-function button 195 to operate the control apparatus, such as a smartphone, to take a picture. In other embodiments, the multi-function button may send an email or text message to a predetermined party. Further alert settings depend upon conditions such as location pairing 196. In this case, the alert is conditioned upon the tracking device being at work or at home. As shown in FIG. 10, the locations are identified by latitude 198 and longitude 199.

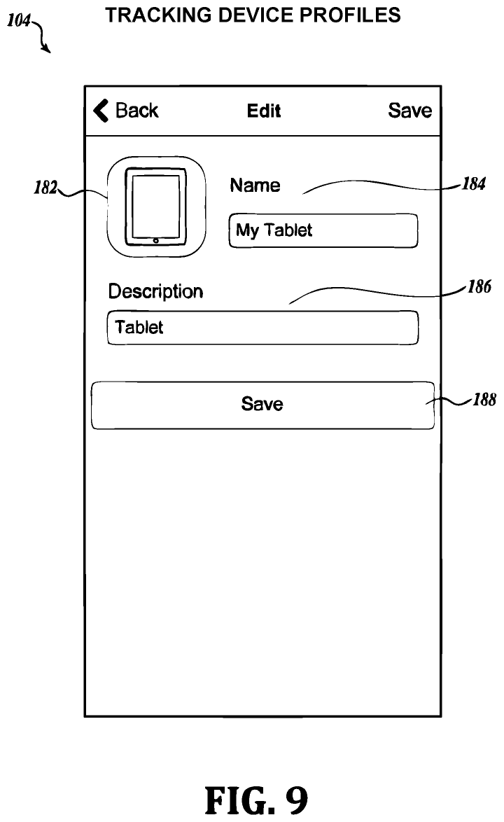

Returning to screenshot 103 (FIG. 8), the symbol 164 is a map symbol. As shown in FIG. 11, touching the map symbol 164 changes screenshot 103 from the range image to map 167 illustrated in screenshot 106. The map 167 includes a pin symbol 168 at the approximate location of the tracking device TD1. The location of the tracking device TD1 is acquired from other control apparatuses (variously termed “community” or “bystander” devices), which have acquired the beacon signal of tracking device TD1.

See, for example, the system shown in FIG. 5 above.

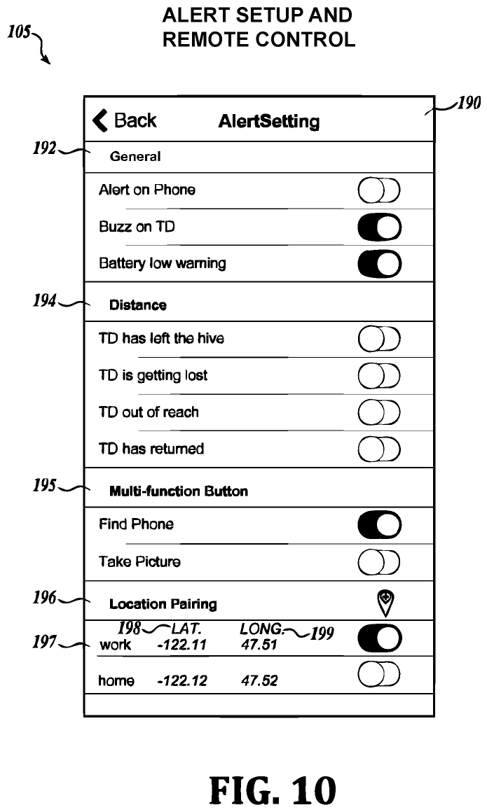

FIG. 12 illustrates a control device 70 (for example a user's smartphone) set up with an alternate control program 300 and a user interface to track multiple radiotags (of the kind shown as tracking device 10) as may be attached to objects, items or assets that make up a user-defined “group” 1203 (dashed frame). The tracking devices may be embedded in, attached to or concealed on items of value to the user, and are indicated here by a triplet of arcs indicating a “radio wave icon” representing emissions from (or to) the radiotag. The program 300 is installed and run on the control device 70.

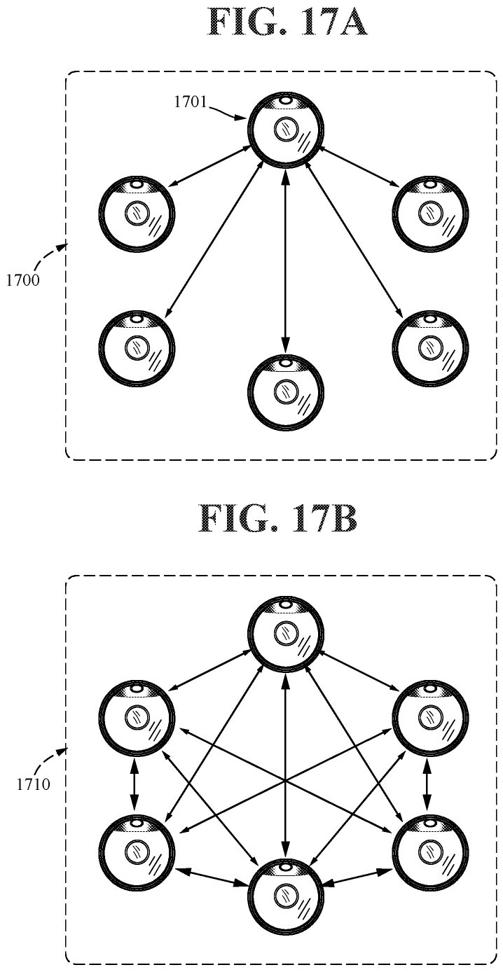

Firmware runs on the radiotags, which typically include SoC radio components. The control program 300 includes a “find and track group” user interface feature and enables a user to conveniently locate items in the group by radio proximity or by using a bell and/or light built into each tracking device 10,1800,2311. Features are controllable from a single screen 302, for example. The group feature may be turned on and off using soft slider control, for example. Each item of the group 1203 is fitted with a tracking device that may take the form of a credit-card sized device (FIG. 19A, 2301) for use in a wallet or a brim of a hat, or other form factor. The tracking device may also include a cellular radio (FIG. 19B, 1950, U.S. Pat. Nos: 11,393,323, 11,450,196, 11,678,141). In this illustration, a keychain 304, wallet 305, briefcase 306, umbrella 307, and hat 308 are selected as a radio “group” such as would typically be gathered up before going to work.

A BTLE piconet between members of the group can be synchronized to include with a single smartphone 70 (sometimes termed a “control device”), or up to seven the members of the group can function as a mesh network without a cellular/BTLE dual-radio center member.

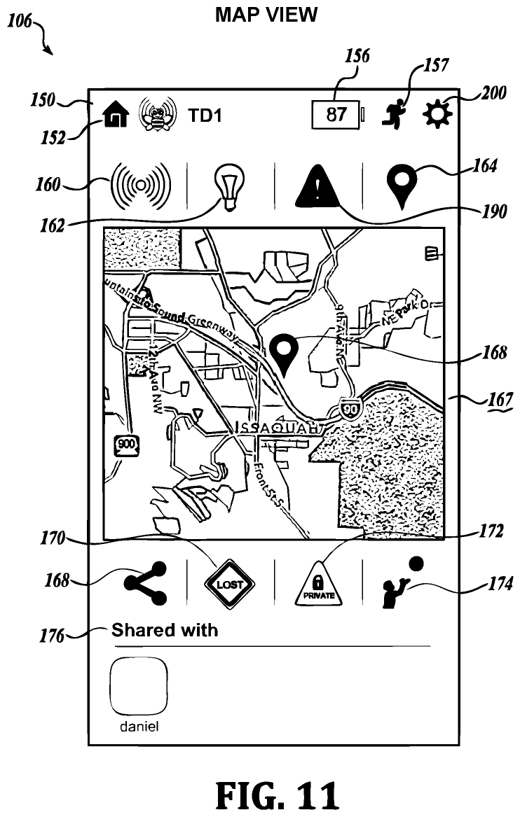

Using the program menu 1300 (FIG. 13), each item of the group member list can be collected and monitored instantly. In the event that any item has been misplaced, program 300 offers a user interface with map and tools to assist in finding them. Also, if the group members typically travel as a group, any mismatch in the motion or heading sensor data in the transmissions of individual group members can be immediately identified and flagged so that an alert can sound or a notification can be sent to the owner's smartphone, for example.

FIG. 13 is a view of a screenshot 1300 of the graphical user interface 302 in group mode: the screen having user interactive controls for finding and tracking groups of items. Top center under banner 150 is a bullseye 1302 that represents a general map of the radio field around the control device 70. Each of the five items is mapped with a map pin 1304. Soft switch 1303 enables the user to switch off the group mode when not needed.

Also shown on the top banner 150 are soft buttons for “home” (152), for hive (“104”), a battery charge indicator 156, a soft button 157 used to release control of the radiotags, as used to change ownership or change permissions, and a menu pulldown 200 for general settings. In this view, the device tagged as KEYS 406 is highlighted so that it may be managed individually.

In the bottom banner, the user may select symbol 168 in order to share a radiotagged item with another user. By selecting symbol 170 the user may designate the device tagged as KEYS as lost. Selecting symbol 172 marks the radiotag as private and only the user may see the data generated from that device as well as its location.

Symbol 174 allows the user to release all control of the device tagged as KEYS. The bottom banner 176 indicates other users 142 with whom the current user has shared the device tagged as KEYS. Other tracking devices can be selected in the menu list for actions.

By clicking on symbol 200 on screenshot 1300, the user is taken to exemplary screenshot 104 (FIG. 9) where the user may enter particular information about a particular tracking device. In box 186, the user may describe the item or person attached to a device and pressing bar 188 or the Save button on the top banner saves all settings. Pressing the Back button returns the user to screenshot 1300. Pressing the Edit Button allows the user to make changes in the settings on screen 104 (FIG. 9).

In sample screenshot 1300, five fields are provided (up to seven are possible) so that the user can monitor each radiotag in a group. Shown here are fields that are user-labelled as “KEYS” 406, “WALLET” 408, “BRIEFCASE” 410, “UMBRELLA” 412, and “HAT” 414. These correspond to the items shown in FIG. 12, but any items or assets selected by the user may be programmed as a group. The tracking devices may also be used with children and pets for example.

Icons 422 show that the corresponding BTx radiobeacon signal of the tracking device(s) 10 are being received by the control device. Soft buttons 420 allow the user to select and generate a visual or audible alarm in any one of the items of the group. In this way, the user can immediately inventory the needed items and cause any missing item to generate an alarm tone that aids in locating the missing item.

In use, radiobeacon signals are monitored by the control device processor, each signal having a unique radio unit identifier and a sensor payload. Depending on how the user sets up alerts, motion, heading, proximity, temperature, or other sensor outputs can cause the processor to execute an alert. Here, a sample ALERT 416: KEYS LEFT BEHIND is shown. This would occur if the group was moving, such as when the owner is leaving a room or walking on the sidewalk, but the KEYS member of the group was not showing corresponding motion, a glaring inconsistency in a group of related log entries that can be detected almost instantaneously. The alert will be shown on the control device 70 and may be accompanied by a vibration or an audible tone as soon as the group member is left behind. Similarly, an audible alert will occur on the radiotag or radiotags if the control device 70 is left behind. Thus the group uses radio proximity to ensure cohesion of the group; any fading or loss of signal from one group member results in a notification. Comparison of inconsistencies and discrepancies in motion or heading signal data are interpreted to determine which tracking device is lost or left behind.

An OUT OF RANGE alert will occur if any member of the group loses radio contact with the control device. The last known location will be retrieved from memory.

A WAYWARD OBJECT may occur if the control device is moving in one direction or at one velocity and an item is moving in another direction or at another velocity. This is more likely to suggest that the item has been taken without permission. By actuation of the LOST button 170, the user can report and record the item as missing and can use cloud host resources to find and track the lost item. The WAYWARD OBJECT alert may also occur in conjunction with a geofence that defines a “safe zone” or a geofence that defines an “exclusion zone”.

Not all alerts relate to location. An OVER LIMIT alert can occur if sensor data such as temperature exceeds a preset threshold. Similarly, an UNDER LIMIT alert can be preprogrammed. This is useful for example by placing a radiotag in a bag in a picnic icebox.

A SEND HELP alert can occur if there is a sudden impact, a rapid increase or decrease in accelerometry data, a sharp noise, very low temperatures, or sustained shaking. The user can confirm a need for help by pressing the alert button or can preprogram the multifunction button 11 (FIG. 12) of a tracking device 10 to respond to a steady pressure or a distinct pulse sequence by causing the cloud host server to relay a possible injury or threat to a 911 operator and provide a location of the radiotag/user.

Another alarm is a LOW BATTERY alarm. Generally this will occur in evening hours (as determined by a photocell in the radiotag or clock of a control apparatus, for example), and indicates that the user should either recharge or replace the battery supplied with the radiotag.

Other alerts can readily be programmed using basic rules-based instructions and one or more sensor conditions. Users may also customize alerts.

As for the FIND PHONE feature described earlier, the multifunction smart button 11 on any one of the tracking devices 10 can also be used to round up any of the other items/radiotags that are missing, avoiding the need to pull out the smartphone 70 and navigate to its user interface.

In some instances, as discussed earlier, the alert function (also termed a “notification”) can be accompanied or substituted by an action. Using motion of a tracking device to cause the control device to take an action was an example given. For example, the radiotag can cause a garage door to go up, a coffee pot to turn on, or an email to be sent.

FIG. 14 illustrates a group 1400 of BTx radiotags that report via a dedicated connection to a BTLE radio of a smartphone 70. By providing an application 300 configured to recognize compatible signals from the group of BTLE radiotags, signals are handled differently than in an unprogrammed device. In some instances the signals are simply forwarded via the cloud 35 to a community cloud server 58 for action, interpretation, or archiving. The cloud server has greater processing power and access to databases 59,60 for correlating information and generating commands in response to the information received from the tracking device group 1800. In other instances, the signals satisfy local logic conditions for commands and actions. The commands or actions can be generated by the cloud server, but in other instances the local program operated by the smartphone 70 is enabled to make the appropriate response. The smartphone is adapted for this purpose by installing program 300 that is designed to operate the tracking devices as a group. Programmable responses may be assigned by the user by customizing or creating “conditional rules” stored in the smartphone, stored in the radiotag, or stored in databases 59,60 on the cloud server in association with a user profile. The radio unit identifier broadcast by the tracking device 1401 and forwarded to the cloud server ties the signal to a particular user profile. In some instances, the conditional rules for customization of executables are stored on the local smart device 70; in other instances the cloud server may store the rules and cause the local device to execute them.

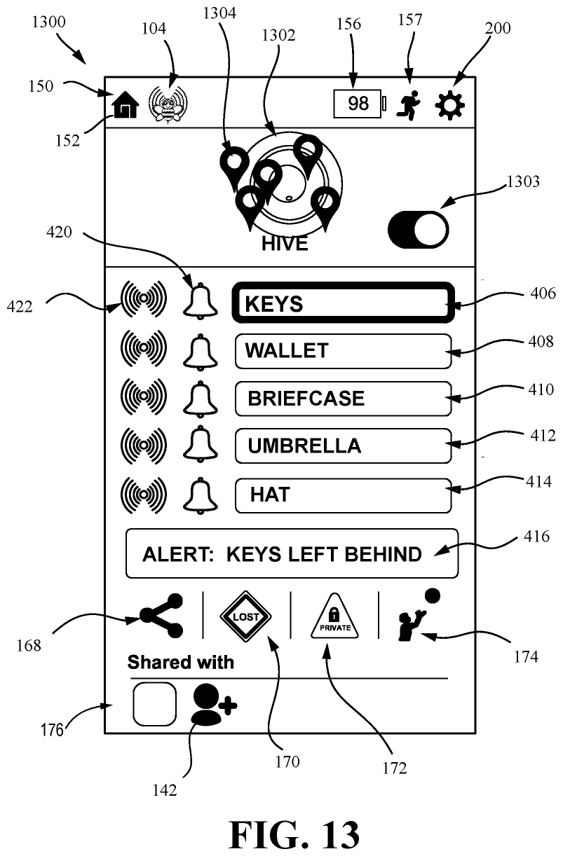

FIG. 15 illustrates a group of BTx/BTLE radiotags 1500 that in addition to connecting to the BTLE radio of a smartphone 70, also are capable of forming a mesh network 1500a with each other. In this instance, the connection with the smartphone defines a piconet with smartphone 70 as central and BTLE radiotags 1501,1502 and so forth as peripherals, but each BTLE radiotag may also participate in a mesh network, peer-to-peer, whereby data is exchanged between members of the group without the smartphone as intermediary. Data may also be shared with server/host 58 via smartphone 70 and cloud 35. Smartphone 70 is also useful in displaying a user interface for setting up the group as described earlier. The smartphone is adapted for this purpose by installing program 300 that is designed to operate the tracking devices as a group. A mesh network is useful in allowing each device to monitor other members of the group, but the cost is a bit more energy drain on the batteries.

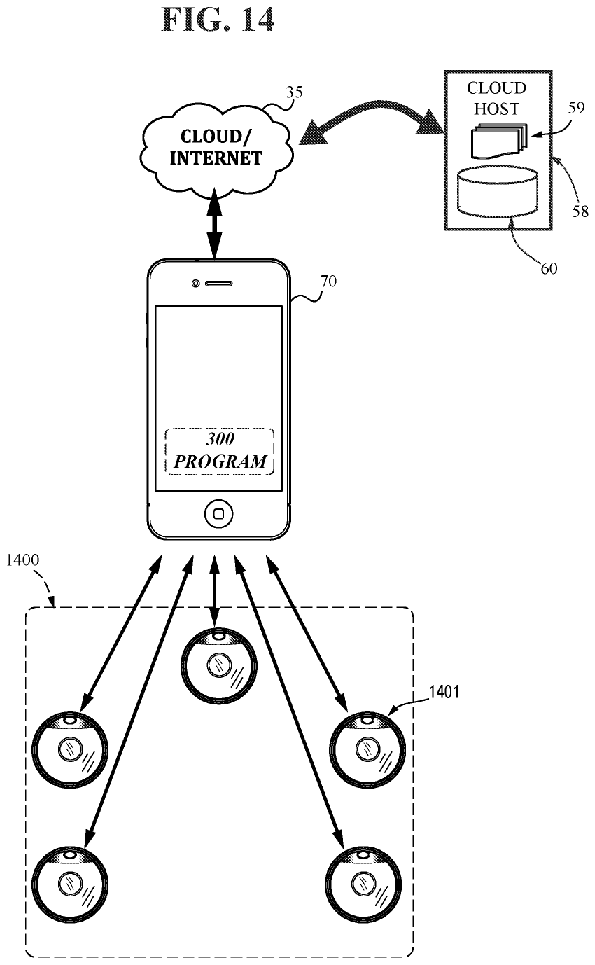

In FIG. 16, the BTLE mesh network is shown as an independent entity 1600a, in which each BTLE radio is able to recognize other members of the group such that the smartphone 70 is a peripheral member or optional member of the mesh network.

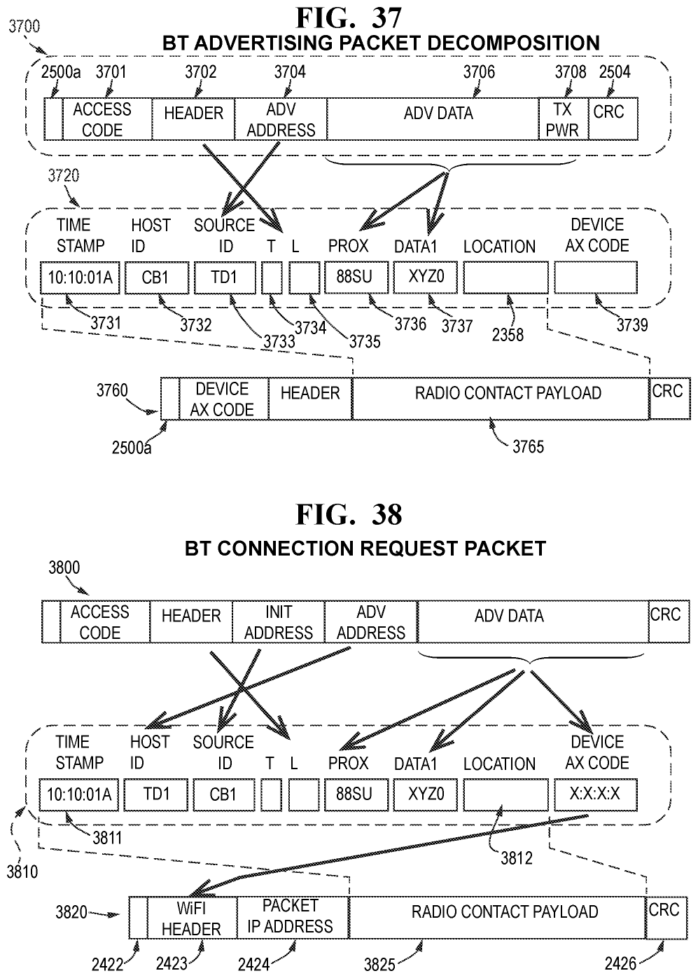

Generally, one member 1601 of the piconet will assume the role of “master” or “central”, but the BTx/BTLE specification allows the role of master to be alternated by a “master-slave switch command” that, when executed, transfers the role of master of the network to another member of the group. Because the roles of master and slave are associated with different levels of transmit and receive activity, and hence different energy budgets, battery power sharing can be achieved by alternating the roles of the members so as to distribute the power requirement of maintaining the peer-to-peer network. The independent mesh network continues to operate as a piconet even in the absence of optional smart device 70. As shown here, member 1601 is unique in its structure, and includes a Wi-Fi radio or functional equivalent, larger flash memory, more registers for storing radio contact logs, capacity to process GNSS signals or to otherwise infer location, and processing power for making predictions and expanding connections from the data in radio contact log entries, as will be discussed further in FIG. 38 and in EXAMPLE XIV.

The smartphone 70 in this view is optional for group cohesion, meaning that the group members monitor cohesion of the group independently by periodically checking for the radio signals of other members of the group 1600. The limitation is that the BTLE network is not capable of directly communicating with the cloud 35 via an IP packet data portal or with a cellular radio network. Thus the smartphone 70 serves as a periodic necessary intermediary for communications with cloud host 35 and server/host 58 with data resources 59,60. Each smartphone is provided with a program 400 that enables the sharing of data from the BTLE group and for intermittent downlinking of commands, data, or program updates from the cloud host to the BTLE group members. Absent a smartphone, at least one of the tracking devices may have an independent processor and memory, operating an application in Python code for example, and may have a more complex user interface for communicating essential information to a user. In one embodiment, the group 1600 stores information and periodically uploads it via the smartphone 70.

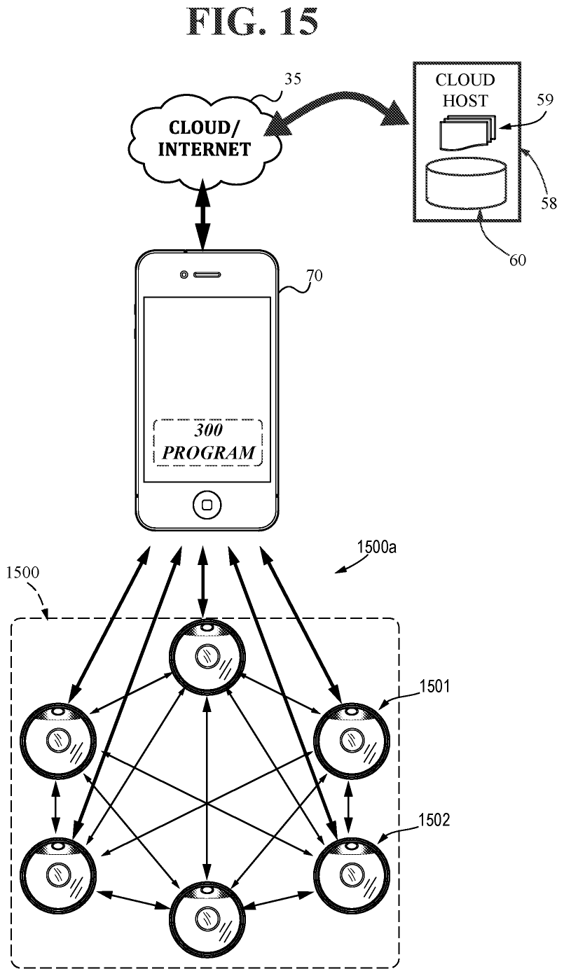

In FIG. 17A, the BTx/BTLE devices of a group 1700 are shown in a hub or star radio network in which one central device 1701 is linked to five satellite devices. But in FIG. 17B, all devices of a group 1710 are enabled to maintain BTLE radio links and share information with all other radios in a true peer-to-peer (P2P) mesh network. This open network arrangement consumes more power than the star configuration, and is optional.

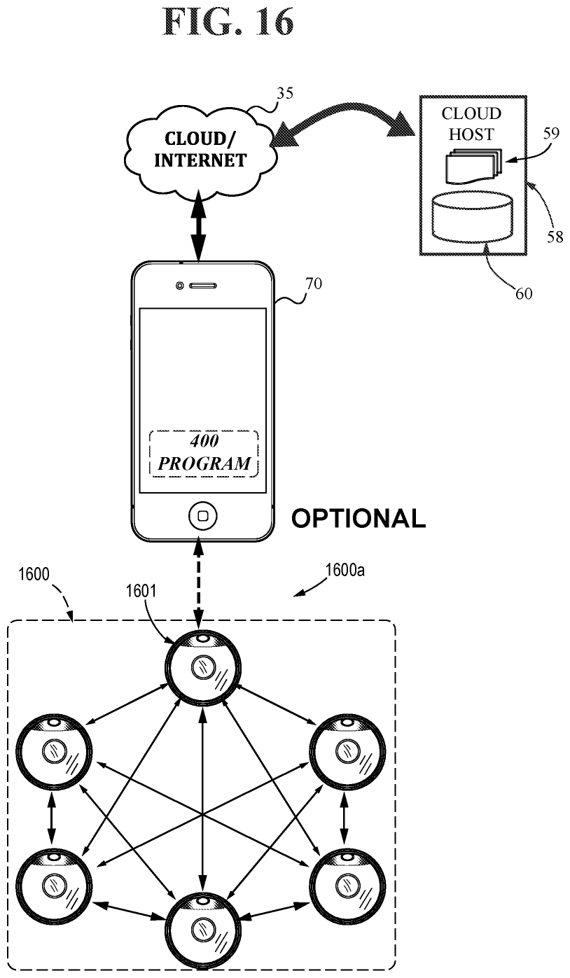

FIG. 18 is a view of a BTLE radiotag device 1800 with an alternate form factor. The device includes a radiolucent housing 1801 with center button sensor 1802 and an RGB LED 1803 mounted edgewise on the body. The center button sensor is a multifunction button and results in a distinctive radiobeacon signal when pressed. Bits in the radiobeacon signal are assigned to be read so as to communicate the number of times the button is pressed and the duration of the press to a smart device, for example. The signal may contain other information as well. Programming 100/300 in a companion smart device allows the user to assign a conditional rule based on the button press pattern or other information in the signal. The RGB-LED 1803 implanted on the wall of the housing extends in a band along about a 180 degree arc opposite the annulus 1804. The RGB-LED may be segmented and may operate in a pulsatile or function specific mode to provide feedback during user setup and interactions. The annulus 1804 is provided for attaching the radiotag to an item such as a keychain. Inductive charging is achieved with a Qi or NFC antenna on the underside base of the device.

FIG. 19A is a view of a BTLE radiotag 1900 with a thin credit card-like body 1901. The body includes a central button sensor 1902 and terminals 1903 for attaching the radiotag to a charging dock. Alternatively, inductive charging may be used by placing an inductive charging antenna in the body of the device.

FIG. 19B is a view of a BTx/BTLE radiotag 1950, optionally with both BTx (BTx) and a cellular radioset with internal SIM card, as can be configured to be worn around a child's wrist or as a collar on a pet. The device includes a mounting strap 1952 and may include a USB port 1954 for charging. Also provided in advanced models is a microphone 1955a and speaker 1955b. A user interface with buttons 1958 is a quick way to send and receive messages, and an OLED or LCD screen 1960 may be provided because the larger unit on a wrist has space for a larger battery.

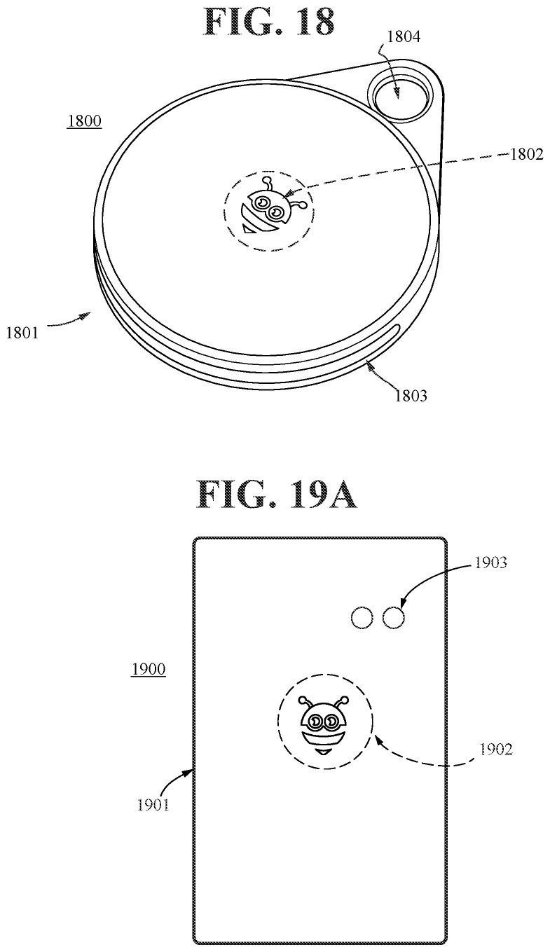

FIGS. 20A and 20B (two paired sheets presented as a single panel) show a block diagram of a more general method of deploying and using an exemplary system of the invention. Represented in a first box (dashed outline 2000) are rudimentary functional blocks (2000a,2000b,2000c) corresponding to sensor measurement, initialization, and broadcast from radiobeacon 2000. In step 2000a, a sensor output is generated. Typically the sensor is an on-board sensor unit or a sensor package. These steps may be repeated at any interval dictated by the needs of the user and by context, or may be initiated cybernetically in response to a trigger such as a change in a sensor value above a threshold. Current generations of radiobeacons may broadcast messages at ten millisecond intervals, thirty second intervals, or any convenient time—as when in proximity to a nodal device, for example, and operate as limited resource computing devices capable of simple repetitive actions.

“To measure” (i.e., “measuring”) is an operation 2000a having the quality of digitizing a contextual condition or event and can be as simple as a step for determining whether a button is pressed and held or not, or an operation such as collecting and digitizing a photocell output, which may include steps for amplifying and filtering as needed, or more complex operations such as providing a memory component and instructions for determining a measurement change over an interval of time.

The measurement data is then incorporated into a radio signal through an initialization operation 2000b in which a preamble and any signal formatting is performed. The broadcast is then sent stepwise 2000c (the “BTx stack”) via an SoC radio module, and the transmit process is iterated as needed or directed. Compatible devices in radio proximity may receive and decode the measurement data in the radio broadcast 2000d.

The sensor unit or package (25,26,27, FIG. 2A) is in electrical contact with circuits for basic processor functions and program execution. A simple processor may function as an “encoder” for initializing a message, in which a digital radio signal is “loaded” with the sensor data while conforming to an underlying radio communications protocol format (as disclosed earlier in U.S. Prov. Pat. No. 62/175,141 filed 12 Jun. 2015 titled “Devices and Network Architecture for Improved Radiobeacon Mediated Data Context Sensing”, which is co-assigned). A radio emission 2000d by a radiobeacon that carries a sensor data payload is termed a “message”.

Next in the figure, community nodal device (2010, dashed outline) is represented as a series of functional blocks, including steps for transmitting a “broadcast forward” 2013 containing the message to a cloud-based administrative server or cloud host 1000 (continuing in FIG. 20B). The community nodal device includes a transceiver for scanning 2011a and receiving low energy radio signals. The scan function is represented as an iterative loop 2011b. When a qualifying radiobeacon message is detected (YES), the signal is timestamped 2011c and optionally geostamped 2011d.

If owner identification information associated with the radiobeacon message is associated with the owner of the nodal device (2011e, YES), the message is conveyed to foreground services for immediate action or processing. The message is processed, stored in memory 2011g, and any action appropriate for the message is taken. The process of scanning 2011a and capturing 2011b radio transmissions repeats.

If not (2011e, NO), software of the invention preempts normal operation of a nodal device, which is to discard unrecognized signals. Instead of discarding the message, the message is preempted and processed in background services 2011h.

Background services are an ad hoc organization of hardware resources needed to shunt or “upswitch” the message to a broad area network radio transmitter for broadcast forward. Preemption is triggered when the radio signal is identified by a software application of the invention as a message from a qualified radiobeacon but the ownership of the message is not recognized by the nodal device.

Beginning at 2011h, those messages not meeting the common owner test 2011e are handled anonymously in background services. The message is switched 2011i to a communications layer or stack in the device, initialized 2011j for broadband transmission to an internetwork-compatible receiver, and forward broadcast at 2011k on the PHY radio layer. The message is then discarded and the process ends 2011m by clearing background resources. This process, including structuring of a “soft switch” at 2011i, is directed by a software application supplied to users of the inventive system. Soft switch 2011i switches the message from a low energy radioset in the nodal device to a broad area radioset in the nodal device, the latter operating with protocol communicatively compatible with an internetwork portal and network architecture. End function 2011m is generally conducted by existing machine functionality in the nodal device. Nodal devices are constructed to discard (i.e., “dump”) unrecognized low energy radio signals and to record and store any owner-recognized radio signals in memory for processing. A variety of permissions and policies control the “dump” function. The software applications of the invention are executed so as to preempt and re-route signals recognized by the application as community “messages” to soft switch 2011i. The soft switch has been created to broadcast forward those messages to a designated cloud host server. Although the nodal device 2010 discards and clears the message from local resources at 2011m, the forward broadcast 2013 is transmitted at 2011k to network cloud host 1000 for processing before being dumped.

Furthermore, if foreground services are not responsive (2011f, NO), then the message may be processed in background services in the same way as an anonymous message. The nodal device can be programmed so that the owner-user will receive a push notification, including a command to open a screen on the user interface, depending on priority and context associated with the owner's identification or preset instructions as known to the cloud host. Essentially the owner gets a second opportunity to receive and see the message from a co-owned radiobeacon, for example. Alternatively, even if the owner is unresponsive, the cloud host may be preconfigured to aggregate the message contents, such as any sensor payload, for later retrieval. The cloud host has access to other messages, and may also aggregate message 2013 with messages from other community members, forming a larger picture that the owner of the radiobeacon can later access.

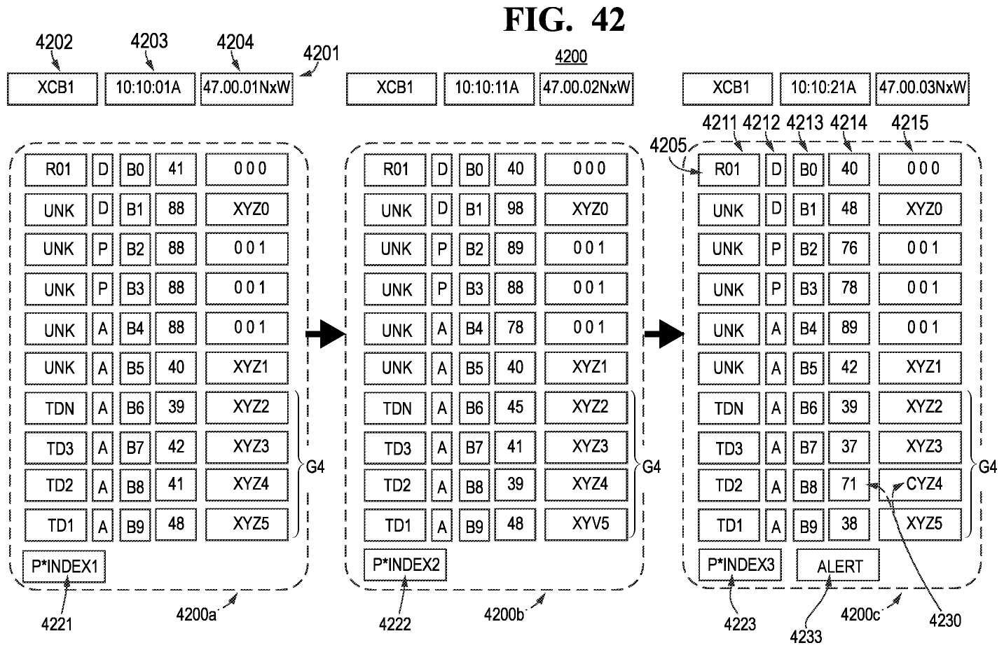

Forward broadcast 2013 is captured by an internetwork IP gateway or portal and routed as per standard IP packet protocols to a designated cloud host 35 operated by the system administrator. Each incoming message is parsed for content, including owner radio unit identifiers, sensor content, including any location information derived from the radiobeacon (some are “lighthouse beacons” installed at fixed locations) or from a geostamp applied by the community nodal device, which typically has a GNSS receiver. Location may be further deduced by the server from a pattern of contacts of nodal device 2010 with proximate radiobeacons in a familiar location (referencing FIG. 41 and discussion), XCB devices (co-owned U.S. Pat. Nos. 11,450,196, 11,393,323, incorporated in full by reference), or other nodal devices having geostamp/GNSS capability that emulate radiobeacons.

Cloud host server (dashed box, 2050) is a fully resourced computing environment for establishing rules-based policies and permissions. The server includes user accounts and at least one database 2054 for storing owner information, parsing incoming messages, and processing or aggregating data. Aggregated data is used in making context-based decisions on behalf of individual users or on behalf of user communities according to rules established by the community and the system administrator.

The cloud host server may be accessed with a graphical user interface or through an application program interface, and includes an administrative interface for maintenance, subscription management, and quality assurance. Typically, the server is accessible through a dedicated web site, and may be able to publish and transmit web pages to individual users or communities of users in response to a query or command. Relational databases may include user profiles and aggregated data and may be dis-identified to protect identities of individuals where release of that level of detail is inappropriate. The system may also include a distribution server for installing the software application, which will typically include instructions for upswitching community messages and instructions for pushing notifications and for accessing the administrative server for account setup and maintenance.

The broadcast forward 2013 is first parsed 2055a for owner identifiers, sensor data in the original message payload, and any timestamp or geostamp in the broadcast. If the originating radiobeacon is owned by a co-owner of a community nodal device (2055b, YES), a command response or notification 2060 may be initiated directly to the owner through either a wireless IP mode or a landline. If the sensor data is such as to actuate a trigger 2055c for a defined conditional rule-based action, the command response 2060 will be given accordingly, either as a command or a notification. If any context, including the realtime merger of events and conditions that envelop the message, dictates 2055d a modified decision, the response 2060 will reflect the context to the extent permitted by policies established by the owner of the beacon and any global policies or prohibitions exercised by the administrator of the system. Messages may be re-routed as appropriate. While not shown, more than one internetwork server may be recruited for making a response. Thus the cloud host 35 has the capacity, for example, to perform searches and to incorporate search data before issuing a command or notification 2060.

Communications with client devices and machines are frequently bi-directional.

Responses may be logged and stored 2055e along with the initial commands and notifications for later retrieval, for use in tracking lost items, and for other aggregative uses. Several examples of applied uses are provided at the close of this section. The cloud host server will generally complete a process of responding to an incoming message and then stop 2055f until another message arrives, but may be programmed to refresh its command executions at desired intervals, or when conditions change, or on selected calendar dates, for example. Thus the location of a friend can be reported on the occasion of a birthday, for example. The uses increase exponentially as the Internet of Things (IoT) expands, but the energy consumption of the system may be reduced.

The system executes a remote machine transformation, as illustrated in dashed box 2070, in which the cloud host server 2050 transmits or otherwise conveys an actuation instruction 2060 to a machine effector and/or actuation device (broadly conceived in exemplary variants, this is shown here as a wireless signal 2060a). The wireless or wired instruction 2060 may be conveyed to an “effector machine” or an “actuation device”. These are generally smart machines having a limited but sufficient level of signal recognition and computing capability to perform a machine transformation in a physical sense, such as opening a garage door, turning off a stove, steering a driverless vehicle to a preselected destination, updating a display to show a map, or initiating a telephone call to an emergency responder when a strong jolt is detected by an accelerometer and gyroscope sensor package, and so forth. In some instances, the cloud host administrator will reserve action, or will aggregate data over time or geographical area before initiating an action. These and other features allow the operator of the system flexibility to initiate actions according to a broad range of contextual information and to learn by observing historical, geographical, and diurnal patterns, for example.

Effectors and actuators 2070 include remote machines 3000x, that may be operated directly as described already, or indirectly through a controller 4000x, and may also include smart actuation devices 70,72,41,3270a generally, whether addressed to individuals or to communities of users, and may also include other types of actuator devices 2000, where the item is to take an action and end 2070b until further instructions are received. Chains of active machines having a sequence of actuation may also be engineered using the systems and network architectures of the invention.

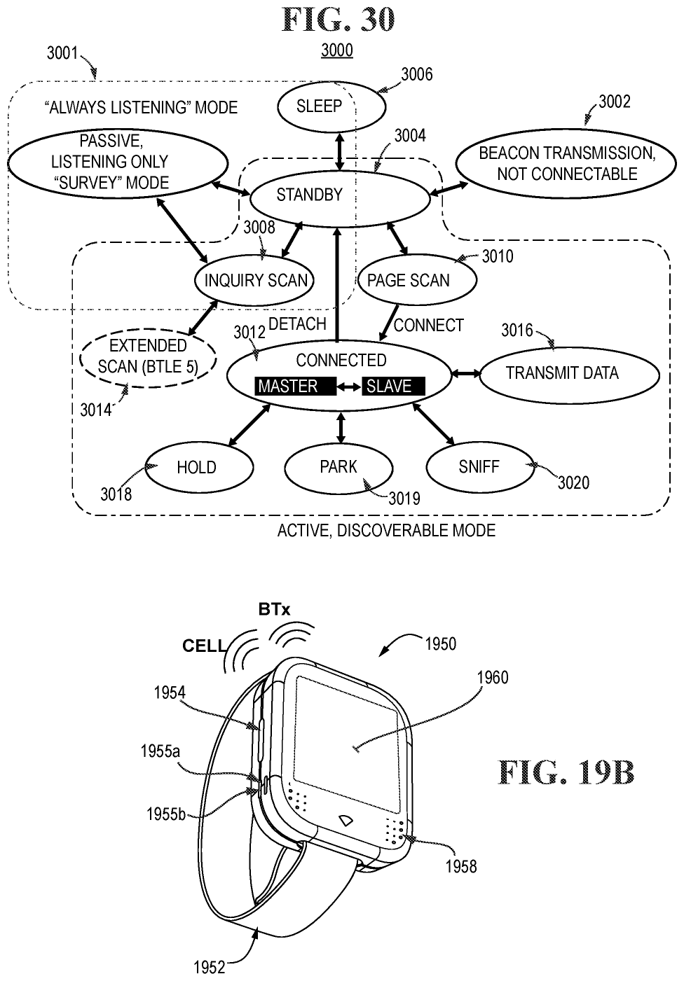

FIGS. 21A, 21B and 21C show three genera (2101,2102,2103) of radio interconnects used globally, a cellular tower 2110 network at the top, a Wi-Fi system (IEEE 802.11b/g/n and 11ah) with base stations (such as modems 2111) in the middle, and a peer-to-peer (P2P) scatternet of Bluetooth devices (BTx, IEEE 802.15.1, 2105) at the bottom. We note that the Bluetooth® network (BTx) is unique in that the individual devices can switch the “master” (or “center”) and “slave” (or “peripheral”) identity with a single command, and can belong to multiple piconets simultaneously, thus realizing a wide-open mode that is explicitly a mesh network (as preserved in BTx5.2×). U.S. Pat. No. 6,590,928 to Haartsen describes “Frequency Hopping Piconets in an Uncoordinated Wireless Multi-User System”, and is perhaps the father of all patents on Bluetooth radio technology, and the greatest advance since its early conception in U.S. Pat. No. 2,292,387.

BTx has a specialized and unique digital wireless communication device architecture deployable as a population of self-powered radio units capable of ad hoc networking. BTx has the option to be promiscuous in making new connections via a spontaneous inquiry and discovery process that can occur continuously (with a latency of less than a few milliseconds), can selectively limit discoverability and scan responses, and can be encrypted with private and public keys. Neither BTx nor Wi-Fi are natively “packet data formats” but Wi-Fi has been adapted to connect with Ethernet IEEE 802.3 devices via a packet signal architecture that has further adapted so that Wi-Fi and the IP Packet Data environment are interconnectable in near real time. More recently, the BTx is adapted to send and receive data to network protocols like TCP/IP, IPX, Appletalk, but in fairness, BTx requires an interlocutor to interact with IP Packet Data devices and wireless or wired environments of the Internet.

BTx, with its scatternets and frequency-hopping protocols, is both messy and promiscuous, features which go together and result in peculiarities not characteristic of Wi-Fi. BTx devices spontaneously discover proximate devices, forming ad hoc P2P scatternets, and initiate identity-indiscriminate broadcasts. Promiscuous setup of a connection is inherent in the network structure, but 128-bi encryption, FH-CDMA flickering network add/drop connectivity based on proximity, access code rejection, and radio distance permit implementation of network-independent security features for BTx devices.

BTx is also remarkably low energy (1-5 mW), unlike the 600-800 mW draw for GNSS signal capture and localization, and the 0.8 to 2 W draw for “portable” Wi-Fi. The power draw of a BTx radio is about a thousand-fold less than the power draw of a Wi-Fi radio. Of course radio range is the tradeoff; BTLE signals start at 0 dBm versus 16 to 23 dBm for Wi-Fi, but BTx adapts by its infectious sharing features so that Wi-Fi/Bluetooth hybrid devices are recruited sua sponte as interlocutors to larger PWAN networks as needed. Battery life of portable Wi-Fi devices is typically measured in hours or at most days, but for BTx devices, battery life may approach or exceed one year. For these reasons, Bluetooth has largely replaced Wi-Fi for PAN networks-according to Shukla et al (Shukla_2016. Utilization-Based Power Consumption Profiling in Smartphones, DOI 10.1109/IC31.2016.7919046).

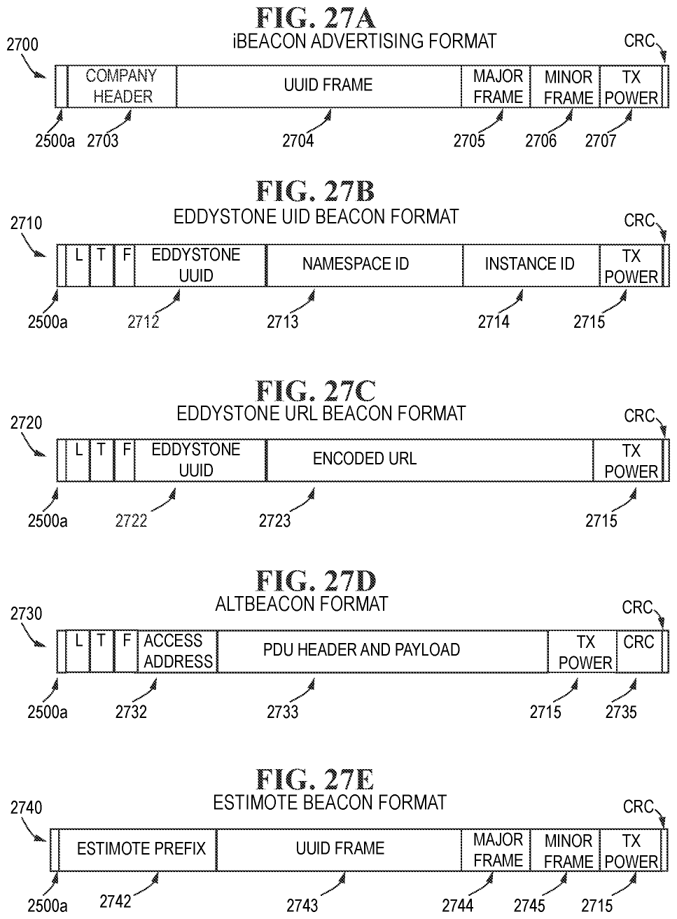

Power management is a central feature of BTx devices. Bluetooth devices do not “sleep” in the sense of “turn off”, they continue to listen responsively in a standby state (FIG. 30) for relevant radio traffic, and activate any needed functions when a qualified message is detected, even if the message is not addressed to the particular device. But needed functions are activated only for their designated purpose and only for as long as they are needed. This promiscuous connectability enables a passerby or bystander who is carrying a Bluetooth device to sample the local Bluetooth scatternet environment around them, and to be sampled themselves. A wealth of information is revealed in the Bluetooth “radio topology” around the user, whether engaged or unengaged in scan and response interactions.

BTx is readily embedded in items and appliances, unlike Wi-Fi (Wi-Fi battery size imposes limitations to miniaturization). For use in remote sensing, BTx has become a key enabler. Not surprisingly, Sensorcon (Cheektowaga, NY) launched a BTx sensor package (in a USB connector body) that adds a dozen sensors and an App to feed the sensor data to other smartphone apps. Sensors include a breath analyzer, infrared thermometry, carbon monoxide measurement, hydrogen sulfide assay, dissolved oxygen, pH, humidity, altitude, and light intensity meter, for example.

Even without use of GNSS, BTx devices may be given direction sensing antennae such that approximate positions may be deduced from signal strength as a function of the path taken by a moving device, and the information can be uploaded to a cloud and aggregated to obtain a consensus location. Similar data may be obtained from heading sensors when used for inertial navigation. While for now, commercial GNSS location detection (using smartphone Cellular radiosets) is the standard for location-based services, BTx networks may include the hardware to supersede or supplement smartphones in that role.

Thus BTx standard radio architecture is ideally suited for “Find Me” functions where a miniature radiotag is needed. Objects and persons of interest are tagged by attaching a BTx tracking device and the position of the device in the sea of other radio transmissions is periodically updated by virtue of the radio unique identifier RUI associated with each signal. And the BTx tracking device can also be used to find and control a paired smartphone with just a button function and a suitable App installed in the phone.

The messiness of BTx FHSS radio signal architecture becomes a surprising virtue, not a bug, and leads to emergent properties that would not have been predicted but are now manifest as larger clusters of BTx devices have been deployed in a home or around the globe. At this writing, there are about six BTx devices for every human on the planet and this is resulting in changes in the way information is collected and shared at the level of societies, continents, and nation states.

The ubiquitous capacity to join multiple networks and change network memberships at random while in an ocean of radio transmissions from like radio devices entering and leaving radio proximity is termed a “scatternet ad hoc environment” and this is a unique radio capacity that distinguishes Bluetooth networking devices. It is also a source of the criticality that differentiates the inventive systems from those based on GNSS, Wi-Fi, RFID, or cellular networks. FIG. 21A through 21C are graphics that demonstrate the basic structure of three most common types of radio networks (A) cellular systems; (B) conventional Wi-Fi systems (e.g., walkie talkie radio nets); and (C) Bluetooth scatternets, and introduce here a new perspective on how we share the planet with this class of BTx radio species. As can be seen, BTx is the only free and ‘open’ network on the public airwaves.

Unlike Cellular and Wi-Fi networks, password access is not required for BTx link communications except in paired piconetworks, where individual radios form a group of up to seven credentialed members. No subscription is required. The uniqueness of Bluetooth was in its original conception (as outlined in more detail at Wikipedia in a page titled simply, “Bluetooth”, and a separate page titled “Bluetooth Low Energy” (BTLE was developed by Nokia, Espoo, Finland) and that openness has not been lost as uses expanded. Commercialization by Ericsson (Lund, Sweden, see Swedish Patents SE8902098-6 and SE9202239) as a personal area network (PAN) and low energy short-range network in embedded appliances was the first breakthrough to large-scale adoption.

Bluetooth supports two kinds of links: Asynchronous Connectionless (ACL) links for data transmission and Synchronous Connection oriented (SCO) links for audio/voice transmission. Retail BTx devices were first announced in 1999, but in the space of 25 years at this writing, almost 50B BTx devices now populate the world, an astonishing growth curve.

Haartsen's U.S. Pat. No. 6,590,928 contrasts prior art radio networks of FIGS. 1, 2 and 3 (in the '928) with a BTx network architecture of FIG. 4 (in '928) in which network interconnections are extensible as multi-branched chains in which individual nodes can make ad hoc connections between branches to discover new signal paths as an evolving system of growing rings. We can imagine rings spreading from a drop of water hitting the still surface of a pond. We also imagine a superorganism that uses multiple layers of radio types for interconnections based on a BTx ring or core that has the capacity to reconfigure itself spontaneously and transmit information over long distances via flickering pathways through multiple devices. But we also immediately realize that the passworded connections of the handsets, hubs and SIM cards, create a bottleneck that limit core BTx connectivity. As Haartsen points out in the context of HIPERLAN development, when interacting with a MAC Protocol network under IEEE802.11, BTx units that discover the restricted network are excluded for lack of a compatible MAC Address and WEP or WP2 password. The Haartsen patent seeks to break the limitation of point-to-point connections based on a single network by enabling co-existence of multi-point-to-point connections in a PAN as a “scatternode infrastructure” capable of autonomous configuration of the mesh connectivity tree structure, so that we can talk about first master and second master units in a shared network of networks of slaves or peripherals, a remarkable reimagining of radio electronics, all occurring in millisecond timeframes. Each radio unit necessarily shares a unique radio identifier that is then assigned an ephemeral node in the flickering-network radio topology. However, the higher level MAC-addressable devices are native to a hierarchical “star” network configuration around a single center, and lead to network consolidation-essentially a “bottleneck” in throughput at a cellular tower or a modem. While modem processors have speeds by which these signal or packet collisions are not noticeable (mostly not noticeable), there is a winnowing out of information as data passes up the hierarchy through a single credentialed channel and a consolidation when measured at the rate-limiting infrastructure—and a discarding of enormous amounts of data. Techniques for improving the BTx core are described in Haartsen's EP Pat. EP1119991, titled, “Access Technique of Channel Hopping Communications System”, which enables individual node page trains to find new pathways through a BTx nodal landscape. Essentially, BTx devices achieve an autonomy that allow them to look out for themselves. Not only do these devices display superior network power management technology, but also signal topology that is far more open and transparent. We now turn to ways in which this growing BTx population has been adopted by existing telecomm utilities, social media, and the first round of AI companies. Essentially, the Haartsen view has not materialized; a handset-centric radio topology is dominant.

FIG. 22 is a view of a pyramidal scheme 2200 of human radio networks, as could be topped by an AI 2201 or capitalist meta-organism that might be imagined as a repository of all human information, in which the channels for communication with the repository are hierarchical to it, linear and managed at the cellular network level 2203, which functions as a two-headed funnel, a subscription layer, and exhibits restricted access based on fee structure and end use. Imagine a future of computing in which desktop portals are declining in frequency of use and smartphones and devices with SIM cards are increasing in number. This is what is shown in FIG. 22.

But there is also a vast BTx scatternet 2202 (shown as a hatched box representing a signal cloud) at the base, and a smaller but significant regiment of Wi-Fi devices in a first overlayer that interfaces with of the cellular networks 2203, and above those devices are a loose association of cloud hosts 2204 (with their PPck Dta n/Internet and WWW signal envelope outlined in a dashed line) and higher still, a network of communications satellites 2205 that are increasingly linked to the Internet (as infrastructure upon which the World Wide Web is operated). In this view, the BT signal envelope overlaps in a zone 2210 of ‘signal confluence’ with the BTx transceiver of the cellular handsets and their Wi-Fi and cellular radios that can swap data up and down the pyramid. The signal confluence zone 2210 perhaps most closely represents a description of the radio topology environment that bathes large areas of the planet, and includes BTx, Wi-Fi, WLAN, 6LoWPAN, UWB and Cellular at varying amplitudes and frequencies. It is this “confluence zone” 2210 that is detected by radio traffic sensors and—by surveying this layer—can be used with pattern matching for providing location services.

The BTx layer has a frame, slot or loosely, a “packet” language; Wi-Fi has a different frame, slot or packet language. The Cellular and the Wi-Fi networks talk to the cloud layer using a specialized digital IP Packet Network of the Internet, and satellite communications are also specialized in their radio signal architecture. BTx frames and the standard messaging protocol are not directly readable by the Internet.

Because of the language limitations, the handset layer 2203 in the stack of communications between society and the Internet is a two-headed funnel and the interlocutor for the planetary stack. Other access points for cable or DSL are increasingly less relevant because of their spatial rigidity and the need for extensive wired infrastructure.

As suggested by FIG. 22, as a matter of size comparison, there are about 50B BTx radios, almost 8B smartphone subscriptions (up from 3.5B in 2016), about 2B personal computers, a “top-ten” layer of cloud platforms (perhaps a few hundred total) with their server farms, and several thousand communications satellites. These resources outnumber the 8B people on the planet, who have very unequal access to the radio resources they offer, much of which is mostly idle or filled with network chatter. Not shown is the large data capacity of seafloor cables and other telecomm services such as fiber optics, but the capacity to cut communications at borders suggests that the global network is not as interconnected as we had hoped. As drawn here, the layers are divided like a cake, with the BTx/IoT layer 2202 at the bottom, separated by dashed line 2310 from the handset layer 2203, separated by dashed line 2320 from the cloud and satellite layer 2204/2304, simplifying some, but gaining a perspective. While BTx comms are multipolar and omnidirectional, comms in the upper layers are linear, highly directional, monetized, and restricted.

How much of the Internet is engaged in cloud-to-cloud data exchange is largely a matter of conjecture. Size tends to be reported in dollars rather than in GBytes, TBytes or ExoWatts. The largest cloud resources, ordered by market share, are Amazon AWS, Microsoft Azure, Google Cloud, IBM Cloud, and Alibaba Cloud. The part of the Internet most people interact with, the WWW, is a specialized niche of the Internet, and uses only a small fraction of the satellites or cellular layer resources; most satellite activity is related to telecommunications. Granted, Starlink (Redmond, WA) has more than 1.5M subscribers in 2023, but this is a small share. Cloud-to-cloud (C2C) traffic is probably mostly optical cable. Last mile wireless links are primarily to customers.

The basic engineering issues of Bytes and Watts should be factors of social interest. Indirect measures suggest that infrastructure is largely experienced by the public with respect to latency and bandwidth in streaming services, with a note that streaming is expected to generate $7B in revenue by 2030. In 2022, there were discussions that “hyperscale cloud” purchases were falling (i.e., a decline in pre-ordering of Internet resources to lock in lower pricing), but the recent uptick in AI services and related hype will reverse that. Microsoft cashed-in its Azure Cloud accounts receivable to buy a majority stake in OpenAI (the sale was valued at $29B). Today, Amazon AWS bills by the second, and a virtual machine is spun up for global scale deployment every minute. These are vast operations. Bare metal (i.e., physical servers), is supplemented by sharing of cloud capacity for autoscaling of services above predictable demand, and allows content providers to meet customer expectations, so that the troughs in demand are not backfilled to preserve the rental time at hyperscale rates, but rather supply is elastic. Given increasing demand, much of an expansion in online commitment gets contractually locked in, leading to the spread in server farms and increasing need for coal and gas-power.

In today's Internet Wild West, there is no energy budget, the services are by subscription or prepaid, and advertising dominates the traffic and the modus operandi. Information on users is marketed to target the advertising. This is all guesswork, but the estimate is that the computing machines, the “server farms”, that drive the Internet today consume 200 to 400 TWhr. The expectation is that in 2023, all the wind energy harvest worldwide will finally exceed 1 TWhr (see Global Wind Energy Council at gwec.net/globalwindreport2023/). A sensible observer will conclude that most of the energy driving the Internet bonanza is generated, directly or indirectly (because electricity is fungible) using fossil fuels. The actual energy production numbers by source, for the United States in 2022, are: 0.6% Oil, 39.8% methane (natural gas), 19.5% coal, 18.2% nuclear, 6.2% hydroelectric, and 15.3% non-hydro renewables, including wind (source: eia.gov, iea.org).

We have tested Virtual Private Network gateways (VPN, 2350) versus unreserved Internet Portal access, and the character of the traffic is entirely different. Inside the VPN, handset battery drainage drops exponentially. We attribute this to termination of the astonishing incidence of the “wake events” on a typical smartphone handset; the wake events are due mostly to unsolicited “push” advertising and network use monitoring. Backhaul, status check, and network tracking consumes most of the total Cellular and Wi-Fi throughput. Measured in dollars, the amount of advertising via the cloud-based radio networks is over $700B, but the relevant number, the energy in Watts, is unreported because the market incentives include no premium to limit or report energy usage.

In contrast, the BTx layer is engineered to limit power consumption, and total energy consumption of the network layer 2202 (FIG. 22) is perhaps 50 MWhr when integrated globally, without fractionating for duty cycle, which is highly variable. BTx deployments in the IoT are under pressure to reduce energy consumption, to extend deployable battery life to months or years, and BTx devices cooperatively control and manage their burn rate by synchronizing network parameters. Taken as a ratio, the energy consumption of Internet traffic versus BTx traffic is six million times greater (for one-fifth the number of nodes). BTx devices wake each other up when there is work to be done, and the system goes to standby/sleep as the default state. Yet latency is measured in milliseconds and wakeup can spread virally if needed throughout a network. Using UWB radio to complement BTx, location precision is on the order of or better than commercial GNSS, with a much lower energy budget. The engineering of the BTx radiotag is vastly superior to that of Cellular device engineering when considered as information per unit energy all in.

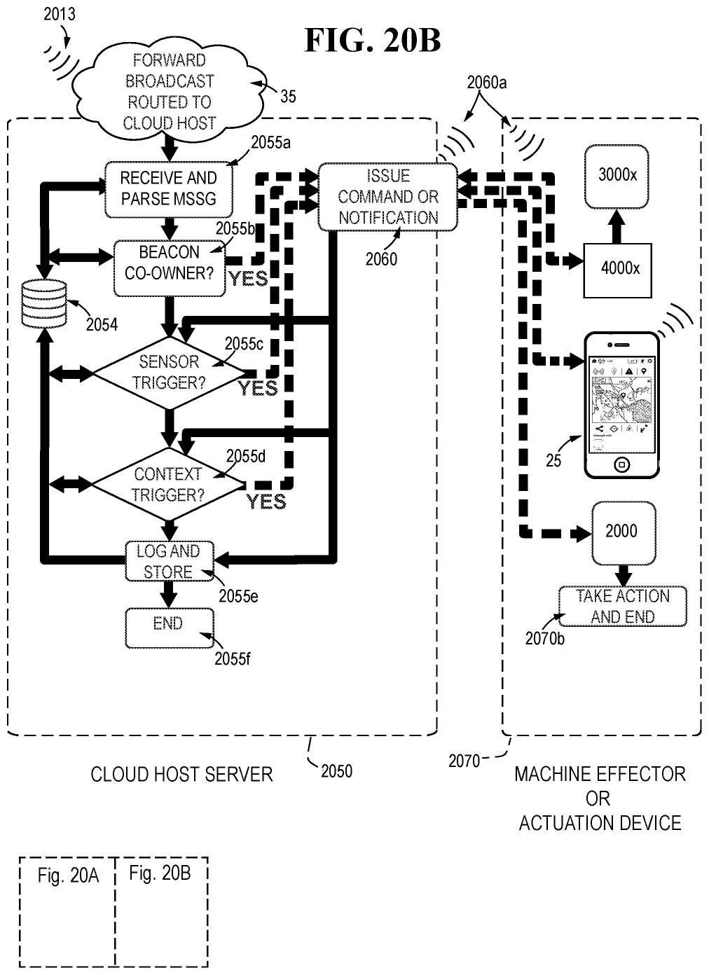

FIGS. 23A and 23B form a two-panel view illustrating the density of the BTx in what can be termed the “Internet of Things” (IoT, bottom layer 2202). The Multicloud 2304 is introduced, on the left with smartphone handsets 70 as the intermediary between the IoT and the Multicloud layer, on the right including handsets and XCB devices 2311 as the interlocutors between the IoT and the Multicloud layer, including satellites. So the point here is that data from the lower layers filters up through the handsets into a segmented layer of cloud infrastructure, some of which is relayed by satellite transceivers, and commands plus backfill is transmitted back to the handset layer, where some of it is relayed to individual IoT devices 1800 and embedded BTx radiosets in all sorts of items, broadly included in layer 2202.

The diagram is divided into a three-layer stack, with the BTx IoT radiotag layer 2202 at the bottom, an intermediate Cellular handset layer 2203 (that includes other SIM devices such as XCB radiosets (FIG. 23B, 2311) and specialized laptops and pocket computing devices), and a cloud layer 2204/2304 that corresponds roughly to the backbone infrastructure of the Internet (represented here as containing a vast amount of distributed server power 2301a,2301b and resources 2302a,2302b in cloud castles). The transitions between a BTx frame signal environment, a Wi-Fi frame/packet environment, and a true IP Packet signal environment are at horizontal dashed lines 2310 and 2320. Note that slice 2310 corresponds to the transition to the “subscriber identity module” (SIM) handset layer 2203. The transition from handsets to the Internet infrastructure of servers and databases is at 2320, where the Internet infrastructure is represented figuratively by distributed cloud hosts #1 (2305), #2 (2350), #3 (2306), #4 (2307), and is discrete because the MAC Address or IP Identifier directs information traffic. VPN 2350 is a specialized cloud functioning as a private Internet portal. We find it helpful to think of layer 2304 as a domain of multiple clouds, like castles, each with their own moat of infrastructure, not as a smooth, borderless sky. So as to focus on the wireless system, top-to-bottom, as a whole, details like cell towers, Ethernet, cable wiring, transoceanic trunk lines, laptops, and so forth, are not shown.

At this writing, the BTx frame protocols (as will be discussed below in more detail) are not adapted to be read by the Internet Protocol (IP) Packet Environment of the Internet. Thus the “IoT” is a bit of a misnomer, the traffic envelop as radio units and data units would suggest that a more apt term is the “BTx network of Things” in which the Internet is an overlayer, not a part, . . . but the name IoT has stuck. In fact, smartphones form a critical link or adaptor between the layer of BTx sensors embedded in vast numbers of electronic devices and appliances, including tracking devices, and the cloud domains where data is collected and analyzed before commands are retraced to the IoT devices in bottom layer 2202. Device 2359, a child's toy and device 2360, a wrist-worn health monitor, are just two examples of BTx radio devices that are members of the IoT, represented broadly as the collective devices depicted in IoT layer 2202.

In this view, the information network structure of modern society is viewed as a three-layer cake, in which the newcomer, the satellite layer(s) 2205 launched by SpaceX and others, will have uncertain effects, because the smartphone layer 2203 continues to be the funnel through which all information is filtered and controlled.

We suggest that satellite ground receivers do not fundamentally change the architecture of the 3-layer cake. While the ground antenna are direct links between end user devices and the “Internet”, the last link is a Wi-Fi link and no effort has been made to engineer BTx radio into the satellite ground receivers supplied by StarLink. Also, the typical Starlink service plan discriminates between Android installation and iOS installation, emphasizing that the bottleneck at the Wi-Fi/handset layer is not bypassed.

Shown again are the difference in layer characteristics, the BTx layer is promiscuous in forming P2P mesh networks (dashed arrows as loops) within itself whereas the upper layers are tightly structured as hierarchical (FIG. 22), linear, and access-controlled funnels for receiving and dispensing information through what are the wireless equivalents of wired links.

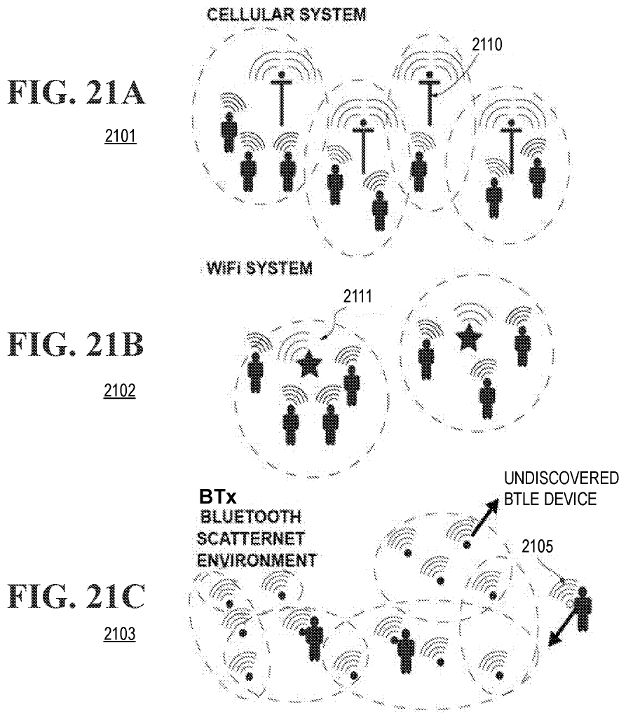

FIG. 24 (described as prior art, more explicitly the world as it now is) reinforces the point that links in the upper layers 2203,2204,2205 are throttled. Proprietary structures prevent general access, a “subscriber network” approach prevents access except through designated portals by subscription only. In contrast, the BTx network 2202 is wide open and data exchange is, at least in its inception, free and open. Smiley faces indicate successful contacts; unsmiley faces indicated refused connections.

Within the BTx network, multiple piconets 2401 exist. These may be flickering scatternets or may be controlled by a particular user/owner. BTx radiosets broadcast open messages, exemplary message (2400, bold arrow) is a bidirectional link to a cellular handset 2203b. In contrast, another BTx device may not succeed 2401 at making a connection with that handset or vice versa. Not all connections need to be bonding connections, but in some instances, scanning devices will discover undiscovered BTx devices and initiate an INQ signal, and in other instances, the scanning device may be set up to ignore those signals 2401 per protocol.

In this view of four stacked link layers 2202,2203,2204,2205, the BTx scatternet is on the bottom 2202, and the satellite network is on the top 2205, with a mix of Wi-Fi devices and cloud infrastructure running an IP Packet Environment “interface” in the middle. The stack is sliced at 2410, which marks the transition to the SIM layer, e w 2420, which transitions to the Multicloud layer with clouds 2204a,2204b, 2204c and 2204e and associated MAC protocol, and sliced again at 2430, which transitions to satellite layer 2205, with its own radio protocols and longer latencies. At each layer, messaging authentication and credentials may be accepted or declined. As indicated by the ‘unsmile’, handset 2202b fails to communicate with cloud service provider 2204b, but successfully links (‘smile’) with cloud service provider 2204c. Handset 2202b successfully communicates with cloud 2204d; handset 2202a with cloud 2204a, and so forth. Within the cloud layer, cloud 2204a does not communicate with cloud 2204b, and so on. At the satellite level, several shells are envisaged. Different clouds will communicate to different shells, so that for example, cloud 2204c will communicate with satellite shell 225, and cloud 2204d will be restricted in communicating with cloud 2 as indicated by the unsmiley face. Multiple shells of the satellite layer 2205 will serve different cloud infrastructures 2204a,2204b,2204c,2204d, etc.

The people at the bottom (FIG. 22) are not radios. People carry a variety of BTx devices with them through their day, and those devices are well-provisioned to serve as environmental sensors for everything from altitude to temperature and to social interaction density. We turn next to the unique characteristics of the BTx radio signals.

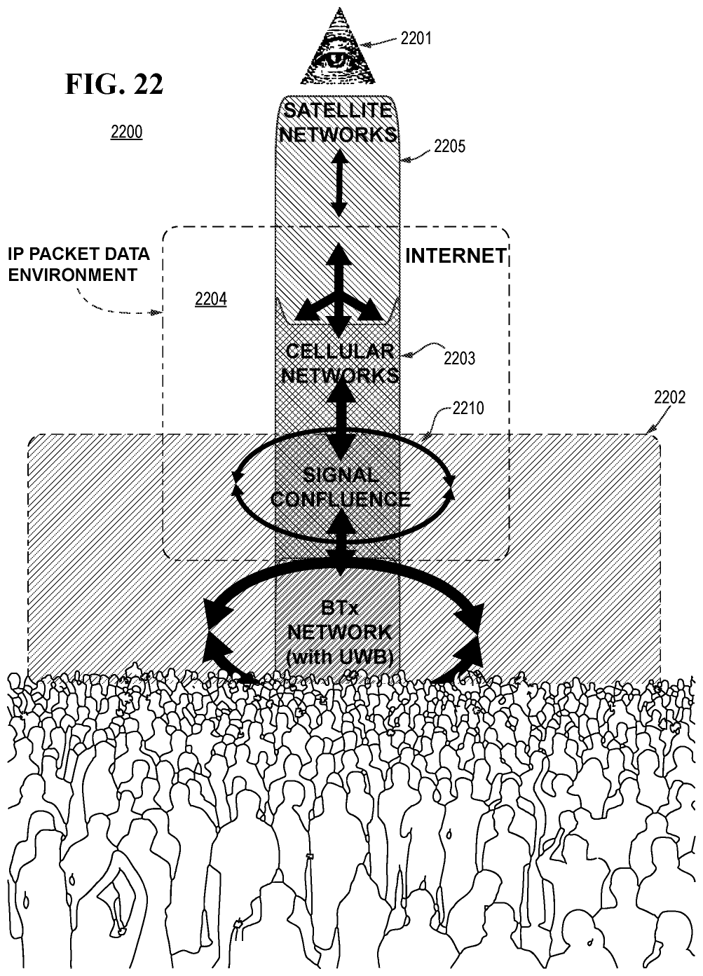

FIG. 25 diagrams the structure of a generic BTx transmission 2500 as specified by the BT SIG. This diagram has been updated to show newer payload structures with a flexible architecture for transmitting and receiving a “resolvable private address” (RPA) that encodes the radio unit identifier specific to an individual BTx radio device, and also a manufacturer's identifier (as can be what we describe as a “community identifier” in a co-owned filing, U.S. Pat. No. 9,774,410 et seq.), the two data elements needed to practice the crowdsourcing of lost-and-found services using radiotags.

Each signal begins with a preamble 2500a and ends with a CRC 2504. The PDU is a protocol data unit 2503 and has its own header in the formal signal structure. A “message integrity code” may be used for encrypted content, but the explosion of interest in private key encryption and rotating public keys and values is quickly filling the newly expanded size of single-slot advertising signals in BTx 5+, now a nominal 254 bytes versus the mere 31 bytes available a few years ago in BTx 4×.

Starting “little endian” style with the least significant bit (LSB) the signal structure specifies a standard preamble 2500a followed by the SYNCH WORD and trailer of the ACCESS CODE, and then a PDU Header followed by the PAYLOAD and CRC. Access codes 2510 address BTx radio traffic by class. For example, a general inquiry access code (GIAC) identifies traffic broadcast to any listening device, and indicates a discoverable device. Other inquiry access codes may be directed to individual devices, such as particular members of a piconet. The access code may be derived from, but is not the radio unit identifier of the transmitting device or the intended receiving device. The synch word is designed to identify the relationship of the sender and receiver and to specify a basic synchronization sequence such as for DSSS and clock offset for exchanging messages in the spread spectrum. The preamble is independent of the access code.

The payload 2503 may be an advertising data payload of 0-27 Bytes or in the newer BTx 5+ releases, a data payload of up to 252 Bytes. Signals in the advertising channels will include the preamble 10101010 (1 octet); and signals in the data channels may have preambles of 01010101 or 10101010. The PDU header will specify the message type and length, which may be selected from (i) connectable undirected; iii) connectable directed, (iii) non-connectable, non-directed, (iv) scan request, (v) scan response, (vi) connect request, and (vii) scannable undirected. A stealth access code may also be used that will not be accepted by the correlator of BTx radios set up for routine BT SIG designated interactions. In this way, the access code used in an advertising signal can be designed to impose a significant level of structure on BTx radio interactions as dependent on the BT stack.

The standard data structure of a signal as designated by the Bluetooth Special Interest Group (SIG) is published as part of the BT Specification. BTx radio signals are formatted as frames, sometimes also termed “packets”. BTx devices include frame composers and decomposers. BTx radios also include correlators with registers for sorting and identifying received signals based on access code or service UUID, for example as described in US Pat. Publ. Nos. 2002/048330 and 2009/0086711, which are incorporated herein for all they teach and reference.

BTx unique radio identifiers (RUI) or “radio signatures”, as used here, may be a MAC Address of a BTx radio device or may be a universal unique identifier (UUID) or a part of a UUID, and may include a serial identifier assigned by BT SIG as administered through the IEEE Standardization group (accessible via a WHOIS-style lookup). The RUI may also include a part number given by the manufacturer. The SIG standard permits developers to encode a “group identifier” or “community identifier” inside an extended unique identifier (EUID) issued by the manufacturer, inside the BD_ADDR, or inside a Service UUID. Proxy identifiers such as service UUIDs link to services associated with a discovered BTx device. As BTx has expanded, proprietary variants of RUI signatures and identifiers have proliferated.

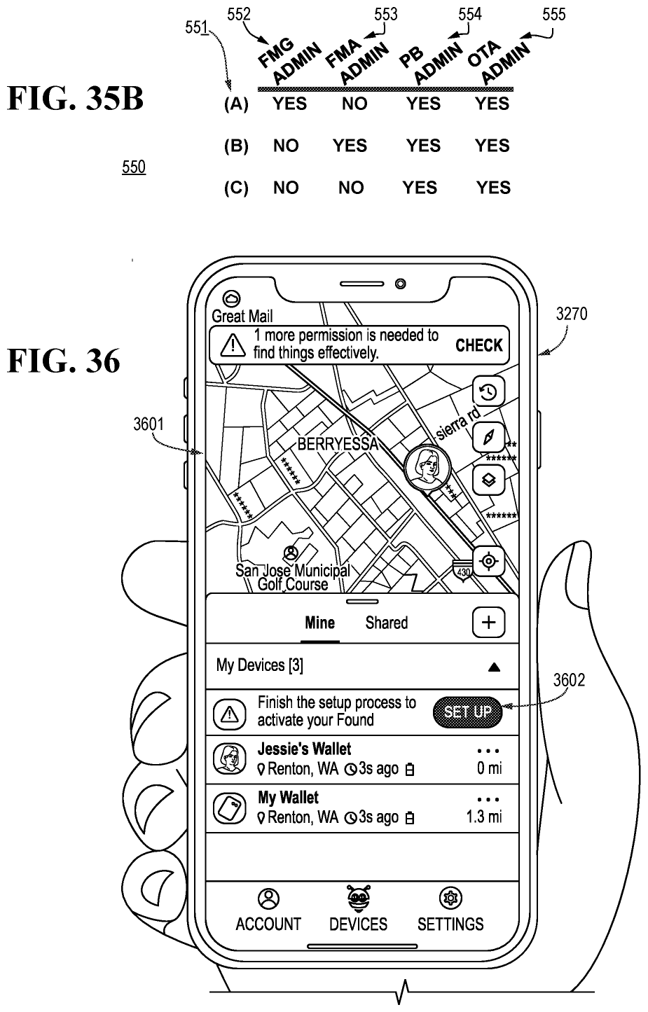

Identifiers or keys and values may also be embedded in payload URLs, service identifiers (UUIDs), and payload unique identifiers (UIDs) that identify proprietary services. The payload may include frames or “values” containing sub-frames with more detailed information addressed to receivers that know how to parse the sub-frames. Payload information may include sub-type or location, sensor output in digital form, and records of Bluetooth radio contacts, for example, as will be described in more detail with respect to FIGS. 37-40. Single bit identifiers may be read to trigger context-specific reactions, as described in U.S. Pat. No. 9,961,523 and 10,638,401, for example.

UUID service identifiers and subfields are tied to protocols to be followed in sending or receiving data, and allow developers to create tools that incorporate elements of the payload as “deep intent” triggers for software applications. Advertising messages may include one or more identifiers in service UUIDs that can trigger response behaviors, for example. Other messages may not provide sufficient information to identify all services associated with a device, but a qualified BTx receiver can inquire to obtain more information without actually connecting. In some instances, the payload is not fully broadcast on the advertising channels, but may be instead split across several data channels so as to balance the bandwidth.

As examples of “deep intent” control, identifiers in a message actuate protocols in receiving BTx radios that can wake smart devices, direct a smart device to a URL, push a notification to a remote device, or pull attachments from cloud library resources. A smart device can receive Bluetooth radio traffic from any Bluetooth device in radio proximity, and forward that traffic to an IP address associated with a Bluetooth group or community after adding a timestamp or a location stamp. By doing so, the smart device serves as a “hub” to transfer Bluetooth traffic radio contact records to the broader cellular network (or vice versa), enabling a host of location-driven services that can be subdivided according to sensor data thresholds or trends. This kind of smart device programming may be supplied by the BTx radio manufacturer, but some generic BTx interactions are standard in all smartphones, for example, having evolved with the technology.

It is still common that many BTx devices broadcast their RUI or MAC Address in the open, or in response to a SCAN REQUEST. A class of “BT Sniffers”, typically provided as apps installable on a smartphone, for example, may detect and tabulate these addresses and their signal strengths. Peripheral devices such as printers may also be recognized by the services they advertise. For dedicated BTx peripheral devices, a client application can scan for devices offering services or features associated with a UUID that specifies the GATT services the device supports, and in full CONNECTION, data specific to a service or feature can be transmitted across the connection. A BTx headset can advertise itself by its service as an audio headset, for example.

The RUI address can be an advertising address, a service address, a dedicated address of a piconet device, a virtual address, or a subscriber address. Some identifiers are open, others are proprietary or are obfuscated to prevent BTx sniffing.

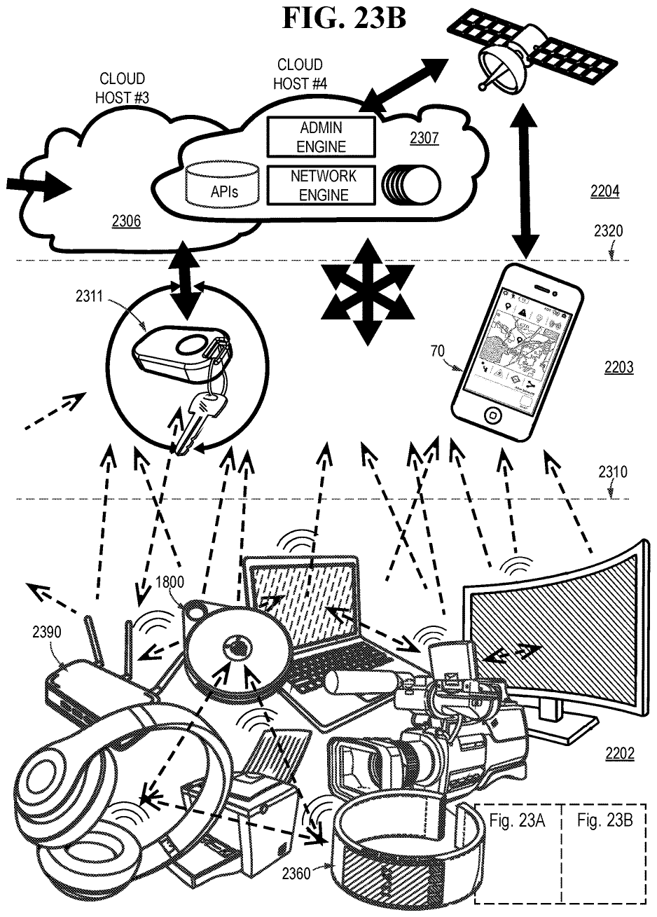

The general structure of a BTx message per BT SIG is shown for comparison with exemplary commercial deployments depicted in FIGS. 27A, 27B, 27C, 27D and 27E.

As can be seen, significant modifications are made to fence in proprietary markets, such as by use of proprietary access codes.

In recent trends (Eddystone, below, for example), BT signal payloads 2503,2723 may include “uniform resource locators” (better known as URLs) or “hyperlinks” that may direct the receiving device to an IP Address in the physical web. Alternatively a community identifier is transmittable in a message as part of a header, routing address, or payload that when recognized by a packet decomposer in a receiving device programmed to recognize the community identifier, causes the message to be forwarded to an IP Address and associated cloud host. This approach has enabled community lost-and-found services (such as described in US Pat. Appl. Publ. No. 2016/0294493, which is incorporated in full by reference). Google has also pioneered “fast pairing” methods that provision piconets for quick formation, an innovation that has had a very positive impact on the user experience with BTx devices.

The radio header and payload may also include resource identifiers, keys or values that may direct communications protocols in the link layer and may activate software applications keyed to URLs or values. This approach is seen frequently with smartphones-installed Apps react in real time to BTx transmission content. For example, a received BTx transmission can “wake up” a sleeping smart device (U.S. Pat. No. 11,170,338, titled “Cellular Devices, Systems and Methods for Logistics Support”), which is incorporated herein in full by reference. More recently, data supplied in the fields or payload(s) of a BTx transmission can cause an App to be installed, or if the App is installed and the appropriate permissions are in place, the App can be run at a particular instance in the program as most relevant to contextual clues, keys, values and identifiers in the received BT signal (US. Pat. Prov. Ser. No. 63/528,056, titled, “Global Bootswap Adaptor for FHSS Radiotags”). This “deep intent” indicates that the App anticipates the user's thought process and causes the client smartphone to display the most relevant materials from a resource or takes an appropriate action in anticipation of an expected need. The process has been improved by implementation of “WebApps” that manage user interactions via web host resources. This process has been extended to wall screens, so that “walk up” computing is increasingly automated by invisible BTx radio transmissions that identify the user and guess the user's intent from radio proximity, gesture, or accelerometry data. For example, if a user picks up a shoe in a shoe store, a BTx radiotag attached to the shoe will send a sensor output and a wall monitor will display more information about the shoe, or push that information onto the user's smartphone.

In connected links, BTx signals transmit data values, files and even firmware updates. Newer BTx 5.2, 5.3 and 5.4+ standards permit multi-slot messages for sharing larger amounts of information, even audio encoding of speech or music. Connectionless data sharing is also supported in the newer protocols.

In a typical BTx interaction, a first BTx device will send an INQUIRY packet one-hundred twenty-eight times in 1.28 seconds, each inquiry packet is sent in 16 time slots (10 msec, 625 μsec each) over two alternating sets of frequencies. The INQUIRY packet is short, just an inquiry access code. A second BTx device, operating in an unsynchronized listening mode, may randomly intercept one of these transmissions (there are 79 possible frequencies [or 40 depending on the standard], three of which are reserved as “advertising” frequencies for making inquiries). The Baseband protocol causes each radio to use pseudorandom “frequency hops” to jump from frequency to frequency over the spread spectrum (U.S. Pat. No. 2,292,387). A device that is in INQUIRY SCAN at some crossover hop will intercept a packet with an inquiry access code that it recognizes, or that it chooses to accept. The frequency hop protocol is inherent in the access code, and a device that accepts an access code can then join the hop sequence with the first device or can send an FHS response packet containing its hardware address and its clock so that the first device can specifically address it with further instructions, if permitted. The interaction may then rapidly be escalated to a PAGE and PAGE SCAN interaction, resulting in a CONNECTION that formally makes a piconet link in which the RUIs of the connected radios are stored in device memory. The piconet relationship defines one of the devices as a “center” device (“master”) and the other device as a “peripheral” (“slave”) for purposes of organizing the transmission and receive sequences, but at the hardware level, these roles are interchangeable and are controllable by a master-slave ‘switch’ that is just a line of code.

A BTx device can participate in two or more piconets if they can be separated by time division multiplexing with millisecond separation. While more limited in the newer BTLE standards, in one embodiment, any BTx device may belong to a hierarchy of piconets, in which its participation in a second piconet is alternated with its active participation in a first piconet. Thus larger mesh networks are a natural outgrowth.

The device in the central role scans for BTx radio sources, looking for advertisements and inquiry responses. The device in the peripheral role advertises itself and offers a service. GATT server vs. GATT client determines how two devices talk to each other once they've established the connection. GATT metadata is transferred from server sensor node to client center node, for example.

To inquire about other radio units in a receiving area, BTx radios may also promiscuously announce their presence to other BTx devices by sending a general INQUIRY access code (x9E8B33, GIAC). An ID Packet may be exchanged in response to a frequency hop synchronization (FHS) packet. Access codes are classed as DAC, IAC and CAC, indicating Device Access Code, Inquiry Access Code, and Channel Access Code, respectively, the details of which relate to link management. All packets begin with the CAC, DAC or IAC, and a clock number segment. A correlator identifies relevant packets for processing. BTx devices acquire information about other local BTx radios in this way.

In a piconet, using link management, devices that are parked or lose a pairing connection can ignore public traffic but will “wake up” (almost instantly) in response to a beacon signal RUI from a familiar or “whitelisted” partner-so as to restore or recover a piconet connection. The listening device can also partially wake up its MCU so as to log any radio contacts, while not responding further. Not all radio interchanges result in a CONNECTION, but the listening radio can record information about the transmission, and by escalating to INQUIRY SCAN without wasting time or energy, will receive more detailed information about the transmitting device.

Bluetooth Core Specification, Version 5.2 and Supplement, (2019, incorporated herein by reference), includes an “Extended Inquiry Response”. Data types may be defined for such things as local name and supported services in connectionless mode, information that otherwise would have to be obtained by establishing a CONNECTION. A device that receives a RUI and a list of supported services in an extended inquiry response does not have to connect to do a remote name request and service search, thereby shortening the time to useful information reception. Backchannel communications facilitate the connectionless mode.

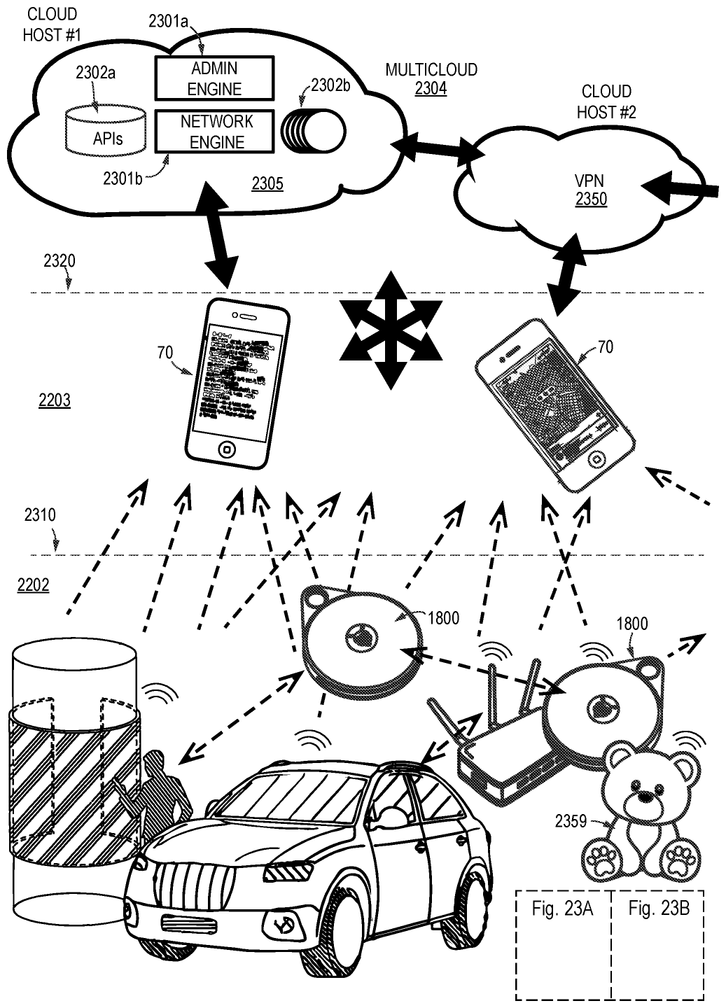

FIGS. 26A, 26B, 26C and 26D are sample packet structures that relate to the BTx advertising and link layers. These tend to be proprietary formats having defined fields in the header and two to three open fields or frames in the body of the message for non-format contents such as an identifier associated with the device or an advertising service.

The shortest packet is an INQUIRY packet 2610 as shown in FIG. 26A, with a length of 68 bits. This is an access code 2611 of an inquiry or a device ID_PACKET of a scan response. POLL 2621 and NULL packets used in messaging have a length of 122 or 126 bits (FIG. 26B) and include an access code 2622 and a header 2623 that defines the packet. The FHS packet (2641, FIG. 26C) is important in exchanging identifiers and clock hopping schema as part of the connection process prior to further data exchange by pairing and is 270 bits in length. The FHS packet includes an access code 2642 for addressing the transmission, a header 2643, and a payload 2644. In extended connection mode and connectionless transmissions, packet lengths may span up to 5 slots. For fidelity in voice transmissions, higher numbers of repeats of short packets are used. But individual packets are typically limited to a maximum payload of 258 octets (about 2 Kbits) with a total length of about 12000+ bits in a 5-slot data payload, optionally with enhanced rate packet transmission with DPSK at 2 Mbps or 3 Mbps. While this is successfully applied for audio streaming, video streaming is still uncertain. These details point to the limitation of BTx for data throughput, the utility of Wi-Fi or Cellular radio as an enhancement of BTx radio for transmission of larger amounts of data at greater speed, so for illustration, 5G tops out at a theoretical 5 Gbps, permitting much greater use of broadband services on dedicated channels.

With existing BTx radiotags, data mining for location information is doable. When viewed from the original goals of the Bluetooth founders, a radioset optimized for promiscuity enables radios to sense like radiosets in an immediate radio proximity and to pair readily, building local personal area networks in milliseconds on an open architecture that was fast and flexible. This ubiquitous connectivity has long been a goal of the Bluetooth Special Interest Group (SIG) since the first launch in 1999 but has been made less practicable by the proliferation of proprietary devices and formatting. And by legitimate privacy and security concerns. The popularity of these devices speaks to the power of connectivity and the willingness and need to continue to innovate so as to strike a balance between conflicting goals.

FIG. 26D is a newer species of BTx packet, a “LOST PACKET”, in which an encrypted identifier 2664 is broadcast to a companion handset and relayed to a compatible cloud host server. The signal includes an access code 2662, header 2663 and PDU 2664 that encrypts user data with a rotating public key and value. The companion handset adds an encrypted location. The encryption includes the RUI encrypted with a private key and a public key, so that the cloud host server can forward the encrypted location information to the owner of the lost radiotag, and purportedly only the owner can actually break the hash and do the location decryption. Lost radiotags automatically begin transmitting LOST PACKETS exactly 3 days after their last connection with their companion handset. In the proprietary world of these radiotags, each radiotag bonds to a companion handset, and communicates only with that handset unless lost. The owner is able to access a map view that shows the current location of the radiotag. If that connection is lost, then the radiotag broadcasts the LOST PACKET signal that may be recognized by a smartphone from the company, or smartphones specially configured to recognize that company header 2662. To make unwanted stalking difficult, various encryption schemes are used, including rotating key and value encryptions that obfuscate identity of the tracking device and also, as a countermeasure, detect uninvited tracking devices that remain in radio proximity for a suspicious duration. While the host company retains the ability to report location information to law enforcement, the host server does not routinely record or tabulate locations as a privacy feature, so the user can feel secure that location information is not leaked for malicious intent. User-specific identifiers are not paired with location in unencrypted data in these systems. As a corollary, the companion smartphones do not routinely report location information about radiotags not made by the company.

Several competing standards have arisen for advertising radiobeacon transmissions. These include the iBeacon®, Eddystone, Altbeacon, Estimote, and Geobeacon standards, for example, all competing for IoT placements in a growing sales market. Brands include Chipolo, Tile, Jiobit, Geobeacon, Samsung and each alternative may include software that when installed, works on both Android and iOS companion smartphones. However, a device that is set up to work with Android will likely not work with the Apple Find My network, for example, in character with Apple's exclusive product ecosystem and its proprietary BTx radio system.

FIG. 27A, 27B, 27C, 27D, 27E are views of proprietary BTx advertising packets with data payloads. Shown is an iBeacon advertising format circa year 2015, an Eddystone UID beacon format circa year 2016, an Eddystone URL beacon format circa 2017, an Altbeacon circa 2021 and an Estimote beacon circa year 2012.

FIG. 27A is a view demonstrating a first BTx radio signal format currently known and used. This iBeacon advertising format 2700 with UUID Advertising Frame 2704 was introduced by Apple Computer (Cupertino, CA) for the iPhone 6, which contains a preamble 2500a, a company header 2703, a payload with at least a 128-bit universally unique identifier (2704, UUID), along with major 2705 and minor 2706 frames for advertising location. Transmit power 2707 was included to improve rangefinding. As originally released, the signal is unidirectional; the beacon acts only as a transmitter and was indisputably envisaged for its advertising potential, not for bidirectional radio links. The preamble is used by a receiver such as a smartphone to capture the rest of the signal, which requires clock synchronization and adjustment of power gain. The preamble also triggers a calculation of the RSSI of the message. The iBeacon prefix 2703 is proprietary and includes Apple-defined flags for classifying messages. Devices are identifiable, at least in part, by their “services”. For example, a UUID frame may be broadcast that corresponds to a generic attribute profile (GATT): which codes a general instruction set for pushing information to a smartphone from a retailer's booth. Other GATTs may code how a device works in a particular application that is called by an attribute profile. In broader applications, a device could contain a heart rate monitor and a battery level detector, or a speaker and microphone, or a link pointing to a webpage. Each attribute is uniquely identified by a Universally Unique Identifier (UUID), which in the iBeacon standard is a 128-bit string used to uniquely identify information (data) specific to each type of sensor output. The attributes are formatted as characteristics (classes) and services (collections of classes). A “Service UUID” in an extended inquiry response may include shortened 16-bit, 32-bit and global 128-bit service UUIDs, and may include supplemental major frame 2705 and minor frame data 2706.

FIG. 27B shows frames of a radiotag format 2710 broadcast by an Eddystone beacon, and is of historical interest. Google announced Eddystone in 2015. The service was downrated in 2018 and discontinued in 2020. These beacons were registered via a Proximity API, related data was stored via the Proximity API in a database and viewed and managed with a beacon dashboard, typically on a smartphone, as was useful for SDK development, particularly for advertising. Moreover, Eddystone included three broadcast styles so as to be compatible with both iOS and Android, and also operable to broadcast URLs (or shortened URL lookups) and sensor data. A TX POWER field 2715 is used by a receiver to improve the rangefinding accuracy. RSSI (dBm) as a fraction of TX POWER (dBm) is a better indicator of signal distance than RSSI alone. With newer hardware, BTx Channel Sounding (HADM: high-accuracy distance measurement) also improves range estimation beyond what was best mode at the time.

FIG. 27C displays an Eddystone beacon message 2720 with a URL payload. Eddystone used an open standard (Apache) that is compatible with both Android and iOS but requires a Google Proximity API installed on the smartphone. As an added service, Google supplied a lookup web server whereby shortened URLs or user identifiers are used to call background resources termed “attachments” from a cloud host server. The attachments can be anything from a subdomain link to a video clip. The Google beacon transmission interval (duty cycle) was programmable, unlike the iBeacon standard, permitting operation with a reduced battery consumption rate.

All beacon signals include a standard preamble 2 and generally a header frame that follows includes signal length, type and data field codes (LTF) so that the receiving radio can determine how to decode the signal. The Eddystone UUID 2712,2722 is shortened and includes an identifier value that allows any device to use the resources offered by the beacon by using WebApps, without the need for installed software.

Eddystone was a family of standards built around common use cases, each having a different flavor of payload. The Eddystone concept assumes that beacon broadcasts are unidirectional, as for advertising. The beacons can switch to another flavor at timed intervals. Cloud services are more extensive with the Google beacon platforms and include the capacity to update messaging on the fly as well as control over transmission frequency and capacity to omit some fields where a shorter message length is preferred. In a first flavor (FIG. 27B, 2710), the Eddystone UUID 2712 includes a MAC Address, but can be encrypted, and Namespace ID or frame 2713 combined with an instance ID 2714 that may include one or more client services offered by the beacon that again tie into code supplied by the developer using the beacons. In one application, a telemetry message (TLM) type may include sensor information, for example heart rate telemetry, and a beacon diagnostics suite. TLM messages may be interleaved with other Eddystone beacon messages to provide monitoring and maintenance of beacons in the field. Transmit power is also encoded 2715.

In a second flavor (FIG. 27C, 2720), the beacon transmits a URL (as may be compressed when used with a cloud-based look-up table). In the UID beacon format 2720, radiobeacon message length is transmitted in a prefix, along with type and data flags. The payload includes a UUID 2722, a webpage reference, often as an encoded URL 2723, that signals “deep intent” to a browser. A developer's App opens when the beacon message triggers it, and takes the smart device to a webpage, and can even fill in fields in the webpage for an immediate interactive experience that merges the physical world of the IoT with the cloud world of supporting webpages. Google supplied WebApps added a “walk up and use anything” quality to the user experience.

Also available was an advanced “EID” payload, which is dynamic and is used with a cloud resolving service to provide timely or context specific messaging by a “fetch” process. The EID message is limited to licensee-specific content, and has stronger privacy settings. Google EID messages contain signal characteristics that are difficult to spoof and can be associated with secure location services. The EID case is included here because it indicates how a radio topology can be shaped by dedicated beacons operating in concert with a dedicated cloud service so as to join web radios with dynamic Internet content on demand based on a BTx radio envelope or topology surrounding the radiobeacon.

FIG. 27D displays an Altbeacon broadcast format (Radius Networks, Kutztown PA), another of several proprietary radiotag formats. The Altbeacon advertising format is an open source, non-connectable beacon signal 2730 that is intended to work with iOS smartphones, Android smartphones, and VPNs using its private cloud servers, and closely follows the BT SIG standard 2500. Android does not have native iBeacon support. Due to this, to use iBeacon on Android, a developer either has to use an existing library or create code that parses BTx signal frames to find iBeacon advertisements. Here, the access address 2732 may be used to key the message to specific users or a general audience and conforms to BT SIG standards, not proprietary standards. AltBeacons appeal to advertisers in need of a larger payload 2733. But post-introduction of BT SIG standard 5+, with a 250 byte payload, the entire industry has benefitted from larger data slots. A cyclic redundancy check 2735 may be included to ensure message fidelity as received.

FIG. 27E is an Estimote beacon format 2740. Estimote (founded 2012 in Krakow PL) was introduced before the earliest Apple beacon system and also relies on a UUID frame as a sort of payload. Preamble 2500a is followed by a header or ID prefix 2742 specific for Estimote. Estimote is intended primarily for indoor use, supports radio for UWB to refine proximity location fixes, and is non-connectable. The hardware may even include an HDMI wired port so that a wall monitor can be connected to the Estimote beacon such that any bystander smart device that approaches the wall monitor will activate display content. The beacon triggers and controls a display of contextually related video content while pushing advertising onto the smart device. For effective advertising, user SDKs enable programming by which the smart device is engaged in interaction with the video content via the beacon. However, in typical applications, the Estimote beacons are not connectable, so all user-interactive programming is done in the smart device.

Estimote beacon signals include formatting that can be generated using an SDK compatible with both iBeacon and Eddystone formats, but the UUID frame structure 2743,2744,2745, with major and minor frames, more closely previews the iBeacon frame type. Telemetry packets may be broadcast. Transmit power 2715 may be altered to improved location tracking in indoor spaces. UWB and NFC radio support has also been added as an option. The TX Power field 2715 with UWB appears to be evolving toward more sophistication in enabling high accuracy triangulation for indoor location services.

While initially introduced for advertising, BTx devices may also be used in location services. The capacity to miniaturize the radioset is superior to Wi-Fi for helping a user find lost items. In some cases a MAC Address or MAC-Lite Address is broadcast, but in other instances, device addresses are given dynamic pseudonyms or are broadcast behind non-discoverable access codes so as to provide location services limited to an owner with a private decryption key.

Clearly the BTx experience, as depicted in FIG. 22 and FIGS. 23A-23B, is subject to competing pressure. There is a benefit availed by the mesh network characteristic of the BTx layer 2202, but there is also a commercial pressure to proprietize the experience so as to extract an optimal cash return, generally in the form of advertising dollars. BTx radio devices have also evolved to be connectable, having both transmit and receive radio capability, which opens whole new applications. Proprietary signal structures have evolved that seek to balance these two pressures so that a operating system of the smartphone in radio proximity to the radiotag extracts the value of the interaction. But there may be alternatives.

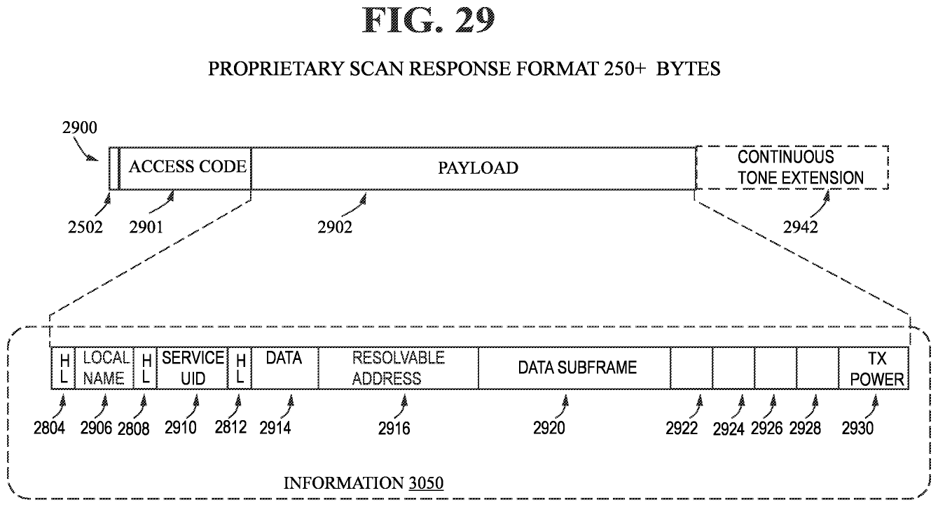

In a first example of sharing the BTx/IoT expanse, we introduce a BTx radiotag that can be custom onboarded for use with either iOS or Android smartphones and uses the BTx transceivers that are in our radiotags (FIG. 32, 3200) and in other BTx devices.

In a second example, we describe a BT signal structure in which BT signals are intercepted and anonymized, reduced to patterns of 1's and 0's that by DSP correlation and Artificial Intelligence, deduce the character of a surrounding location, or often the location of the transmitters themselves, so as to modify the behavior of the proximate radiotags, and also any companion smartphones. In fact, with minimal re-engineering, the BTx radiotag layer can control the system layers 2202,2203 and 2204 to reduce unwanted and unnecessary signal traffic and energy consumption. Apps 100,300,4760 are written to complement changes in firmware in the radiotags themselves so as to effect change.

While this advance does not cure the ongoing fragmentation of the IoT into individual camps, each monitored by individual clouds, it does demonstrate the power of bottom-up management as applied to energy consumption and network management of unwanted advertising, for example, and also suggests ways in which the networks taken as a whole can be adapted to greater resilience and capacity to absorb point failures and local disruptions such as associated with power outages, war, incoming missiles, fire tornadoes, tsunamis, advertising and disinformation campaigns, for example, without sacrifice of privacy.

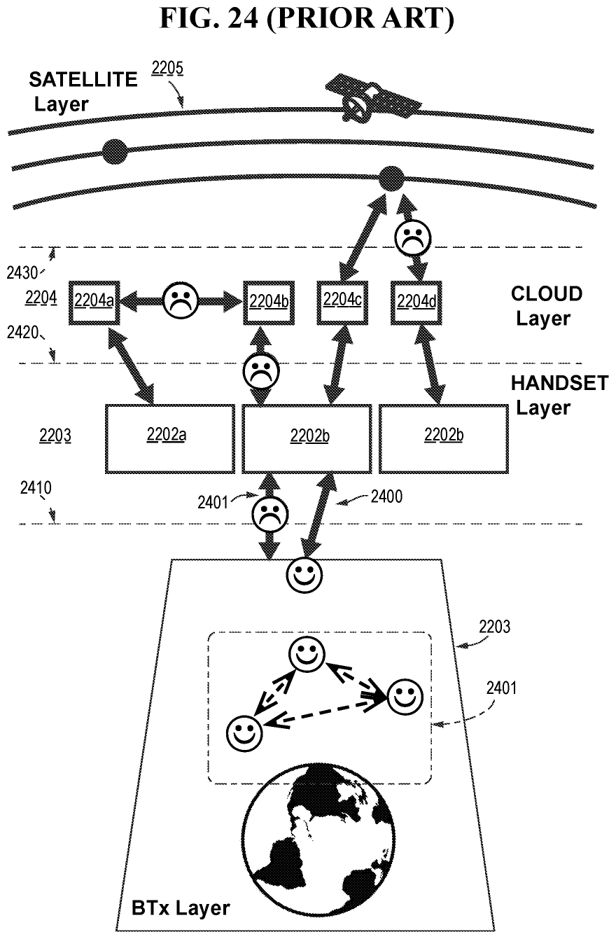

FIG. 28 is a view of a first structure of a proprietary inquiry response packet 2800. The first two bytes 2818 of a six byte MAC Address 2816 are pre-empted as a manufacturer's identifier that is invariant from unit to unit. Packet 2800 includes a preamble 2500a, access code 2801, payload 2802 and error check bytes (CRC) 2504. In this embodiment, a radiotag may be structured to transmit a data payload to a receiving device such as control apparatus 70 or community nodal device 2010,3270a, for example, in response to an inquiry or scan. The structure includes a series of length fields (designated by “H/L”, 2804,2808,2812 for example) that help to mask data in the intervening frames for parsing. Frame 2806 is a local name specified by the manufacturer or administrator, and may be FNDR or FND, for example, to designate a brand or nickname. Frame 2810 is a Service UID and acts to trigger a software application or API when received by a control apparatus 70. Frame 2814 is a data service filter that can contain information that specifies how the packet is to be read, and thus terminates a “header” (H) part of the payload 2802.

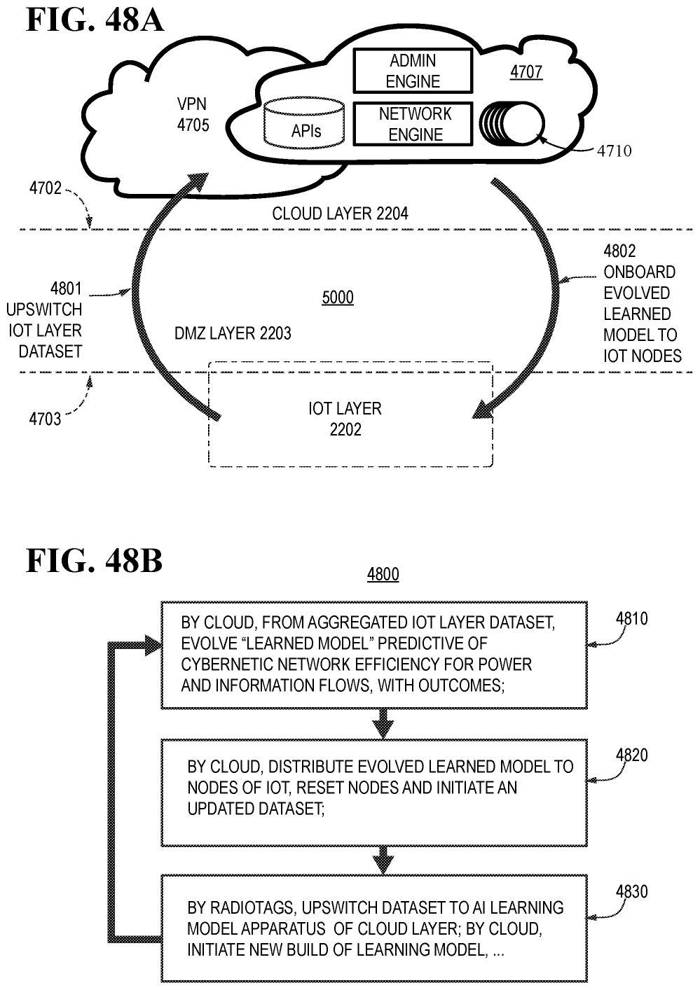

In this proprietary format, the next frame 2816 in the payload specifies a 48-bit MAC Address (6 octets). In this embodiment, the first two octets 2818 of the payload body define a “community identifier” that “points to” a designated server to which the data may be forwarded; a system that is typically operated by the system administrator. The community identifier is shared by other devices made by the same manufacturer and is important because the power of the tracking devices rests in great measure on the cloud-based system that administers the devices for a community of users. Thus the community identifier is key in accessing the lost-and-found services of the system. This is described in more detail in FIG. 47 and U.S. Pat. No. 11,792,605, titled “TRACKING DEVICE SYSTEMS”, filed 12 Apr. 2021 which is co-owned and incorporated herein by reference for all that it teaches.

The remaining four octets of the MAC Address 2016 are a unique device specific identifier and are broadcast so that the devices can be identified not only by the user, but also by other devices that are community members and can run the required software for recognizing the message structure and decomposing the packet to parse out the MAC Address. The MAC Address thus serves as a radio unit identifier (RUI) or short version of a UID. This RUI allows any compatible device in the world to report the location of a lost tracking device to the designated cloud server 4707 or gateway 4705 (FIG. 47) and allows the cloud server to pair the radio unit identifier with a user profile of record. Once the user is identified, the cloud server can generate an alert or notification to the owner, or can cause an action in a remote machine. With maximum parsimony, each type of data in the signal is capable of acting as a flag to trigger a remote response.

The rest of the payload is divided into other fields that are particular data types. The content of some fields can be dynamic, for example field 2820 can be an action sequence specifier or key in which the value of the field specifies a particular behavior or mode such as an alarm state. Another field or key 2822 can indicate whether the device is bonded to a control apparatus or is in an unbonded state available for bonding. If bonded, the device may not respond to invitations to connect from another control apparatus. A field 2824 may specify the state of a multifunction button (3216, FIG. 32) that serves as a command when parsed by compatible software in a control apparatus. Next field 2826 may specify a temperature sensor output, for example, or other sensor value. And field 2828 may specify a heading, accelerometry or a motion sensor output, and so forth, such that the field changes continuously during motion. Field 2730 may specify the transmit power of the radiotag signal, as is useful to the receiving device in more accurately calculating radio proximity. These data fields, and others in other signal types, contain what is referred to here collectively as “information” 2850 that may be used to locate or track lost items and to cause remote actions by triggering command and notification functions in a control apparatus 70,3270b, in a cloud host 35,4501,2305, or in other radiotags 1800, for example.

The tracking device with transceiver may also receive encoded data that results in execution of a command sequence. The devices have both packet/slot compilers and decompilers for sending and receiving encoded messages.

Thus the BTx tracking device 10,1800,1900,1950,2000 exhibits a significant level of sophistication in a simple package. The primary limitation is range of a BTLE radio transceiver. At 2.45 GHz (or in dual mode), a signal transmitted at 0 dBm decays in quality of detection within a radius of about 100 yards. This is in part due to the GFSK modulation of the primary signal and the use of a spread spectrum, but is also simply the mathematics of antenna power. In order to overcome these limitations, we have introduced a next generation of “XCB radiotags” (4575,4775, FIG. 47) (U.S. Pat. Nos. 11,184,858, 11,450,196, 11393323 et seq) that may include a PSK- or quadrature modulated Cellular radioset capable of more powerful transmissions, typically with SIM card. An XCB radiotag with BTx and Cellular radio hybrid chips was disclosed. While these newer radiotags are technically different, the basic operation of the lost-and-found system (FIG. 47, 4700) includes many features of the earlier systems, but with the augmentation of Cellular network connectivity, as will be described below. Here we discuss enhancements to the BTx radiotags, subsequently we will discuss enhancements of the XCB radiotags. But the network capacity to capture the “radio topology” is what is centerstage in this filing.

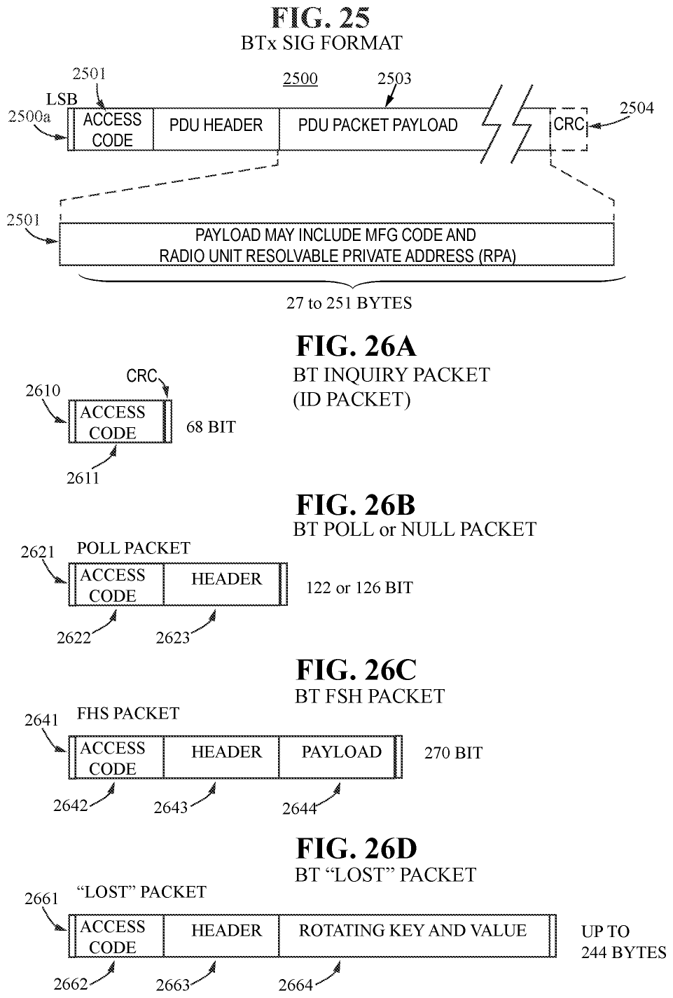

FIG. 29 is a view of an alternate proprietary inquiry response packet 2900 with access code 2901 in current BTx models and takes advantage of the larger payload 2902 in the BTx 5.2+ release. Nominal byte load is increased from 29 to 252 bytes per slot, and up to 1600+ bytes may be linked together in a daisy-chained or concatenate data stream. Also in BTx 5.2+, an advertising signal may include a pointer that takes the observer device from an advertising channel to a hop sequence through data channels so as to receive a larger package. These changes were made to improve audio streaming performance but have spillover effects for radiotags that offer location services or report sensor and location data. Also shown here is an extended signal 2900 that includes an end tone extension 2942 for “angle of attack” location refinement in some applications. BTx signal architecture continues to evolve.

BTx devices may also include encryption that may be native encryption specified by the BT SIG, or may be proprietary encryption utilities that operate with public keys, private keys, rotating keys, or even end-to-end system encryption that requires for example a companion device owned by the same user and logged into the same server to decrypt private radiotag signals. While not so over-engineered, “Identity Resolving Keys” (IRK), for example, are known in the art and are used both to generate and to resolve “resolvable private addresses” so as to ensure a high level of privacy—while also providing location services to users. Frame header “H/L” specify header type and length as before. In this way, MAC Address 2916 may be resolvably encrypted to broadcast a private RUI identifier. In this schema, local name 2906 or Service UID 2910 or even manufacturer ID data 2914 may be used as a “community identifier” to actuate software or API protocols in the receiver and to cause processing or forwarding of at least some of the signal identifier and payload to an administrative server 35,4501,2305. Arguably, community identifiers do not require encryption. Thus there are a number of ways to link a device to an identifier that can be used to implement programmable user “conditional rules” as part of an IoT of BTx radiotags that talk to each other, either as piconets paired to handsets, or as mesh networks operated by a community of users.

In addition to the resolvable private address 2916, other data values 2920 may be sent such as a full 9-axis accelerometer and heading sensor output bitstring with compass and gyroscope. Some header fields are bitfields indicative of particular data types. The content of these fields can be dynamic, for example field 2920 can be an action sequence specifier or key in which the value of the field specifies a particular behavior or mode such as an alarm state or a paired state. Another field or key 2922 can indicate a Hall effect sensor output or a battery status output. Field 2924 may specify the state of a multifunction button 3216 that serves as a command when parsed by compatible software in a control apparatus 70,3270b. A next field 2926 may specify an altimeter sensor output, for example, or other sensor value. Field 2928 may specify a photocell output, and so forth. Field 2930 may specify the dynamic transmit power of the radiotag signal, as is needed by the receiving device to optimize receive and transmit power settings for optimal efficiency with minimal interference (recall that BTx 5.2+ permits realtime feedback adjustment of transmit power based on receiver reception and reply). These data fields, and others in other signal types, contain what is referred to here collectively as “information” 3050 that may be used to track lost items and to cause remote actions by triggering command and notification functions in the control apparatus 70, in cloud host 35,4501,2305, or in remote devices that are members of the IoT (layer 2202, FIG. 23A/B).

FIG. 30 lays out a new concept. BTx device power management is discussed as a way to realize a capacity to use the BTx layer as a power regulation architecture for the network layers above it. Continued expansion of server farms that consume unlimited energy speaks to the need for an engineering solution that limits power consumption in the frugal way that BTx devices manage power. BTx device largely make up the IoT, and have a sophisticated power control system. Signals received by smartphones in the 2203 layer can design, implement and control smartphone identity and energy consumption, as will be shown below.

FIG. 30 is a schematic 3000 showing an embodiment of power states of a Novel BTx radio stack with “always listening” state or mode 3001 as part of its stack. Shown are multiple sleep and standby states with functional modularization and isolation of power consumption states, including definition of “always listening” mode or state 3001 where energy usage contracts to the minimal SoC services needed to passively monitor the BTx antenna for signal preambles. In the “always listening” state, SCAN and INQ transmissions are not generally used to receive or acknowledge BT signals and are not triggered by a preamble followed by an access code unless other criteria are met. Discovery of the listening device (a response to a scan or inquiry) is optionally disabled or on standby; maintenance of the device's membership in a piconet role is minimized. The device attends to listening for BTx transmissions and more selectively filtering those transmissions that it intercepts. Detection of BTx transmissions may include recording of a radio contact record in a radio contact log for radio signals having the qualifying preamble. When entering radio contact log entries, received signals are timestamped and may also be geostamped. But the device may also be programmed to record additional bytes of longer BTx signals, as will be described below. This is a “listen only” mode and may include a de-identification protocol for a subset of signals, or not.

The preamble of every BTx transmission is an 8-bit octet that takes one form in advertising channels and another form in data channels; there are typically 3 advertising channels that can be monitored, and 37 or 67 data channels, each with a 1 or a 2 MB bandwidth. A BTx radio sets a listen window in a target channel, and if a signal preamble is detected in conventional use, instantly activates the full radio receiver apparatus. A BTx radio that encounters this preamble instantly mobilizes resources to capture and parse the remainder of the signal, or at least the access code. An “always listening radio” requires a sweep through multiple channels at a random walk or a sequential walk of sufficient duration to intercept a transmission of a preamble code and may not parse the bitstring, but rather fill a register and save the signal to a radio contact log. Some intercept opportunities are missed, but this is the way in which BTx devices make connections, by random intersects of the preamble with the listening device. This listening can be done at low energy, with adjustment in the amplification made only if a qualified signal is detected. The BTx radio modem is an SoC, and makes any adjustments essentially instantaneously. In the newer BTx 5.2+ hardware, the adjustments to gain are automatic and optionally can include feedback to the sending device, the feedback resulting in optimization of the transmit power and receive gain between the two devices.

It has long been known that some radiobeacon devices continuously transmit advertising frames and are not connectable, in fact, one-way “transmit only” advertising to smartphones was the earliest use of BTx radiobeacons by Estimote and Apple. Given that the advertising signals were not connectable, the receiving device, in an “observer role”, would find no value in responding. The observer intercepts the advertising transmissions of the non-connectable beacons and can take action as programmed based on the signal contents or can dismiss the signal without notice.

In the new “listen only” stack 3000, the “always listening” mode 3001 is built into the hardware/firmware of the radiotag, not the smartphone. This is a Novel behavior, that a BTx device is observing radio traffic without responding, without INQ or SCAN, and is actively storing samples of the radio traffic in preparation for transmitting a record of the radio traffic or operating an algorithmic sequence based on the contents of the radio traffic log. Active (i.e., interactive) listening may be alternated or replaced by passive listening. Any BTx radio traffic begins with a preamble on a channel, so by surveying all the channels for the occasional hit, when a preamble is intercepted, there is no requirement that the listening device engage in transmission of radio signals in response. What results is a minimal energy cycle in which channels are “surveyed” systematically, and positive intercepts are filtered and stored according to a logic tree in the receiving device. The depth of the survey can be full spectrum (all channels) or just a few channels, such as just one or two advertising channels, or a representative mix of all channels, and the duty cycle can be limited based on energy requirement as per intended field life between battery recharges. The action taken can range from merely storing the contact information to actively responding to the signal or forwarding the signal.

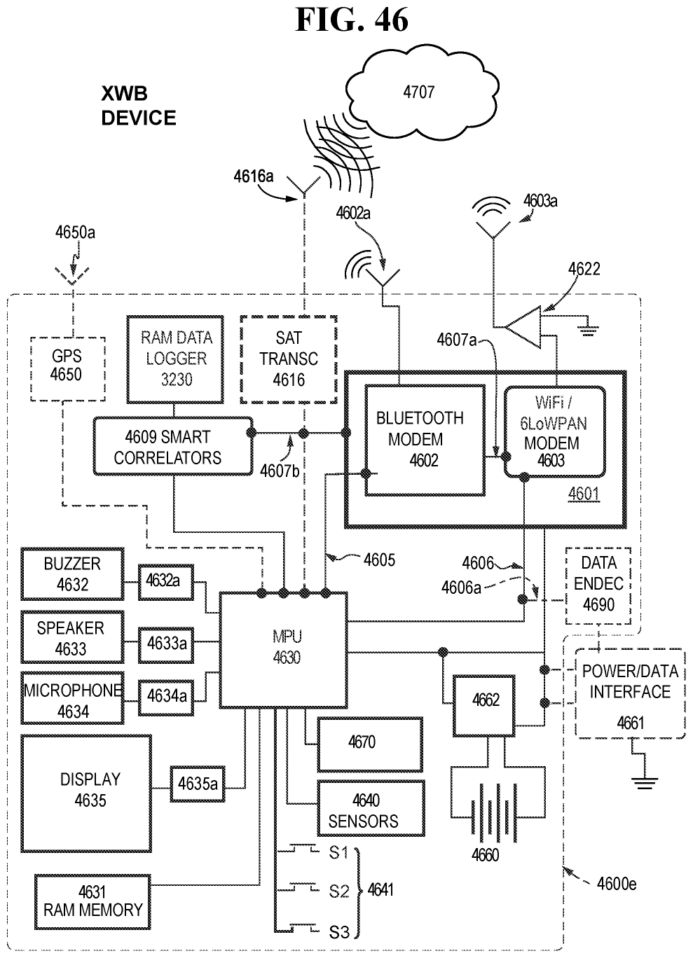

The “active listening” function 3001 is entirely programmable and all BTx hardware not engaged in active listening are awakened only if the signal detected is determined to be relevant to the user's specifications: a signal that is recognized, or a signal that has potential to be of interest. Typically, the access code provides some clues to make the decision, but the device may also elect to listen to the payload header or full payload (and to store at least some of the bitstring) before determining whether to respond. And the response can be directed to the user or to a cloud administrator, not necessarily to the BTx device that sent the preamble and access code (for example, see signal structures 2510,2521 or 2541). There is an information content to each of these bitstrings that can be parameterized, even if no annotation of the signal's origin or RUI is recorded or decoded. A correlator or digital signal processor (DSP), the pieces of radio hardware that recognize a digital signal sequence, may be programmed as a field gate array, or may be constructed in banks of correlators operating in parallel to filter and score bitstrings, and to separate those that are recognized partnerships or threads as part of an established piconet, versus those that are “alien” or “familiar”, but are part of the BTx background (“radio topology”) or the environmental “noise” of a location. Even the remote mountains of Iceland may have a few BTx signals. For example, we recently discovered patterns in the signal background on the remote hills of Iceland's active volcano at Litli-Hrdtur hill on Reykjanes Peninsula; signals that are unique to that location. In ordinary art, these signals would be discovered by a SCAN of transmitters in the area, but the device 3000 shown schematically in FIG. 30 would “survey” (using always listening 3001) and can record those signals silently for later use in managing location functions and power consumption. That is the “always listening” function 3001 that is new as it relates to “smart correlators” 4526 that can adaptively be taught to recognize signals of interest. The entire body of signals captured by an “always listening” device can be transmitted to a cloud host, which may analyze those signals for patterns using AI. The result is a “learned model”, operable within the computing resources of the BTx device in the smart correlator assembly 4526 or MPU 4515 (FIG. 45). The “learned model” functions to educate and teach the network about the radio topology around the individual user, and to make use of that topology for building location-dependent services.

Radiotags of the invention may also engage in connectionless advertising 3002. Both passive listening (“listening only”) and connectionless advertising (“transmitting only”) can be multiplexed with a standby mode 3004, and the standby mode may be gated to enter a true “sleep” or “hibernate” mode 3006 if so programmed. Standby mode also may be gated to active functions of inquiry and scan. Thus STANDBY is a multipotent hub state, and can be interrupted by INQUIRY SCAN 3008 and PAGE SCAN 3010, or can be exited or entered by a signal from core piconet management functions 3012, which control CONNECT and DETACH functions. [These piconet-related functions can be suspended on an extended schedule as needed].

In other instances, an intercepted advertising signal is a teaser, and points to more data on a data channel, so the “always listening” device has the option to follow the data, or to limit its survey to just the initial bitstring and its introductory payload. Also, in some instances, inquiries may be broadcast to solicit more signal traffic, but in crowded BTx environments, where the inquiry function is likely being executed by numerous alien devices, the need for a particular device to send INQ signals is minimal-unless reaching out to contact a specific transmitter for immediate access.

The power states of FIG. 30 correspond to an adaptive BTLE protocol stack as modified. The lowest level of functionality of a BTx radio is a SLEEP mode 3006 running with low power clock only. To approximate an “always listening” radio mode, a STANDBY state 3004 alternates with a sequence of listening windows, in which the radio will detect BTx preambles channelwise and typically will filter at least the access codes for relevant traffic. The listening mode is coupled to a “Wake Up Radio” gating protocol when a signal is detected that meets programmable criteria. In “listening only”, the device is unresponsive while listening for and optionally logging non-specific radio contacts and may not be “discoverable”. So by adjusting the STANDBY/LISTENING duty cycle, a very low energy, low latency system can be achieved that meets performance goals in most respects for a close approximation of an “always listening radio” (ALR) with option to be a “wake up radio” (WUR) under defined conditions. The latency is not perceptible to a user without an oscilloscope, and the radio is readily able to resume a CONNECT linked state in a familiar piconet without user attention or intervention, for example, by transitioning from STANDBY to CONNECTED 3012 in a quick step. These BTx devices 1800,2301,3000 take care of themselves.

A discoverable Bluetooth radio may be configured to listen for (i.e., SURVEY) and to respond to PAGE and INQUIRY signals from other units with or without active SCANNING. In SURVEY 3001, energy states corresponding to “INQUIRY SCAN” 3008 and “PAGE SCAN” 3010 are suspended in a flickering dance with the core piconet management state 3012. The basic function in SURVEY is listening on multiple channels for a characteristic preamble of a BTx signal, and recording the ensuing bitstring, in full or in part.

The device may recognize and respond to inquiries and pages that include a recognized access code. A PAGE is a radio signal that initiates a connection from a piconet. The radio unit that receives the page responds in a way (by sending an FSH packet) that leads to or restores a formal CONNECTED mode 3012 between the receiving and transmitting radio units. In CONNECTED mode there are two substrates: MASTER and SLAVE, which for any two devices are interchangeable. Units that are bonded to a piconet around a MASTER or CENTRAL may be limited in bonding to third-party radio units and a DETACH event may be required to free the radio unit to bond to a new MASTER. Bonded devices can participate in more than one piconet at a time, depending on permissions stored in cache memory.

Importantly, a BTx radio in “always listening/standby” mode 3001 may burn less than 30 uAh power while retaining the capacity to wake up the processor and accessory circuitry from deep sleep in response to (i) a qualified radio command from a smartphone or a reference hub (i.e., a master), (ii) in response to a crossed threshold in sensor data, (iii) or in response to ambient radio traffic having selected characteristics. The mode supports portable applications for IoT use. Channel listening without response participation consumes only 0.3 mA maximum (for antenna gain and register gating at parts of the duty cycle when the receiver is on). In standby between listening periods, power consumption drops to less than 60 uA (Karjalainen O. et al. A Comparison of Bluetooth Low Power Modes, 7th Intl Conf Telecomm 2003. IEEE DOI: 10.1109/CONTEL.2003.176900). In embodiments of radiotag hardware with a customized ALR/WUR-enabled Bluetooth stack, by adjusting latency to a reasonable range for the environment and application, we find that overall power consumption can average out as a microwatt load less than 30 uAh (while offering ALR essentially continuously during extended remote deployment) with WUR latency that is not noticeable for most applications.

BTx radios may also be operated in a BEACON TRANSMISSION mode 3002, which is not connectable. The radio broadcasts a canned message (optionally with dynamic sensor content) at a regular interval and is unresponsive in this state to any radio responses or inquiry traffic. A baseline energy budget for a BTx radio in not-connectable advertising mode may consume about 30 uAh assuming an intermittent transmit period of 20 msec, a transmit cycle of 2.5 sec, (i.e., 1440 transmits per hour), and a transmit power of 3.5 mA (0.3-30 mA depending on packet type, radio hardware and range). The advertising duty cycle is adjustable. Transmit power and frequency may be configured according to the application, and with increasing miniaturization of chip architecture to 14, 10, 7 nm or even 5 nm gate structures, total energy consumption continues to fall sharply in newer builds, enabling increasingly longlasting IoT devices in packages that use either disposable, replaceable or rechargeable batteries. Batteries formed in the shape of a stick of gum may be used to reduce device thickness (FIG. 19A), and temperature resistance of the components is sufficient that 3D printers may layer the device to embed the radio chipset in an article of interest. Water resistance need not be sacrificed. For example, snowboards have recently been described that incorporate low thickness radiotag devices (co-owned US Pat. A Ser. Nos. 17/699,112 filed 19 Mar. 2022 and 18123,2.44 filed 17 Mar. 2023 and incorporated herein in full by reference).

Connected units establish a “pairing” relationship that anticipates the frequency hopping regime and any HOLD 3018, PARK 3019, or SNIFF 3020 timing. The BTx baseband/link manager of the SoC chip configures sleep, standby, and a constellation of selectively active modes that separate interactive transmission and reception sessions on the energy ledger to maximize deployable lifetime while meeting function targets.

Access codes 2501 define the specificity of the relationship between the units and act as “thread” markers to sustain ongoing “conversations” over time. These formalities are native to the BT SIG Specification, which enjoys essentially global adoption as the BTx standard for wireless devices ranging from headsets to keyboards to printers to thermostats, smoke alarms, coffee pots, refrigerators, televisions, cameras, smart doorlocks, heart monitors, to smartphones, . . . in short, most of the IoT.

It is expected that a newly emergent class of IoT devices that combine BTx radio and cellular Wi-Fi radio will emerge at the top end of these devices (4575,4775, FIG. 47). Co-owned patents on these XCB devices include U.S. 11,848,58, 11,393,323 and 11,450,196, with others in prosecution. The family of patent documents (including U.S. patent application Ser. No. 17/870,385, filed 21 Jul. 2022) is incorporated here in full by reference for all purposes.

Interestingly, devices equipped with an “always listening” mode 3001 can be programmed to look out for themselves in ways that devices set the rules for how to manage their duty cycle. Internal sensors such a motion or heading sensors are combined with BTx (and optionally Wi-Fi) traffic sensors to determine whether more or less signal listening and response is needed. This hardware may include more than just some field logic gate correlators and a DSP, it can include an AI presence on or off device that has been trained by analyzing signal outcomes for large numbers of sessions and has programmed the field logic gate correlators and DSPs to respond flexibly to familiar versus alien environments and to flag situations where heightened sensor use and reporting is warranted. This “situational awareness” is what our BTx systems have realized, and that level of energy management can be taught to the devices in layer 2203 by linking to the energy intelligence of the 2202 layer. CALL HOME logic is an example of a working application.

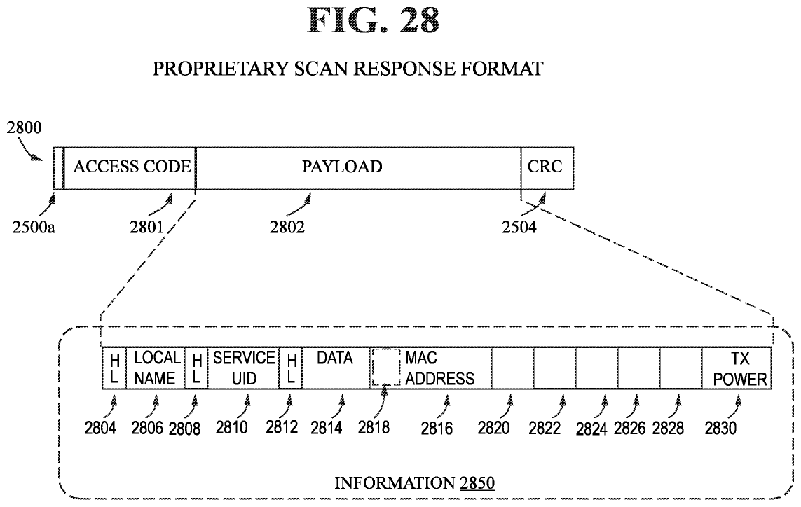

FIG. 31 simply states the Wi-Fi and/or Cellular radio linkage characteristic of handsets, by which BTx traffic is digested to be eligible for upswitching. Wi-Fi requires a modem as a central hub; cellular radio requires cellular towers as a central hub. Yes, simple in concept, but both Cellular and Wi-Fi typically are subscription services as monitored by cloud assistant 3110, and while some institutions provide open Wi-Fi hotspots, a great deal of public-facing Cellular and Wi-Fi traffic is junk-useful only to maintain subscription revenue. This parasitic traffic between handset 70 and cloud assistant 3110 may account for much of telecomm revenue, but does not serve the end customer or the network. In a new vision, the BTx layer 2202 controls the smartphone by reversing the master/slave, central/peripheral roles in a piconet that is operated by the end customer so that subscription services are put on a shortened duty cycle, saving the consumer money and productivity interruptions, and saving energy.

Advantageously, BTx low power management can also control the cellular hardware of device 3270 (FIG. 32) leading to a low-power LTE device with on-demand network accessibility in a battery-powered, “standaway” package with an “always listening” BTx radio capacity. In one embodiment, BTx radio power states can be used to manage cellular low power states so as to implement a more robust standby condition, termed here a “standaway” state in which the network connection is on an interruptible duty cycle 3201 that improves over EDRX. The BTx radio core 3202 can actuate and adapt the cellular handset 3270 (and device processor(s)) according to more flexible rules that override the inflexible snap-awake duty cycle that continuously interrupts cellular extended sleep modes in conventional cellular modems. The BTx radio 3202 can also implement a cellular CALL HOME trigger capacity according to switch or sensor inputs (3216,3217a,3217b) or BTx radio traffic logs (3230), which includes the initiation of a cellular ‘Connection Request’ with network attachment if a network is lost or connection by a MANET network when the cellular connection is disabled. In other words, the BTx radio may assist in recovering from a cellular connection failure or loss. Only about 4% (or less) of the energy a typical cellular modem expends is actually necessary. More than 90% of cellular modem power can be throttled off on the condition that the cellular radio activity is reversibly throttled by the BTx radio modem 3202 as described here.

With stringent application of integrated power management, these companion devices 3270 achieve a field life that readily exceeds one week in richly functional use, and can approach 1 year in remote monitoring and emergency use applications. By comparison, most smartphones 70,3270 in the United States are recharged at least once a day and server farms are not going up fast enough to meet the inflated traffic forecasts proposed by telecomm companies.

Power savings are achieved by selectively powering the handset and controlling power to the cellular modem according to the state of the BTx radio, and by establishing qualifying radio signals and radio traffic patterns that, when intercepted, wake the BTx processor. By using the BT STANDBY “always listening” mode to control the cellular modem, a “Wake up!” command may be executed so that the cellular modem of an XCB device 4575,4775 or smartphone device 3270 is activated to initiate a cellular network connection with a cloud administrative center on any compatible cellular network. The initiation of a cellular network connection is termed here as a “CALL HOME”.

The cellular handset 3270 is packaged as a modem that stores the cellular network connectivity and synchronization data including IMEI and ISMI data. By combining the cellular and BTx radios in one device and using the BTx stack to control the cellular modem, the main disadvantage of cellular device power saving mode (that the radio is unresponsive in sleep mode) is overcome because BTx radios have a “flickering” standby mode that is “always listening” (FIG. 30) for radio traffic at low power even when the rest of the device 3000,4575,4775 is in deep sleep. The latency of the system is adjustable, but can be satisfactorily balanced by making milli- or microsecond transitions from passive listening to standby and back in a continuous repeating loop, and increasing active power to one or more cellular components if and only if relevant radio traffic is intercepted. More details are provided in U.S. Pat. Nos. 11,184,858, 11,450,196, 11,393,323.

The hybrid radio networks enabled by community deployment of hybrid XCB devices 4575,4775 result in other emergent properties of combined Bluetooth/cellular hybrid systems. For example, a virtual geofence formed around a reference transceiver may be a radio tether: a repeating broadcast that defines the radio geofence or “radio tether”. The signal quality of the repeat broadcast, as received by a hybrid radiotag in need of location monitoring, is an indication of the integrity of the radio tether: i.e., poor signal quality may indicate a deterioration or breakage of the radio tether as for example if the hybrid tag leaves a “safe zone” within the radio geofence, a sensed condition that can trigger a CALL HOME. Unauthorized movement can have a similar result, but these refinements enable an owner to implement cellular location services such as monitoring a pet in a fenced yard, and also provides a community resource for creating a BTx radio map of a neighborhood (the BTx radiobeacon “lighthouse” effect) without the need for daily recharging of a heavy battery in each radiotag housing. And with even more sensitivity, the BTx traffic envelope around a dog wearing an XCB device radiotag is detected to change the moment the dog jumps a fence and goes around a first corner. This change also occurs when a user crosses the street or steps out of their doorway without their car keys in their pocket, the best possible time to receive a LEFT BEHIND alert, as we recently patented (U.S. patent Ser. No. 11,792,605, titled “Tracking Device Systems”). The hybrid radiotag becomes a specialized platform that is capable of taking on additional functions as described for example n U. Pat. No. 11,495,108, titled “Private Wireless Network Communications Systems, Methods and Devices”, U.S. Pat. No. 11,678,141, titled “Hybrid Cellular Bluetooth Tracking Devices, Methods and Systems”, which are both co-assigned and are incorporated in full for all that they teach. Essentially, a mesh network in the IoT layer 2202 is effectively linked to the Cellular and Cellular hybrid device layer 2203 by modifying the BTx device stack (in both devices) and the Cellular device API or base programming and/or firmware.
EXAMPLES
   EXAMPLE I—Nordic Nrf52833 Soc
   EXAMPLE II—OTA DFU Bootswapping
   EXAMPLE III—WebApp OnBoarding with Pre-Provisioned Devices
   EXAMPLE IV—OnBoarding with Cloud Assistant
   EXAMPLE V—Drawing of Onboarding with WebApp
   EXAMPLE VI—Radio Contact Logging
   EXAMPLE VII—IoT-to-Internet Reporting as Wi-Fi Signals
   EXAMPLE VIII—“Familiar” and “Alien” Radio Topology Indexing
   EXAMPLE IX—Hybrid XCB Device
   EXAMPLE X—NXP IW612 for Hybrid XWB Device
   EXAMPLE XI—Global Location Services Management
   EXAMPLE XII—Cybernetic Open Network
   EXAMPLE XIII—NXP IW612—Plug-In Access Point with PoE
   EXAMPLE XIV—Sharing Radio Contact Records

### Example I—Nordic nRF52833 SoC

Our work provides a first missing link in a multicloud world. FIG. 32 shows a smart onboarding adaptor that can recognize a compatible cloud platform for a given handset 3270 and radiotag device 3200 in radio proximity to the handset, and cause the onboarding of new functions (and firmware) to be completed with a fast and enjoyable UX. Onboarding is a process by which flash memory in the BTx device is used to install a firmware package, for example, where in this case, the firmware is designed for compatibility with the handset and establishes the handset as the master of a piconet in which the radiotag is a valued member. All instructions critical to the operation of the piconet are uniquely and specifically “onboarded” onto the handset depending on what operating system the handset is using. For example, an iOS-operating system requires a radiotag that behaves like an Apple (Cupertino, CA) radiotag, whereas an Android-operating system in a handset requires a radiotag that behaves like an Android radiotag. Google's Eddystone attempted to be both flavors of radiotag by alternating beacon messages, but the continuous updating of firmware that now is routine in our cellular networks made this unworkable, and instead we cause the radiotag to match the handset by an OTA utility that is stored in the radiotag 3200 and is accessed by the network, causing the firmware in the radiotag to be updated to match.

As shown in FIG. 32 the concept of OTA onboarding initiated is supported by requisite hardware in a radiotag 3200 which includes a “system-on-chip” SoC 3202 with Bluetooth radio 3304, BTx antenna 3204a and microcontroller 3205 (MCU). The SoC includes an MCU flash cache 3206 for storing keys and values useful in configuring newly installed firmware to connect and operate with existing networks and a bootloader 3207 that loads the firmware on command and reboots the radiotag in its new configuration, ready to go. Firmware in multiple flavors are stored onboard in flash memory segments 3308 and 3309. A third segment 3310, or a subsegment of the other flash memories, is useful to store OTA utilities and other software that simplifies the onboarding process for optimal UX. First memory slot 3208 is used for pre-provisioning a default firmware image. Second memory slot 3209 is for pre-provisioning an alternative firmware image, as is needed if the radiotag is partnered with an alternate handset operating system. Added slots 3210 may be included.

The Nordic nRF52833 (Nordic Semiconductors, Trondheim, Norway) is a leading example of this kind of chip architecture. This SoC, with internal API BTx stack, is set up as a BTx transceiver with optional encryption at low power, and was selected for incorporation into our custom radiotag (manufactured by PB, Inc. of Issaquah, WA).

The nRF52833 uses 64 MHz 32-bit ARM Cortex-M4 processor with FPU. It contains large capacity Flash (512 KB) and RAM (128 KB). Memory slots are split to store two copies of firmware-loadable cloud platform interfacing protocols, one operable with a first cloud platform (and with PB's cloud service), the other operable with a second cloud platform (and with PB's cloud service), each slot also including OTA capability for future upgrades. Although Nordic warns against having both memories enabled at the same time because it can lead to unpredictable behavior, our smart bootloader swap implementation of two memories has proven to be orderly and reliable. Firmware was constructed for two boot situations and a smart bootswap adaptor with bootloader was built to receive the two firmware images. As deployed, devices 1800, 1900, 3200 perform equivalently and interchangeably on any of the cloud-supported administrative platforms. This interconvertability enables the capacity of the device to bridge the divided world of proprietary BTx radiotags, and with time is expected to result in standards that permit the entire global BTx IoT (layer 2202) to function as a single organism to sense lost radiotags and to provide encrypted notifications to the radiotag owner(s). BTx mesh 802.15.4 networking is enabled for future applications.

We can see that the processor-cache 3206 (FIG. 32) provides added flexibility with minimal latency in configuring the device for use with its new “master” handset in this exemplary “onboarding” application. Note that the initial firmware is not downloaded on demand, but instead is installed from flash memory and that the initial network configuration is completed with onboard values from cache memory 3206, but subsequently, the handset and radiotag are updated as a piconet bonded pair. Any subsequent interactions rely on the capacity of the radiotag to take on the behavior expected by a handset with that particular operating system, but the radiotag makes the initial decision of what firmware is appropriate based on the characteristics of the initial survey of signals transmitted by the handset.

The PCB may include other features in a miniature package 1800, 1900, 3200. A USB port 3218 is provided for recharging onboard battery 3219 via power management chip 3220, and may also be used to communicate data and programming to the SoC core 3202. The housing of the device may include a switch, switches 3216 or other user interface for operation of the device in conjunction with a “setup GUI” and utility installable on the handset. A set of user interface switches 3216 includes multifunction switches S1, S2, S3, for example. Also included here are a speaker 3214 for making notifications, and as may include an audio codec. The audio codec may include an amplifier and driver for the speaker 3214. The speaker may be mounted on the housing rather than on the circuit board so as to take advantage of any resonance of the housing shell. LED 3215 is a display lamp for making notifications and as an assist in locating the device. The radiotag may also include a vibrator driver 3225 and one or more vibrators 3226,3227 configured to provide notification functions and may be combined with one or more buzzers 3228. By selecting a higher dB piezoelectric buzzer, a FIND notification can be realized analogous to the FIND PHONE function taught in U.S. Pat. No. 9,892,626, herein incorporated in full by reference for all it teaches. Using the vibrator, a radiotag device may also be “nudged.” A nudge is useful when a user of a parent device wants to attract the attention of the user of the radiotag device, such as when a message is sent that needs a prompt reply the device will “nudge” the recipient from inside a pocket. A first sensor package 3217a (optionally embedded in the SoC) may include an accelerometer combined with gyroscope and magnetometer or a nine-axis heading sensor, for example. A second sensor package 3217b (optionally embedded in the SoC) may include directional rangefinder radio for measuring direction of incoming radio signal, as is useful in homing in on a signal, and may include other sensors such as Hall Effect, temperature, altitude, humidity, and so forth.

GNSS is not generally used because of the power requirements. The radio is not powerful enough to reach cloud assistant 3210 without the intermediary of the handset 3270. However, the batteries of the radiotags are chosen for BTLE radio precisely because the low power permits longer unattended service life while in use.

Data logger 3230 may be supplied as an optional RAM data logger for monitoring waypoints and snapshots of radio signal environments, as will be described in more detail below.

### Example II—OTA DFU Bootswapping

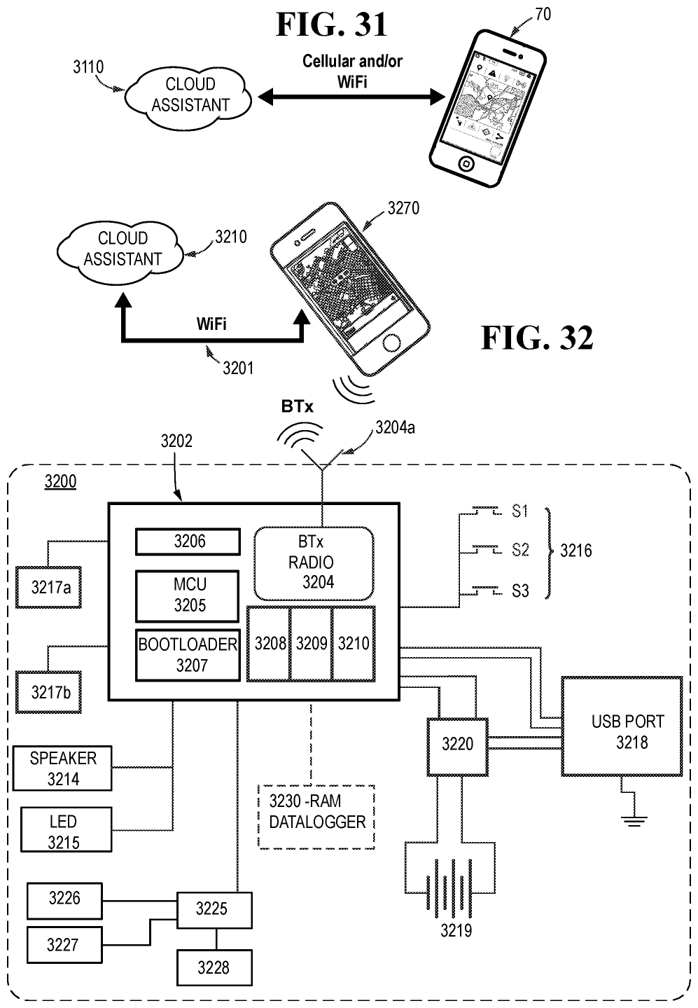

Referring to FIG. 33, a system view is depicted that demonstrates the operations of an apparatus for providing global location and tracking services from one or more cloud administrative and service platforms 3310,3320,3340. The apparatus includes a new BTx radiotag 1800,3200, a handset (3270, a “smartphone” or an equivalent smart device), a QR code 3314a affixed to packaging associated with a new radiotag, and a cloud environment 3300 with a plurality of administrative platforms. Also, given that the cloud platforms are, in general, mutually exclusive in their relationship with radiotags, PB, Inc. has deployed a Cloud Assistant 3310a that specializes in initiating a process of registration of radiotags with a compatible administrative platform based on the kind of handset 3270 the user has. In this illustration, the initial goal is “activating” (termed here “onboarding”) a new radiotag 1800 so that it is paired with the most compatible of platforms 3310,3320,3340. To complete the process, a compact firmware package or packages is installed and configured onboard the radiotag in a seamless and rapid experience for the user.

Simple setup instructions are provided to the user with the new radiotag. The user's camera 3313 in handset 3270 scans QR Code 3314a (on the radiotag's packaging) for information that identifies the radiotag type. The QR Code includes a hyperlink that directs (bold arrow I, 3301) the user's handset to PB's Cloud Assistant 3310a, first interrogating the handset and then, based on the type of handset and the information contained in the QR Code, initiating a series of automated steps to complete the onboarding process. During the onboarding, firmware will be loaded from memory slots 3208 OR 3209 (FIG. 32). Keys and values from cache 3206 are loaded as needed and the configuration is completed from the Cloud Assistant. Pairing will be performed by the handset, but the required configuration is pre-provisioned.

For example (FIG. 33, just for illustration), the compatibility is such that the correct choice for compatibility with exemplary handset 3270 is Services Admin Platform B (3340). Dashed line 3305 connecting to Services Admin Platform A is NOT selected; instead the PB Cloud Assistant 3310a coordinates with the target platform 3340 via bold arrow B (3303), and provides software to the handset, if needed, for configuring the handset to be linked to Platform B via Wi-Fi or Cellular radio, while also instructing the radiotag to install the appropriate firmware. When software installation in the handset is completed and firmware in the radiotag is installed and rebooted, the radiotag 1800 will be switched to a “discoverable” state (by the user) and the handset will complete the onboarding process using instructions included in the software. The handset acquires direct control via (bold arrow II, 3302). This is a pairing or bonding process summarized as “CONNECTED” (3012, FIG. 30).

Following onboarding, Platform B 3340 will control the operation and signaling of radiotag 1800, including any advertising messages, periods of discoverability or non-discoverability, scanning and inquiry functions (FIG. 30) unless overridden by the user via controls on the handset. Each radiotag retains some autonomy under control of an authorized user. The user may also set up a ‘user profile’ using a GUI on handset 3270 to cloud platform 3340 by which contact information, waypoints, last known location, battery status, friends, and so forth, may be stored for easy access.

As a local finding assistance function, using the handset, the user can cause the radiotag to display an alert state in which an audio and/or a visual notification is displayed so that at short range, the user can quickly locate the radiotag and its attached asset (or if the radiotag is embedded, the associated asset). This system has been adapted to track items and valuables: a variety of items such as car keys, wallets and luggage, for example. The short-range function is handled by BTx radio commands, the long-range location and finding services are cloud server functions.

In this embodiment, the cloud environment 3300 is an IP Packet Data environment accessible via Wi-Fi and cellular radios, for example. The link 3301 from the handset to the radiotag 1800 is a BTx radio link typically at 2.4 GHz in the ISM band.

The engineering required to coordinate signals between the two radio linkages (BTx 3301 and Cellular or Wi-Fi 3303) is performed in the handsets 3270. This is a handset-centric system and does not yet include P2P mesh networking among radiotags. Also, note that Platform A does not share data with Platform B (link 3312 is not implemented at this time).

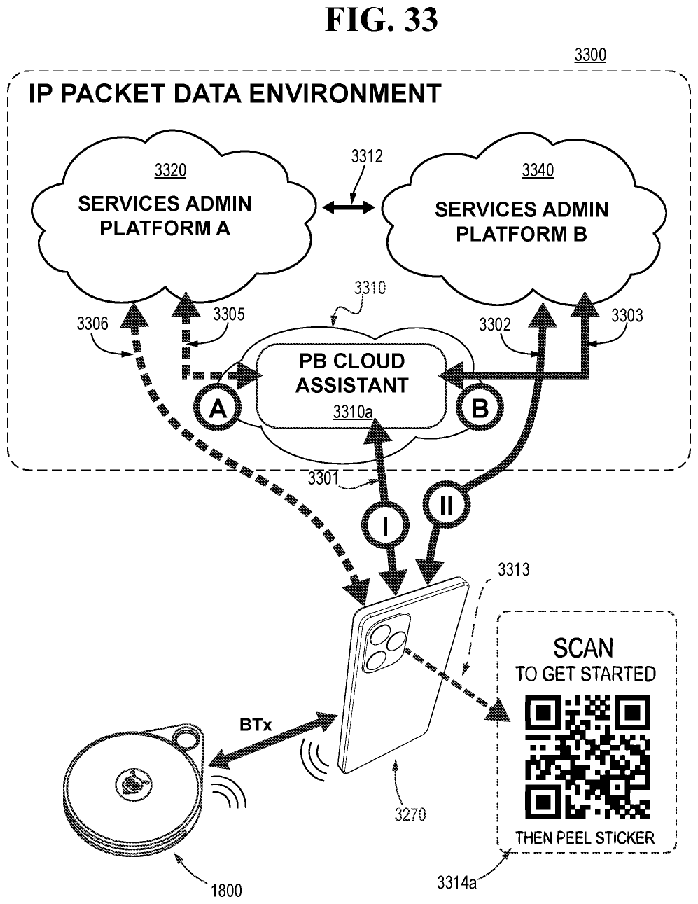

Once setup is completed, a factory reset involving bootloader 3207 (FIG. 32) is the most convenient method for finalizing the firmware installation in the radiotag and configuring the radio tether from the radiotag to the handset and cloud. This occurs with a change in handsets or a change in owners, for example. Other changes, such as sharing the radiotag among friends, are completed as part of the user interface, accessed via a cloud user portal that is supplied as part of the apparatus of FIG. 30. All components of the figure are needed for initial setup and onboarding. Following successful onboarding to Platform B (3340), radiolink 3301 becomes inoperative and radiolink 3302 drives all finding and location services. A reverse illustration, where the radiotag is claimed by Services Admin Platform A 3320 is shown in FIG. 34.

Note that in some instances, the radiotag 1800 is permanently hosted by the PB server 3310 and has the characteristic or flavor of a PB radiotag (not a Platform B radiotag; not a Platform A radiotag). PB, Inc. operates a full service location and finder services network with proprietary GUIs. The PB radiotags may be shared with both Platforms A and B. BTx link 3301 between the handset and the radiotag is active, so are links 3303 and 3305. Given that the power of crowdsourcing of location information increases with the size of the handset pool, the capacity of the PB Cloud Assistant to query both Platform A and B when fielding location inquires provides flexibility by which, for example, both Android and iOS radiotags may be located.

Other vendors also supply proprietary radiotags that may be associated with cloud services provided by one or more independent cloud platforms, a “multicloud world” with Platform A, B and C. As indicated in FIG. 34, compatibility is not universal, and no linkage is ensured between the cloud platforms. Radiotags administered by Services Admin Platform B 3340 may not be accessible to handsets or users with a connection to Services Admin Platform A 3320. When Platform B is chosen, links 3305 and 3306 (FIG. 33) are inoperable.

An even greater boost to onboarding performance experience is achieved by providing an out-of-box device having two flash memory slots (3208,3209, FIG. 32) associated with a bootswapping module 3207, each memory slot having the capacity to execute, as directed and received, one or more OTA events for receiving new software such as an upgrade. The two slots are pre-provisioned each a distinct version of firmware needed for onboarding and operation under cloud control. As an initial state, the microprocessor 3205 is provided with an image in firmware by which it executes an instruction stack. The default memory stack may be swapped out so as to load a resident firmware image in the other memory slot so as to be coupled to the microprocessor.

Memory slots may also contain an instruction list or kernel sufficient to operate a tracking services package provided by an independent vendor, if desired, and instructions may be packaged so as to optimize non-redundancy and branch point efficiency if warranted. Miniaturization and/or embedment is a driving feature in the design of the radiotag circuits and user interfaces. The initial radiotag state is configured to operate in synchrony with the handset radio held in radio proximity to the radiotag, and to be synched via the handset to a cloud operator (3410,3310a,3320,3340, 3421,3423,3425) that completes the onboarding process. Often, when a device is onboarded, a first task is to update any pre-loaded firmware included at time of manufacture. To do this the device will likely be rebooted, but the process is speedy and with good execution can appear to be seamless so that the upload is not dependent on user reactions, and instead auto-configures itself. Thus, OTA firmware updates are not a problem, even for the slower baud rate of the BTx radio.

### Example III—WebApp OnBoarding with Pre-Provisioned Devices

FIG. 34 is a schematic of a flow chart for onboarding using a WebApp 3402 configured for user hands-free updating via OTA. Four cloud platforms are drawn, Platform A 3421, Platform B 3423, Platform C 3425, and Platform 3410. Platform 3410 has interconnections to the other platforms, which are otherwise separate. This multicloud system is distinguished from the handset 3270 layer 2203 and IoT device 1900 of layer 2202 (FIG. 22). While common teaching is to consider the cloud environment to be monopolar, it is so only in sharing a common packet format, but not in its porting and wireless address bus. Each Platform has been erected with its own gateway and signal format and is exclusive of other cloud services, even for services that overlap.

To navigate this multicloud world, we have stood up a cloud server 3410 with WebApp 3402. A handset device 3270, when interconnected (3401, Arrow I) with our cloud server by a camera-activated 3413 QR Code 3314b, is instantly connected (34023, Arrow A) to Platform A 3421 because the web app, with support from cloud server 3410, associates the QR Code with BTx radio 1900 (as a type of radiotag) and identifies handset 3270 as a type of handset most compatible with the Platform A server. Our cloud administrative engine 3410 may keep records and may manage a user interface during setup, but ultimately hands off the handset/radiotag pair to Platform A.

Subsequent user/cloud interactions 3404 are handled by Platform A. The WebApp does this automatically, and from the user's viewpoint, the process is dynamic, seamless and immediate. These onboarding features provide significant advances to the user experience (UX), both in speed and simplicity to operate.

The WebApp assists in linking the user's devices to higher level proprietary services with assistance by cloud admin engine 3410. Because the choice of platform is largely based on handset characteristics and user preference, any Platform A, B or C will be supported. Optionally, recognized users may be linked to Platform C, as another example, so that the cloud services associated with location, finding and tracking are performed by Platform C instead of A or B. Services include tracking, locating, monitoring, discovering, privacy support services, anti-stalking routines operative in background, and so forth. Because the cloud server 3425 is set up to allow users to program customized services, such as activation of remote devices by use of a button or other user interface on the BTx radio device 1900, the hurdle of adapting BTx radio signals to the cloud IP Packet Data Environment 3400 is overcome.

And interactions can be bidirectional; for example commands can be sent from the cloud administrator 3425 to device 1900 on the user's behalf, such as when the user requests assistance in locating a lost wallet in which device 1900 is inserted. The cloud server will send a command to the device 1900 to sound its buzzer and display a bright LED light. Or the user can set up the network so that the button causes the garage door to go up, or the coffee pot to turn on. Any remote machine can be actuated, including the handset 3270. So it is possible to find a smartphone misplaced in a jacket pocket using just the card device 1900.

The IP Packet Data Environment in the cloud 3425 is explicitly accessed and set up from the handset via “WebApp” 3402 which is able to dynamically connect the radiotag to Platform A 3421 (via bold arrow 3403) or Platform C 3425 to provide a full range of tracking services. Here Platform C 3425 may be operated by the same service administrator as for server 3410, shown here as a cloud host for the WebApp. Other administrators may use the cloud host 3410 to implement similar fast pairing schema.

For setup of services, the “WebApp” streamlines making the onboarding selection and in a preferred embodiment initiates the setup using pre-provisioned data associated with the radiotag and handset. The end result in a first case is Platform A has claimed dominance in controlling and administering tracking services provided to the user via the new device and operates directly (bold arrow II, 3404) with the handset 3270 to track and locate radiotag 1900. The initial cloud outreach 3401 following scanning 3413 of the QR Code is to a WebApp 3402 operated as part of PB's cloud services 3410. This is identified by bold arrow I (3401). Bold arrow 3403 carries the action forward to the Platform A host. Activation of WebApp 3402 immediately actuates the onboarding process to claim the device in cooperation with Platform A (3421). The process with Platform A is a handoff. Upon completion, link I (3401) is no longer needed, but may be reactivated by performing a factory reset of the device, for example or by pressing the device button switch five times in a row. Note that the use of a WebApp eliminates the need for a downloadable software application that the user must first install on the handset, eliminating significant work for the user and reducing the coding footprint for the process. The result is a streamlined UX and direct bidirectional link II 3404.

In alternative embodiments (for example as illustrated in FIG. 33) PB may supply a software App for the handset, Apple or some other handset supplier may also supply native software tools, and the software in the handset may include added features and tools that are system driven and aid in finding and locating services. Here, Platforms A, B and C (3421,3423 and 3425/3410 are all competent to provide finding and locating services, but the degree of stringency varies. Platforms A and B are limited to compatible handsets (Android or iOS).

An alternate route to server 3423 is shown as dashed line B but will be inactivated once a claim to the radiotag 1900 has been successfully implemented by Platform A, for example. Thus in an initial out-of-box state, the radiotag may be advertising in alternating “identities” or “flavors”: Platform A flavor, Platform B flavor, and Platform C flavor—where the advertising signal cycles the device identity, each identity a different signal format specific to one platform. Following completion of setup, the device no longer advertises with an identity that was not selected.

During the initial steps following scanning the QR Code, initial choices include A, B and C (bold arrows), but the decision is based on the radiotag device type, state (whether already registered or not in a user history flag), the handset type, and user override. However, to preserve compatibility, if the handset is not compatible with the WebApp 3402 protocol, then the protocol of FIG. 33 may be used instead. The end result m b bidirectional link II (FIG. 34, 3404? or bidirectional link II (FIG. 33, 3302), and the improvement is the way in which the system is integrated to provide a seamless, direct and immediate setup that is not interrupted by the kind of handset the user has chosen.

### Example IV—OnBoarding with Cloud Assistant

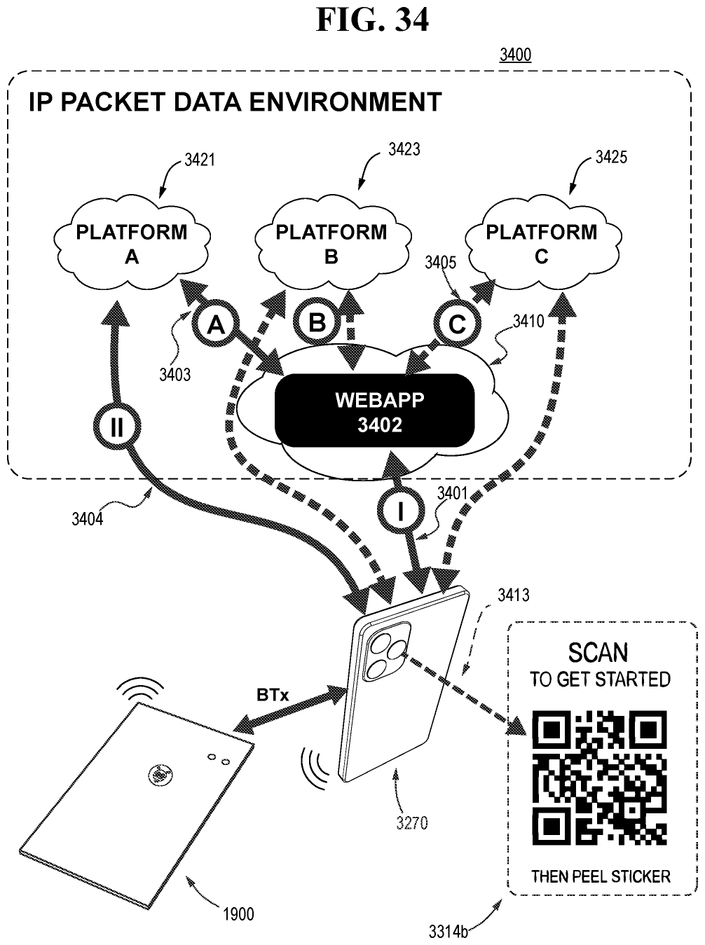

FIG. 35A is a more detailed, stepwise view as a flow chart 3500 for the process of onboarding firmware into a BTx device 1800,1900,3200 via a WebApp, such as illustrated with the apparatus and systems of FIGS. 33 and 34. Upon completion of the process, the radiotag is under active monitoring by a cloud platform (3410,3310a,3320,3340, 3422,3423,3425) and an owner's profile has been established in database records. Future notifications will be sent to the owner directly via the cellular layer 2203, bypassing any intermediary web host involved in setup, and encryption may involve a public key and an owner's private key, or rotating keys as described earlier. Notifications may be customized as part of the owner's profile but will also be subject to administrative policy. In response to user concerns, data privacy safeguards, such as anti-stalking controls, are included with all tracking services packages.

The process begins 3501 by using the handset to do an optical scan of the QR Code. A QR code reader is included in the phone or is installable as needed. The QR Code (3314a,3314b) includes a hyperlink to a cloud server configured to welcome the handset by opening a WebApp 3402 designed to complete the setup.

In step 3502, follow the hyperlink to be directed to a WebApp, in which the WebApp is a cloud assistant configured for assisting with device setup (“onboarding”) for tracking applications with any of the available platforms compatible with the handset.

With user permission 3503, initiate setup of radiobeacon 10a,10b (FIG. 1) as follows: the WebApp will make the assumption that the QR Code was scanned because there is a BTx radio device in wireless proximity to the handset; and surprisingly this assumption, proven correct, permits the handset to connect directly and automatically via BTx radio to the radiotag and to collect information to begin setup. The Android BTx APIs include the capacity to scan for the radiotag, and Google “Fast Pair” may be called as a subroutine if the pre-provisioning is sufficient. Similarly, Apple allows this behavior for its handsets, or a simple click can be implemented to give a permission.

Based on information contained in the BTx radio signals exchanged with the radiotag, by the handset 3270, the radiotag is caused 3504 to force bootloading of an appropriate image into a firmware slot of the device MCU, the image containing an instruction set configured to work with a finder platform selected as being appropriate (i.e., performing a bootswap under control of a smart bootswapping adaptor 3207 resident in the radiotag and operable by the MCU);

Then, by the handset, a first instruction stack of the firmware is caused 3505 to be executed so as to initiate a communications link with the appropriate cloud server platform (3410,3310a,3320,3340, 3421,3423,3425). Key codes are pre-provisioned in memory 3206 of the device so that when read by the cloud platform, the device is caused to be fully licensed, seamlessly and immediately operable on that platform.

If needed, the radiotag will execute 3506 an OTA update of the firmware or a reboot. The OTA instruction set and any supporting content is a module supplied with the image selected to be loaded into firmware. The OTA module remains operable and is stored onboard the device (555, FIG. 35B).

Optionally, if needed, the WebApp will cause 3507 the image in firmware to be swapped out with a second image stored in a second flash memory register onboard the device and will command a reboot if needed to transition the device from control by a default finder platform to an alternative finder platform. Again, keys and settings for the transition are pre-provisioned in a secondary memory cache onboard the device and can be updated once the user's personal account link is established. We note that several finder platforms may be supported, with the sole condition that only one finder platform, as autoloaded (subject of course to override by the user) is operable at any given time.

Typically, the process culminates by initializing 3508 location-based services based on handset-supplied location and timestamp data, completing user profiling, establishing any encryption and renaming of the device under control of the user, and tracking the device from that point via the selected cloud location/finder services platform (3310a,3320,3340,3410, 3421,3423,3425).

The radiotag device may be supplied out-of-Nx in a default condition with a first operating platform-compatible image already in firmware. In a preferred embodiment, the device and WebApp are configured to either (i) finalize configuration of the existing image or (ii) rewrite the firmware so as to administer location services from an alternate operating platform. For example, the WebApp is written to enable all web BTx APIs needed for operating an Android handset and the WebApp will initiate a bootswap of the firmware if the handset presented for pairing is an iOS handset. Alternatively, the WebApp may install Apple-compatible software in the handset to augment existing FindMy® software and complete configuration of default iOS-compatible firmware in the radiotag device. These steps are practically seamless, and require only a first click by the user to acknowledge platform choice (the cloud assistant or WebApp automatically presents the correct choice based on type of handset). In a more interactive process of permissions, a second pair of clicks on the radiotag may make the radiotag Discoverable, with a click on the handset screen at a CONTINUE icon, another click on CONTINUE to authorize the firmware update in the radiotag, and a press on CONNECT if the device has not automatically a for example. The device may be pre-provisioned with key codes and data to expedite setup on its own but in some instances, user permissions are prudent or required to comply with expectations. Another option is to provide a review screen or checklist on the handset with an opportunity to make exceptions or to go back and select another option. A “reset” mode may also be provided with interactive user options. However, because of the incompatibility of iOS and Android operating systems, no one solution is suitable for all handsets 3270 and consumers have already made the choice(s) by selection of the handset, so any permissions are formalities that can be automated using the WebApp 3402. A “reset” protocol is also provided that allows the user to “start over”.

FIG. 35B tabulates 550, as an example, the range of compatibilities A, B, C (551) that may be installed as part of setup of a new radiotag. Each radiotag will be categorized and paired with a compatible administrative cloud platform (3410,3310a,3320,3340, 3421,3423,3425). As an exception, compatibility with the PB platform 3425/3410 (Renton, WA) may be retained when Platform A 3421 (552) or Platform B 3423 (553) is automatically selected, for example. The PB platform 3425/3410 (554) includes aftermarket software designed so that PB radiotags may retain compatibility with handsets from all major manufacturers and the needed firmware in the radiotag is automatically configured by the WebApp 3402.

In some embodiments (our “Pebblebee box” embodiments 553) the device can be claimed using automation built into the iPhone iOS. At the time of this filing, the Apple-claimed radiotag device, when fully installed, offers a significant range of added location services. Users must decide which handset to use, a decision that may limit their choice of the compatible firmware needed to operate a radiotag. The PB software, installed as an App on the Apple handset, is generally compatible with both cloud platforms 3421 and 3425 (FIG. 34). However, the global mix of radiotags and handsets has resisted a single solution by which the operating systems of all major cloud platform tracking/locating service providers are accessible by all possible combinations. Significant proprietary limitations and restrictions exist which prevent users from interacting with radiotag devices or handsets of another manufacturer.

In a next embodiment 552, (our “contract box” or MfG units), the radiotag device is supplied out of box as pre-provisioned with a first operating platform-compatible image in firmware, and in a preferred embodiment, the device and WebApp are configured to execute the firmware for onboarding with direct administration by cloud platform 3423 (FIG. 34). The WebApp is written to enable all Web BTx APIs needed for onboarding and operating an Android handset (including scanning for a discoverable radiotag by the handset) and the radiotag is configured to perform a bootswap of the firmware and to install updates as needed so that the radiotag is claimed by Platform B.

This is practically seamless, and requires only a first click to confirm platform compatibility (the cloud machine automatically presents the correct choice based on type of handset or user history). Optionally, the process may involve a second pair of clicks on the radiotag to make it discoverable, a click on the handset screen at a CONTINUE icon to discover the new radiotag, another click on CONTINUE to authorize any firmware update in the radiotag as needed, and finally a press on CONNECT if the device has not automatically “fast paired” using native Google software, for example. No queries to or decision from the user is actually required. The device is pre-provisioned with key codes and data to expedite the setup on its own. Pre-provisioned data will include device type and state, for example.

The firmware may be swapped to an alternate firmware image operable with a second operating platform if the user's handset requires it, for example. If the second operating platform is the recommended platform based on handset compatibility or user history, some added software is supplied aa part of a smart bootswap adaptor 3206 under control of the handset 3270 or WebApp, and this is downloaded in a direct branchless chain of events that require only the user's permissions and a step to activate the radiotag device for Discovery. This process is performed as a simple series of steps as programmed by software supplied from PB, Inc. that is part of the WebApp protocol 3402 of FIG. 34 but optionally operates as part of the Cloud Assistant protocol 3310a (FIG. 33). Redundancy is acceptable because the limiting parameters are power consumption and miniaturization, not cloud size, and devices such as Nordic's nRF52833 permit implementation of multiple firmware slots on a single SoC with room for pre-provisioning of initial keyset(s) as may be needed for various options.

For devices not compatible with the Android features of a WebApp, the smart bootswap adaptor is configured to identify the needed firmware to cause it to be swapped out, configured, rebooted and active in the radiotag device so that the user can begin using the device in a single short session to complete the claiming (‘onboarding’) process. The UX of a clean install is a major factor in customer acceptance of IoT devices despite the partitioning of cloud services into different camps. The user can of course also elect to have PB, Inc. supply a complete wrap-around, end-to-end finder service (554) including location and item recovery services, with an added bonus of programmable remote device activation services.

In current embodiments, the firmware “flavors” that are supplied for PB's BTx devices all support PB as a location/finder services provider, but are distinct in that one firmware image operates on iOS handsets and another other firmware image operates on Android handsets. Other handsets may be another flavor for example, but are not discussed here.

### Example V—Drawing of OnBoarding with WebApp

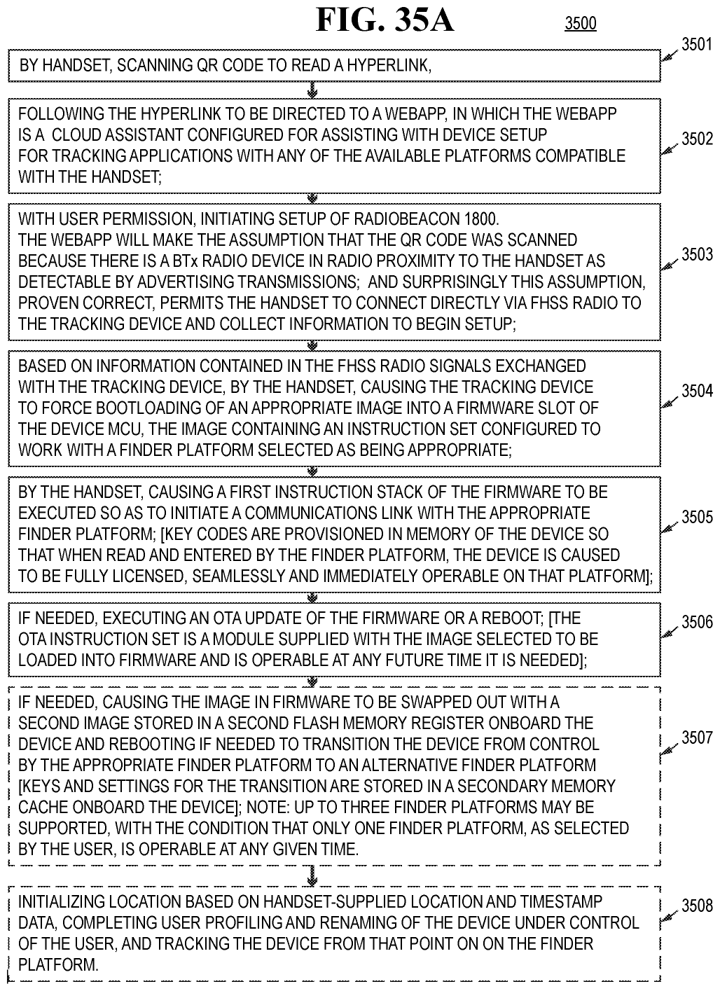

FIG. 36 shows a setup and installation of a radiotag 1800,1900 and a display screenshot on a user handset with successful implementation of local mapping of a user's radiotag, as was illustrated in co-owned U.S. Pat. No. 11,792,605, is shown. This is a gain-in-function for the user handset, because not only is the location of the radiotag displayable, but outputs from sensor's onboard the radiotag may also be displayed, and the user may program executable “conditional rules” by which remote devices will actuate electronic and motorized behaviors based on logic conditions such as sensor thresholds, trends, time flags, location flags, and so forth. Users may typically operate one, two, four or even six radiotags at a time, and the behavior or the radiotags may be configured as a “group” if desired as described with reference to FIG. 13 (1300), FIG. 24 (2401), FIG. 41 (4150), and has been described in U.S. Pat. No. 11,145,183.

FIG. 36 illustrates a screenshot 3601 on a handset 3270 in which setup 3602 of a new radiotag is almost complete. In this example, the user has installed two radiotags successfully and has a map display of the local area. Distances to each radiotag are tabulated with the note that a final setup step is needed. In this view, one more permission is needed. Our system provides global mapping capability with the capacity to locate multiple radiotags. When setup is completed, a map pin will be shown for the location of the last radiotag, as is depicted in FIG. 12 (168) of U.S. Pat. Nos. 9,392,404 and 10,580,281, which are co-owned and are incorporated in full herein by reference. Typically, this map location will be nearby during setup because the handset and radiotag are in proximity for BTx radio pairing mode, but subsequently the radiotag's last known location will be shown, even if it is across town or across the country.

Once setup is completed, the radiotag may be useful in reporting location, reporting sensor data, reporting conditions from a mesh network of radiotags, reporting location of a friend, child or pet, and for activating a remote device or devices, for example. The remote device that is controlled may be a designated device. The remote devices may be a network or layer 2203 of devices, as will be described below.

### Example VI—Radio Contact Logging

In this example, we demonstrate how ambient BTx radio signals may be decomposed to yield useful information without intrusive loss of privacy. Logging can begin with a unique preamble that identifies the start of a BTx signal, is instantly recognized by receivers, and the ensuing bitstring can be loaded into a memory register without the need to identify any signal identifiers. That information may then be assembled in memory with a timestamp and geostamp if available, and archived as an entry or “record” in a radio contact log (4000a, a “snapshot”), which may contain multiple entries and may be transmitted periodically to a cloud host. FIG. 37 is an arbitrary representative advertising packet 3700 containing data unique to time and place that can be extracted to build a radio contact record 3720,4000. Similar BT signals were reviewed earlier in FIGS. 25 and 28 and in FIGS. 26A, 26B, 26C, 26D, 27A, 27B, 27C, 27D and 27E. Those signals are representative of the plurality of BTx radio signals that would be received or intercepted as part of a survey of the BTx radio topology or envelope of a location at any given time. Obviously, the BTx radio traffic of the canals of Amsterdam would be quite distinct from the BTx radio traffic of the freeways of Los Angeles or the lakes of Ontario. By collecting unique signals for several seconds or several minutes, a collection of unique signals results, each signal having a preamble 2500a, an access code, often including a company header or prefix, and a payload (PDU) of some length between zero and hundreds of kB, and optionally a repeat frequency or a length metric and a statistical variance metric. Headers that partition the frames of the signal into interpretable segments are evident in the structure. The PDU may appear to be random noise, may be variable in length, and may be encrypted, but is part of a pattern from which inferences can be drawn. Signals from machines such as printers and headphones may contain UUIDs (advertising their services) that are consistent and are transmitted on a predictable timeline; other patterns may be more difficult to crack, but with a DSP or a machine learning (ML) model (a “learned model”) to work with, the patterns emerge.

FIG. 37 describes a decomposition schema for an intercepted BTx packet 3700 that is harvested to generate a radio contact record 3720 with time stamp 3731 and host ID 3732 (referring to the host radio device RUI that captured the radio contact record). Because advertising packets vary in structure, the correlator is a smart correlator or DSP that will categorize incoming radio signals to efficiently pull out some or all of the useful fields and to assemble those data into the radio contact record, using null fields where data cannot be recovered or is not present. The preamble 2500a of the received message will be used to calculate an RSSI for the signal, and any TX POWER 3708 information in the advertising data packet can be used to calculate proximity 3736. If heading sensor data is transmitted and can be parsed, that also can be captured. The PDU Header 3702 of the transmitted signal typically includes type T (3734) and length L (3735) and of the packet. The MAC Address of the signal source (TD1, 3733), if transmitted, may be in the ADV ADDRESS 3704, at the front or tail of the PDU header, or may be part of a UUID transmitted by an iBeacon, and two, three or all six bytes of the MAC Address may be recorded, depending on the context. For typical use, only six LSB bits of the MAC Address may be enough to establish a radio snapshot of the location traffic; for law enforcement use, a full MAC Address may be captured. The receiving device also has a MAC Address (HOST ID, 3732) that may be archived too. Service UIDs are also included in the advertising data payload 3706, and can be taken as proxies of device identifiers (PROX, 3736). Other parts of the advertising data may be useful as sensor data and stored in a separate field DATA1 (3737), such as for example telemetry including temperature, battery voltage, biometric readings, and so forth.

Location, radio contact record field 2358 may be the location of the transmitting device (if location is transmitted), may be the current location of a proximate cellular device with GNSS, or may be a notation added by the user, for example. The user may store a radio snapshot of a living room, a garage, an office, and other familiar locations, for example. XCB devices 4575,4775 are fitted with means for capturing location from surrounding networks. The radio contact record may also include the device access code in field 3739 as is received in the ACCESS CODE 3701. This information may be useful in establishing relationships between BTx devices so that the intercepted signals can be viewed as a family structure of a mesh network or a piconet with master and slave relationships outlined by the use of GIAC, DIAC (DAC), LIAC access codes, for example.

Each radio contact record 3720 can be packaged in a PDU 3765 of a BTx data transmission 3760 that includes its own BTx preamble 2500a and standard BTx data packet structure. Such packets 3760 would be sent to a master of a piconet or to a smartphone, to a reference hub or to a cloud assistant, for example. Analysis of the meta-data in the logs of radio contact reports over an interval of time may be performed onboard the host device, or may be performed at a higher network level, such as by a cloud host with access to server power for making correlations. In some instances, the radio contact record will be refined by periodic updates so that representative radio topology at a selected location is accessible by time of day, day of the week, time of year and so forth, and has been updated routinely, and in which older data is only retained so as to estimate variability. The object is to develop a profile for radio traffic at the location that will allow the BTx device, the master of a mesh network, a smart device, or a cloud host to make a prediction with a definite level of confidence at a later time—that prediction matches the location to the radio traffic, but without the use of GNSS and without intervention by the user. That prediction can be tested so as to be verified by a separate process step. Once a requisite confidence level is achieved, the prediction as to the location of the radiotag will be a contextual underpinning of the device behavior at that location. The device in a work environment will behave differently, and have different priorities, as compared to a device at a home environment or in a vehicle.

In one embodiment, the host device will make a record of a radio contact in a log, and will add a timestamp 3811 to its record, and if available, may also add a geostamp. While the BTx core radioset has a limited set of instructions, it controls power to a processor (microcontroller or “MCU”) and actuates the logic for managing computing and memory resources with the executable instructions needed to harvest the BTx radio traffic in its local environment and prepare or even process the radio snapshots. Onboard sensor data outputs can also be coupled to actuation of designated logic systems and executables.

In logging radio contacts, a convention is used for convenience. The “Source” device refers to a transmitting unit that is the source of a service or data. The “Host” device refers to the unit that enters and “hosts” the radio contact record. Both devices may generate radio contact records that include sensor data and location. For connection request packets, the terminology “INITIATOR” and “ADVERTISER” are used to indicate that the INITIATOR sends a SCAN RESPONSE to the ADVERTISER in response to an advertisement packet.

“Bluetooth radio contacts” are logged as an array of records in a stack, each record having multiple fields accessible as a database of data entries. The records are stored in a cache register or flash memory of a device and may be transmitted as packet data in response to an INQUIRY or PAGE from a qualified center unit. This database becomes useful by organizing it as a “whitelist” or a “blacklist” for example, of locations that are welcome versus locations that require caution or are out of bounds, or by organizing the data into “familiar” locations versus “alien locations” depending on whether the radio traffic patterns are familiar or unfamiliar, and adjusting the device behavior accordingly. BTx device behavior may also be extended to other companion devices such as a smartphone paired with the BTx device, and a “familiarity index” developed by the device may be shared with family members, for example.

Whitelisting can be complemented by blacklisting, which may avert unwanted or dangerous situations, such as a family's youngsters hanging out at a place of misfortune, just as an example. The cloud host would receive data from a child's smartphone or XCB device that shows where the child is spending his time, and the cloud host will supply a notification to the parents. Similarly, a dog that persists in returning to an undesirable location can be tagged and tracked so that any future return to that location will result in a realtime alert to the owner. In each case, the user collects a library of radio signatures or snapshots, programs a conditional rule or command with any new radio data that matches a pattern in the library as a trigger and the system takes over automated monitoring and execution of the rule.

In one embodiment, each record in the radio contact array is time stamped and records the radio unit identifier (RUI) of the receiving “host” device where the radio contact record is stored and the radio unit identifier of the source transmitting device, the received radio signal strength measured by the receiving device, and optionally a geostamp. A MAC or MAC-Lite address may also be included if available. In response to a trigger, the radio contact log is uplinked to a smart device over BTx radio or more efficiently to a cloud host by making a cellular radio link to the network. The data may then be analyzed to derive predictions such as the length of a drive home, or the safety of a child.

The trigger to uplink the data may be a correlator configured for recognizing particular BTx radio signatures, or a correlator configured to flag a particular digital sensor output from an onboard A/D converter linked to a sensor package, or to a simple IO pin such as a flag from a HOMING button, or to a pattern recognizer, such as a DSP, that can recognize voice fragments, radio signal patterns generated by a software-defined radio (SDR), or unique sound sequences. The DSP may also recognize QR Codes or fingerprints. The correlator that acts as a trigger may be a smart correlator, that has received training from the system to recognize patterns associated with particular impending events such as pulling into the driveway or anticipating a bank robbery, for example.

The trigger may be a floating point value presented to a specific I/O port in a specific logic state of the device. In some instances BTx radiosets can be used to transmit larger datasets such as radio contact logs. But in practice, the trigger may instead actuate a packet composer to assemble a table such as shown in FIG. 41 (4100) containing a cluster of radio contact log entries tabulated as a message for uplink directly on a cellular network to a cloud host, or indirectly via some other wireless radio technology such as Wi-Fi.

Timestamping may also drive a field termed “Time to Live” (TTL) that specifies a duration in which a radio log snapshot is kept. The number of transmissions in a memory stack may be limited, so older memories are dumped and fresh context updates the stack in a Last in/Last out stack.

### Example VII—IoT-to-Internet Reporting as Wi-Fi Signals

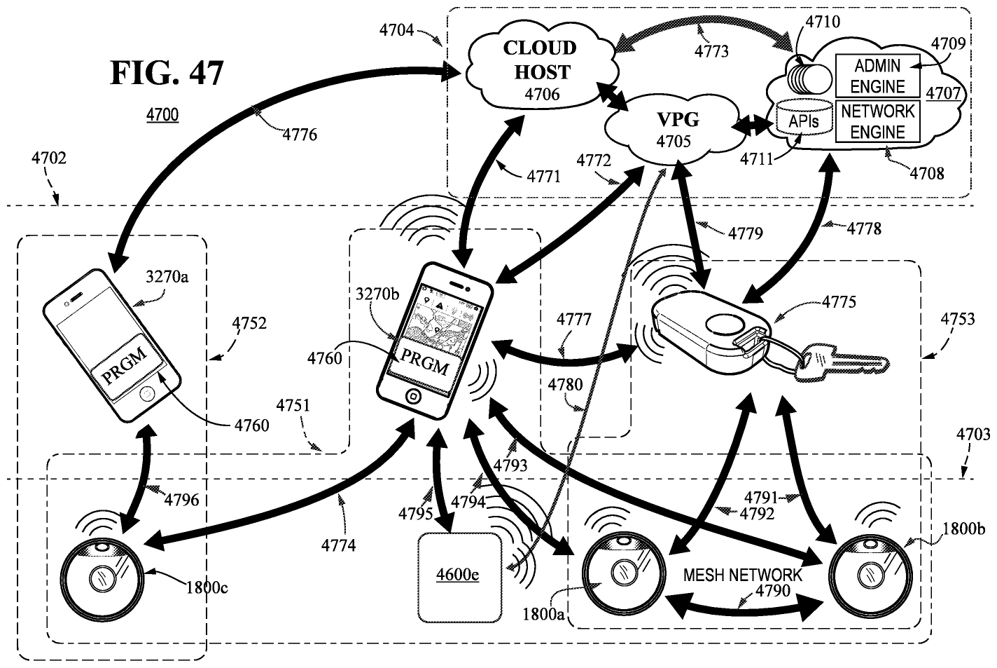

All BTx signals must be parsed and restated for transmission and analysis in an IP Packet Data environment. FIG. 38 illustrates a decomposition of a BTx radio transmission 3800, here a connection request, but the resultant radio contact report 3810 is packaged in a Wi-Fi IP Packet format 3820 with payload 3825. The payload includes a timestamp 3811 and geostamp 3812 and the message is formatted with an IP Address for transmission by Wi-Fi through the IP Packet Data Environment layer 2204 and may be analyzed locally or forwarded to a cloud host for analysis of the meta-data in the logs of radio contact reports over an interval of time. The device needed to transmit BTx data to a WLAN or WPAN access portal as IP Packet data with an IP Address and Wi-Fi compatible radio signal structure includes a packet decomposer and composer configured to decompose BTx packets and assemble IP Packets from the radio contact information as shown in FIG. 38, plus a Wi-Fi radio unit, such as is offered as an SOC by NXP Semiconductors in a 7 nm package, the IW612 (NXP88W9098). By doing the “repacketing” at a BTx radiotag 1601,4600e, the timestamp and geostamp are valid indications that can be accurately aggregated with other data received at higher network levels from other concurrent reporter nodes. Multiple reports from special BTx/Wi-Fi hybrid radiotag 1601, handsets 3270, or a plurality of IP Data Packet-compatible devices 4700 may enable the system to accurately triangulate a signal origin or waypoint, for example. Devices 4600e containing an SDIO Wi-Fi/6LoWPAN radio modems (wired in an SoC to a BTx radio) are native to IP Data Packet transmissions that are Internet compatible and serve as another way to bypass cellular devices with SIM cards in moving data from the IoT layer 2202 to the cloud layer 2204. This is discussed further with respect to FIGS. 46, 47 and 48A.

Wi-Fi equivalency is realized with lower-powered portable radio devices. With the adaptation of 6LoWPAN, Thread, Matter, Weave, and SNAP protocols, IPv6 can achieve a crossover between BTLE and WLAN communications. IPv6 can be emulated over Bluetooth Low Energy (BTLE) as defined in RFC 7668 according to the Internet Engineering Task Force, for example. But this standard does not allow native BTLE transmissions to be routed onto the IP Packet Data environment of the Internet unless first adapted and reformatted by Wi-Fi or Cellular devices as would be compatible on Wi-Fi and cellular networks. The newer Thread/Matter radio protocols based on IEEE 802.11 and 802.15.4, such as with Nordic's nRF54H20 SoC, are native IP Packet Data radios, meaning that they can cross-connect from BTx to Wi-Fi in smartphones and laptops, for example, using Matter Bridge. Thread, Weave or SNAP are border router gateways having IP Address hardware that may connect directly to cloud infrastructure and can bypass the smartphone/SIM interlocutor or Wi-Fi interlocutor needed for BTx interconnects with cloud services. While most computers are able to recognize BT signals, no operative interlocutor to translate and adapt those signals for forwarding their contents to the Internet is available because the IP Address hardware is missing. Thread may eventually supersede BTx for many applications, but with BTx so densely populated globally, the obsolescence of BTx is over a far distant horizon.

In one embodiment, the devices described here map BTx radio packets to a standardized database entry format or “record”, and these records are shared as a sort of “radio snapshot” of the BTx world around the originating device in a transmission that is recognized and readable in a Wi-Fi IP Packet Data Environment 2204. This snapshot can be used for authentication, but also finds a myriad of uses in provisioning new devices, in erecting geofences, in wayfinding and locating, and in maximizing throughput in the ISM spread spectrum. The radio log snapshot may include larger records when transmitted over Wi-Fi or using the 6LoWPAN standard, but the seed dataset or “radio contact log” is assembled from smaller snippets extracted from the BTx advertising packets and PDUs in the intercepted BTx radio traffic, those snippets going into log entries of BTx radio contacts as shown in FIG. 38.

A similar tabulation may be implemented to include sensor outputs from each of the networked devices. Each sensor output is recorded with a timestamp, a host identifier, a source identifier, and some indication of location. A compilation of sensor data and radio contact data is shown in the following figure.

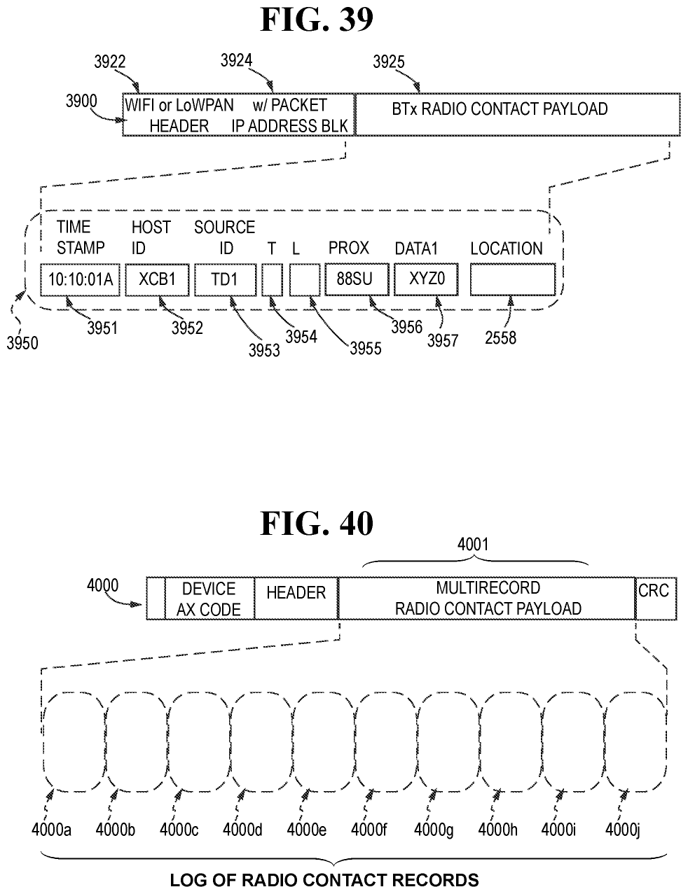

In FIG. 39, an IP Packet Data message 3900, sent in Wi-Fi or LoWPAN (connectable as nodes to the Internet via an IPv4 or IPv6 network backbone), contains an embedded BTx radio contact record 3950 with Wi-Fi or 6LoWPAN HEADER 3922 and PACKET IP ADDRESS 3924. In the exploded view, the payload is decomposed to its elemental parts. The IP data packet includes a preamble and header 3922, an IP Address 3924 of a cloud server that acts as a recipient or clearing house for the records, and a payload BTx data packet 3925. The payload (expanded, 3950) is a radio contact record, and includes a timestamp 3951, an ID of the host device 3952 that captured the radio contact record, an ID of the transmitting device 3953 that sent the radio signal that was intercepted, message type 3954 and length 3955 statistics, a proximity indication 3956 that correlates the distance of the receiver and transmitter, any sensor data 3957, UID, service characteristics or URL fragment in the payload, and a location 2558 of the host device at the time the signal was intercepted. Host devices 3270,4575,4775 and 4700 are able to derive a location from LTE PoLTE, GNSS signals, or other network services.

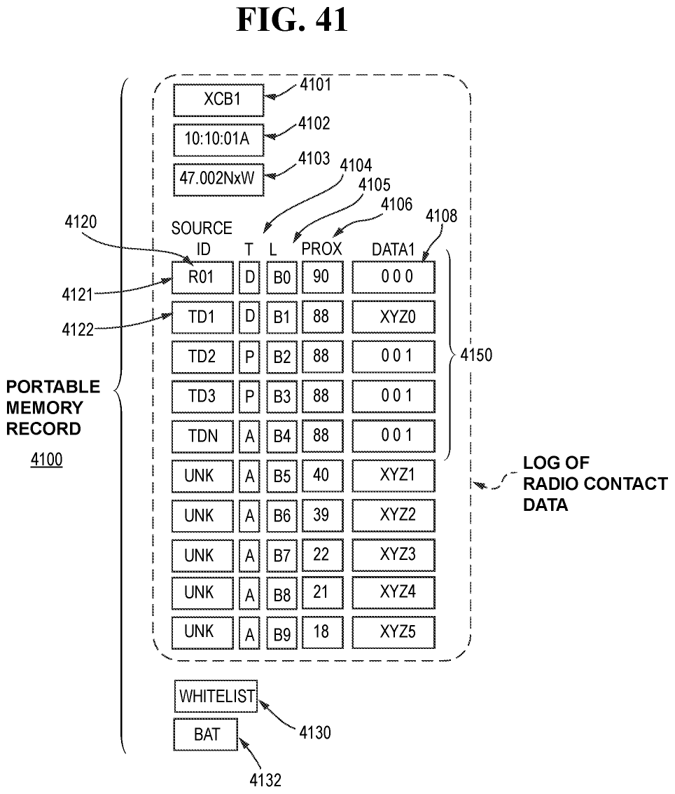

FIG. 40 makes clear that the IP data packet 4000 can be logged and transmitted across a Wi-Fi or cellular signal in an efficient and data intensive way by concatenating the radio contact reports. A multi-record radio contact payload 4001 is a log or “snapshot” of the ambient radio traffic around the host BTx device for a slice of time. Shown here are ten log records, 4000a, 4000b, 4000c, 4000d, 4000e, 4000f, 4000g, 4000h, 4000i, 4000j of individual BTx radio signals that were captured in this BTx report. The snapshot provides a real time look at what kind of BTx radio neighborhood or topology surrounds the receiving device. If the device is in a familiar home office, there will be the BTx printers, a smartphone, the user's radiotags, perhaps a headset, a BTx mouse or laptop, all expected members of the “radio ensemble” that is characteristic of that home location. The unique radio identifiers of each device are combined to form a “radio signature” that indicates familiar surroundings. When the user leaves the front door, some of those radio identifiers accompany him, and are picked up on the next radio snapshot. Over time, a consensus “portable memory record” that would be a second version of the record 4001 of the expected BTx topology associated with the user on the move is stored in memory of the host device or host server.

A portable memory record may also look like that shown in FIG. 41 (4100), where useful elements include the RUI 4101 of the host device that generated the record, a timestamp 4102, and a geostamp 4103 that relates to the snapshot as a whole. Within the snapshot, the records 4121, 4122 and so forth take the form of an array of fields in a relational database. Data may be containerized to limit access and to open the data for access by a variety of user Apps.

The relational database includes fields for SOURCE ID 4120 (the ID of the transmitter of the signal that was intercepted), the type of BTx message T 4104, the length of the message L 4105, the proximity 4106 of the host device to the transmitter, and a field for data 4108 that can be anything from sensor readings to service characteristics, biometric readings, temperature, or even URLs indicating deep intent pushed by the transmitters. Dataset 4130 (in memory) may cross-reference a whitelist of BTx devices that are owned by the owner of the host radiotag against a group 4150 or cluster of signals in the ensemble of signals captured in the snapshot 4100. Field 4132 may indicate battery life or charge residual in the host radiotag device, or some other telemetry useful in device maintenance.

Thus it may be useful to look at the local BTx radio topology from the point of view of a meta-analysis at a first level, and then, based on correlator fits to known message types, to set up a permission structure for controlling the “deep intent” features of smartphones and installed apps using meta-data or flags generated from the BTx topology. In managing security, defensive smartphone control may be possible without specificity and without identification of the incoming signals. Particularly, by calculating a realtime “alien-ness index” or “strangeness index” of the surrounding BTx chatter or radio topology, the level of trust extended to recognizable BTx messages may have to be adjusted, additional authentications may be needed, and further sandboxing or “drying” of wet code may have to be engineered to suit the potential danger represented by the environmental milieu of BTx traffic. On the positive side, the BTx traffic can also have a “familiarity index” or “comfortable-ness index”, and this can be used to recognize particular devices having or in need of a special relationship of sharing, and for auto-provisioning a whitelist of those devices for immediate access based on history of pairing and history of DIAC inquiries, or other local chatter that is characteristic of a safe, familiar place, such as home or a secure office. When BTx data is consistent with a familiar location absent alien signals, the need for password-type authentication may be automatically uncoupled, easing the UX.

Let's take some other examples. De-identification of data is doable. De-identified data is data that has not been associated with an identifiable user. It is possible to know, for example, how many people in a county have been vaccinated without knowing who has been vaccinated and who has not. It is possible to know how many dogs within whistling distance have collars that are paired by a BTx radio to their owner's smartphone without knowing where the owners live. And it is possible to walk up to an ATM machine, tap a smartphone on a pad, and have your encrypted balance information downloaded to your Financial Advisor App in your BTx device, to bootstrap setup of a Wi-Fi, 6LoWPAN or Thread connection on top of a BTx inquiry for more information. Higher data transfer speeds are limited with BTx, but the ubiquity of the BTx radio interface by shear number of installed devices clearly supports increased effort toward making the BTx radio interface into a flexible hand within the glove of a synthetic radio and antenna capable of M2M communication over a range of authenticated connections, supplemented by 6LoWPAN or Wi-Fi to bridge to the IP Packet Data Environment of 2024. A synthetic radio is capable of initializing a BTx connection and then morphing it into a 6LoWPAN connection for checking sensors and into a Wi-Fi connection for transmitting images, for example. The real hurdle is the information/energy ratio, as is well understood in cybernetics.

In another simple example of a user case study, consider a user who notices something is lost—and that something has an attached radiotag 4575,4775. The user consults the cloud, the cloud looks up the last known snapshot of BTx radio traffic captured by the lost radiotag and sent to the cloud. The cloud then determines that the radio traffic “snapshot” is identified as associated with the user's garage, so the user goes there and can use BTx proximity tools to turn on a beeper or a lamp on the radiotag so that the lost item can easily be found, such as under the front seat. Those tools are described in FIGS. 15A and 15B of U.S. Pat. No. 11/184,858. GNSS with latitude/longitude coordinates are not needed for making location-based interventions using local BTx connections where radio contact log information is used in pattern learning systems.

The BTx radio signals that are associable with a user's garage as a location-specific signature or snapshot are numerous. Some garage door openers use BTx radio; some cars have BTx speakers or user interfaces, some user's place a BTx radiotag in their car so that they can find the car if they forget where they parked; and in some instances, the next-door neighbor has BTx devices in close proximity to the user's garage, so a reasonably good BTx “radio snapshot”, “radio fingerprint”, or “radio signature” of the garage location is highly likely. And even if the car is not in the garage, but is in the driveway, a signature characteristic of the car in the driveway is also known to the cloud or to the XCB device or to the user's smartphone, for example. A predicted fit of location to a BTx topology is near certainty. If necessary, a user can obtain a network-assisted location fix using the cellular radio to tag the radio snapshot, or can obtain a GNSS location fix using a GNSS chip and radio, or in many cases, the GNSS capacity can be resident in the cellular radio, so that triangulation of cellular signals are not needed. Even more simply, the user can simply label a radio snapshot as “My Garage” and store it in a memory of places. Multiple features and pathways allow the system to quickly converge a prediction on a consensus location for the lost radiotag by accessing the last BTx radio snapshot uploaded to the system and comparing it to familiar locations.

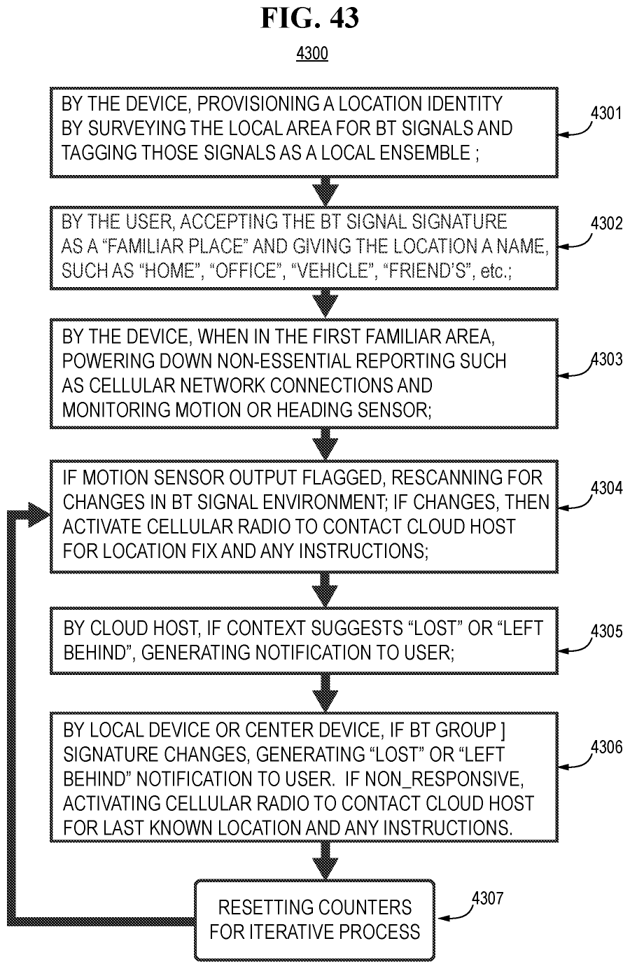

FIG. 42 is a view of a rolling memory stack 4200 containing radio contact records. In this model, a continuous rolling stack of BTx radio contact records (left to right: each tabulated as a snapshot 4200a,4200b,4200c, is taken in a time series. Top line 4201 shows the host ID 4202, the time 4203, and the location 4204 as derived from GNSS at the time the snapshot is recorded. The snapshots are hosted by XCB radiotag (XCB1, 4575,4775) that is paired with a group G4 of four personal BTx radiotags TD1, TD2, TD3, TDN. The host records the signals of the paired group and any ambient BT radio signals UNK captured from the proximity of the receiver. Also detected is the user's smartphone, tagged here as R01 (4205). The snapshots are taken by intercepting radio traffic in BT advertising and data channels at ten second intervals. Passive listening is used preferentially so as to not consume more battery power by generating back-and-forth radio messages. In this instance the top ten BT signals intercepted during a few seconds of time are captured in each snapshot. Five columns correspond to the transmitter identification 4211, the type of message 4212, a length of the message 4213, RSSI 4214, and any data content 4215 (such as accelerometry) in the message. The gain and sensitivity on the receiver can be adjusted to construct conditions by which a tabular content of suitable meta-complexity is filled.

At the bottom of each snapshot, a “familiarity index” (a probability) is calculated (4221,4222,4223) that analyzes the integrity of the BTx topology as it accounts for each member of the owner's BTx ensemble and the other factor, the exogenous signals that are associable with the location at which the snapshot is taken. User's may carry several radiotags with them, but there will also be miscellaneous signals from BTx radios encountered as the user moves from place to place. With familiar locations, these miscellaneous signals will be analyzed as a pattern known to the system so that the system predicts the familiar location with a confidence level. The familiarity index is associated with a location, the system scores device signatures that typically remain in a familiar zone differently from device signatures that always accompany the owner, and devices that are not associated with the familiar zone separately. A strangeness index can also be provided that accounts for irregular or unexpected BT signatures associated with a new location. By quickly recognizing the pattern of familiar and alien or unfamiliar BTx transmissions in a location, the XCB device can quickly auto-provision a kit list of what to keep track of, infer actions to be taken if there is an exception (‘anomaly’), and also note the overall characteristic of the location as a mélange of ambient BTx radio traffic so that in the future, when that pattern is again detected, the device can know where it is. In this way, the enhanced BTx device can know something is lost before the owner does, can guide the owner to the lost device, and can also know where it is without the need for GNSS, AGPS, PoLTE, or other advanced, more energy intensive location acquisition means.

Referring to FIG. 42 again, sensor data is reported in columns 4214,4215. The sensor data may be useful in generating alerts when there is an anomaly that needs to be brought to the user's attention. Radiotag TD3 is part of group G4, but in the last snapshot 4200c, the RSSI data 4214 has increased suddenly and there is an impact recorded in accelerometry sensor data 4215. The combination of a sudden decrease in proximity and a vectored impact in the data columns at 4230 is manifested in a summary ALERT 4233 that one of the radiotags has been left behind or likely dropped. This conclusion is made by the host device (as a vibration or flashing LED) and is communicated to the owner directly or via the user's smartphone 3270. The host device performs the analysis autonomously; further confirmations are obtained if radiotags of group G4 are members of a piconet and a change in a member's heading is noted. But by tagging a change in signal strength at 4230, a consensus emerges and a “left behind” or “lost” alert 4233 can be issued within ten seconds; while the owner is still well positioned to backtrack and recover the lost radiotag.

Anomalies in the data are detected by machine learning and probabilities associated with predictable outcomes are used to design and execute interventions, such as a notification. A ten second lag is built into the memory stack and the delay has the effect of reducing false alarms due to random bounces in the data. Rapid identification of issues results in a significant uptick in consumer confidence and successful resolutions of location and asset management issues.

Old data is sent to the network for use in building models for machine learning and is then discarded from the local device so that the memory resources inside the radiotag are not overloaded. An XCB radiotag might contain several gigabits of DRAM, or just a few thousand Kb, depending on the computational load that is done locally versus in the cloud. a 6LoWPAN device may contain one or more megabytes of RAM memory, enough to store whitelists and a rolling stack of radio contact log entries.

### Example VIII—“Familiar” and “Alien” Radio Topology Indexing

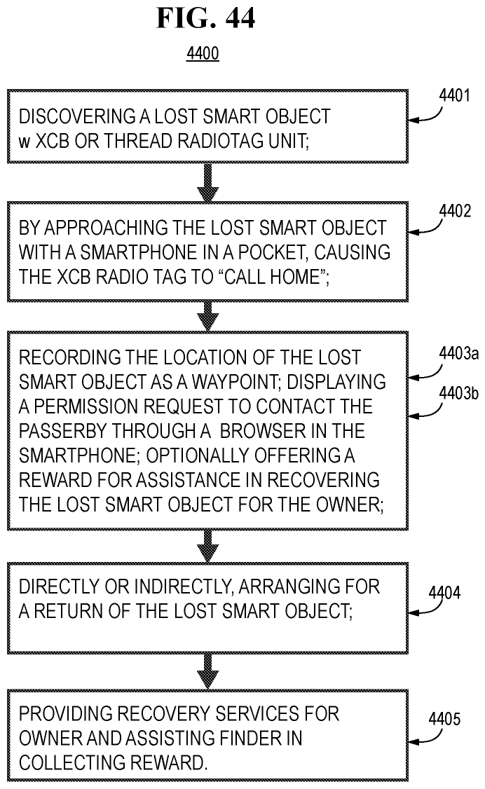

FIG. 43 is a view of flow chart for marking a snapshot of radio contact records as a “familiar place” and for using that information to manage device behavior. “Alien” is taken with the meaning, strange, not extraterrestrial, as in “outside of a nominal, expected experience at this place and time”, or, “representative of an unknown and unfamiliar place and time”, or, “extraordinary and exceptional-anomalous”. Obviously, what is strange can be harmless or heartening and enlightening, and what is familiar can be unhealthy and disheartening, but situational awareness begins with knowing the difference between a predictable environment and an unpredictable environment, and acting differently based on that awareness.

The more difficult technical problem is how to parameterize the difference, and then what program step to write in which a “familiarity” or an “alien” flag is an input. A radio signal environment is an environment having intermittent radio transmissions at a detectable level. To be more specific, the kind of radio transmissions, natural versus man made, and pulse modulated versus frequency modulated-those kind of questions, relate to how to parameterize the difference between radio signal background that is predictable and expected, versus a background in which the radio signals are unexpected in some way related to their strangeness, their amplitude, their spacing and duration, or their frequencies, for example. A strangeness index or parameter is coded. A BTx device having a circuit for parameterizing a BTx radio signal environment is shown in FIG. 32 3200, where the RAM data logger 3230 includes logic circuitry for entering radio contact log entries and for calculating familiarity indices (4221,4222,4223) and other meta-data constructs.

BTx radiotag devices in a CONNECTED state exchange FHS packets and coordinate the frequency hopping regime across the data channels to avoid interference. BTx radiotag devices in a SCAN or INQUIRY mode use three strategically selected advertising channels to initiate radio contacts. The traffic number of hits in the advertising channels versus the data channels is a parameter that can indicate the character of a radio signal environment, looking only at the ISM band, for example, or just looking at Bluetooth® radio signals, or just looking at Wi-Fi radio traffic, or Cellular radio traffic in the LTE or GSM bands, in various embodiments. In one application, for a BTx radiotag unconnectedly surveying the full set of BTx radio channels, what emerges from the survey is a distribution of channel usage across the spread spectrum (data and advertising channels), and an index can be derived from this distribution pattern that provides insight into the familiarity or strangeness of the locale surrounding the XCB survey device. Devices that encounter primarily traffic on the advertising and inquiry channels are clearly in a public space that is readily differentiable from the more balanced private and connected data traffic that characterizes a home or office that is physically isolated from busy commercial locations. With increased availability of synthetic radio, the capacity to “sniff” all the BTx channels for traffic is realized and offers the users a simple method for scaling their encryption efforts in direct proportion to the local radio topology or concentration of advertising channel use. Conversely, in a familiar location that is secure from alien radio transmissions, password and encryption protocols that bulk up or complexify radio signal volume can be dropped so as to speed data throughput.

In another use, familiar locations can be recognized by MAC Addresses of stationary transceivers such as the neighbor's television set or Wi-Fi modem. The open MAC Address need not be a smartphone or laptop, it could be just a wireless mouse on a desk that poses no risk to privacy but sends a periodic “lighthouse” beacon signal saying “I'm me! I'm me!”. The advertising stream changes to data when the mouse is in use, providing another logic flag that the system can use to streamline the UX.

FIG. 43 is also a flow chart showing a method for controlling a community of devices by the ambient BTx radio topology they are immersed in. Simply, radio topologies are divided into “familiar” and “alien” and in familiar locations, BTx radio energy usage and monitoring is reduced. In familiar locations, energy usage for security is reduced, in unfamiliar locations, or if an intrusion is detected, energy usage for security is increased. Method 4300 is directed at recognizing a familiar location by the BT radio signals most associated with that location and for programming power management, notification management, and an “airplane mode” features (defined generally as a reduction in transmission and reception, with corresponding reduced activity of commerce-related radio traffic and network maintenance, but with exceptions for messages and notifications having a high priority that can be configured by the user) based on that location, for example.

Locations that benefit from being recognized by the radiotag as familiar include HOME, OFFICE, VEHICLE #1, FRIEND'S HOUSE #2, and so forth. The underlying apparatus is the radiotag that operates a BTx survey or scan program 4301 configured to detect and catalog BT signals periodically (with or without making connections) for ambient BT signals. The BTx radio stack may be implemented to do this as a SCAN or INQ function, or may be implemented to listen passively 3001 as discussed with reference to FIG. 30, but also to create radio contact records for each signal encountered during a designated survey interval or when some sensor input flag is raised. The survey interval may define a radio contact log page and may be tagged by a nickname or a location, or by its association with an event reported by a sensor.

In one embodiment, the BTx radio functions to survey in “PASSIVE, LISTENING ONLY” mode (3001, FIG. 30), although a similar process can take place in BTx INQUIRY SCAN 3008 and PAGE SCAN 3010 modes. The always-listening mode need not be continuous, it may be executed at designated intervals, such as 2 seconds out of every 10 seconds, depending on the density of BTx radio traffic that is encountered. The device can listen for BTx preambles, GIAC signals, radiobeacon broadcasts, and optionally for fragments of data that can be dropped into a signal register without connecting or responding, as well as listening for signals from familiar BTx devices. Signals that are picked up in the “survey” process by the listening device may include connectable signals and non-connectable signals; public signals and private signals, discoverable and non-discoverable signals, because the antenna is coupled to a smart correlator that flags any signal having a qualified BTx preamble, either an advertising preamble or a data preamble, and the stack operates a register configured to capture a defined length of a bitstring for each preamble detected, then adds a timestamp, optionally a geostamp, and any sensor data that is in need of logging. The register can be parsed to decompose the bitstrings as described in FIGS. 37 and 38, and the output from the parsing operating is entered in RAM memory 3230 for future upload or archiving. In post-processing, the radio contact log entries may be characterized as “familiar” or “alien”, for example, based on DSP analysis in the stack. Sensor data may also be evaluated and any condition flagged that merits a responsive action or notification.

To initiate the process, a survey or scan begins by collecting traffic from a given location, and optionally repeating that so that a consensus radio contact log page emerges that identifies the BT signals to be expected at that location. That page can be tagged as a whitelist and associated by the user with a particular location or tagged automatically. The scan results are stored in a rolling table (FIG. 42, 4200), typically including MAC Address or any other RUI identifier(s) of the transmitting radioset and a timestamp or geostamp, optionally with RSSI and any sensor data captured with the source signal.

Examples of signals that may be captured include the user's wireless modem, smartphone(s), a BT-equipped television, the neighbor's smart coffee machine, a home office printer, a smart refrigerator, other BT radiotags that the user carries in a pocket and leaves by the nightstand, a Wi-Fi hotspot with BT transceiver at the library across the street, a heart monitor, a computer wireless mouse-any or all such signals could form the signature or part of a signature of BT signals that are a characteristic of the given location, for example a HOME location. Similarly, office printers, scanners, fax machines, computers, and office worker's phones and other devices may be entered in a radio contact log page at an OFFICE location. A log page for signals captured in a VEHICLE location would include a few radiotags in a user's jacket plus the vehicle radio and BT headset or earpods that the user keeps in the car, albeit the signals associated with a moving location such as a vehicle will also include one-time encounters with radio units passing around the vehicle. There will be a mix of familiar signals that characterize a familiar place, and some unfamiliar signals that are non-recurring. By a process of iteration, as can be performed automatically, the device can “learn” to recognize the location(s) from the radio signal ensemble. This learning process can be performed in the owner-user's device (as in “edge computing” or “boundary computing”), can be performed or assisted by a central server, or can be performed or assisted by a companion smartphone or smart device with suitable “App”. Location log pages (a representative sample of radio chatter associated with a location) associated with a “whitelist” or a “blacklist” may be stored locally or stored in a central server. Location log pages given a user nickname may be stored locally or in a central server and may be shared with other smart devices.

Each of these BT signal clusters of a “radio snapshot” are “radio signatures of a place” or “radio snapshots of a place” and can be programmed 4302 to be identified as and associated with an identifier by which the group can be “nicknamed” according to its location (or stored with location coordinates such as Lat/Long coordinates). Parameters such as time and day of the week can also be useful and may be included in a timestamp with each log entry or record. Each radio signal ensemble or page of the radio contact log, based on the snapshot(s), becomes a “nicknamed location”, possibly a location on a “whitelist” that identifies the location as familiar and safe, and the BTx device, at some future time, upon receiving mixed signals and matching or correlating them to the most highly correlated whitelist location, knows where it is. A “correlator” is linked to a signal logging buffer and operates by assigning a logic rank value of a “match index function” based on the contents of the buffer as compared to a reference log page in memory. Once that location recognition is affirmed, user-programmable rules-based logic can conditionally cause the execution of functions by the receiving device, and/or commands to be issued to remote devices, networks and systems. For example, when at a familiar location 4303, power to the radiotag's cellular modem can be reduced to standby or sleep. Battery status can be assessed and a notification to plug in a recharger may be sent to the user. When HOME, executable commands may include: send a text to spouse, open garage door, turn on the air conditioning, and so forth. And in the event that the radiotag is moved, such as when carried to a new location, or carried from the kitchen to the living room, the motion signal clears the logic flags associated with the familiar location recognition event and may cause the device to recheck (4304), again using the scanning function, so as to confirm or identify the new location. This process can be compressed if signals highly correlated with a location are still being received. To prevent unnecessary scanning, a heading sensor, which outputs an integration of motion, compass and gyroscopic micromachined multi-axis sensors, can do inertial navigation to prevent false “motion” activations that might occur if the device is bumped or picked up and put down. Multiple activations that would otherwise drain the battery are avoided.

By extension, any discrepancy in the signal log of the BT radio ensemble can be detected. Detection of contextual anomalies 4305 is an advanced form of “situational awareness” and uses simple AI learning models to improve predictive scoring. Initially, only a notification to the user may result, but with increasing learning, the device can become its own master, and in fact can take over management of larger systems. Each BT device capable of reporting a radio signal inventory of its surroundings, and knowing where it is, will also be capable of reporting that something is missing or out of place by comparing the BT topology with the expected BT signals on a whitelist or whitelists.

When there is a mismatch, the device may generate an exception notification, may attempt to learn a new location, or if a “strangeness index” is activated, may add protective features such as transmission anonymity (DIAC, LIAC), may increase anti-viral measures, or may increase the frequency of cellular CALL HOME events so that the cloud host and user can track the device as it moves. At the very least, the device can rescan periodically for changes in the BT signal environment 4204, can then activate the cellular radio modem to request a network-assisted location fix, take a GNSS location fix, and/or to request instructions if an anomaly is detected. For devices having on-board GNSS, a location fix command can be executed only when truly needed in order to save power.

In some instances, if anomalies are detected in network communication, the device may assign “sandbox” resources in a cloud host to detect malicious software, and the system may automatically deploy anti-viral agents if a threat is detected.

With cloud intelligence or by refinement of edge computing capability, this “survey to self-locate” process can be an “auto-provisioning” process, by which the system assigns location coordinates by determining where a BTx radio signature or radio signal cluster is uniquely found, and cross-checking future radio contact lists against possible matches by Bayesian probability indexing. In a user-directed learning process, user has only to give each location a nickname, or confirm a system-suggested nickname, for instance. The user can also set up any actions, notifications or commands to be executed when the signals correlate with that place. Similarly, the cloud host can evaluate the radio contact logs of one or more radiotags as transmitted to it, and can generate a notification 4205 to the user via an XCB radiotag or via a text or push notification to a user's smartphone (or guardian's smartphone), allowing the user/guardian to evaluate any warnings or alerts. Programmed actions may be automatically performed when the device or system analyzes a BTx radio contact log and determines that the device is in a place identifiable by those signals. Full automation of location finding and location services is achieved by sharing radio contact logs with systems having cloud resources for building “radio location learning models” (RLLM).

In one embodiment, the system provides location, finding and tracking services, by aggregating radio signal log data from a battery-powered radio devices, each with a data logger. As a Bluetooth radio contact data logger, each device is operable to detect a plurality of radio signals having a Bluetooth preamble over a defined duration of time at a current location, and to record for each of the radio signals a timestamp, an access code, and a bitstring from a payload of the radio signal. As an example of edge computing in location determination, the bitstrings of the log entries are whitelisted in a log memory as a first radio location signature of a known first location so that they can be subsequently compared with a later radio signal snapshot to calculate a probability that the current location of the snapshot is the same as the reference location from the whitelist n the log memory. The user generally makes the decision to label locations for a whitelist, and also for any blacklist that is created.

Optionally, the cloud host can share a “learned model” as a program or firmware update for local execution while continuing to improve the model with further learning, larger datasets, and practice. This process becomes a virtuous circle because smart radiotags provide additional data to the cloud learning model, which provides better “learned models” for the smart radiotags to operate with. In advanced instances, the local Access Point or radiotag device uses the learned model to train its local computing resources so that individual customization of the learning is performed at the boundary of the network in direct contact with the IoT layer 2202. This can be termed “auto-provisioning” and is applied to location-based services.

Auto-provisioning can be applied to a variety of location-based services. The radio contact log is a map of radio signal topology specific to the user's surroundings, so it includes all the signals in radio proximity. The “radio snapshot” includes radio contacts with friends and family, not emails, not tweets, so it is a friendliness index as well as a familiarity index, and can find use not only in establishing network security parameters, but also scoring interpersonal activities, community get-togethers, and social integration by the radio signals encountered at the user's location. Also mentioned was the capacity to automatically, or with the press of a button, to call home on a satellite transceiver without a smartphone even when in a strange town.

Most of the applications are still just being discovered. In another instance, radio contact log entries are categorized by the processor or RAM data logger as persistent or transient contacts, and may be compared with motion sensor, heading sensor, or location data to establish that the contact recurs with differing locations from those log entries categorized as persistent contacts, categorizing the RUI or other signature in the radio signature as familiar or alien; and, generating a notification to a user if a persistent alien contact log entry is detected and advising the user locate the alien device or take precautions against possible stalking attack. The signal persistence can be brief if the signal is alien, and has a high, stable RSSI, for example, leading to an immediate threat alert. A user can use a smartphone with BTx scanner to find the alien device. Other threat patterns, strangeness index or malicious code can also be detected and an alert generated.

Avoidance of certain place-associated signals and certain kinds of signals such as radar is also contemplated, again with possible actions to be taken and notifications to be made; and this can be termed a “blacklist” function that is analogous to a “whitelist” function, but is a list of signals which are to be avoided, or for which some defensive action is to be taken. As an example, if a pet owner has a dog that frequently strays to a neighbor's yard or a park down the street, the pet owner can attach a radiotag to the dog, and can capture a “reference” radio snapshot of the BT radio ensemble that characterizes the neighbor's yard or the park, and then will program an alert if the radiotag reports that signal cluster. The user programs the system by storing the reference snapshot in a library of stored locations, some of which are allowed locations and some of which are restricted locations, but each of which has a characteristic radio signature. Radio snapshots captured in real time are compared by the system (or the device) with reference snapshots from the library. The system, a smart device or smartphone will notify the user if the pet is in one of the restricted areas. In one embodiment, a warning voice or tone will be played from a speaker in the dog's collar so as to train the dog to avoid that location. In another embodiment, the proximity of the dog to the source of the radio signals can be assessed using RSSI technology so as to better assess the dog's position. But in a further advance in the art, the fine mapping of BT signal complexity in the signature is a much more sensitive indicator of location and proximity, given the low energy character of BT radio and the lack of outdoor UWB reference signals. At low gain in the receiver, only the strongest and closest signals will be captured, at higher gain, a broader range of signals will be captured. Instead of tracking a single RSSI datum, a whole cloud or RSSI data is embedded in each radio contact log page. In one embodiment, the amplification may be dynamically adjusted to fine tune the certainty of the dog's location. Similarly, a young adult's whereabouts can be monitored for time spent properly in school and time spent in unauthorized locations. Devices that include polyradio or synthetic radio capabilities for Wi-Fi or 6LoWPAN radio can also be used to map proximity-received signal strength decreases with increasing frequency at any fixed distance; a tone scale or “chirp” can be analyzed to estimate distance as an analog scale.

These improvements have the effect of complementing and clarifying the information provided by RSSI, and the same hardware 3200,4574,4700 can be applied to finding missing items—using BT signal complexity capture as an adjustable measure, with a matching function of a smart correlator in RAM 3230,4730 or processor 3205,4608,4730 configured to assess the depth of a match, to calculate a most probable location and even a direction of travel that can be confirmed with a motion sensor and/or a heading sensor. In some instances, proximity to a well-characterized, strong signal, such as the BT printer upstairs (that broadcasts its UUID or nickname at frequent intervals) will render more complex analysis unnecessary, but between the radiotag, smartphone, and cloud host, the analytical power of the system to generate a probable location notification with high confidence in near real time is realized. By correlating and analyzing radio contact data in real time at the local level for patterns that include loss prevention indicia based on radio topology as well as accelerometry and radiotag signal strength, the network latency of a time filter, which can require several minutes, can be eliminated, providing a 10 second early warning of a “left behind” or “wandering” radiotag.

In contrast, RSSI proximity data can have a significant level of variability and be harder to reliably interpret, going high/low/high/low without an obvious change in position, but the radio contact records gain predictive strength with the number of signals in the group cluster, so that locations having a plurality of known signals can be assigned with a high degree of reliability. Conceptually, the population of BTx devices on the planet is so large that what has been termed “BT pollution” (an overlapping mélange of signals) can be turned to advantage in locating items having an attached or embedded BTx radioset, particularly in commercial, residential and generally urban areas. And with the increasing size of cellular networks, the synergy of a BTx and cellular combined network realizes a global lost-and-found system and supporting services.

The log of radio contact records can be preserved in memory (FIG. 42, 4200) as a library entry and if a radiotag is dropped or lost, the last known radio contact record 4230 may provide the clue to its current location. System exception latency is reduced by incorporating motion or heading sensor data into the log entries. In practice, discrepancies in the motion of a group of tags (expected to be travelling together), such that one tag becomes stationary while others are still on the move, or one tag takes one heading while the others of a group take another heading or velocity, result in unambiguous rapid notifications to the user. Similar logic may be coded from BTx topology, where changes in BTx signal environment either are coherent and expected or are anomalous.

A process for learning familiar sites is also developed. By collecting model data in multiple scans and rescans over days or weeks and extracting a more robust pattern with ranked data from the variability and complexity of the scans when taken as a whole.

The learned pattern(s) are stored in a library of patterns 3230 and used to improve location matching. While this kind of learning model may initially require cloud resources, a proven algorithm (a “learned model”) may be implemented using local processing resources and memory on the radiotag.

Databases that grow organically by collection of data and metadata are realized as extensions of a basic system built on the radio contact logging platform. Bayesian algorithms, vectored matrices, and probability match functions are provided as OTA upgradable firmware or software to local devices. The radiotag devices, smartphones, hubs, smartwatches, or smart devices generally, comprise software and firmware configured to solve probability match functions from matrix data, for example. The administrative engine 4709 and files 4710 in a cloud host may include user profiles, programmable executables, and data, for example, but a subset of the model may be designed to be operated in a local device, and the logic shell periodically updated to operate on locally stored data that refreshes and refines autonomously by gaining real world experience.

Security threats may also be reduced. Individual device provisioning may be supplemented after the radio contact data is processed by cloud resources. From radio traffic containing anomalous signals, initial experimentation with an incoming signal in a cloud sandbox is followed by immediate dissemination of a prophylactic to all available devices in radio proximity. An anti-viral kit may be downloaded and installed if the community monitoring program detects spread of a malicious code snippet in the radio ecosystem.

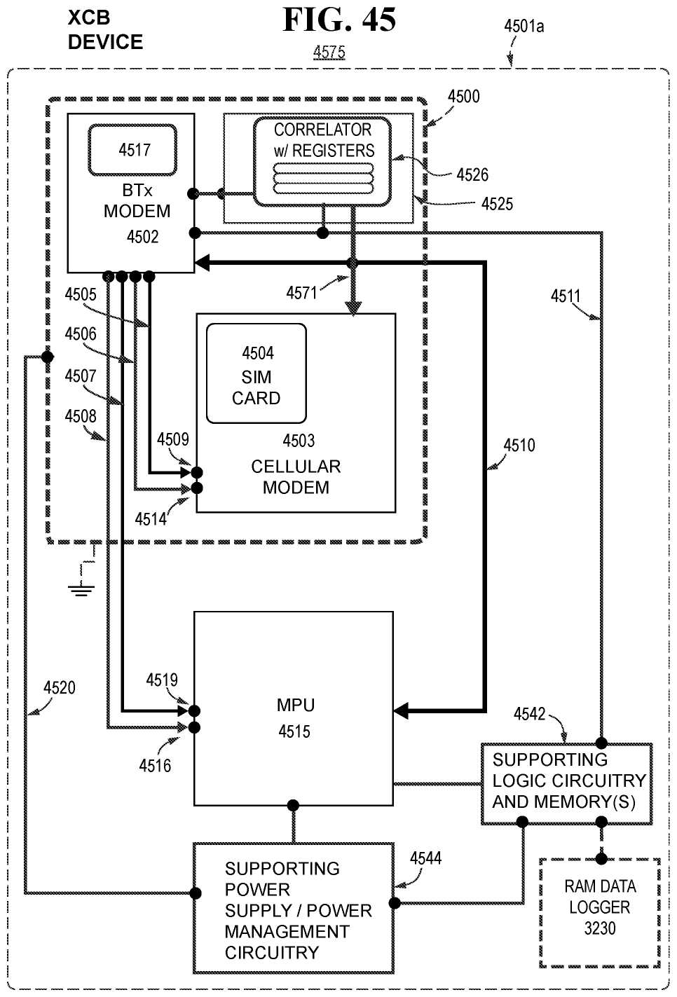

FIG. 44 shows a flow chart for the steps of a found/recovery method 4400 effected by a cloud host in cooperation with an XCB radiotag and the smartphone or other BT device of a passerby. This can be a global finder management service.

In an initial step 4401, a passerby will discover a lost smart object having an attached or embedded XCB radiotag unit. On inspection, the radiotag will be found to provide instructions for making a notification to a lost-and-found recovery service.

Generally, this will be an automated system operated as a cloud server. While it is possible to initiate a link to the cloud server by (1) scanning a QR code on the radiotag, for example, another actuation step for initiating a network link may involve (2) tapping the radiotag 3802 to create a distinctive output at a motion sensor in the radiotag; the signal wakes up the radiotag processor, or optionally activating the radiotag by (3) pressing a switch 1802,2302,1958 on the housing, or, if the smartphone includes a compatible processor or modem-executable application, (4) capturing a BT radio inquiry from the radiotag and according to the community identifier in the signal, forwarding a message with the BT radio unit identifier to the cloud host. Alternatively, (5) an NFC field of the radiotag is recognized by an NFC reader of the smartphone, and a limited amount of data sufficient to bootstrap a connection is exchanged using NFC signals.

In yet another activation method, the passerby (6) activates the XCB radiotag unit by bringing a BT radio device in their possession close to the XCB radiotag so that the XCB radiotag will detect that an “alien” BT signal is within a one-to-two meter range (4402), and that will trigger the radiotag to wake up the cellular modem and initiate a CALL HOME independently of the passerby's smartphone. Essentially, this is “walk up” computing, because the passerby will naturally bring their smartphone into close radio proximity just by picking up or touching the lost smart object;

Regardless, the initial data from the XCB radiotag can generate a deep intent link sent to the cloud server's webpage and/or can cause the smartphone browser to be taken to the webpage, where an automated assistant, chatbot, or human agent may provide found/recovery services.

In an initial report, the XCB radiotag will transmit its current location 4403a. Also transmitted is identifying data that is used to look up the radiotag and pull up a user profile.

By the smartphone (or the XCB radiotag), the initial link may be escalated to a cellular connection. When the task of reporting the lost radiotag is handled by the passerby's smartphone, the escalation may be by a bootstrapping process that is managed by a WebApp and begins with a hyperlink presented to the passerby with an invitation to help in return of the lost item, optionally with a reward (4403b). The escalated WLAN connection can bootstrapped via the BTLE radio of the XCB radiotag, and then via a Wi-Fi radio of the smartphone, or can be a direct cellular connection through the smartphone of the passerby, optionally using BT to link the radiotag into the call, or can be a direct cellular connection from the XCB radiotag to the cloud, while linking in the passerby's smartphone by pushing a browser link through a BT connection, for example.

Regardless, the net effect is that the cloud host will list the radiotag as having been reported at a location (the location can be provided by the passerby's smartphone or by the XCB radiotag GNSS, PoLTE or AGPS, for example) and generates a notification to the owner.

The intent is to facilitate a way to have the lost object returned to its owner 4404. As a way to protect the privacy of the passerby and the owner, the cloud host can set up a chat room so that some anonymous arrangement can be selected to recover the lost smart object or can provide a chat bot for mediating recovery. Assistance can be as simple as entering into a conversation or exchange of text messages with the owner to make arrangements to meet, for example. Or obtaining a mailing address. The cloud administrator can operate a pickup and delivery service if needed. A taxi driver or police officer can serve as an intermediary, as another example. The nature of the services 4405 is dependent on the goodwill of the passerby and the nature of the lost smart object. A variety of telecommunications and network-enabled services may be offered.

If the radiotag is attached to a child, for example, the police can assist. Pets also can receive assistance from authorities, and in some instances, an arrangement can be made to leave the smart object at a pre-arranged shop or office where the owner can go by and pick it up. The net effect is that the community can extend the search network to find a lost radiotag, and the XCB radiotag can facilitate or enable itself to be reunited with its true owner by engaging a cloud host directly or indirectly 436. The cloud host can also coordinate a reward to the passerby.

Minor variations in the method, for example, allow the owner to map the location where the smart object is found and to navigate a path to go there. Alternatively, the radiotag can adjust its power management so as to broadcast more frequent location updates to the cloud host, and the owner can catch up with the lost item even if it continues to move.

The method of operating a global lost-and-found service directed to reuniting the asset (for example a child or pet) with its true owner may include cloud services selected from: i) by the cloud server, sharing a chat link by which the true owner is enabled to arrange for return of the smart object, the chat link opening on a browser window of a first smartphone of a passerby who has activated the radio tag; ii) sending a voice message to the radio tag, causing the radio tag to audibly articulate the voice message in a speaker of the radio tag; iii) receiving from the radio tag, a voice reply audibly articulated into a microphone of the radio tag. A voice-over-Bluetooth (VoBT) link can also be established as a relay to carry a voice message to the radiotag or vice versa. Third parties may also be recruited to assist in re-joining the smart asset with its true owner.

### Example IX—Hybrid XCB Radiotag

FIG. 45 is a selected embodiment shown as a block diagram of a Novel XCB device with PCB 4501a containing a unique integrated circuit (IC,4500). The IC 4500 incorporates two radiosets, each with a modem that guides the transmit and receive protocols for the digital radios. The BTx radioset 4502 includes an antenna and oscillator optimized as known in the art to the 2.4 and/or 5 GHz ISM bands. The Cellular radioset 4503 includes for example a more complex antenna tree capable of broadcasts in multiple LTE or GSM bands that may vary with the jurisdiction for which the device is designed.

The SIM card (Subscriber Identity Module, 4504) is a sophisticated key that is recognized by a Cellular network access point available only to authorized users.

The IC combination 4500 of radiosets is designed for power management. Using power management signals 4505,4506 from the BTx modem 4502, the Cellular radio modem 4503 is insulated from what is otherwise an almost continuous stream of housekeeping and commercial messages that keep an open connection “hot” even when not in use. This “housekeeping traffic” has expanded to include spam, email, text, and data, including robocalls, much of which is unwanted, but consume battery 4544 nonetheless. Power saving mechanisms of the Cellular modem and network such as EDRX, PSM and SUSPEND reduce the duty cycle by permitting short gaps in the exchange of messages, but these gaps are typically a few seconds in length, or minutes at most unless extended network latency is acceptable. Given the higher power requirement for analog transmission and reception, the Cellular modem is at par with GNSS chips as an “energy hog” in radiotags. A sample TAU (Tracking Area Update) plot of power versus time to complete a LOGON and user validation was shown in U.S. Pat. No.

U.S. Ser. No. 11/184,858 (see FIG. 13 therein).

In a first embodiment, Cellular modem “wake up” is illustrated as a power savings mechanism. A more complete discussion of the required clocks is found in //www.thalesgroup.com/en/markets/digital-identity-and-security/iot/resources/developers/lpwan-module-configuration-and-timers-calculation, for example, and illustrates the AT command structure that is directed to the cellular modem processor and logic stack. During gaps in EDRX paging cycles and the extended deep sleep of SUSPEND or PSM mode, the Cellular modem cannot be reached by any network signal. It is dead to the world until the next paging window, and by then the network connection may have been lost or synchronization may have failed. In short, power savings can be achieved, but only by increasing network latency. The solution offered here is based on building into IC 4500 a “wake pin” (4509, sensu lato) driven by BTLE modem lead 4505 that activates the Cellular modem 4503 on demand.

The bitwise signal carried on conductor 4505 from the BT modem to the cellular modem may be an AT command, but the firmware of the cellular modem can instead be modified to recognize that when the “wake pin” 4509 goes high, it should activate itself and can self-initiate a network connection. When awakened, the cellular modem can communicate with an off-chip MPU 4515 as needed via databus 4510, and can send and receive information in its active connection with a cellular network. Data bus 4510 is not always on; the MPU 4515 may be placed in a sleep mode as a default state, and it is the BT modem that can activate both the cellular modem and the MPU via two wake pins 4509,4519, independently or in concert. In some instances, given the autonomy built into the cellular radio modem, the MPU may not be needed until a network connection is established and questions such as “Where am I?” or “Why was I awakened?” rise up in the logic stack. On chip 4500, by separately depositing an electrical connection 4505 from the BT modem to wake pin 4509 of the cellular modem and an electrical connection 4507 that connects off-chip to GPIO wake pin 4519 to the MPU, separate power control to the two processors (cellular modem 4503 and MPU 4515) is established and can be coordinated as needed. The BTx modem 4502, which is highly engineered for power management, is re-engineered to extend its power control to other functions of the device such as a block of functions (described here loosely as supporting logic circuitry and memory(s) 4542 and power management circuitry 4544). In short, the BTx modem, with its parsimonious energy budget, takes charge of power to the MPU, the cellular radio, and possibly other device functions such as a GNSS radio if supplied, so as to maximize the time between battery recharging cycles.

Control is not exclusive, during regular operation the MPU 4515 may also share commands, data and instructions with both the BT radioset and the Cellular radioset via bus 4510. But the resting state of a radiotag as useful in IoT applications is necessarily a standby mode at low power, and the design decision disclosed here is to establish that standby state by putting the MPU and the Cellular radioset to sleep as much as possible under power management implemented to depend in part on the BTx radio environment around the device and other sensor outputs. Sleep becomes the default state of the MPU and cellular radio modem. Power is restricted to clock and essential constitutive chip functions. The BTx and Cellular modems may share a low-jitter clock to simplify. The Cellular radioset may have periodic activity cycles in which it wakes up to report to the network and/or update its location (TAU) as needed, while spending most of its time in EDRX, PSM or SUSPEND sleep. The MPU may have periodic activity cycles in which it wakes up to perform maintenance of data archives in memory and sample sensor input, for example. But the BT radioset 4502 is able to maintain low energy surveillance of the proximate radio signal environment while controlling power to the entire device. The proximate radio environment includes signals from any proximate smartphone or radiotag, for example. If a signal is detected that requires system attention, the BT chip can wake up the Cellular radioset at 4509 to make a CALL HOME, or can wake up the MPU to process received signal matches according to a learning model developed with a customized library or log of familiar places to identify the location according to the BTx signal signature, and with data from the motion or heading sensors, then use a simple logic tree to decide whether to escalate a given radio contact or to just log it.

In some instances, the BTx radioset will cause the Cellular radioset to execute a CALL HOME to the cloud administrator, and following establishment of a network connection or TAU, instructions will be relayed to the MPU (and BTx radioset) directly from the Cellular radioset at 4571.

In one embodiment, IC 4500 may include supplemental hardware, firmware and memory 4525 for operating a matching algorithm in which radio contact signatures captured by the BTx modem 4502 are stored in a radio contact log, and then matched, using a correlator 4526 with registers that serve as a whitelist (or blacklist) of reference signatures based on the BT radio environment and its “familiarity index”. This can occur on the chip 4500 rather than in MPUi 4,515 and can involve flash memory and registers built into the chip for full interoperability between devices having various MPUs. The correlators include AND gates that trigger an output (45,4570 to the MPU and/or to the cellular modem when a match is found on a whitelist (or blacklist) or when a signal is received that has a characteristic such that a cellular network connection is desirable. For example, the package may discriminate calls received at HOME, calls received in transit through an alien environment, and calls at WORK. Each environment is defined by a BTx radio topology. Each environment is associated with a whitelist and a blacklist, and with an AI learning model that pipes unwanted or unsolicited calls to a network memory for further screening or promotes calls likely to be of immediate interest. Calls on the whitelist or of immediate interest result in a “wake up” to the cellular modem, calls on the blacklist are rejected. In this way, the XCB device can control its power consumption to achieve deployments with only one monthly recharge or less, without requiring a VPN as a shield against network intrusion. While a VPN is an effective mediator of reduced smartphone power consumption, it is not always cost effective, particularly for radiotag devices such as XCB device 4575.

In other embodiments, the needed RAM memory and correlators 4526 may be built into the BTx modem 4502. in some embodiments, the BTx radio modem and Cellular radio modem are supplied on separate chips and interact using firmware or software associated with the MPU, for example. In yet other embodiments, the radio contact package is network resident; however, this increases network traffic, hence it becomes desirable to design an edge computing package, a border router, or some means to limit the need for network resources to solve local power management problems.

As shown, the onboard radio contact record package 4525 has direct connections to the primary bus 4510 by which data is shared between the radios and the MPU 4515, and to supporting logic circuitry 4542. In the exemplary embodiment shown here, the BTx modem 4502 includes firmware 4517, but the device 4575 optionally also includes flash memory and registers 3230 for creating radio contact records and for comparing those records to whitelists, blacklists, or learning models when making response and location determinations according to the BT radio topology around the receiver.

Other parts of the circuitry may also be slaved to the BTx radio modem, and thus may be caused to be asleep or awake depending on the state of BTx traffic around the device. This is a unique way of looking at the architecture of a microelectronic device, but it builds on the notion that the radio signal environment or topology around the device is part of the device, is the glue that connects the device to the real world, is the “community” that drives the need for and value of XCB radiotag 4575, and as a matter of intelligent design, is the controlling stimulus that drives energy use and device function. Integration of the external radio environment and chipset(s) in IoT devices is a directed evolution in chip architecture illustrated here. As synthetic radio becomes more readily available, the chipset for cellular radio is not expected to change, but the BTLE chip may acquire other radio frequencies and capacity, such as for UWB, dual-band capacity, and MIMO, where the needed antennae can be built into the radiotag.

One advantage of a single chip IC 4500 with BT and Cellular radiosets and a separate MPU 4515 is borne out by the experience with BT consumer products in the market. Solid state radiosets do not evolve at the same rate as microprocessors and memory devices, so segregating the ICs provides a means for conserving costs when constructing next generation devices with newer MPUs or peripherals with fast evolution of security measures, in contrast to the slower evolution of analog devices.

In contrast to the inNovative design described here, the trend in the art has been to integrate all features as an SoC. The ESP32-S3 and -C2/3 SoC chip series (Expressif Systems, Shanghai CN) include an MPU and also BTx and Wi-Fi radios, for example, essentially a complete package, but a disadvantage is the inability to update the package design with a newer MPU without also rewriting code for the radios. By separating the radios onto a separate chip and attaching a bus for offloading data and memory to a MPU or MCU that is mounted on the PCB separately, the latest MPU or most efficient MCU 4515 can be easily substituted with minimal reprogramming of the radio interface. This is advantageous because MPU technology is evolving very quickly whereas radio chipsets evolve more slowly, if at all, over generations of products, in part because they must conform to regulatory standards for sharing the public airwaves and are thus constrained in ways that MPUs and MCUs are not.

IC 4500 is mountable on a PCB and leads are soldered to the needed antennae and logic connections. The antennae may be on the PCB or on a housing around the device. Flash memory size for registers and logs may vary according to the application, so in some instances expansion of the memory size may be accomplished by designing a series of chips 3230 each with larger memory or by including expansion ports that can be wired to larger memory units in parallel or series on board 4501a. The firmware is also expandable as needed, and generally, as coordinated by the MPU or a network administrator, can be upgraded via OTA to permit future upgrades.

Clocking is critical. In some instances, such as for the base layer of the BTx modem and cellular modem, the clock is part of the modem(s). The clocks of the BTx radiotag (not shown) execute GHz synchronization in an early stage of listening, and the earliest convergence between transmitter and receiver on an 8-bit preamble is entirely by chance, emphasizing the need for precision clocking. Spread spectrum bandwidth is distributed so that the preamble to a digital signal is sufficient to initiate a connection when two or more BT radiotags are within radio range and operating for a few microseconds on a common channel. Programmable scan settings for capturing the sending unit's preamble, instantly adjusting the gain, and demodulating the access code and remainder of the signal, which includes frequency hop and synchronization routines and also optional channel mapping instructions that allow the two devices to follow the transmission(s) while shifting channels in unison despite interference. Generally, BTx clock precision is quite good; scan intervals may be 10 msec or longer; packets are transmitted in 2.5 to 40 msec bursts, and using 2.4 or 5.0 GHz modulation, and achieve bit rates of up to 3 Mb/sec (up to 2 Mb/sec for BTLE). In fact, BTx radio modems may include multiple clocks. A low-jitter BT radiotag clock can do extra duty to provide a cellular clock signal and radio frequencies of cellular transmissions by clock division.

Alternatively, separate clocks may be provided for the BT and cellular modems and transmitters. But where synthetic radio is implemented, a high precision clock with multiple clock dividers is necessarily used, and may also clock other chip functions.

In the selected embodiment, dual radio chip 4500 receives power via lead 4520.

Power is typically gated at several levels so that some parts of the chip 4500 are not powered until needed. The correlators of the BT modem may require access to memory 4525 or 3230 (FIG. 32) in order to recognize signal patterns, that memory can be accessed via lead 4511 without mediation of the MPU, for example. In other instances, the memory 4525 is provided on-chip with the correlators and supporting firmware.

Persistent memory may require low power, and may be flash memory as is widely available and expansible.

The term “wake pin” (4505,4506) is used more broadly than would be connoted by “general purpose I/O pin” (GPIO), and may include any digital signal path or paths by which an instruction is introduced from the BT modem 4502 and executed by the cellular modem 4503 or the MPU 4515, for example, initially to wake the downstream chips from a sleep or idle mode. When a “wake signal” goes high, the receiving element may have all the needed instructions to respond, but in other instances, a digital key may be sent to the “wake pin” that includes one or more needed instructions to activate certain functions. In some instances, the received signal at the “wake pin” is an AT-command. Hierarchical control of power and wake states builds on the established capacity of the BTx chip to manage its power consumption at a subcircuit level, and extends that control to manage power to the cellular modem 4503 and the microprocessor 4515. Thus the microprocessor is no longer the sole master of the logic stack, but instead is in a hierarchical relationship in which its tasks may be initiated by a radio contact event, a wake signal, or other clock signal from the BTx modem 4502. Most instructions executed by the BTx modem are encoded in firmware whereas the microprocessor may access a combination of volatile and non-volatile memory, including flash memory. The cellular modem is better suited for transmitting secure firmware updates from network, but local updates can be performed over the BTx radio. GNSS radios and location processing circuitry are often incorporated into the Cellular radioset in the die, and may be included here on-chip.

In environments where security threats are low, IC 4200 may include leads for sending inhibitory signals 4506,4508 that reduce power consumption by the Cellular modem and the MCU by direct action on “sleep pins” 4514,4516. The user may dial in a comfort zone in which interruptions via a smart device are deliberately ignored unless a signal at a correlator is on a selected whitelist. Such a correlator necessarily is coupled to the SIM card 4504 and the Cellular modem 4303 directly.

With evolution, a circuit as described in FIG. 45, 4500 may also be used in smartphones to extend battery life. An adaptive EDRX mode for smartphones, using the BTx companion device to adjust the power mode of the Cellular network connection, can be implemented as a first step in this evolution.

A simpler duplex radio device is shown in FIG. 17 of U.S. Pat. No. 11,678,141, which shows a Wi-Fi radio (or other LAN radio) operatively coupled to a BTx radio modem in a portable radiotag, said patent document being incorporated by reference in full for all that it teaches. A family of tri-radio SoC from NXP Semiconductors (Eindhoven, Netherlands) features a BTx wake-up of a Wi-Fi radio modem when packaged with an SDIO processor.

XCB devices that encounter malicious code will report local radio devices to a network administrator. Proximity alerts and radio contact logs can then be used to quarantine and disinfect the infected devices.

### Example X—NXP IW612 for Hybrid XWB Radiotag

FIG. 46 shows a hybrid XWB radiotag 4600e in schematic view with tri-radio 4601 plus satellite transceiver 4616 and RAM data logger 3230. The device uses local radio topology-control of power consumption. As a unique feature, the BTx radio modem 4602 and Wi-Fi/6LoWPAN modems 4603 operate with IPv6 Addressing but with RFC 4944 and RFC 6282 protocols to compress headers and increase throughput for the 6LoWPAN signal. The radio modems 4602,4603 are integrated on a single chip 4601 with shared clock and power supply. A suitable chip is the IW612 from NXP Semiconductor (Taiwan, TW), which interestingly, includes an antenna design suitable for concurrent operation of the BTx and Wi-Fi radios in the ISM band. The combination is also available as an SoC marketed as NXP88W9098, which has been modularized in a sub-centimeter package by Murata Manufacturing (Kyoto, JP) without processor.

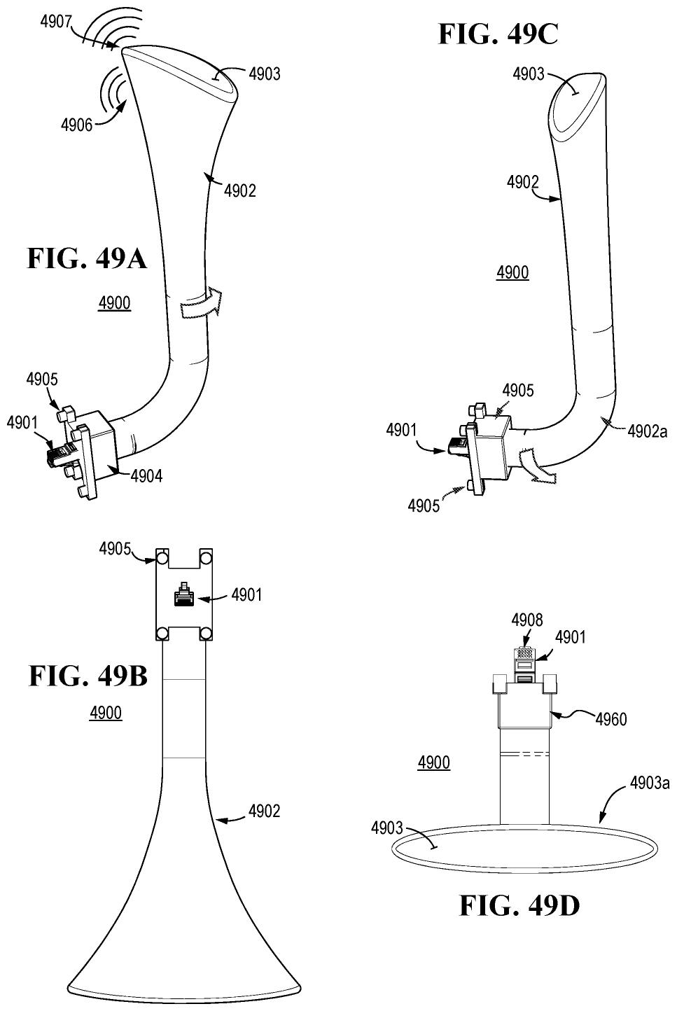

In this device 4600e, there is no cellular modem analogous to that seen in FIG. 45 (4503) because the device engages the satellite layer 2205 directly, and can be routed from there as needed for telecomm or other cloud communications. While this would seem counterintuitive given the widespread use of handsets, the system 5000 (FIG. 48) is evolved away from the handsets used and controlled by telecomm utilities, building on the IoT layer 2202 as a global networking function with alternative wireless infrastructure supplied by a deeper satellite resource layer. Direct satellite access also ensures a strong option for finding and reporting location directly by global satellite navigation tools.

A data upload of BTx radio contact information from memory to the cloud is made using the satellite transceiver 4616 and associated Kₐ/Kᵤ band antenna 4616a in this first embodiment. The SoC 4616 and supporting circuitry is for use with a portable battery. A chip supplier is the 28 nm STiD337 satellite transceiver from ST Microelectronics (Tamarac, FL). The satellite chip does not require GNSS and is operative with UART or Ethernet. The object of device 4600e is to supplement a BTx radiotag with Wi-Fi and Satellite connectivity in a desktop or rooftop package in a first instance and as a portable pocket-sized package in a second instance.

The integration of Wi-Fi radio or 6LoWPAN radio into a network broadly in layer 2202 requires widespread adoption of a suitable Access Point, provided separately. A home or business modem may contain a Wi-Fi Access Point. Thread mesh networking in and across layer 2202 to layer 2204 is supported. A compatible MPU is supplied separately and the radio interface is SDIO, easing development of IoT applications that can be installed on smartphones, but are not dependent on smartphones for deployment of the devices.

Device 4600e is also a next generation device in a preferred embodiment, as is described with reference to FIG. 47, and is seen here in a network role as an IP Addressable member of the IoT layer 4703,2202 (FIG. 23A) with potential, given sufficient power to transmit to an Access Point or to shortcut communications directly to VPN 4705 or cloud host 4707, to disrupt all or any of the Internet, WWW search, AI, and location services markets by opening services without a subscription model.

The device includes three or four dedicated antenna, a BTx antenna 4602a, a Wi-Fi antenna 4603a, satellite antenna 4616a (described above), optionally dual antennae for Wi-Fi and 6LoWPAN. A GNSS chip 4650 and antenna 4650a may also be provided as an option for pocket-sized devices. The Wi-Fi antenna system may include a switch and amplifier 4622 that operates for low power (<10 dBm) and high power (>20 dBm) as is useful for WAN use. Limited battery life limits deployment for wearables, but it is desirable to have more and larger numbers of Access Points throughout the IoT layer 4703,2202 (FIGS. 22,23A,23B).

The device includes an MPU 4630 with leads to the tri-radio package supporting BTx 4605 and Wi-Fi 4606 traffic. Radio data may be shared 4607a and on bus 4607b. Radio data is also reported to a co-processor with RAM and smart correlators 4609 that functions cooperatively with data logger assembly 3230 and is termed here a “RAM data logger” 3230 as a description of a function that may be implemented in a variety of ways. Data received by the radios is matched for patterns with radio contact records in memory and any correlations in bitstring content, user identifier, community identifier, generic character and content of a message, or patterns in message tempo are communicated to MPU 4630. The RAM data logger 3230 may function to complement the MPU in processing of radio topology, and maintains a radio call log as described in EXAMPLE VIII. The radio call log may be fed to a cloud host and the MCU, RAM data logger and smart correlators may receive a “learned model” as a download from the cloud host, wherein the model is used to better or more inclusively interpret and act on (i.e., as an instruction set and supporting content for edge computing of location-based services) the radio contact log entries and patterns as is a virtuous cycle of learning that makes this a living, learning network rather than a mere machine learning server farm.

This XWB unit is provided with a rechargeable battery 4660 and power source 4661 for recharging the battery. The battery is protected by a power regulator 4662. While not shown, a USB-C port can serve the functions of both recharging the battery and port for serial data exchange with the microprocessor. In other embodiments, the XWB unit may be a hub as would be wired to a home or in a vehicle, and may be powered by solar with battery backup, for example.

In some embodiments, power source 4661 can function as a power-over-data connector. Two options achieve this: a USB-C connector or a power-over-Ethernet (PoE) adaptor with RJ45 connector, providing up to 100 W if needed. Data is split from power and connection 4606a is provided directly as a bus or star network from the chip 4690 to the MPU 4630 and to the radioset 4601, providing flexibility in applications where data processing is secondary to data transmission and reception, such as the satellite hookup described in Example XIV. For this purpose, adaptor 4690 is included that functions as an Ethernet data encoder/decoder (ENDEC). CAT 6 is a common cable standard and may be used in full duplex mode. Optionally a USB data adaptor with UART (not shown) may be used.

MPU 4630 is helpful in operating a suite of optional peripherals, including a display 4635 and display driver 4635a, which may be a single LED, multiple RGB LEDs, an LCD, or even an OLED display screen, for example, depending on the application and available power. Also included is a microphone 4634 and driver 4634a used for dictating messages, and a speaker 4633 and speaker driver 4633a for audio. A piezo buzzer, vibrator or LC bell is included 4632 with driver 4632a for simple audio notifications.

The MCU also may be provided with one or more sensors 4640, including motion and heading sensors for example, and one or more switches 4641 that function as sensors, such as for sensing commands from a user. The switches, display, buzzer, microphone and speaker form a user interface (UI). Other more complex setup and programmable tasks may be performed by installing a surrogate full user interface on a smart device 3730b, wirelessly linking the smart device to the MPU, and programming features and instructions to the radiotag remotely on the surrogate interface, instructions and user profile data that is then stored in memory 4670. Flash memory is provided for storing an instruction set and can be rewritten as needed. Volatile data buffering for the microprocessor or co-processor is generally provided by cache RAM 4631. The MCU may also include support for vector matrix instructions, as is useful for acceleration of neural network computing and the signal processing workloads associated with matrix pattern matching calculations.

As outlined in FIG. 48A, the device is part of a larger system in which IoT data is captured, much of it in the form of geostamped and timestamped radio contact records and sensor data, and that data is upswitched to a cloud so that it can be used in training a learning model to predict events and outcomes, but that learning model, as it evolves in quality and specificity, is exported as a “learned model” back to IoT nodes such as XWB device 4575,4600e,1601a where the firmware or code is executed using realtime sensor and radio contact log entries to predict events and outcomes locally and to make location-based decisions. The object is to reduce the traffic on the web and especially, to reduce the latency in the decision tree about whether and when to notify or alert the user about location-specific information. The learned model includes a general frame of context for community matters and a specific personal frame of context for individual user matters. While the learned model is not learning as installed as it it interacts in real time with the user in a device node, recorded data is being sent periodically to the cloud so that a refined learned model will be available in a subsequent release, evolving as a part of system 5000. The learned model may be distributed in device hardware and software for compactness, with some instructions in the RAM data logger 3230, some in smart correlators 4525,4609 (by which the smart correlators get smarter), some in MPU cache memory 4515,4631, some in reference or cache memory 4670, or in the form of firmware, keys and values in memory slots in hardware. The learned model renewal cycle also updates security and encryption features and is in its essence a living, growing cybernetic superorganism at the heart of system 5000.

As currently deployed, conventional systems provide for limited cloud-to-smart device (and smart device-to-cloud) communication over a cellular network using SIM authenticated devices. In the XWB radiotag 4600e, BTx is the more commonly chosen vehicle for communication from smart device-to-radiotag and radiotag-to-smart device.

The consequences are striking. BTx is a promiscuous radio technology and can communicate with any other BTx radioset directly. Thus the BT radioset 1800a,1601,4575,4600e will be able to sense and to connect with all BTx radiosets in radio proximity, and the cellular radioset 3270b will have a limited but direct pipeline to the cloud host and a telecomm service provider. In the systems 5000, the organism has several neural networks in synergic contact with the cloud layer 2204. Not all these networks are conducted through the SIM layer (termed here DMZ LAYER 2203), but instead shared in ground-to-satellite, cable-to-Access Point, wireless-to-Access Point, and any other IP Data Packet-enabled bitstream that can be received by a cloud or cloud VPN. Dispersion of learned models back to the IoT nodes, as may be conducted on multiple channels over multiple media, will also result in evolution of cloud algorithms using AI learning model processes.

The proximate radio environment 2202 and 2203 that floods the IoT nodes includes signals from proximate smartphones or radiotags, for example. If a signal is detected that requires system attention, the BT chip 4601 can wake up the MCU at 4630 or wake up the Wi-Fi radio at 4603,4607b to make a CALL HOME via Wi-Fi “call-home-over-internet” (CHOI), or can wake up the MCU to get a GNSS location fix, or can initiate a correlator process on a library or log of familiar places to identify the current location according to the radio topology signature, and with data from the motion or heading sensors, then use a simple logic tree to decide whether to escalate the radio contact or wait for further development. Power is supplied to IC chip 4601 via pin 4420 and is shared by the tri-radio modems, but beyond basic standby power, the radios share sleep and standby modems unless either routine wake activity is scheduled with the network, a sensor anomaly occurs, or the radio signal environment or topology around the device shows a pattern that suggests a change has occurred or is about to occur that will merit a notification or an intervention in the form of a remote machine or network activity. While the system parts periodically wake up to provide needed maintenance, the primary state of the network is sleep, and network reactivity is carefully monitored by Cloud AI resources to detect anomalous electrical activity, patterns in the ether, and adjust network tone and latency accordingly.

The individual devices, BTx radioset, Wi-Fi/6LoWPAN radiosets and processor may share sensor data and power on a Power-over-Ethernet bus 4606, and in some embodiments, the BT modem may have a logic stack that pre-disposes it to analyze and act on BT radio contact data according to a sensor context more broadly, but in many instances, the BTx modem and the MPU have stacks that act convergently to achieve a programmed active state with generally more than one resting or sleep mode nested in the form of a cascading energy state.

In one embodiment, during up time, the MCU will collect BTx “radio snapshots” from the BTx radioset and log them as radio contacts, optionally with timestamp, location and sensor data. Comparator 4609 or data logger 3230 at the level of the MCU (or the BT radio modem) is used to determine whether the bitstrings in registers match a known location with a threshold probability to make a location determination, or otherwise classify the location. The radio contact data and any location data may be collected and periodically uploaded to the cloud for archiving and analysis, but this is preferably only for training purposes because network latency is a restrictive performance criterion in routing data and instructions. Cloud administrative services provided as part of the global finding and tracking network 4700 will include notifications to parties of interest if a familiar pattern or a data anomaly is detected in a local environment, community or region. Specific user protocols are also active. Users can be notified when a partner or pet enters radio proximity, for example, or alerted if the partner or pet has left or is leaving radio proximity. At the satellite level, radar data may be coupled to cloud sensors as needed to provide early notifications of incoming missiles, firestorms, for example, or whatever information needs immediate dissemination. Hedy Lamarr's U.S. Pat. No. 2,292,387 (to Markey), which taught BTx radio signalling in wartime, is incorporated here in full by reference for all that it teaches, with the note that the spread spectrum achieves its modern application in overcoming electrical interference, even in dense network environments, and has demonstrated remarkable capacity for encryption, if desirable and necessary, without use of blockchain or other high bandwidth technologies.

In conventional devices, services may use RSSI to detect LEFT BEHIND items, to establish safe zones, and to create radio leashes. However, the RSSI signals output by conventional BT devices are quite noisy and discreditable (for a number of reasons) and the most straightforward solution to the noise has been to implement a time filter in which a persistently rising, falling or lost RSSI over several minutes results in a notification. However, by correlating and analyzing radio contact data in real time at the local level for patterns that include Bayesian “loss prevention indicia”, the network latency of a time filter, which can require several minutes, can be eliminated and notifications are provided in 10 to 20 seconds for stable detection of a pattern shift when two or more signals are monitored as a group, or when a companion radio contact log history shows the discrepancy in real time (such as for a cluster of radiotags, FIG. 13). As we advance to 9, 7 or even 5 nm chip architectures in radiotag builds, the device energy consumption will be reduced, but by enabling remote IoT device nodes of layer 2202 to practice AI learned models, the energy savings are orders of magnitude greater because the level of traffic is what is throttled—while increasing the quality of radio traffic—a necessary engineering Q-factor for reducing processing resources. Increased demand is not unbounded demand, there is a symbiosis that results, the superorganism finds a saturation point where demand and cost are optimized for essential functions plus a budget for emergencies, and a budget for exploration. Reserve capacity is highest in a system that rewards parsimony of use.

Misuse is also surveilled. Whitelisting can be complemented by blacklisting, which may avert unwanted or dangerous situations, such as a family's youngsters hanging out at a place of misfortune, just as an example. The cloud host would receive data from a child's smartphone, XCB or XWB and the cloud host will supply a notification to the parents. Similarly, a dog that persists in returning to a problematic location can be tagged and tracked. In each case, the user collects a library of radio signatures or snapshots, programs a conditional rule or command with any new radio data that matches a pattern in the library, and the system takes over automated monitoring and execution of the rule.

Security threats are reduced. On each cloud cycle, after the radio contact data from individual nodes is uploaded to cloud administrative servers, the cyclical renewal of onboarding is an opportunity for renewing individual device provisioning with secure encryption and identifiers, for example a resolvable private address renewal cycle.

As for network protection from virus and malware attacks, from radio traffic containing anomalous signals reported to the cloud, along with any snippets of code captured as bitstrings, initial experimentation with a fuller, collectively captured image of the virus or malicious executable in a cloud sandbox is followed by immediate dissemination of a prophylactic or immune response to all available devices in radio proximity. In one instance, an anti-malware kit may be downloaded and installed if the community monitoring program detects spread of a Novel malicious code snippet in the radio ecosystem. For example, the protocol includes automated indexing of an Internet security threat level deduced from the log entries (comprising categorizing each of the log entries as familiar or alien), and in response to the threat level, a stepwise loosening or tightening of security measures. Security is loosened stepwise in familiar locations and tightened in alien locations according to an index that weights the number of whitelist matches, the number of blacklist matches, and the number of unmatchable log entries at a programmable confidence level, for example.

### Example XI—Global Location Services Management

FIG. 47 is an overview of a Global Lost-And-Found system 4700 that includes a network with associated community of users, and shows here the basic concepts of “cloud shortcutting”. Two of a plurality of community users are represented by their companion smartphones 3270a and 3270b. At the top of the network (above dashed line 4702) are found the cloud hosts, servers and fixed network hardware of the backbone of a global Internet network. The cloud/Internet 4704 is an IP Packet Data environment consisting of wired and wireless devices that make up a Global Area Network (GAN). The GAN may include gateways (VPN, 4705) that define private IP channels carved out from the Internet and a plurality of cloud hosts represented by clouds 4706,4707. The cloud/Internet and VPNs interface as server engines (represented by servers 4708,4709) that define “cloud hosts”. In this instance, the cloud host 4707 is a dedicated administrative host for operating the global lost-and-found system 4700. Multiple cloud servers and “cloud assistants” may be used to administer the system. As part of system 4700, cloud host 4707 includes databases 4710 and network resources 4711 that maintain user profiles and track tracking device locations. Below dashed line 4702 and above dashed line 4703 are found portable devices that make up the portable cellular and Wi-Fi layer of a system network architecture. Implicit in this structure are the base stations of the telecomm companies, Starlink satellites, Access Points, modems, and portals of cable companies that route traffic between user handsets, Wi-Fi and 6LoWPAN devices, and cloud resources. This layer may also include XCB devices 4775 and in some instances, XWB devices 4600e (those with higher powered signal capacity). Below dashed line 4703 are found IoT devices with limited broadcast range, such as the BT tracking devices 1800a,1800b,1800c,1501,1502,1601,2359,2360,4600e (and so forth, FIGS. 23A/B) described above. In Cellular 5G+, this layer is expanded to include fixed installations of many kinds of devices that operate in allocated 5 GHz, 6-7 GHz, 11 GHz and 28 GHz bands, for example, including UWB.

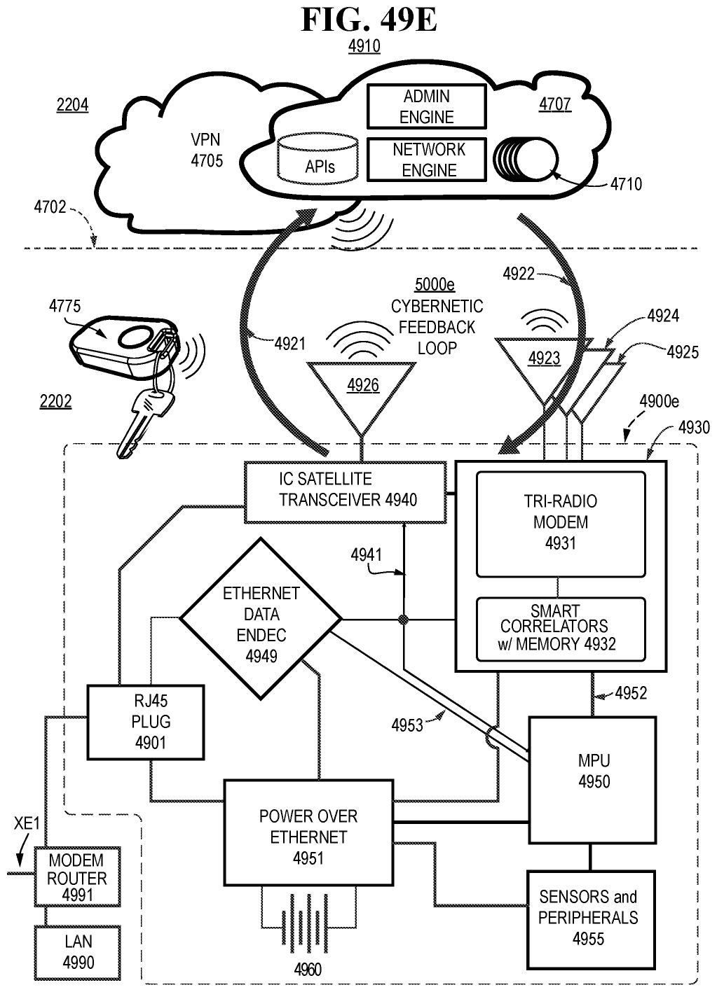

Device 4600e is also a next generation device, as was described with reference to FIG. 46, and seen here in a network role as an IP Addressable member of the IoT layer 2202 with potential, given sufficient power, to shortcut communications 478 directly to VPN 4705, for example, a radical new vision that bypasses the dependency of portable devices on SIM-card devices 3270a,3270b,4575,4775 of layer 2203. In this example, device 4600e is illustrated as a battery-powered tracking device unit with hybrid tri-radio BTx/Wi-Fi radioset provided by the NXP IW612 SoC (4931, FIG. 49E) with satellite transceiver provided by the ORCA3990 endpoint ASIC (4616, FIGS. 46,49E).

Information in signals from BTx devices also can be relayed to the cloud layer by use of intermediary handsets and XCB devices, which have both BT and Cellular transceivers. As presently practiced, Cellular and Wi-Fi make up the bulk of the bandwidth available for moving information and commands between the bottom wireless device layer 2202 and the cloud host layer 2204 through the bottleneck of signal confluence (2210, FIG. 22). Given that rapid expansion of 5G+ alternatives and the IoT is expected in this decade, as more 5G bandwidth is deployed, additional device types are able to link within the layers or from layer 2202 to layer 2204 and particularly directly to VPN 4705 and directly or indirectly to cloud host 4707, which hosts the APIs and data transfer means of the global lost-and-found system 4700.

As a first illustration, handset 3270b, tracking devices 1800a,1800b,1800c and 4600e can be considered as a group (box, dashed border 4751), representing devices owned by a common owner. The handset 3270b includes a PROGRAM 4760 for operating the tracking devices as part of the global lost-and-found system. Bold arrows indicate bidirectional information links. Handset 3270b is able to communicate with XCB radiotag 4575,4775 and directly with VPN 4705 in the cloud layer, and with devices 1800a,1800b,1800c and 4600e in the IoT layer. We can assume that the IoT devices can form mesh networks 4790 for intercommunication, and that the handset can also detect any discoverable or undiscoverable BTx transmitter in the IoT layer. Program 4760, when installed on a handset, enables the handset to report detections of BTx devices to the VPN 4705 and to receive cloud-supported, crowd-sourced lost-and-found services. Similarly, handset 3270a is also able to detect most BTx devices in the IoT layer, and for this example, also has the program 4760 for reporting BTx detections to the VPN. The initial disclosure of this software tool is published in U.S. Pat. Nos. 9,392,404, 9,564,774, 9,774,410, 9,892,626, and 10,580,281 et seq.

Connections 4771,4772 connect the owner's smartphone 3270b with the VPN 4705 and cloud host 4706 via a cellular telephone network (or Wi-Fi hotspot). Bluetooth radio data is packeted, but the packets are not directly compatible with the cloud layer IP network 2204/4704. The smartphone App 4760 may include software that parses BTx data packets, extracts radio contact data, and forwards relevant information to the cloud host for processing by servers 4708,4709, which can be reached via VPN 4705 or other cloud internet connection 4773.

Similarly, when handset 3270a detects BTx tracking device 1800c, it parses the advertising signal and may send the relevant data, with timestamp and geostamp, to the cloud host 4707, directly or indirectly. Thus if tracking device 1800c is separated from its group and is reported lost in database 4710, the cloud administrative engine 4709 will recognize the lost status and report the location data to the owner by sending a notification to the owner's smartphone 3270b. Note that the data interconnections are all bidirectional, unlike early uses of Bluetooth radio beacons in which advertising signals were sent unidirectionally. The smartphone 3270b may also send commands to the BTx devices 1800a,1800b,1800c and 4600e. In one scenario, the owner may send a command to the lost radiotag to initiate an alarm display, or in more sophisticated tracking devices such as the XCB radiotags 4575,4775 and XWB radiotags 4600e, the owner can initiate a call home from the radiotag, or even be put in touch with a bystander who comes close to the radiotag, as was described stepwise with options in FIG. 44, 4400. In another related instance, the call home can occur if sensor information is anomalous, and the call home can be responded to by the cloud administrator, or by a concerned friend or relative, for example.

In advertising mode, each BT tracking device 1800a,1800b,1800c,4600e uses its core BT transceiver to broadcast a periodic radiobeacon signal with information including the identity of the tracking device (whether encrypted or not) and may also include any information from onboard sensors of the respective tracking devices.

Samples of signal payloads that include information 2850 such as sensor data, radio identifiers, battery reserve, transmission power, and piconet status, for example, were shown in FIGS. 25 through 29 and FIGS. 39 through 42. Representative means for decoding the information are shown in FIGS. 37 and 38. The BT beacon signals have a range dependent on transmission power, but the range can be 100 ft to 100 yards, for example. While 6LoWPAN signals may be boosted to 10 dBm or 20 dBm, BT signals are commonly transmitted at 0-4 dBm to sustain battery life. Smartphones have the advantage that they commonly include AGPS, Position over Cellular, or GNSS means for adding a geostamp to a qualified BT signal. Thus the capacity to field a host of smartphones and other devices that can intercept BTx transmissions and forward them to a cloud host configured to decode and act on the latent and explicit location information in the forwarded messages realizes a global lost-and-found service 4700.

The BTx device transmissions may be monitored by the smartphone, XCB or XWB radiotag on a regular basis. The smartphone will typically add a timestamp to a received transmission and may also add a geostamp before forwarding any relevant information to the cloud host. In this way, the system is able to track the BTx devices 1800a,1800b,1800c,4775,4600e as shown in FIG. 47, but also BTx devices of strangers. Given the three billion or so smartphone users on the planet (some users have multiple subscriptions), and the fifty billion or so BTx devices, this information is very useful in finding lost items.

If the smartphone 3270b loses track of BT device 1800c by loss of signal 4774, the system will rely on a community smart device 3270a (a “bystander,” box 4752) to report a location where the lost device was detected. The system can extrapolate waypoints and possible places where a search can be directed. Community smart device 3720a includes a BT radio and is enabled to listen for BTx radio traffic and to forward relevant information, generally encoded, using installed program 4760. When in BT radio proximity, community smart device 3270a will receive the beacon broadcast from the tracking device 1800c and can relay the information in a transmission 4776 to the designated host 4707, directly or indirectly, such as via gateway 4705, and the transmission can include a GNSS location added by smart device 3270a when the radio contact was made. The smart device 3270a does not need permission to receive and forward the advertising signal information broadcast by device 1800c. As long as the control program 4760 is running, the beacon signal from any of the tracking devices 1800a,1800b,1800c,4600e will be received and forwarded. Generally, the bystander's smart device will add a timestamp and a location stamp and can encrypt the data per instructions in program 4760, which may be periodically updated by OTA firmware updates and may be fitted with tamper-resistant features such as capacity to support resolvable private addresses.

The smart device may also add other information (such as sensor output from sensors onboard the smart device) to a “record” of the radio contact before forwarding the record to the cloud host. The retransmission of beacon information by smart device 3270a imposes no hardship on the community member because each smart device regularly transmits a signal and data to the cellular network as part of maintaining a network connection, but the community member receives a reciprocal benefit when the roles are reversed. The forwarding of data can be handled in background as described in U.S. Pat. Nos. 9,774,410, 9,900,119, 10063331, 10371800, 10389459 and 10937286 et seq, which are co-owned at the time of filing and are incorporated in full by reference for all their teachings. The forwarding of beacon signals may occur even if device 1800c is not reported as lost by the owner, but the cloud host will look up records associated with its radio unit identifier, determine the owner, determine whether the device is reported as lost, and if lost, then will notify the owner and assist in recovery of the lost device. The cloud host may also have the intelligence to send a notification if the device meets criteria suggesting the device is lost—before the owner realizes it. The notification to the owner may include an option to display a map showing the approximate last known location of the lost device (for example with a map pin as suggested in FIG. 36). The system will also aggregate multiple reports of radio contacts with the lost device and can present those as a consensus location if the device is stationary, or as a trail of waypoints if the device is on the move.

Smartphone 3270b may also be enabled to track XCB device 4575,4775 using a BTs radio link 4777, but beyond the limited range of the BT radios, the system will rely on the cellular radio of the XCB device for periodic location reports if all permissions have been provided. If the smartphone 3270b loses track of the XCB device, the system will still receive periodic location data via cellular link 4778 because the XCB device is programmable to make an autonomous cellular network connection with server 4707.

In fact, XCB device 4775 is able to manage a group (box 4753) without a smartphone in the loop. In this instance, the group consists of devices 1800a,1800b and 4775 under common ownership and routinely reporting to the cloud host 4707 via virtual private gateway 4705. The cloud host tracks not only cellular XCB radiotag 4775 but also BTx tracking devices 1800a,1800b which are in a mesh network with the XCB device. The XCB radiotag is able to report location independently using one or more location services selected from GNSS, AGPS, PoLTE, and so forth and can CALL HOME 4778 if conditions meet the programmable criteria of a conditional rule. The XCB radiotag 4775 is locatable both by its BTx beacon signal, but also by its cellular network connection in a cellular network. As long as the BTx radio contact is maintained within the group 4753, the approximate location of the three devices is known to the system 4700. If the XCB device is forwarding information to the cloud host from the BTx devices 1800a,1800b, and that information includes motion sensor output, then the system can monitor the relative motion of the devices, and infer a “left behind” or a “lost” condition from the data even before radio contact is lost (as described in U.S. Pat. No. 11,792,605).

Groups 4751 and 4753 may be permitted to co-exist. A bonding relationship between the smartphone 3270b and BTx devices 1800a,1800b,1800c defines a “piconet” in the memory of the BTx devices (as peripherals) and the smartphone (as central). The program operated by the smartphone permits sharing of BTx devices with others, but in some coding scenarios, the access codes may be changed so that XCB device 4775 cannot serve as a central if the BT devices have already been “claimed” by smartphone 3270b. A flag may be inserted in the broadcast of the BTx device that marks it as a claimed device. However, the BT SIG standard also permits BTx devices to participate in two or more piconets using time-division multiplexing, so groups represented by boxes 4751 and 4753 can be formed and operate independently if coded to operate as separate groups, more broadly considered as a scatternet.

Interestingly, smartphone 3270a may be granted privileges at the cloud level to send commands to BTx devices 1800a,1800b via XCB radiotag 4775 in this model, for example if smartphone 3270a is operated by a friend or associate who works with the owner of smartphone 3270b. As conventionally deployed, the BTx devices will change their access codes once they have bonded to an owner's control apparatus 3270b and will not be detectable by passersby (bystanders), but when that bonded link is broken, the devices will again begin transmitting a general advertising beacon signal with access code GIAC that can be detected by smart device 3270a. Also, by modifying the BT stack, the devices may pick up undiscoverable radiotag traffic by intercepting the signal preamble and processing an arbitrary number of bits following the preamble, as was discussed with reference to FIG. 37, 2500a.

At another level, all of the devices 3270a,3270b, and 4575,4775 may be operated (i.e., may be programmed) to sweep up BTx radio contacts and report them to the cloud host 4707. The XCB radiotag, as it moves through a workday, may encounter and report a series of radio contacts with devices having the preamble characteristic that qualifies the signals as BT signals for reporting to the cloud host. While not shown, tracking devices owned by other community members will be included in these sweeps. Thus the net effect of deployment of the system is to convert the middle layer of the diagram, between dashed lines 4702 and 4703 into a large machine for detecting and reporting BT radio units. These radio contacts are reported via the cellular links 4771,4772,4776,4778,4779 and via 6LoWPAN link 4780, or by various Wi-Fi reporting stations. Radio contact information can also be transferred laterally as BTx packet data, for example via link 4790, from the XCB radiotags via BTx links 4777 to their more powerful cousins, smartphone 3270b and (if permitted) smartphone 3270a. In some instances, the system will rely on location data generated by the community smartphone 3270a or the owner's smartphone 3270b, but the XCB radiotag 4575,4775 may also generate an autonomous location fix, and as described here with reference to EXAMPLE VII, the location information can be sourced explicitly or by inference, by geolocation or by radio signal pattern recognition.

If tracking devices 1800a,1800b,1800c and XCB radiotag 4775 define a group having four members, then the XCB radiotag 4775 has the capacity to report its current location to the host server 4707 via links 4778,4779 or directly to the owner's smartphone (via link 4777), and to monitor the radio proximity (and hence the approximate locations) of the remaining radiotags of the group. We have shown that use of a virtual private gateway (VPN, 4705) in making these location reports can be structured to ensure privacy and also to dramatically cuts the energy budget for cellular connectivity when compared to the telecommunications link 4771 on smartphone 3270b.

Smartphones use a significant amount of power for network traffic, much of which is clutter or exploitive marketing. Use of a VPN reduces this traffic markedly. VPNs can be used with access point names (APNs) as private static IP addresses to tunnel traffic to individual devices; the potential is clear, but the issue has been the hardware.

By adding processing power to the XCB radiotags, network traffic can be further reduced. Local processing of received sensor data from the members of the group permits some inferences about group cohesion to be made locally, either by the XCB radiotag 4575,4775 or by the smartphone 3270b. By using the processing power of the XWB radiotags 4600e, locally derived inferences that approach “situational awareness” can be used to manage energy consumption, for example security, which may not be needed if the devices are essentially air gapped by a remote or insulated location, and can limit interruptions by using the XWB device to screen calls. Capacity of the system to limit “wake up” of a smartphone is discussed in now U.S. Pat. No. 11,170,338, titled “Cellular Devices, Systems and Methods for Logistics Support”), which is incorporated herein in full by reference.

Using data forwarded to the cloud, the host server 4707 can also assess radio proximity as measured by BT radio signal strength or heading data and can issue an alert if the signal strength or heading direction is not copacetic between any two tracking devices, as would occur if the devices are not moving with the same direction or speed.

Accelerometric data is useful for this purpose, but heading sensor output from an integrated sensor package that corrects the heading output for tumbling and random motion (by use of solid state gyroscopic and magnetic compass sensor output) refines the capacity of the system to detect motion anomalies that are correlated with divergence of members of the group from the owner's path, for example, such that a “left behind” or “wayward device” notification are issued within 10 to 20 seconds, as was discussed in EXAMPLE VII and in relation to FIG. 42.

Connections 4791,4792,4793,4794,4795,4796 to BTx tracking devices are bidirectional, and may be used to send commands from a local handset or relayed from a cloud host. In some instances, the commands are relayed over a BT radio link, and in other instances the commands are relayed over cellular connections. While not within the scope of this filing, Wi-Fi radios such as Zigbee, and WPAN radios generally may also be used to share data and commands.

Snapshots of radio contact data shared in a group or shared with the cloud host may be used to generate notifications or commands to a smartphone or to a remote machine for execution. Conditional logic is used to pair a trigger signal in the received information with a command or notification to be executed. And using the user interface provided on smartphone 3270b, the executables may be programmable by users. Shared devices may be programmed to perform different actions by different users, for example.

In one useful application, a button press on an XCB radiotag can cause a location of the XCB radiotag to be archived on a server database associated with the user's account. This location can be accessed by the user's smartphone and displayed on a map if there is a need, for example, a need to return to the spot where a car is parked. When in BT radio proximity, a button press on one of the tracking devices can cause an alarm tone to sound on the owner's smartphone if misplaced, and conversely, the owner's smartphone can cause an alarm tone to be generated on a tracking device as an aid in finding a missing device.

An advantage of including a cellular modem or a 6LoWPAN modem is that the range of cellular or Internet connectivity becomes unlimited where cellular and Internet coverage is available, so finding of missing devices that have been tagged by one of the cellular-enabled or 6LoWPAN-enabled tracking devices or radiotags of the invention extends as a global lost-and-found system 4700.

The “App” installed on smartphone 3270b is used to set up the group of tracking devices and also to set up XCB radiotag 4575,4775, which may have a limited user interface to conserve power when deployed. Once a group 1203,2401,4150 is defined, the XCB radiotag can monitor and report on the group location and the cloud host can send relevant alerts and notifications to the owner via smartphone 3270b for example. In some embodiments, the App may be upgraded using OTA (over-the-air) methods.

Similarly, an image update of firmware in any of the tracking devices or XCB radiotags can be onboarded into the devices using OTA methods as described in EXAMPLES II and III.

XCB radiotags 4575,4775 can also be used as a standalone radio tracker when not part of a group. For example, it may be desirable to attach one to a pet by a collar or to a child's backpack or coat. The XCB radiotag can be programmed to periodically CALL HOME using a cellular connection with a virtual private gateway 4705. The radiotag will report current location, and the server will maintain an archive of chronological location data so that the pet or child can be found or tracked if needed.

### Example XII—Cybernetic Open Network

FIG. 48A is an overview of an IoT layer 2202 as a poly-radio network forming a feedback loop with an AI facility 4707 in a cloud layer 2204. Poly-radio network 2202 includes devices 1800,1900,1400,1601,2311,2360,2390,4575,4600e,4775 and so forth, operating mostly but not entirely in the ISM bands. The feedback loop is characterized by multiple paths, with spillover into the LTE, GSM and Kₐ/Kᵤ for data to arrive 4801 at the cloud layer in the “sky” Multiple paths for onboarding 4802 new software and firmware that update the operation of IoT nodes on the “ground”. Onboarding may include software updates and may impact multiple components of radiotag architecture so as to optimize compact operation of an AI learned model in a battery-powered device. By separating the development of AI learning models and the deployment of AI learned models, a significant compaction is achieved. Each device will also be programmed to adapt its model to its own whitelists, blacklists, and other user-specific conditional rules without direct reliance on the network for coding. The system taken as a whole includes component network entities of cloud layer 2204, IoT layer 2202, DMZ layer 2203, paths 4801 and 4802, but most compactly, the system is a cycle 5000 by which a radio signal topology at ground level is analyzed in the clouds for patterns and predictive correlations are written via a feedback loop to the ground level nodes so that each ground level node can draw its own inferences from the unique pattern of radio signals it is enveloped in.

This distributed approach is related to language learning models of AI familiar to computer science, but is distinguished by the need to write a compact “learned model” to the nodes so that each node, with limited resources, can translate the unique pattern of radio signals it is enveloped in into location-based assessments and logical decisions that it executes with a reasonable level of autonomy, minimal user oversight, and a good UX.

AI may take a number of forms. Model-based reinforcement learning is one approach; but model-free methods are also envisaged, especially for problems having epistemic risk. Risk-aware models can compensate by evaluating uncertainty in all decision processes. This is helpful in building training datasets that do not require deep neural networks for routine operation in predictive learning modes. Ultimately, with very large datasets available and cloud resources scaled to model these datasets, the end product is a set of instructions relatively simple in execution that use local variables and wildcards to derive endpoint-unique solutions and recommendations. This avoids the need for a supercomputer on every wrist and transfers much of the ultimate intelligence to simpler nodes in a larger network. The Scikit-learn model in Python is one example of the development that has already occurred. A sample of the art as currently known shows that this is possible. We assess machine learning by use of regression modelling of parametric data as one approach, machine learning by non-parametric classification as another approach, such as for differentiating positive inputs from spam or malicious code in a message tree using logistic regression or K-nearest neighbor logic to separate the classes. Machine Learning Tree-Based models have broad applicability that lends itself to decision trees, where outcomes are predicted from patterns in a dataset. By combining approaches at the cloud level and provisioning data at the node level, by importing the most up to date “learned model” from the cloud AI learning machine, the node/agents can be established as autonomous decision makers and are capable of multi-turn context: based query and decision. Here we have emphasized BTx radio contact log entries as a large learning dataset, particularly as combined with other sensor information, and the outcomes analyzed are on a scale of 1-3 months, a relatively small memory set sufficient to fit trendlines and to make correlations. With larger memory, the outcome timescale can be advanced to 1-2 years. Given this level of network node situational awareness, and the capacity of users to tap into this heuristic awareness when organizing their thoughts, a cybernetic superorganism emerges.

FIG. 48A simplifies the ideograms of FIGS. 22, 23A/B, 24. In the new model 5000, the system reduces to an IoT node layer of sensors, including radio contact record sensors that capture BTx or Wi-Fi and related radio signal sources as a dataset, and a cloud layer that provides the software and/or firmware for the IoT node layer to be able to remotely and locally process that collection of sensor information, including radio topology, with the most intelligent, heuristic predictive algorithms available, a continuously evolving process as indicated by the feedback loop 5000 (cyclical bold arrows). The evolutionary drive is provided by tying the learning process to improved outcomes in the form of decreased user exceptions, fewer system anomalies that cascade to system failures, increased hours of stable usage, reduced power usage per unit of increased productivity, improved social satisfaction as measured by physiological stress indexes, and so forth, where productivity is measured in the language of cybernetics, a first information transfer rate in bytes/watt, where the bytes that count are those bytes that inform a device decision, such as the decision to notify a user, to display an alarm, to CALL HOME, or to summon community resources, and a second information transfer rate in bytes/watt, where the bytes that count are those bytes by which the user experience is improved as manifested in outcomes: higher personal credit rating, more personal facetime, personal fulfillment, blood pressure and respiration rate, oxygenation and neural tone, heart rate and blood pressure, and user-established goals of time management and goal achievement, for example—while intangible in some aspects, a heuristic and experience-based model. At a system level, the score for renewable energy utilization as a percentage of total usage is constructed and published. Indirect beneficial effects due to wider dispersion of sensor data, such as soil moisture, mean and peak air temperature, windspeed and humidity, promotion of sustainable community interactions, and access to information, including information about each other, are also measured. The AI of this system is first a bottom-up AI, controlled and harnessed for user goals. User adoption is proceeding.

FIG. 48B describes the cycle 5000 as a process or method 4800. In a first step, 4810, the cloud host uses learning models as probability screens for developing testable predictions based on an aggregate collection of radio topology data obtained from IoT nodes, verifying the success rate of the predictions by hindsight, before packaging the algorithms in a “learned model”. In a next step, 4820, the system deploys the “learned model” back to the IoT nodes so that the predictions are tested again, but this time in the arena of real life, where foresight is associated with better outcomes and a better UX. Then, as suggested in step 4830, the IoT nodes report a new batch of radio topology data back to the cloud, along with outcomes measured as user exceptions and system exceptions. User exceptions are parameterized by motion sensors, where healthy levels of activity and sleep are measured, for example. System exceptions are parameterized as the number and frequency of viral cascades of messaging or alerts and the latency of message throughput, or rate of dropped calls or contact events, for example.

Cybernetics is associated with models in which an intelligent arbiter compares the tempo, intensity and classes of events in a system at various sampling times with some standard of what is appropriate (or some target to be evolved), a controller adjusts the system's behavior accordingly, and the arbiter ensures that the control adjustment has successfully reset the tempo, intensity and classes so as to approach that target. Here the process is repeated cyclically as needed to stabilize or direct the system, and by “direct” we include an evolution of location services from minimally impacting to significantly impacting social outcomes and network performance. This definition also allows for evolution of the system to new control set points in response to new conditions or challenges. While the arbiter is a cloud system, a machine in the clouds, the individual user continuously assesses and controls the cloud performance. As an initial training exercise, the concept of cybernetics readily embraces the definition and seeds the kind of Apps, hardware and cloud algorithms or intelligence most useful in implementing the control cycle for administration of location services sensu lato. With AI, the logical progression from language learning models to radio topology models drives the new system 5000 into its fully emergent form as a global lost-and-found system (FIG. 47), and from there to a management utility in maximizing network efficiency, individual health and satisfaction, and collective social success. When all boats are rising, monetization is an afterthought.

### Example XIII—NXP IW612—Plug-In Access Point with PoE

FIG. 49A is a CAD view of a plug-in Access Point device 4900 that is designed to be connected via an Ethernet port on a conventional Wi-Fi modem with router port connectivity, in which the Access Point piggybacks on the Wi-Fi modem's router port connections, but also has a satellite transceiver 4940 and antenna 4926 (FIG. 49E) configured for direct connection 4780 (FIG. 47) to a cloud host 2204,4705,4707 or satellite operator 2205.

Such devices are not intended as solo devices, but are part of a community of like devices that support a community of lookout devices, much as the “community nodal devices” and hubs operate in U.S. Pat. Nos. 9,774,410, 9,900,119, 10,063,331, 10,361,800, 10,389,459, 10,937,286, and 11,403,924, all co-owned at this time of filing and incorporated in full by reference for all that they teach. New life is breathed into a concept by which neighbors help neighbors, community “crowdsourcing” of location information is turned into a global lost-and-found network, and the device is powered by and plugs into an ethernet port on the back of a modem or router. The more devices there are, the better the location data. We have demonstrated this with BTx radiotags, and this is the next step.

In a first build of Access Point device 4900, using a tri-radio SoC with BTx and Wi-Fi, the IW612 chip from NXP Semiconductors, for example, the device collects bitstrings of digital signals from BTx, 6LoWPAN, Wi-Fi and other PAN signals and uses a local correlator or bank of correlators to generate and digest the radio contact logs, essentially as described earlier. In a preferred embodiment, the device 4900 plugs into an RJ45 Ethernet jack on the modem/router, and is powered by power-over-Ethernet at up to 50 or 100 W as needed, essentially as shown in FIG. 46, with standard Ethernet star or bus data connectivity between the device radio or MCU and the modem. An Ethernet male jack 4901 is shown in the several views of FIGS. 49A,49B,49C,49D; the jack is a 4-twisted wire pair jack meeting CAT 6 standards, for example. While it would be helpful to have 10 strands on the jack, the 8-strand jack (4 twisted pairs) 4908 is suitable for a power-over-data connection. Use of a 6-wire jack would likely be reason to design for an accessory power injection jack as a matter of convenience. A power injector, inside or outside the modem, is optional but well within the IEEE 802.3 specifications. The jack connects to the back of a router/modem at an Ethernet port and contains in the housing a PCB with multiradio capacity, multiple antennae, PoE power management, supporting logic circuitry, memory, and capacity to encode and decode Ethernet signals plus the capacity to modulate and demodulate digital radio signals.

Connection of BTx radio data to the cloud is made using a satellite transceiver 4940 and associated antenna 4926. SoC 4940 and supporting circuitry is battery powered. In a first embodiment, chip 4940 is the ORCA3990 direct-to-satellite IoT endpoint connection (Bangalore, IN) with ToTum Labs (San Diego, CA) LEO satellite radio network and Dolphin Design power management ASIC (Meylan, FR). The chip is from GlobalFoundries (Malta, NY) and is a 22 nm chip, reasonably inexpensive for a tracking device. Total package size is on the order of a business card in dimensions, excepting antenna. Output is about 28 dBm at 2.4 GHz. An alternative supplier for chip 4940 is the 28 nm STiD337 satellite transceiver from ST Microelectronics (Tamarac, FL). The satellite devices do not require GNSS and are operative with UART or Ethernet. The object of device 4600e is to supplement a BTx radiotag with Wi-Fi and Satellite connectivity in a package that can plug into an Ethernet port in the back of a Wi-Fi modem or be mounted on a roof when sealed in a suitable exterior housing.

The device housing 4902 includes a composite antenna 4923,4924,4825 (FIG. 49E) for LAN connections. For GAN satellite reach, antenna 4903,4926 is supplied with sufficient isolation from the BTx and Wi-Fi bands, essentially operating as a mini-dish or sat-phone with plug-in capacity to upgrade any home or business modem/router as a piggyback Access Point and direct cloud access to a VPN 2603,4705 or cloud host 35,2350,4707 for example. Signals are routed through the satellite transceiver for uplinking and for receipt of responses. The device housing also encloses an inside battery 4960,4660 sized to operate over extended power outages but in normal operation is fully charged by the PoE connection 4901.

In this example, the business of the cloud network/host is to provide location-based services, and the plug-in Access Point 4900 is a way of collecting location information on devices within radio proximity to the plug-in device, perhaps a 100 yard radius. Using Wi-Fi signal collection, that radius can be increased perhaps five-fold on the condition that interference can be managed, a problem that the BTx radio protocol has largely solved. The satellite transceiver gives global lost-and-found reach and even at 28 dBm is minimally disruptive of BTx radio operation. These Access Point plug-in devices may be installed in residences or businesses and provide lost-and-found services to the device owners—but while also providing a layer of service to the community at large, worldwide, our “community crowd-sourcing solution” updated to include these plug-in devices as network ears. Each private owner benefits from the community of Access Point plug-in devices, just as the operators of radiotag services have demonstrated that larger communities of users accrue greater value with each new owner and user. Thus the device 4900 is a super-radiotag, and a super-provider of location-based services, having the capacity to make redundant the smartphone that currently is an essential accessory in radiotag lost-and-found business models such as the Find My® network operated by Apple Computer (Cupertino, CA). The devices 4900 operate with a RAM data logger to log BTx radio signal topologies chronologically and exports those datasets to our cloud host 4707 as a way of finding lost devices in our database. The data logger can also capture other radio signals as new uses are found for de-identified radio signal data in large learning model datasets.

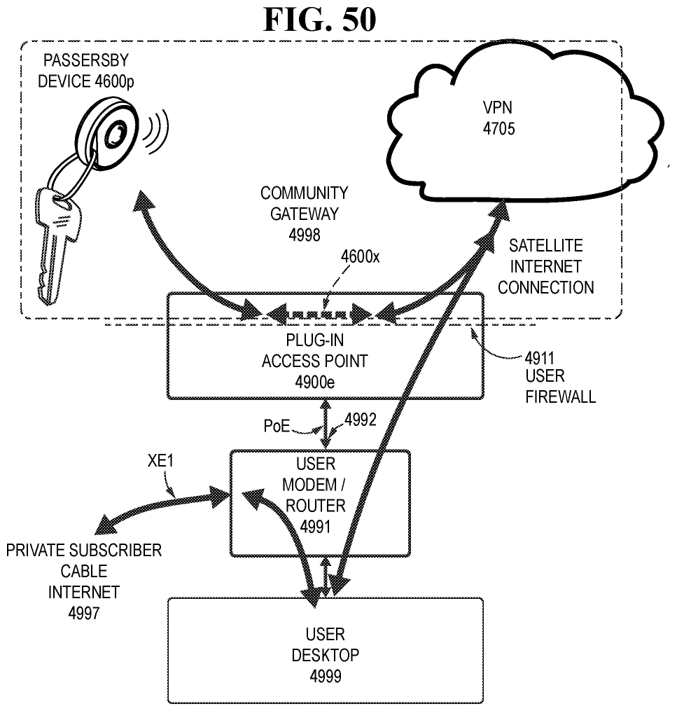

Ultimately, this device, with direct ground-to-cloud, cloud-to-ground connectivity 4921,4922 via a VPN 4705, for example, is able to bypass not only the DMZ layer 2203 and handset 30,70,3270 but also the cable and telecomm operator layer of Wi-Fi modems (FIG. 50), allowing the business operator of the cloud host to establish a new business, starting with provision of location-based services, but branching into other wireless services ranging from VOIP, video streaming, to banking and remittances, for example. In one instance, Access Point 4900 may replace, not supplement, the modem's IO data link. Like BTx, where 25 years has seen the number of units in use rise to 25B worldwide, the device fuels its own business growth, and offers a basket of low-fee services to sustain the global infrastructure and cloud overhead for an explosive growth curve worldwide.

By a cybernetic process, a plurality of Access Point devices collectively upload a plurality of Bluetooth radio contact logs from a neighborhood, city, region, or continent to the cloud host. The cloud host receives the uploaded Bluetooth radio contact logs, aggregates the data with de-identification, runs a heuristic model that associates an outcome with one or more learned patterns in one or more of the radio contact log entries, generates a new instruction set for capturing radio contact logs and providing location-based services, and downloads the new instruction set to the Access Point devices, where it may be shared on a LAN. A smartphone App may be supplied to maximize resulting services so as to accelerate user adoption. Having received the teaching model, using edge computing as an advanced distributed AI platform, the Access Point devices provide location-based services to a user/owner, while also providing the (1) global lost-and-found services to the community at large and other at-large services such as (2) call-home service that overcomes the need for a smartphone, as was a limitation of our earlier rollout and is an advance in the art. Outsmarting the smartphone is not the primary goal, a more ambitious goal is to build an inclusive, open network in which the IoT truly becomes a shared resource.

In one embodiment, the upper curved planar surface or cap 4903 that covers the radio gateway antenna of the stalk 9602a is radiolucent, but may also function as a fractal antenna for synthetic radio or as a transparent OLED (TOLED) screen to aid in setup, status reporting, and troubleshooting. Otherwise, selected LEDs (not shown) on the lip of the cap 4903 may be installed to show basic modem connection status. The goal is to optimize the UX. In other embodiments, the radiolucent cap covers a radio-reflective dish fashioned as a “hearing aid” and designed to concentrate s ie radiowaves for a pick-up antenna inside.

Optionally, the antenna may be rotated on two axes (curved arrows) in the XY axis and in the XZ axis to optimize reception or to minimize signal blockage if needed. With satellite microwave antennae, directionality and an exposed horizon is typically important. Optionally, while shown as an ear, the stalk and cap can instead take the form of an inverted dish or a partial dish as needed to transmit and capture LEO radio waves with improved efficiency. The BTx antenna may be mounted on the stalk and multiple Wi-Fi antennae on lip 4903a may be used for MIMO reception if desired. This filing is the first realization of a satellite dish with BTx signal collection linked to a global lost-and-found cloud system 5000.

Base 4904 is supplied with semi-elastic standoff pads 4905 to engage the back wall of the modem/router, providing additional support to the stalk, but also tensioning the releasable clip of the Ethernet male RJ45 connector so that a firm and steady engagement is secured. The base may include battery 4660, or the battery may be installed in the stalk 4902a.

In yet another embodiment, device 4900 functions as a satellite user terminal with a 40 cm dish (not shown), may be connected to the router/modem by a flexible CAT 6 cable, for example, and may be mounted on a rooftop, balcony, tree, pole, eve, or other raised support well positioned to send and receive satellite signals and at the same time to surveil the local area for its radio LAN and BTx signal topology. Note that entrants to the radio local area, such as a delivery truck or a mailman, will be picked up by the BTx antenna 4906 or the Wi-Fi antenna 4907 in the enlarged cap, and a “NEW CONTACT ALERT” may be generated and sent to an owner-user's smartphone to precede the delivery of the mail or the knock on the door by a minute or more, for example.

Similarly, a passerby who decides to take a closer look in the window or to try the doorknob may set off an alert based on radio proximity.

While the device 4900 is shown in FIG. 49 as a compact unit for indoor mounting on a desktop router/modem, in another embodiment the device may be disc-shaped and functions as a satellite dish inside an optional weather dome. Satellite signal round trip latencies are a matter of physics, not electronics, but the satellite business wing has the advantage that it does not observe borders. While ToTum network satellites are operative at 2.4 GHz, other satellite networks typically transmit in the Kₐ (26.5-40 GHz) and Kᵤbands (10-18 GHz) or higher, and the signal is processed in a frequency converter to be demodulated for Wi-Fi and Ethernet. For example, Starlink (Hawthorne, CA) antenna are stated to be based on Wi-Fi 5 dual band meeting the IEEE 802.11a/b/g/n/ac standards that consume 50-75 W and require a RFFE wavefront-steering phased array of patch antennae with shared clock IC to track satellites. Interestingly, the Starlink network is variously reported to operate in licensed bands over a range of endpoint-to-satellite uplink 14.0-14.5 GHz and 47.2-50.2 GHz and 50.4-51.4 GHz, satellite-to-terminal 10.7-12.7 GHz and 37.5-42.5 GHz in Kᵤ (12-18 GHz), Kₐ (26.5-40 GHz) and V (40-75 GHz) bands, well in the microwave range, which are not expected to generate local crosstalk interference with the BTx or Wi-Fi radios at reasonable amplitudes. Satellite dishes, whether table-sized or pocket-sized, have not been created which include frequency converters for a BTx radio packet transceiver or a 6LoWPAN radio packet transceiver so as to act as a local “Hot Spot” for BTx 4906 and Wi-Fi linkage 4907 on board having local RF transceivers at 2.4 or 5 G=z, such that the XWB devices are an advance in the art with unexpected functional synergies in global IoT networks by permitting 3d parties to make use of a wireless uplink/downlink while securely isolating owner-user access and control in a private domain. Crowdsourcing satellite resources is Novel.

A piggyback network IP signal envelope is developed and implemented in the firmware of device 4900 so that the poly-radios of the inventive devices are able to share signals. WiMAX is a competing technology but in no way does it offer the utility and widespread adoption of BTx. Instead, with a simple repackaging of the BTx signal payload 3925 in an IP envelope as shown in FIG. 39, a BTx-satellite device 4900 has the potential to be very disruptive in access to information and social connectivity in the United States while repeating this success globally. The BTx radio proximity-based services are differentiated from services provided by GlobalStar (U.S. Pat. No. 8,913,960, RE35829), OneWeb, ToTum and Starlink, for example, by providing multiple pathways across the DMZ 2203 for radio proximity data such that the system 5000 is not dependent on any particular external proprietary support.

IPv6 and ANP are well-established, and provide another way of creating an RUI for use in tagging IoT devices such as the radiotags disclosed here, and likely will lead to emergent functions inherent in the radio structures and networks of this invention when cross-over signal architectures compatible with BTx payloads are implemented.

### Example XIV—Sharing Radio Contact Records

In this last example (FIGS. 49E and 50), the concept of whitelisting “familiar locations” by radio contact “snapshots” and modifying BTx behavior in “alien” radio topologies as discussed earlier is extended. A new and potentially more significant social dimension is realized with surprising implications. Here we present a cybernetic loop 5000e as was shown in FIGS. 47, and 48a, but with more granularity as a specific case study 4910 using XWB device 4600e grounded by a PoE tri-radio device plus satellite transceiver 4616 in miniature package. Two embodiments are envisaged, in one case the satellite dish or wand 4616a is part of a larger fixed-position device and the ethernet connection is the default condition; in the other case, the device is pocket-sized and the ethernet connection is female jack socket (not shown) with gasket. So in one case, the device may be a home computer accessory or even a rooftop installation, in the other case, the device may be pocket sized or even small enough to use as a keybob.

As a problem statement, recall the description of “radio contact log” given in FIGS. 41 and 42, and note that Twitter “friends” or friends on Facebook do not result in any gain in diversity or signal count for the BTx radio contact log 3900,4001. Sending a thousand emails to a friend's list makes no mark on a BTx radio contact log and increases no social standing score. The risk of social isolation in a virtual cocoon is higher today than ever before. In contrast, walking into a classroom of fellow students, taking in a football game, or going to lunch with friends blossoms the BTx radio contact log with positive signal diversity and signal abundance. The electronic cocoon of an online social life is blown open and the BTx log serves as a parameter or index for measuring the social difference in a lifestyle of meeting people in person versus having remote interactions. The social implications are vast, and we provide a means for quantitating that face-to-face interaction parameter of an individual's social life which is established because of the radio-proximity requirement for generating a BTx radio contact.

BTx social contacts have the effect of overlapping the radio signal envelopes of the PAN that surrounds each person and the LANs of the background community. An overlap in PANs is recorded in BTx radio contact log records 4000,4100. Continuing, when the logs from two persons or a group of persons in close contact are shared on the cloud or in interpersonal radio connections, the log entries, as a matched overlap list, where the uniquely separate contacts in each list are as significant as the shared contacts, has the effect of parameterizing a social index of personal interactions if measured daily, as can be, taken as a trendline, a predictor of success in certain age groups, can identify excessively introverted individuals, traumatized individuals, and individuals with strong skills in converting mesh networks of a radio topology into real-life interactive personal relationships. The capacity to share radio contact logs through the system is a measure of trust, transparency and goodwill, and may also be of value to parents. Transparency is sharing, so that one person's network becomes a piece in a satellite view of global mesh networks; the number of hops to get from person A to person B is an index of societal connectedness, fulfilling Haartsen's vision for BTx (U.S. Pat. Nos. 6,590,928, 7,280,580). The social implications are disruptive of several large tech businesses, where remote connection has no person-to-person foundation in an empty meta-universe.

The difference between X-dot.com friends and real friends becomes quantifiable as a simple Venn diagram. And in the same manner that Linked-In is able to extract a monthly subscription for tracking business associations and contacts, the BTx radio envelope, added to a Wi-Fi radio envelope, becomes a measure of and a resource for making direct personal contacts that can be cultivated to improve success and personal satisfaction in any endeavor. The capacity to network has long been held to be a virtue and a tool for success, so that an “opt in” business model of our cloud model 5000,5000e provides incentive for users to share their BTx radio contact logs with each other or with the cloud, and to build personal relationships from virtual relationships. This level of social intelligence, the capacity to network at an IoT level 2202, is made accessible by the miniaturization of memory and processors such that the PAN becomes a basic individually controllable learning module in engineering distribution of information and power, and in scoring success. Once a group of individuals is in possession of a shared set of radio contact logs, our device's 4600e,4900e behavior is instantly modified from piconet to meta-mesh, giving autonomy to devices in the shared radio logs to stay connected using alternate radio modes that merge LAN, WAN and GAN, their radio domains and their situational awareness.

Referring again to FIG. 49E, device 4900e include a housing and printed circuit board operable as a tri-radio device with satellite transceiver and processing power for local autonomous acquisition of sensor data, administration of local network resources, and capacity to both supply and request location-based services. Satellite transceiver 4940 is operated on a common bus with the tri-radio, the MPU and the smart correlators, but has its power supply direct from the battery or Ethernet jack that connects at XE1 to an external LAN hub such as a cable Internet drop 4997. Internet connector XE1 may be an Ethernet cable, a DSL cable, a telecomm cable, or a Wi-Fi link for example.

In this block diagram, a cloud layer 2204 is in direct communication with an IoT layer 2202. The handset interlocutor layer 2203, previously characterized as a two-headed funnel, is not shown because it is not needed, a revolutionary concept. Tri-radio chip 4931, represented by the new IW612 (NXP88W9098) family from NXP Semiconductor, has capacity to bridge ground-based low power IoT devices such as BTx radiosets (shown here are BTx devices 4775 and 4900e) with cloud resources (shown here as a virtual private gateway 4705 and cloud host administrator 4707 as previously discussed (FIG. 47) via a Wi-Fi Access Point or via a satellite link. The cloud host 4707 is operated to provide location-based resources in its initial launch and includes an administrative engine, a network engine, APIs for interfacing with other cloud and user programming, and data 4710, here including a learning model dataset collected as radio contact records from a large and growing population of users in exchange for the location-based resources. VPG 4705 is a screening resource used to isolate the cloud host from unwanted intrusion and to host WebApps that make easier setup and interconnection for various user devices.

Device 4775, an XCB radiotag, has been discussed with reference to FIGS. 45 and 47. While it is a supernode, with capacity to link to the Cellular network, here it is considered primarily for its capacity to participate in layer 2202.

In a first embodiment, device 4900e is powered primarily by the use of PoE rather than battery power (battery may be a backup power), limiting it to a fixed location installation for the most part. While it is conceivable that a larger lithium rechargeable battery and a few upgrades with speaker, microphone and display could make this a nice pocket toy, the intent here is to build a new link, satellite and Access Point into the IoT device for direct communication with our cloud host 4707 via gateway 4705, which may be a satellite gateway, a cable gateway, or a DSL gateway, for example. Bridging link 4921 is a radio traffic link forming the upswinging arm of feedback cycle 5000e that includes the transmissions from radio 4940, a LEO satellite radio, for example, much in the same way that a satellite dish or sat-phone operates. Device 4900e is an Access Point, but to bypass terrestrial links to cable and telecomm hubs, the device may tie in directly to a satellite relay 2205 to the cloud layer 2204. Similarly, cloud traffic to device 4900e is received by GAN radio 4940 and antenna 4926 and demodulated before distribution to smart correlators 4932 and MPU 4950 over links 4941,4952. Links or bus 4952,4941 are bidirectional and also conveys outbound message traffic from MPU 4950 to any one of the SDIO radios of modems 4931 or 4940. Feedback cycle 5000e is closed by traffic on loop 4922, which carries cloud learned models, user permissions and configuration data to one or more IoT devices of layer 2202 via interlocutor device 4900e. A central role of cloud 4707 or equivalent cloud resources is to configure cycle 5000e to optimize outcomes for the community of users and for individuals. Recovery of a set of lost keys 4775 is just a first example of the location-based services we have demonstrated using related networks. Groups of the owner-user's radiotags may also be monitored as described earlier. In this more ambitious network, the goals include network power consumption optimization, control of remote devices, detection of stalkers, cultivation of positive associations, introduction of friends in one circle by arranging meetings with friends in another circle, for example.

Radio 4940 operates at 20 to 100 W, whereas radio 4924 is a LAN Wi-Fi radio and generally consumes <20 W. Radio 4923 is a BTx radio. Radio 4925 may be configured for 6LoWPAN, UWB or other PAN radio requirements. While not shown (see FIG. 46), a GNSS radio and processor may be provided if needed, but in some instances, the satellite link through radio 4940 enables synergic global positioning as an external service (using a satellite with geolocation circuit), eliminating the need for a GNSS chip from the device's energy budget. In other instances, finding the location of a Bluetooth radiotagged item may be a process that combines Cellular radio location means, Satellite radio location means, and Bluetooth radio location means so as to minimize network traffic and energy consumption. The global lost-and-found service is configured to optimize its services according to user needs and network availability.

Device 4900e is unique in that Internet signals are received across RJ45 plug 4901, but may also be received from radio modems 4940 or 4931. In fact, radio modem 4940 can relay signals received on BTx radio antenna 4923 (with associated BTx radio modem) to the cloud. Thus there are three (4941,4952,4953) data bus links to MPU 4950: a first 4953 from the user's LAN 4990 via Ethernet connection 4901, a second 4952 from chip 4930 with the tri-radio modem 4931 and correlator memory bank 4932, and a third from the satellite modem-to-cloud link at 4940.

As a bill of materials, the smart Access Point 4900e, independent of form factor, may include a tri-radio SoC with companion antennae, a satellite transceiver with antenna, a processor and supporting logic and memory circuitry, a radio contact logger with programmable correlator registers, and a power-over-ethernet power supply with RJ45 plug.

By erecting a firewall 4911 (FIG. 50) between processor 4950 (starting at Ethernet data ENDEC 4949 and from jack 4901), third party data or probes entering at antenna 4923 or 4926 does not penetrate or intrude to the user's LAN 4990 and private computing domain 4999. The firewall 4911 is a hard air gap with diode protections where antennas are shared. Outside user's data may be piggybacked on antenna 4926 for transmission to the cloud host independently of the XWB device role in bootstrapping owner-user communications through LAN 4990 (and any associated devices such a laptop or smartphone) via modem router 4991 to MCU 4950 or to cloud host 4707. This takes advantage of the capacity to operate the Wi-Fi antennas and the BTx antenna concurrently in this chipset, and at a conceptual level, extends our concept of crowdsourcing location services from our initial patented model (in which we supplied radiotags configured for capturing BTx signals and forwarded them over smartphones to our cloud host so as to compare the RUI with a database of User Profiles and reported lost radiotags, then sending notifications to users via their smartphones if the lost radiotag is located) to a model in which we supply Wi-Fi modems equipped to do the same job, while not burdening the owner of the modem or even alerting the owner of any cross-traffic, which is flushed from the system as quickly as it is relayed (with the exception that the radio contact is logged).

Surprisingly, the BTx radio is able to operate concurrently with Kₐ/Kᵤ band transception. The symbiosis is a compelling value proposition: the owner of the host modem is offered a basket of location services plus a package of notifications ranging from home intrusion alerts to notifications that the mailman has dropped off the mail, or a ten-second notification that you just left the office without your wallet (left in the other jacket), or a button-actuated alert that your smartphone is under a pillow on the couch. In this model, the consumer has an ‘opt in’ option by which these services are granted in exchange for our capacity to surveil the neighborhood for its radio topology and report a radio contact log collected by correlators 4932 (optionally operated with RAM data logger 3230,42) to our server 4707 on a regular basis.

Power for device 4900e is provided by chip 4951 that receives power from the Ethernet RJ45 jack 4901 and separates the DC power from the data, which is shunted to chip 4949, where it is decoded. Similarly, data is loaded onto the Ethernet bus exiting plug 4901 by encoder chip 4949 and is received by the user's router 4991 for sharing with private LAN 4990. This data includes not only radio contact data received from device correlators 4932 on chip 4930, but also sensor data obtained locally from personal BTx sensor packages 4955 and from passersby BTx sensor packages, and again, also input from the cloud host via link 4922. This link can transmit firmware that updates the radio contact log capture protocol, for example, as described in FIG. 48A and that software or firmware can be supplied to multiple devices of a mesh network or piconet.

This device may be supplied with a user interface that can be used to troubleshoot Ethernet network setup or operation and to detect data leakages, rather than relying on an App loaded on a smartphone. The device may be given authority by the user to repair Ethernet modem MAC and Link Layer assignments and to provide the user with more control of system updates that include changes in LAN addressing and drivers, for example as a less stressful and more rewarding UX. The modifications of the user interface and the internal circuitry will be discussed in a next filing.

FIG. 50 is a simplified view of the hybrid “crowdsourcing” of global lost-and-found services achieved with introduction of a super-radiotag LAN/WAN/GAN product, focusing on the concept. In this view, the user operates a desktop computer 4999 and uses a ported gateway connection 4997 with modem 4991 and plug-in Access Point 4900e to connect to the cloud through a cable link XE1 and through a cloud link at Ethernet jack 4992. On the back of the modem 4991, an Ethernet router port 4992 is provided having a female connector for receiving an 8-bit wire RJ45 Ethernet jack. The user plugs in device 4900e and the device configures itself autonomously to connect to the computer as part of a tree of interconnections of LAN 4997 and to the Internet via satellite antenna 4926 (FIG. 49E) and via the PoE Ethernet data port 4992 to Access Point 4900e. In this Multicloud setup, the Internet provided via cable 4997 is separate from the cloud access provided through VPN 4705. This is not redundancy: it is a recognition that the cloud is a multicloud resource and can be shared and sliced from different access points.

This is essentially a modified drawing akin to system 4910 (FIG. 49E), but emphasizes two parallel and independent activities that may occur concomitantly by users who have never met. Two use cases are demonstrated. In a first use case, an owner/user does routine computing in which data is exchanged across a cable internet drop XE1 and in another case, device 4900e provides a direct satellite line to cloud host 4707 and related cloud content via associated cloud resources, via satellite antenna 4926.

The owner/user also benefits from local radio topology surveillance provided by the antennae 4923 and 4924 plus some benefits in PAN networking using radio antenna 4925 for more precise local triangulation or for addressing network traffic on an IPv6 addressable network. Software may be provided to registered users to make the most of these services, including software or firmware upgrades installable not only on desktops, but also on laptops and smartphones. In addition, the global finder service becomes naturally a combined “one-stop” solution by providing a line of radiotags adapted for making the most of these services. Such tags include all of the BTx radiotags, XCB and XWB radiotags introduced here. In one future, the radiotags are compatible on a universal standard, like 911 service.

In a second use case, a passerby is surveilled by device 4900e, the passerby's XWB or BTx radiotag 4600p is detected and logged as a radio contact, but the radiotag 4600p is also able to make a BTx link to device 4900e via satellite modem 4940 and antenna 4926 up via link 4600x to cloud VPN 4705 and cloud 4707. In this exchange, device 4600p updates location information and uploads its latest radio contact log 4000,4100. The cloud host 4707 harvests this latest windfall, screening hits for address information consistent with any known lost radiotags in its records 4710. The cloud, if it finds a lost radiotag, can notify the owner of the lost item of the proximate location in which the lost device's radio signature was encountered, perhaps giving the owner enough information to recover the lost radiotag and any associated lost item from the passerby, whatever the circumstance. And the information may be much richer, and lend itself to other uses, but this example gives a simple rationale for deploying such a system 4998 in urban, suburban and even rural areas, and in vehicles, all of which lend themselves to monetization for recovery of costs of the infrastructure plus a reasonable return.

Is this superveillance? In a very democratic sense, it is a bottom-up capacity to put radio networks to work doing what they were designed to do, breaking out of the X-box or Facebook box; engineering the system 5000,5000e so that the user becomes the creator and controller of individual and community networks that share for success, starting with a simple mission to provide lost-and-found or location-based services, and building trust from there. With newly developed capacity to stream voice and longer messages, BTx is bundled with our XWB and XCB poly-radio devices, challenges SMS, MMS, WhatsApp, WeChat, Line, and Paltalk for user attention in local and global networking by radio contact discovery, with or without a smartphone. While the Multicloud 3300,3400 is increasingly seen as an interlocutor of all things economic and social in a handset-centric world, the miniaturization of electronics offers AI at our fingertip in a pocket-sized multi-radio device 1601,1800,1900,4575,4600e,4775,4600p (complemented by device(s) 4900e) and the BTx and multiradio devices become a tool to re-engineer social networking from the ground up. We refer to Haartsen U.S. Pat. Nos. 6,590,928, 7,280,580, and EP1119991 for that inspiration.

### INCORPORATION BY REFERENCE

All of the U.S. Patents, U.S. Patent application publications, U.S. Patent applications, foreign patents, foreign patent applications and non-patent publications referred to in this specification and related filings are incorporated herein by reference in their entirety for all purposes.

### SCOPE OF THE CLAIMS

While preferred embodiments of the invention have been shown and described, modifications and variations may be made thereto by those of ordinary skill in the art without departing from the spirit and scope of the present invention. Furthermore, those of ordinary skill in the art will appreciate that the foregoing description is by way of example only, and is not intended to limit the invention, except as further described in the appended claims. Those skilled in the art will understand that other and equivalent components and steps may be used to achieve substantially the same results in substantially the same way as described and claimed.

It is intended that the scope of the invention be defined by the following claims and their equivalents as claimed here, while not precluding or prejudicing future applications having claims directed more broadly or more narrowly at the scope of the disclosure.

The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention. Accordingly, the claims are not limited in haec verba by the disclosure and any original claims that are cancelled or withdrawn during prosecution of the case remain a part of the original disclosure for all that they teach.

1-80. (canceled)

81. A system having a BTx radio network of a plurality of BTx radiotags and a plurality of handsets, the handsets defining multiple kinds of handsets, each kind of handset executably enabling an exclusive bonding protocol, the radiotags and handsets having the capacity to form paired bonds as an electronic ownership relationship that finds use in lost-and-found BTx network functions, wherein the radiotag comprises a multi-threaded processor, a user interface, a memory, and processor-executable instructions in firmware, wherein the processor-executable instructions comprise means to sense the kind of handset that characterizes a radio-proximate handset, and means to reversibly adapt the firmware in radiotag memory to bond the radiotag with the radio-proximate handset by an exchange of BTx kind-of-handset compatible radio messages, such that the exclusive bonding protocol is successfully completed between the radiotag and any one handset of the multiple kinds of handsets, said bond-of-ownership operation is completed automatically by a sensed user intent, and is reversible by a factory reset on the radiotag initiated by an owner of an exclusively bonded radiotag-handset pair.

82. A BTx radiotag configured to provide global location-based services, which comprises a multithreaded processor, user interface, volatile and non-volatile memory, and processor-executable instructions in firmware; which further comprises a volatile-radio-contact log (“log memory”) memory, the firmware when executed by the processor causes the radiotag to intercept and record in the log memory a bitstring part of any radio signal beginning with a preamble recognizable as an BTx radio signal preamble as is interceptable from a radio transmitter in a radio-proximate ambient environment, the bitstring part comprising any part of an access code, any part of a message header or headers, or any part of a message payload of the radio signal; and further comprising means for generating a location-based service if the contents of the log memory, taken as a whole, is correlated with a signal pattern that is predictive of a location-based outcome or a sequence of location-based outcomes.

83. The BTx radiotag of claim 82, wherein the location-based outcome is predicted without access to an identity of the proximate radio transmitter or the bitstring part or parts has been deidentified of any user-identifiable information about the radio transmitter.

84. A BTx radiotag comprising a sensor, wherein the sensor is configured to cause a map of the Bluetooth radio topology around the radiotag to be recorded and tabulated in a table as a function of time and location and the table is populated with one or more sensor information data points.

85. The BTx radiotag of claim 82, wherein the pattern that is predictive is learned.

86. The BTx radiotag of claim 85, wherein the pattern that is predictive is learned by a process, executed by the BTx radiotag, of uploading the contents of the radio-contact log memory to a system server and, from the system server, receiving a pattern recognition algorithm executable and storeable by the multithreaded processor of the BTx radiotag such that the pattern recognition algorithm is executed independently by radiotag device and periodically updated at user-defined or system-defined intervals from the system server,

87. The BTx radiotag of claim 86, wherein the pattern recognition algorithm that is predictive is learned by a process, executed by the BTx radiotag, of uploading the contents of the radio-contact log memory to a handset in radio proximity thereto, and, from the handset, receiving a pattern recognition algorithm executable and storeable by the processor of the BTx radiotag such that the pattern recognition algorithm is executed by the processor of the radiotag,

88. The BTx radiotag of claim 86, wherein the pattern recognition algorithm that is predictive is learned by a process, executed by the BTx radiotag, of uploading the contents of the radio-contact log memory to a handset in radio proximity thereto, and, from the handset, receiving a summary of the pattern recognition algorithm output so that the radiotag is effective in recognizing alien radio locations, at least a few radio locations, and a whitelist of familiar radio topologies in the ambient radio environment without making a query to the handset.

88′. (canceled)

89. The radio network system of claim 81, wherein the bond-of-ownership operation comprises a share-privileges operation.

90. The radio network system of claim 81, wherein the bond-of-ownership operation comprises a share-sensor data operation.

91. The BTx radiotag of claim 82, wherein the firmware and the radio-contact log memory is updateable over the air (OTA) with user intent.

92. The BTx radiotag of claim 82, wherein the radio-contact log memory is populated cyclically by messages intercepted from handsets, BTx radiotags, and Bluetooth transmitters that populate a location or that populate a route of travel, and further wherein the radio-contact log memory can be labelled for future use while starting a next radio-contact log memory.

93. The BTx radiotag of claim 92, wherein the radio-contact log memory is uploaded cyclically to a handset or to a cloud host.

94. The BTx radiotag of claim 82, wherein the proximate radio transmitter is a smartphone.

95. The BTx radiotag of claim 82, wherein the proximate radio transmitter is a transceiver.

96. The BTx radiotag of claim 82, wherein the proximate radio transmitter is an BTx hub, said hub defining a hive.

97. The BTx radiotag of claim 82, wherein the proximate radio transmitter is a “Bluetooth device”, such that the meaning of “Bluetooth” is taken generically.

98. The BTx radiotag of claim 82, wherein the radiotag comprises a rechargeable battery.

99. The BTx radiotag of claim 98, wherein the radiotag comprises a circuit configured to recharge the battery.

100. The BTx radiotag of claim 99, wherein the circuit configured to recharge the battery is a circuit configured to inductively recharge the battery.

101. The BTx radiotag of claim 82, wherein the radiotag is disposable.

102. The BTx radiotag of claim 82, wherein the radiotag comprises a multi-threaded processor configured to execute alternative broadcast instructions from firmware threads until a correlator match dependent on the kind of handset results a successful bond-of-ownership operation.

103. A network system comprising a plurality of BTx radiotags of claim 84, wherein each radiotag is programmable to:
i) write and store a first whitelist to flash memory, the whitelist comprising a list of location-associated radio snapshots of familiar locations;
ii) write and store a first blacklist to flash memory, the blacklist comprising a list of location-associated radio snapshots of familiar locations;
iii) with a level of certainty, identify a location on the whitelist from a radio snapshot of a current location in real time;
iv) with a level of certainty, identify a location on the blacklist from a radio snapshot of a current location in real time; and
v) with a level of certainty, distinguish and flag an unfamiliar radio snapshot that corresponds to an alien location; and,
vi) generate a programmable action or notification based on a classification or flag of any location as on the whitelist, on the blacklist, or as an alien location.

104. The radiotag of claim 82, further comprising a sensor selected from accelerometer, impact sensor, displacement sensor, photocell, Hall effect sensor, magnetic field sensor, electromagnetic field sensor, gyroscope sensor, motion sensor, vibration sensor, heading sensor, radio proximity sensor, battery charge sensor, radio signal angle of incidence sensor, temperature sensor, altitude sensor, velocity sensor, pressure sensor, windspeed sensor, humidity sensor, button sensor, switch continuity sensor, resistance sensor, chemical sensor, gas sensor, sound sensor, optical sensor, biometric sensor, physiological function sensor, friend sensor, social interaction sensor, geofence sensor, radio leash sensor, user intent sensor, signal density sensor, location sensor, GNSS sensor, GPS sensor and Bluetooth-radio sensor, wherein sensor output is termed “information” or “sensor data”,

105. The network system of claim 103, wherein the each radiotag is programmable to execute a comparison process in which two or more radio snapshots are compared, to detect a change in the current radio environment of the each radiotag by the comparison process, and to distinguish movement of the radiotag from movement in the radio snapshots as measured by accelerometry or velocity.

106. The network system of claim 103, wherein the each radiotag is programmable to execute a comparison process in which two or more location snapshots are compared from two or more of the each radiotags that define a group of radiotags, and to detect anomalous movement of any one or more radiotags of the group of radiotags by the comparison process.
